(19) United States
(12) Patent Application Publication
(10) Pub. No.: US 2013/0184161 A1
(43) Pub. Date: Jul. 18, 2013

(54) Methods and Systems for Medical Sequencing Analysis

(71) Applicants: Stephen F. Kingsmore, St. Augustine, FL (US); Callum J. Bell, Santa Fe, NM (US)

(72) Inventors: Stephen F. Kingsmore, St. Augustine, FL (US); Callum J. Bell, Santa Fe, NM (US)

(21) Appl. No.: 13/586,932

(22) Filed: Aug. 16, 2012

Related U.S. Application Data
(63) Continuation of application No. 12/910,764, filed on Oct. 22, 2010, now abandoned.
(60) Provisional application No. 61/254,115, filed on Oct. 22, 2009.

(51) Int. Cl. G06F 19/22

(52) U.S. Cl. CPC G06F 19/22
USPC 506/2; 435/6.11; 702/19

(57) ABSTRACT

Disclosed are methods of identifying elements associated with a trait, such as a disease. The methods can comprise, for example, identifying the association of a relevant element (such as a genetic variant) with a relevant component phenotype (such as a disease symptom) of the trait, wherein the association of the relevant element with the relevant component phenotype identifies the relevant element as an element associated with the trait, wherein the relevant component phenotype is a component phenotype having a threshold value of severity, age of onset, specificity to the trait or disease, or a combination, wherein the relevant element is an element having a threshold value of importance of the element to homeostasis relevant to the trait, intensity of the perturbation of the element, duration of the effect of the element, or a combination. The disclosed methods are based on a model of how elements affect complex diseases. The disclosed model is based on the existence of significant genetic and environmental heterogeneity in complex diseases. Thus, the specific combinations of genetic and environmental elements that cause disease vary widely among the affected individuals in a cohort. The disclosed model is an effective, general experimental design and analysis approach for the identification of causal variants in common, complex diseases by medical sequencing. Also disclosed herein are methods of identifying an inherited trait in a subject. The disclosed methods compare a reference sequence from a subject to a library of sequences that contain each mutation. For a given mutation, a normal sequence read aligns best to the normal library sequence. A read having the mutation aligns best to the mutant library sequence. The disclosed model and the disclosed methods based on the model can be used to generate valuable and useful information.

### BACKGROUND

Medical sequencing is a new approach to discovery of the genetic causes of complex disorders. Medical sequencing refers to the brute-force sequencing of the genome or transcriptome of individuals affected by a disease or with a trait of interest. Dissection of the cause of common, complex traits is anticipated to have an immense impact on the biotechnology, pharmaceutical, diagnostics, healthcare and agricultural biotech industries. In particular, it is anticipated to result in the identification of novel diagnostic tests, novel targets for drug development, and novel strategies for breeding improved crops and livestock animals. Medical sequencing has been made possible by the development of transformational, next generation DNA sequencing instruments, such as those, for example, developed by 454 Life Sciences/Roche Diagnostics, Applied Biosystems/Agencourt, Illumina/Solexa and Helicos, which instruments are anticipated to increase the speed and throughput of DNA sequencing by 3000-fold (to 2 billion base pairs of DNA sequence per instrument per experiment).

Common, conventional approaches to the discovery of the genetic basis of complex disorders include the use of linkage disequilibrium to identify quantitative trait loci in studies of multiple sets of affected pedigrees, candidate gene-based association studies in cohorts of affected and unaffected individuals that have been matched for confounding factors such as ethnicity, and whole genome genotyping studies in which associations are sought between linkage disequilibrium segments (based upon tagging SNP genotypes or haplotypes), and diagnosis in cohorts of affected and unaffected individuals that have been matched for confounding factors.

These methods are based on the assumption that complex disorders share underlying genetic components (i.e., are largely genetically homogeneous). In other words, while complex diseases result from the cumulative impact of many genetic factors, those factors are largely the same in individuals. While this assumption has met with some success, there are numerous cases where this commonality has failed. Progress in dissecting the genetics of complex disorders using these approaches has been slow and limited. Software systems for DNA sequence variant discovery operating under this assumption are inadequate for next-generation DNA sequencing technologies that feature short read lengths, novel base calling and quality score determination methods, and relatively high error rates.

Therefore, what are needed are systems and methods that overcome the challenges found in the art, some of which are described above.

### SUMMARY

Disclosed are methods of identifying elements associated with a trait, such as a disease. The methods can comprise, for example, identifying the association of a relevant element (such as a genetic variant) with a relevant component phenotype (such as a disease symptom) of the trait, wherein the association of the relevant element with the relevant component phenotype identifies the relevant element as an element associated with the trait, wherein the relevant component phenotype is a component phenotype having a threshold value of severity, age of onset, specificity to the trait or disease, or a combination, wherein the relevant element is an element having a threshold value of importance of the element to homeostasis relevant to the trait, intensity of the perturbation of the element, duration of the effect of the element, or a combination.

The disclosed methods are based on a model of how elements affect complex diseases. The disclosed model is based on the existence of significant genetic and environmental heterogeneity in complex diseases. Thus, the specific combinations of genetic and environmental elements that cause disease vary widely among the affected individuals in a cohort. Implications of this model include: (1) comparisons of candidate variant allele frequencies between affected and unaffected cohorts that do not identify statistical differences in a complex disease do not exclude that variant from causality in individuals within the affected cohort; (2) experimental designs based upon comparisons of candidate variant allele frequencies between affected and unaffected cohorts, even if undertaken on a large scale, will fail to disclose causal variants in situations where there is a high degree of heterogeneity among individuals in causal elements; and (3) statistical methods will not give detailed information on a specific individual, which is a key need in personalized medicine and medical sequencing.

The disclosed model is an effective, general experimental design and analysis approach for the identification of causal variants in common, complex diseases by medical sequencing. The model can utilize various approaches including, but not limited to, one or more of the following: (1) evaluating associations with component phenotypes (Cp) rather than diseases (D): a “candidate component phenotype” approach; (2) including severity (Sv) and duration (t) when evaluating associations with Cp; (3) evaluating associations in individuals and subsets of cohorts in addition to cohorts; (4) evaluating associations in single pedigrees rather than integrating results of several pedigrees; (5) including intensity of the perturbation (I) and t in associations of elements (E). For medical sequencing, this can mean, for example, focusing on non-synonymous variants with large negative BLOSUM (BLOcks of Amino Acid SUbstitution Matrix scores). For medical sequencing this has the further implication that evaluations of the transcriptome sequence and abundance in affected cells or tissues is likely to provide greater signal to noise than the genome sequence; (6) following cataloging of E, I and t, assemble E into a minimal set of physiologic or biochemical pathways or networks (P). Seek associations of resultant P with Cp; and (7) seeking unbiased approaches to selection of Cp. For example, seek associations with Cp that are suggested by P. Further, Cp can vary from highly specific to general. Initial associations with Cp can be as specific as possible based upon P.

The disclosed model and the disclosed methods based on the model can be used to generate valuable and useful information. At a basic level, identification of elements (such as genetic variants) that are associated with a trait (such as a disease or phenotype) provides greater understanding of traits, diseases and phenotypes. Thus, the disclosed model and methods can be used as research tools. At another level, the elements associated with traits through use of the disclosed model and methods are significant targets for, for example, drug identification and/or design, therapy identification and/or design, subject and patient identification, diagnosis, prognosis as they relate to the trait. The disclosed model and methods can identify elements associated with traits that are more significant or more likely to be significant to the genesis, maintenance, severity and/or amelioration of the trait. The display, output, cataloging, addition to databases and the like of elements associated with traits and the association of elements to traits provides useful tools and information to those identifying, designing and validating drugs, therapies, diagnostic methods, prognostic methods in relation to traits.

Also disclosed are methods of identifying an inherited trait in a subject. These methods exploit the simple observation that any sequence, normal or otherwise, matches perfectly with itself Instead of comparing sequence reads from a patient to a general reference genome, the methods of the present invention can create a library of sequences, each of which is a perfect match to a known mutation. The library includes the normal sequence at each mutation position. Incoming sequence reads are compared to every sequence the library and the best matches are determined. For a given mutation, a normal sequence read (i.e., one lacking the mutation) aligns best to the normal library sequence. A read having the mutation aligns best to the mutant library sequence.

It should be understood that elements (such as genetic variants) identified using the disclosed model and methods can be part of other components or features (such as the gene in which the genetic variant occurs) and/or related to other components or features (such as the protein or expression product encoded by the gene in which the genetic variant occurs or a pathway to which the expression product of the gene belongs). Such components and features related to identified elements can also be used in or for, for example, drug identification and/or design, therapy identification and/or design, subject and patient identification, diagnosis, prognosis as they relate to the trait. Such components and features related to identified elements can also be targets for identifying, designing and validating drugs, therapies, diagnostic methods, prognostic methods in relation to traits and/or can provide useful tools and information to those identifying, designing and validating drugs, therapies, diagnostic methods, prognostic methods in relation to traits.

Additional advantages are set forth in part in the description which follows or can be learned by practice. The advantages are realized and attained by means of the elements and combinations particularly pointed out in the appended claims. It is to be understood that both the foregoing general description and the following detailed description are exemplary and explanatory only and are not restrictive, as claimed.

### BRIEF DESCRIPTION OF THE DRAWINGS

The accompanying drawings, which are incorporated in and constitute a part of this specification, illustrate embodiments and together with the description, serve to explain the principles of the methods and systems:

FIG. 1 is a block diagram illustrating an exemplary medical sequencing method utilizing, for example, 454 pyrosequencing and substitution variants in transcriptome sequence data;

FIG. 2 is a block diagram illustrating another exemplary medical sequencing method utilizing, for example, 454 pyrosequencing and indel variants in transcriptome sequence data;

FIG. 3 is a block diagram illustrating a method of identifying elements associated with a trait, the methods can comprise identifying the association of a relevant element with a relevant component phenotype of the trait;

FIG. 4 is a block diagram illustrating an exemplary operating environment for performing the disclosed method;

FIG. 5 is a block diagram illustrating an exemplary web-based navigation map. Several user-driven query and reporting functions can be implemented;

FIG. 6 shows an example of a sequence query interface;

FIG. 7 illustrates the identification of a coding domain (CD) SNP in the α subunit of the Guanine nucleotide-binding stimulatory protein (GNAS) using the disclosed methods;

FIG. 8 is a graph showing the length distribution of 454 GS20 reads;

FIG. 9 is a graph showing run-to-run variation in RefSeq transcript read counts;

FIGS. 10A-C illustrate an example of a novel splice isoform identified with GMAP by an apparent SNP at the penultimate base of an alignment;

FIG. 11 illustrates an example of a novel splice isoform identified with GMAP by an apparent SNP at the penultimate base of an alignment;

FIG. 12 illustrates a GMAP alignment of read D9VJ59F02JQMRR (nt 1-109, top) from SID 1438, to SYNCRIP (NM_{—}006372.3, bottom) showing a nsSNP at nt 30 (yellow, a1384 g) and a novel splice isoform that omits an 105-bp exon and maintains frame;

FIG. 13 is a graph showing the results of pairwise comparisons of the copy numbers of individual transcripts in lymphoblast cell lines from related individuals showed significant correlation;

FIGS. 14A-D show the alignment of a reference sequence to other various sequences including normal and mutant sequences;

FIGS. 15A-C illustrate the alignment of sequence reads to a normal reference and to a mutant reference.

FIG. 16 shows the workflow of the comprehensive carrier screening test, comprising sample receiving and DNA extraction, target enrichment from DNA samples, multiplexed sequencing library preparation, next generation sequencing and bioinformatic analysis.

FIGS. 17A-D shows analytic metrics of multiplexed carrier testing by next generation sequencing.

FIGS. 18A-B show Venn diagrams of specificity of on-target SNP calls and genotypes in 6 samples.

FIG. 19 shows a decision tree to classify sequence variation and evaluate carrier status.

FIGS. 20A-G show detection of gross deletion mutations by local reduction in normalized aligned reads.

FIGS. 21A-D show clinical metrics of multiplexed carrier testing by next generation sequencing.

FIGS. 22A-C show disease mutations and carrier burden in 104 DNA samples.

FIG. 23 shows five reads from NA202057 showing AGA exon 4, c.488G>C, C163S, chr4:178596912 G>C and exon 4, c.482G>A, R161Q, chr4:178596918 G>A (black arrows). 193 of 400 reads contained these substitution DMs (CM910010 and CM910011).

FIG. 24 shows a screen shot of the custom Agilent Sure Select RNA bait for hybrid capture of gene GAA (disease-GSD2).

FIG. 25 shows a screen shot of the custom Agilent Sure Select RNA bait for hybrid capture of gene HBZ-HBQ1 (disease—thalassemia).

FIG. 26 shows a screen shot of the custom Agilent Sure Select RNA bait for hybrid capture of gene CLN3 (disease—Battten).

FIG. 27 shows one end of five reads from NA01712 showing ERCC6 exon 17, c.3536delA, Y1179fs, chr10:50348476delA.

FIG. 28 shows one end of five reads from NA20383 showing CLN3 exon 11, c.1020G>T, E295X, chr16:28401322 G>T (black arrow).

FIG. 29 shows one end of five reads from NA16643 showing HBB exon 2, c.306G>C, E102D, chr11:5204392 G>C (Black arrow).

FIG. 30 shows the strategy for detection of a large deletion mutation in a human genomic DNA sample.

### DETAILED DESCRIPTION

Before the present methods and systems are disclosed and described, it is to be understood that the methods and systems are not limited to specific synthetic methods, specific components, or to particular compositions, as such can, of course, vary. It is also to be understood that the terminology used herein is for the purpose of describing particular embodiments only and is not intended to be limiting.

As used in the specification and the appended claims, the singular forms “a,” “an” and “the” include plural referents unless the context clearly dictates otherwise. Ranges can be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and the claims of this specification, the word “comprise” and variations of the word, such as “comprising” and “comprises,” means “including but not limited to,” and is not intended to exclude, for example, other additives, components, integers, or steps. “Exemplary” means “an example of” and is not intended to convey an indication of a preferred or ideal embodiment. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed, it is understood that each of these additional steps can be performed with any specific embodiment or combination of embodiments of the disclosed methods.

The present methods and systems may be understood more readily by reference to the following detailed description of preferred embodiments and the Examples included therein and to the Figures and their previous and following description.

### I. MODEL

Genetic heterogeneity is a potential cause for the lack of replication among studies of complex disorders. The prevailing assumption has been that there is sufficient homogeneity in causal elements in individuals affected by a common, complex disease that the comparisons of candidate variant allele frequencies between affected and unaffected cohorts can identify differences based on some inferential measure. This assumption was borne out of successes in studies of this type. For example, HLA haplotypes show association with several common, complex diseases.

However, to uncover the causative genetic components relevant to individual, personalized medicine, a move from the statistical to the determinate is desired. Regarding complex diseases, if there is insufficient homogeneity of causal elements among affected individuals to enable detection of statistical differences, then a move from the statistical to the determinate is also desired. The disclosed model is based on the existence of significant genetic and environmental heterogeneity in complex diseases. Thus, the specific combinations of genetic and environmental elements that cause disease vary widely among the affected individuals in a cohort. Implications of this model include: (1) comparisons of candidate variant allele frequencies between affected and unaffected cohorts that do not identify statistical differences in a complex disease do not exclude that variant from causality in individuals within the affected cohort; (2) experimental designs based upon comparisons of candidate variant allele frequencies between affected and unaffected cohorts, even if undertaken on a large scale, will fail to disclose causal variants in situations where there is a high degree of heterogeneity among individuals in causal elements; and (3) statistical methods will not give detailed information on a specific individual, which is a key need in personalized medicine and medical sequencing.

The disclosed model is based upon genetic, environmental and phenotypic heterogeneity in common, complex diseases. The model notes that multiple elements (E₁ . . . Eₙ) can be involved in the causality of a common, complex disease (D). These elements can be genetic (G) factors, environmental (E) factors or combinations thereof. The traditional approach is to decompose G×E into genetic factors, G (which can be further decomposed into additive “a”, dominance “d”, and epistatic “e” factors), an environment factor “E”, their non-linear interaction “G×E”, and a noise term “epsilon” (always present in every experiment and every data set). The genetic decomposition can be important because additive genetic variance is heritable, while dominance and epistatic variance are reconstituted each generation as a result of each individual's unique genome. It is further noted that elements can have heterogeneous contributions to phenotypes. Thus elements can be either deleterious (predisposition) or advantageous (protection) in terms of disease development. Further, elements can vary in expressivity and penetrance. It is further noted that some elements can have very specific effects whereas others are pleiotropic. For example, a variant in an enzyme can affect only a single biochemical pathway whereas a variant in a transcription factor can affect many pathways. These additive and nonadditive effects can be context dependent. Thus, the model can view D as a phenomenon that broadly describes the outward phenotype of the combinatorial consequence of allelic and environmental variations. The disclosed model utilizes a more general approach that can seek associations in individuals. It is further noted that the magnitude of the effect of an individual element can be dependent upon at least three variables:

First, the importance of that particular element for maintenance of homeostasis (H) relevant to the disease (D). Some elements have minor importance, while others have major importance. For example, the knockout of a specific gene in a mouse can result in a phenotype that varies between no effect and embryonic lethality. Thus each element (E₁ . . . Eₙ) has a specific, contributory role as part of the cause of, or protection against, a complex disease (H₁ . . . Hₐ). Second, the intensity of the perturbation of that element (I). For genetic elements, the intensity of the perturbation is dependent upon the type of variant, the number of copies of variant element or the magnitude of gene expression difference. The types of genetic variant include synonymous (which can be further categorized into regulatory and non-regulatory SNP and/or coding and noncoding SNP) and non-synonymous SNPs (which can be further categorized by scores such as BLOSUM score), indels (coding domain and non-coding domain), and whole or partial gene duplications, deletions and rearrangements. The number of copies of a variant genetic element can reflect homozygosity, heterozygosity or hemizygosity. Thus each element (E₁ . . . Eₙ) in an individual has a specific and variable intensity (I₁ . . . Iₙ). Third, the duration of the effect of the element (t). Environmental elements can be acute or chronic in nature. An example is occurrence of skin cancer following acute exposure to ultraviolet radiation while sunbathing versus continuous exposure through an outdoor occupation. Genetic elements can also be acute or chronic in nature, since many genes are not constitutively expressed but rather under transcriptional and/or post-transcriptional regulation. Therefore, a variant genetic element can not necessarily be expressed in an individual (called “expressivity” for within an individual; “penetrance” for occurrence in a population). Thus each element (E₁ . . . Eₙ) in an individual has a specific and variable duration of effect (t₁ . . . tₙ) that can not be constant but that can be a function of the environment.

Thus, for any given element the contribution towards causality in a disease can be a function, f, of these three factors. Thus:

Eᵢ=f(Hᵢ,Iᵢ,tᵢ)

and similarly the disease itself can be a function, g, of these n elements:

D=g(E₁ . . . ₙ)

This variability has several implications. For example, while in any individual, there are likely to be a finite number of elements that cause a common complex disease, in an outbred population there exist an extraordinarily large number of possible combinations of E₁ . . . Eₙ that can lead to that disease. In turn, while the variance explained by a given element (Eₓ) in an individual can certainly be large (i.e., 5-20%), the variance between that element and a disease in an outbred population is most likely to be very small (i.e., 0.1%). Thus, associations between individual element frequencies (Eₓ) and occurrence of a common, complex disease in an outbred population can lead to false negative results.

Different elements in any individual can lead to a given effect. Thus, both genocopies and envirocopies exist.

Values of t and I can have significant impact on E. Thus, strategies that evaluate gene candidacy based upon a tagged SNP (which can ignore the variables t and I) can yield false positive results.

Sampling of multiple individuals within a single pedigree can be highly informative since the number of combinations of possible elements is greatly decreased by laws of inheritance.

While in any individual pedigree there can be a finite number of elements that cause a common complex disease, in a set of unrelated pedigrees there exist an extraordinarily large number of possible combinations of E₁ . . . Eₙ that can lead to that disease. In turn, while the variance explained by a given element (Eₓ) in an individual pedigree can certainly be large, the variance between that element and a disease in a set of unrelated pedigrees is most likely to be very small. Thus associations between individual element frequencies (Eₓ) and occurrence of a common, complex disease in sets of unrelated pedigrees can lead to false negative results.

Another implication includes phenotypic heterogeneity in common, complex diseases. The model notes that conventional definitions of common, complex diseases can represent a combination of multiple component phenotypes (Cp₁ . . . Cpₙ), also known as “endophenotypes”, that have been rather arbitrarily assembled through years of medical experience and consensus. These component phenotypes can be symptoms, signs, diagnostic values, and the like.

Given the informal process of inclusion or exclusion of Cp in a common, complex disease, the disclosed model notes that individual Cp may not always be present in any individual case of a common, complex disease (i.e., phenocopies exist). Some Cp are present in the vast majority of cases (commonly referred to as pathognomonic features), whereas others will be present in only a few. Further, some Cp are pleiotropic (i.e., present in multiple common, complex diseases). An example is elevated serum or plasma C reactive protein. Other Cp are unique to a single D. An example is auditory hallucinations. Most Cp are anticipated to fit somewhere between these extremes (such as giant cell granulomas on histology).

The model further notes that for any D, the conventional cluster of Cp that is used for disease definition is inexact. It does not include all relevant Cp—but rather a subset that are currently known, established or included in the description of that disease. Furthermore, some Cp may be incorrectly included in the definition of that D. Other Cp may have been incorrectly omitted. Thus each Cp (Cp₁ . . . Cpₙ) can have a specific and individual value in the description of the presence of a common, complex disease (D). The set of Cp that are used for traditional diagnosis may not be complete or completely correct.

An implication of the model is that comparisons of candidate variant allele frequencies between affected and unaffected cohorts as defined by D that do not identify statistical differences in a common, complex disease do not exclude that variant from causality in Cp in individuals within the affected cohort. A further implication is that experimental designs based upon comparisons of candidate variant allele frequencies between affected and unaffected cohorts as defined by D, can be subject to false negative errors. A more general approach is to seek associations with Cp.

The model further notes that the magnitude of the effect of an individual Cp can be dependent upon two additional variables. One of the variables is the severity of the perturbation (Sv) of that Cp. For example, one might have a thrombocytopenia of 100/mm³ or 50,000/mm³ of blood. Auditory hallucinations may have occurred once a year or many times per hour. Thus each Cp (Cp₁ . . . Cpₙ) in an individual with disease has a specific and variable severity (Sv₁ . . . Svₙ).

The other variable that an individual Cp can be dependent upon is the age of onset (A) of that Cp. For example, dementia can occur in young persons or in the elderly. The pathophysiology of dementia in young people is frequently brain tumor. In elderly persons, it is frequently Alzheimer's disease or secondary to depression. Thus each Cp (Cp₁ . . . Cpₙ) in an individual has a specific and variable time to onset (A₁ . . . Aₙ).

Thus, for any given Cp, an effective definition can be a function, h, of these three factors. Thus:

D=h(Cp₁ . . . ₙ,Sv₁ . . . ₙ,A₁ . . . ₙ)

and therefore:

D=g(E₁ . . . ₙ)=h(Cp₁ . . . ₙ,Sv₁ . . . ₙ,A₁ . . . ₙ)

thus mapping causal elements to phenotypic expression.

Cp heterogeneity can have several other implications including that attempts to find causal elements in studies predicated on the traditional definitions of common, complex diseases are likely to be unsuccessful due to the informal methods whereby Cp have been assembled into conventional definitions and by the weightings of Sv or t (if any) by which Cp have empirically been weighted. Attempts to find solutions for individual Cp are more likely to be successful. Furthermore, attempts to find solutions for individual Cp are more likely to be successful if Sv and t values are measured and cut-off values defined prospectively.

Additionally, the inclusion/exclusion of traditional Cp are biased by medical experience and consensus. Unbiased Cp (suggested by experimentally-derived values of E or physiologic or biochemical pathways or networks (P)) are more likely to show associations. Molecular Cp, such as gene or protein expression profiles, are an example of phenotypes that are experimentally-derived and likely to be intermediary between gene sequences and organismal traits.

Another implication is the convergence of elements into networks and pathways. Genetic and environmental heterogeneity in common, complex disorders can be partitioned by assembly of individual E into physiologic or biochemical pathways or networks (P). This is based upon the observations that: (a) eukaryotic biochemistry is organized into pathways and networks of interacting elements. Very few genes act in isolation; (b) eukaryotic biochemistry is rather constrained; and (c) challenges to homeostasis typically evoke stereotyped responses.

Thus, common, complex disorders are anticipated to appear stochastic or indecipherable when considered at the level of E due both to interactions with the genome and to the intrinsic heterogeneity in causality of D. However, it has been realized that heterogeneous combinations of individual E converges into a discrete number of P. Linked, non-casual variations, in contrast, are not anticipated to converge into P.

The convergence of elements into networks and pathways is also based upon experience in analysis of gene expression profiling experiments, where many disparate transcripts are typically up-regulated or down-regulated in expression between two states or individuals. Lists of differentially expressed genes are typically analyzed by synthesis into perturbed networks or pathways in order to understand the principal differences.

Another implication of the model is the combination of medical sequencing data with genetic, gene and protein expression and metabolite profiling data. The analysis of medical sequencing data—a list of genes with putative, physiologically important sequence variation—can be facilitated by integrative approaches that combine medical sequencing data results with results of other approaches, such as genetic (linkage) data, gene expression profiling data and proteomic and metabolic profiling data.

The disclosed model is an effective, general experimental design and analysis approach for the identification of causal variants in common, complex diseases by medical sequencing. The model can utilize various approaches including, but not limited to, one or more of the following: (1) evaluating associations with component phenotypes (Cp) rather than diseases (D): a “candidate component phenotype” approach; (2) including severity (Sv) and duration (t) when evaluating associations with Cp; (3) evaluating associations in individuals and subsets of cohorts in addition to cohorts; (4) evaluating associations in single pedigrees rather than integrating results of several pedigrees; (5) including intensity of the perturbation (I) and t in associations of elements (E). For medical sequencing, this can mean, for example, focusing on non-synonymous variants with large negative BLOSUM scores. For medical sequencing this has the further implication that evaluations of the transcriptome sequence and abundance in affected cells or tissues is likely to provide greater signal to noise than the genome sequence; (6) following cataloging of E, I and t, assemble E into a minimal set of physiologic or biochemical pathways or networks (P). Seek associations of resultant P with Cp; and (7) seeking unbiased approaches to selection of Cp. For example, seek associations with Cp that are suggested by P. Further, Cp can vary from highly specific to general. Initial associations with Cp can be as specific as possible based upon P.

As noted above, common complex diseases can have heterogeneous descriptions based on informal assembly of component phenotypes into the disease description. Given this heterogeneity of the features that can be ascribed to a disease, and because the principles of this model are not limited to “diseases” as that term is used in the art, the disclosed model and methods can be used in connection with “traits.” The term trait, which is further described elsewhere herein, is intended to encompass observed features that may or may not constitute or be a component of an identified disease. Such traits can be medically relevant and can be associated with elements just as diseases can.

The disclosed model and the disclosed methods based on the model can be used to generate valuable and useful information. At a basic level, identification of elements (such as genetic variants) that are associated with a trait (such as a disease or phenotype) provides greater understanding of traits, diseases and phenotypes. Thus, the disclosed model and methods can be used as research tools. At another level, the elements associated with traits through use of the disclosed model and methods are significant targets for, for example, drug identification and/or design, therapy identification and/or design, subject and patient identification, diagnosis, prognosis as they relate to the trait. The disclosed model and methods can identify elements associated with traits that are more significant or more likely to be significant to the genesis, maintenance, severity and/or amelioration of the trait. The display, output, cataloging, addition to databases and the like of elements associated with traits and the association of elements to traits provides useful tools and information to those identifying, designing and validating drugs, therapies, diagnostic methods, prognostic methods in relation to traits.

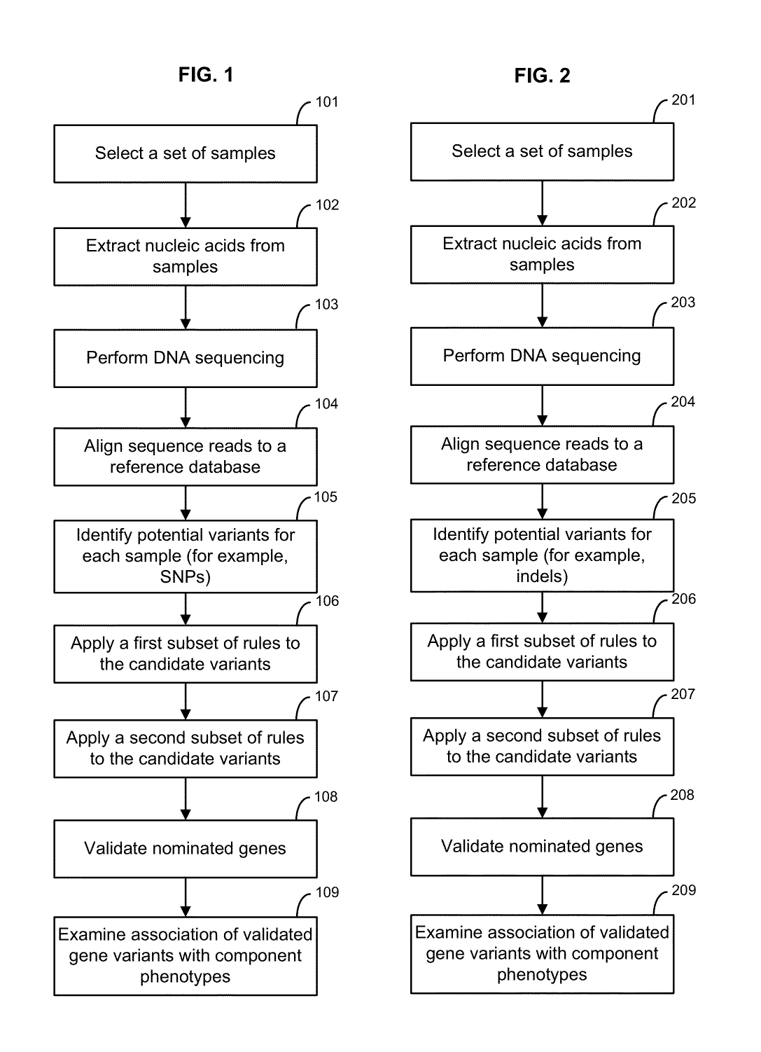

The implications of this model can be incorporated into the design of an analysis strategy such as the examples shown in FIG. 1 and FIG. 2.

FIG. 1 illustrates an exemplary medical sequencing method utilizing, for example, 454 pyrosequencing and substitution variants in transcriptome sequence data. At block 101, a discovery set of samples can be selected. At block 102, nucleic acids (for example, RNA) can be extracted from the discovery set of samples. At block 103, DNA sequencing can be performed (for example, with 454/Roche pyrosequencing). The DNA sequencing can result in the generation of sequence reads. At block 104, the sequence reads can be aligned to a reference database (for example, RefSeq with MegaBLAST). At block −105, potential variants can be identified for each sample in the discovery set (for example, SNPs). At block 106, a first subset of rules (a first filter) can be applied to identify candidate variants (for example, variants that can be associated with a trait or disease). In this example, the first subset of rules can comprise one or more of the following: (1) present in >4 sequence reads; (2) present in >30% reads (assumes frequency is at least heterozygous); (3) high quality score at variant base(s); (4) present in sequence reads in both orientations (5′ to 3′ and 3′ to 5′); (5) confirm read alignment to reference sequence; and (6) exclude reference sequence errors by alignment to a second reference database

At block 107, a second subset of rules (a second filter) can be applied to the resulting candidate variants in order to prioritize the candidate variants and nominate candidate genes. In this example, the second subset of rules can comprise one or more of the following: (1) coding domain non-synonymous variant; (2) severity of gene lesion (BLOSUM etc.); (3) gene congruence in >1 sample; (4) network or pathway congruence in >1 sample; (5) functional plausibility; (6) chromosomal location congruence with known quantitative trait loci; and (7) congruence with other data types (e.g., gene or protein expression or metabolite information).

At block 108, the resulting nominated genes can be validated by re-sequencing the nominated genes in “Discovery” & independent “Validation” sample sets. At block 109, the association of validated gene variants with component phenotypes can be examined.

FIG. 2 illustrates another exemplary medical sequencing method utilizing, for example, 454 pyrosequencing and indel variants in transcriptome sequence data. At block 201, a discovery set of samples can be selected. At block 202, nucleic acids (for example, RNA) can be extracted from the discovery set of samples. At block 203, DNA sequencing can be performed (for example, with 454/Roche pyrosequencing). The DNA sequencing can result in the generation of sequence reads. At block 204, the sequence reads can be aligned to a reference database (for example, RefSeq with MegaBLAST). At block 205, potential variants can be identified for each sample in the discovery set (for example, indels). At block 206, a first subset of rules (a first filter) can be applied to identify candidate variants (for example, variants that can be associated with a trait or disease). In this example, the first subset of rules can comprise one or more of the following: (1) present in >4 sequence reads; (2) present in >30% reads (assumes frequency is at least heterozygous); (3) absence of homopolymer bases immediately preceding indel (within 5 nucleotides); (4) high quality score at variant base(s); (5) present in sequence reads in both orientations (5′ to 3′ and 3′ to 5′); (6) confirm read alignment to reference sequence; and (7) exclude reference sequence errors by alignment to a second reference database

At block 207, a second subset of rules (a second filter) can be applied to the resulting candidate variants in order to prioritize the candidate variants and nominate candidate genes. In this example, the second subset of rules can comprise one or more of the following: (1) coding domain non-synonymous variant; severity of gene lesion (BLOSUM etc.); (3) gene congruence in >1 sample; (4) network or pathway congruence in >1 sample; functional plausibility; (6) chromosomal location congruence with known quantitative trait loci; and (7) congruence with other data types (e.g., gene or protein expression information).

At block 208, the resulting nominated genes can be validated by re-sequencing the nominated genes in “Discovery” & independent “Validation” sample sets. At block 209, the association of validated gene variants with component phenotypes can be examined.

### II. EXEMPLARY METHODS

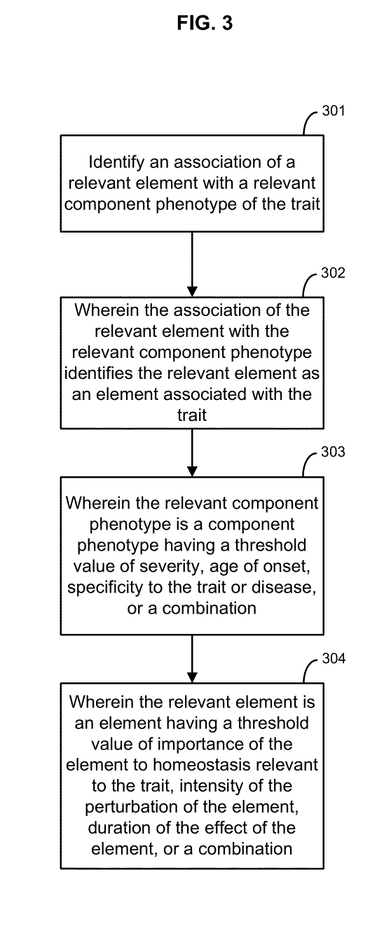

Provided, and illustrated in FIG. 3, are methods of identifying elements associated with a trait, the methods can comprise identifying the association of a relevant element with a relevant component phenotype of the trait at 301, wherein the association of the relevant element with the relevant component phenotype identifies the relevant element as an element associated with the trait, wherein the relevant component phenotype is a component phenotype having a threshold value of severity, age of onset, specificity to the trait or disease, or a combination at 302, wherein the relevant element is an element having a threshold value of importance of the element to homeostasis relevant to the trait, intensity of the perturbation of the element, duration of the effect of the element, or a combination at 303. It should be understood that the method can include identification of one or multiple elements, association of one or multiple elements with one or multiple traits, use of one or multiple elements, use of one or multiple component phenotype, use of one or more relevant elements, use of one or more relevant component phenotypes, etc. Such single and multiple components can be used in any combination. The model and methods described herein refer to singular elements, traits, component phenotypes, relevant elements, relevant component phenotypes, etc. merely for convenience and to aid understanding. The disclosed methods can be practiced using any number of these components as can be useful and desired.

A trait can be, for example, a disease, a phenotype, a quantitative or qualitative trait, a disease outcome, a disease susceptibility, a combination thereof, and the like. As used herein in connection with the disclosed model and methods, trait refers to one or more characteristics of interest in a subject, patient, pedigree, cohort, groups thereof and the like. Of particular interest as traits are phenotypes, features and groups of phenotypes and features that characterize, are related to, and/or are indicative of diseases and conditions. Useful traits include single phenotypes, features and the like and plural phenotypes, features and the like. A particularly useful trait is a component phenotype, such as a relevant component phenotype.

A relevant element can be an element that has a certain threshold significance/weight based on a plurality of factors. The relevant element can be an element having a threshold value of, for example, importance of the element to homeostasis relevant to the trait, intensity of the perturbation of the element, duration of the effect of the element, or a combination. The relevant element can be, for example, an element associated with one or more genetic elements associated with the trait or disease. The one or more genetic elements can be derived from, for example, DNA sequence data, genetic linkage data, gene expression data, antisense RNA data, microRNA data, proteomic data, metabolomic data, a combination, and the like. The relevant element can be a relevant genetic element. A relevant component phenotype (also referred to as an endophenotype) can be a component phenotype that has a certain threshold significance/weight based on one or a plurality of factors. The relevant component phenotype can be a component phenotype having a threshold value of, for example, severity, age of onset, specificity to the trait or disease, or a combination. The relevant component phenotype can be a component phenotype associated with a network or pathway of interest. The relevant component phenotype can be a component phenotype specific to the network or pathway of interest.

The threshold value can be any useful value (relevant to the parameter involved). The threshold value can be selected based on the principles described in the disclosed model. In general, higher (more rigorous or exclusionary) thresholds can provide more significant associations. However, higher threshold values can also limit the number of elements identified as associated with a trait, thus potentially limiting the useful information generated by the disclosed methods. Thus, a balance can be sought in setting threshold values. The nature of a threshold value can depend on the factor or feature being assessed. Thus, for example, a threshold value can be a quantitative value (where, for example, the feature can be quantified) or a qualitative value, such as a particular form of the feature, for example.

The disclosed model and methods provide more accurate and broader-based identification of trait-associated elements by preferentially analyzing relevant component phenotypes and relevant elements. Such relevant component phenotypes and relevant elements have, according to the disclosed model, more significance to traits of interest, such as diseases. By using relevant component phenotypes and relevant elements, the disclosed model and methods reduce or eliminate the confounding and obscuring effect less relevant phenotypes and elements have to a given trait. This allows more, and more significant, trait associations to be identified.

The association of the relevant element with the relevant component phenotype can be identified by identifying the association of the relevant element with, for example, a network or pathway associated with the relevant component phenotype. The network or pathway can be associated with the relevant component phenotype when the relevant component phenotype occurs or is affected when the network or pathway is altered.

Additionally, the association of the relevant element with the relevant component phenotype can be identified by a threshold value of the coincidence of the relevant element and the relevant component phenotype within a set of discovery samples. Threshold value of coincidence can refer to the coincidence (that is, correlation of occurrence/presence) of the element and the component phenotype. Such a coincidence can be a basic observation of the disclosed method. The significance of this coincidence is enhanced (relative to prior methods of associating elements to diseases) by the selection of relevant elements and relevant component phenotypes, based on the plurality of factors as discussed herein.

Discovery samples can be any sample in which the presence, absence and/or level or amount of an element can be assessed. Generally, a set of discovery samples can be selected to allow assessment of the coincidence of component phenotypes with elements. For example, a set of discovery samples can be selected or identified based on principles described in the disclosed model. The set of discovery samples can comprise, for example, samples from a single individual, samples from a single pedigree, samples from a subset of a single cohort, samples from a single cohort, samples from multiple individuals, samples from multiple unrelated individuals, samples from multiple affected sib-pairs, samples from multiple pedigrees, a combination thereof, and the like. The set of discovery samples can also comprise, for example, both affected samples and unaffected samples, wherein affected samples are samples associated with the relevant component phenotype, wherein unaffected samples are samples not associated with the relevant component phenotype. Samples associated with the relevant component phenotype can be samples that exhibit, or that come from cells, tissue, or individuals that exhibit, the relevant component phenotype. Samples unassociated with the relevant component phenotype can be samples that do not exhibit, and that do not come from cells, tissue, or individuals that exhibit, the relevant component phenotype. The methods can further comprise selecting a set of discovery samples, wherein the set of discovery samples consist of samples from a single individual, samples from a single pedigree, samples from a subset of a single cohort, or samples from a single cohort. The relevant element can be selected from variant genetic elements identified in the discovery samples.

The threshold value of importance of the element to homeostasis relevant to the trait or disease can be, for example, derived from the phenotype of knock-out, transgenesis, silencing or over-expression of the element in an animal model or cell line; the phenotype of a genetic lesion in the element in a human or model inherited disorder; the phenotype of knock-out, transgenesis, silencing or over-expression of an element related to the element in an animal model or cell line; the phenotype of a genetic lesion in an element related to the element in a human or model inherited disorder; knowledge of the function of the element in a related species, a combination, and the like. The element related to the element can be a gene family member or an element with sequence similarity to the element.

The threshold value of intensity of the perturbation of the element can be, for example, derived from the type of element, the amount or level of the element, or a combination. The relevant element can be a relevant genetic element, wherein the type of element is a type of genetic variant, wherein the type of genetic element is a regulatory variant, a non-regulatory variant, a non-synonymous variant, a synonymous variant, a frameshift variant, a variant with a severity score at, above, or below a threshold value, a genetic rearrangement, a copy number variant, a gene expression difference, an alternative splice isoform, a combination, and the like. The relevant element can be a relevant genetic element, wherein the amount or level of the element is the number of copies of the relevant genetic element, the magnitude of expression of the genetic element, a combination, and the like.

The element can be an environmental condition, and the threshold value of duration of the effect of the element can be derived, for example, from the duration of an environmental condition or the duration of exposure to an environmental condition.

The element can be a genetic element, and the threshold value of duration of the effect of the element can be derived from, for example, the duration of expression of the genetic element, the expressivity of the genetic element, or a combination.

The threshold value of severity of the component phenotype can be derived, for example, from the frequency of the component phenotype, the intensity of the component phenotype, the amount of a feature of the component phenotype, or a combination.

The threshold value of specificity to the trait or disease of the component phenotype can be derived, for example, from the frequency with which the component phenotype is present in other traits or diseases, the frequency with which the component phenotype is present in the trait or disease, or a combination. For example, the component phenotype can be not present in other traits or diseases; the component phenotype can be always present in the trait or disease; the component phenotype can be not present in other traits or diseases and can always be present in the trait or disease; and the like.

Embodiments of the methods can further comprise selecting an element as the relevant element by assessing, for example, the value of importance of the element to homeostasis relevant to the trait or disease, intensity of the perturbation of the element, duration of the effect of the element, or a combination and comparing the value to the threshold value. One skilled in the art recognizes that comparison of the value to the threshold value can be successful if the threshold is exceeded or if the threshold is not exceeded. Success can depend upon what the value and the threshold value represents.

The methods can further comprise selecting a component phenotype as the relevant component phenotype by assessing the value of clinical features of the phenotype, and comparing the value to the threshold value. The clinical features of the phenotype can comprise, for example, the value of severity, age of onset, duration, specificity to the phenotype, response to a treatment or a combination. The methods can further comprise selecting a component phenotype as the relevant component phenotype by assessing the value of laboratory features of the phenotype, and comparing the value to the threshold value.

The variant genetic elements can be identified, for example, by sequencing nucleic acids from the discovery samples and comparing the sequences to one or more reference sequence databases. The comparison can involve, but is not limited to, BLAST alignments, megaBLAST alignments, GMAP alignments, BLAT alignments, a combination, and the like. The reference sequence database can be, but is not limited to, the RefSeq genome database, the transcriptome database, the GENBANK database, a combination thereof, and the like. The variant genetic elements identified in the discovery samples can be part of a catalog of variant genetic elements identified in a plurality of sets of discovery samples. The variant genetic elements can be filtered to select candidate variant genetic elements, wherein the variant genetic elements are filtered, for example, by selecting variant genetic elements that are present in a threshold number of sequence reads, are present in a threshold percentage of sequence reads, are represented by a threshold read quality score at variant base(s), are present in sequence reads from in a threshold number of strands, are aligned at a threshold level to a reference sequence, are aligned at a threshold level to a second reference sequence, are variants that do not have biasing features bases within a threshold number of nucleotides of the variant, a combination thereof, and the like.

The candidate variant genetic elements can be prioritized to select relevant variant genetic elements, wherein the candidate variant genetic elements are prioritized, for example, according to the presence in the candidate variant genetic element of a non-synonymous variant in a coding region, the presence of the candidate variant genetic element in a plurality of samples, the presence of the candidate variant genetic element at a chromosomal location having a quantitative trait locus associated with the trait or disease, the severity of the putative functional consequence that the candidate variant genetic element represents, association of the candidate variant genetic element with a network or pathway in a plurality of samples, association of the candidate variant genetic element with a network or pathway with which one or more other candidate variant genetic elements are associated, the plausibility or presence of a functional relationship between the candidate variant genetic element and the relevant component phenotype, a combination thereof, and the like.

The association of a relevant element with a relevant component phenotype of the trait or disease can be performed, for example, for a plurality of relevant elements, a plurality of relevant component phenotypes of the trait or disease, or a plurality of relevant elements and a plurality of relevant component phenotypes of the trait or disease.

Embodiments of the methods can further comprise validating the association of the relevant element with the relevant component phenotype. Association of the relevant element with the relevant component phenotype can be validated by assessing the association of the relevant element with the relevant component phenotype in one or more sets of validation samples, wherein the set of validation samples is different than the samples from which the relevant element was selected. The set of validation samples can comprise samples from a single individual, samples from a single pedigree, samples from a subset of a single cohort, samples from a single cohort, samples from multiple individuals, samples from multiple unrelated individuals, samples from multiple affected sib-pairs, samples from multiple pedigrees, a combination, and the like.

Also disclosed herein are methods of identifying an inherited trait in a subject, comprising collecting a biological sample from the subject; counting sequence reads aligning to normal references; counting sequence reads aligning to mutant references; and determining whether the subject's sample yields more reads aligning to the mutant references than to the normal references. The biological samples of the disclosed methods are samples that provide viable DNA for sequencing, and include, but are not limited to, sources such as blood and buccal smears

Disclosed herein are methods of determining the status of a subject with regard to one or more inherited traits comprising assaying a relevant element or elements from a sample from the individual, and comparing the values of the relevant element or elements to a reference set or sets. The status of the subject can be (1) unaffected and non-carrier of the inherited trait, (2) unaffected and carrier of the inherited trait, or (3) affected and carrier of the inherited trait. The trait is a disease, a phenotype, a quantitative or qualitative trait, a disease outcome, or a disease susceptibility, which disease includes, but is not limited to, a recessive disease. The disclosed methods can determine the status of 1 or more traits including, but not limited to, 5, 10, 15, 25, 30, 35, 40, 45, 50, 60, 70, 80, 90, 100, 150, 200, 250, 300, 350, 400, or 450 traits from a biological sample.

In an aspect of the present invention, the association of the relevant element with the relevant trait is identified by a threshold value of the coincidence of the relevant element and the relevant trait within the sample. The relevant element is a type of genetic variant, wherein the type of genetic element is a regulatory variant, a non-regulatory variant, a non-synonymous variant, a synonymous variant, a frameshift variant, a variant with a severity score at, above, or below a threshold value, a genetic rearrangement, a copy number variant, a gene expression difference, an alternative splice isoform, a deletion variant, an insertion variant, a transversion variant, an inversion variant, or a combination thereof. In an aspect of the invention, the association of a relevant element with a relevant component phenotype of the trait is performed for (1) a plurality of relevant elements, (2) a plurality of relevant component phenotypes of the trait, or (3) a plurality of relevant elements and a plurality of relevant component phenotypes of the trait.

In an aspect of the present invention, comparing the values of the relevant element or elements is performed by alignment of the DNA sequences to a reference set or sets of DNA sequences, wherein the reference sets of DNA sequences contain both normal, unaffected DNA sequences and mutated, variant DNA sequences. The mutated, variant DNA sequences include the plurality of known variant sequences. The alignment of the DNA sequences to a reference set or sets of DNA can be performed under conditions requiring a perfect match between the sample and a member of the reference set. In an aspect of the present invention, the status of the subject is determined by measuring the ratio of DNA sequences that match the normal, unaffected DNA sequences and the mutated, variant DNA sequences.

In the methods disclosed herein, the amount or level of the element can be the number of copies of the relevant genetic element, the magnitude of expression of the genetic element, or a combination thereof. In an aspect of the present invention, the variant genetic elements identified in the discovery samples are part of a catalog of variant genetic elements identified in a plurality of sets of discovery samples and the variant genetic elements can be filtered to select candidate variant genetic elements. Genetic elements are filtered by selecting variant genetic elements that are (1) present in a threshold number of sequence reads, (2) present in a threshold percentage of sequence reads, (3) represented by a threshold read quality score at variant base or bases, (4) present in sequence reads from in a threshold number of strands, (5) aligned at a threshold level to a reference sequence, (6) aligned at a threshold level to a second reference sequence, (7) variants that do not have biasing features bases within a threshold number of nucleotides of the variant, or (8) a combination thereof.

DNA sequencing can be used to perform the disclosed methods. Comparing the values of the relevant element or elements to a reference set of set involves, but is not limited to, BLAST alignments, megaBLAST alignments, GMAP alignments, BLAT alignments, or a combination thereof. The reference sequence database is, but not limited to, the RefSeq genome database, the transcriptome database, the GENBANK database, or a combination thereof. In an aspect of the present invention, the reference sequence is generated based on identified mutants.

The methods disclosed herein exploit the observation that any sequence, normal or otherwise, matches perfectly with itself. Instead of comparing sequence reads from a patient to a general reference genome, the methods of the present invention can create a library of sequences, each of which is a perfect match to a known mutation. The library includes the normal sequence at each mutation position. Incoming sequence reads are compared to every sequence in the library and the best matches are determined. For a given mutation, a normal sequence read (i.e., one lacking the mutation) aligns best to the normal library sequence. A read having the mutation aligns best to the mutant library sequence. This approach avoids potential biases associated with aligning sequencing reads to non-exact matching reference sequences. The extent of such biases is variable and difficult to eliminate.

Furthermore, since the zygosity of a potential mutation is derived from the proportion of reads that contain a putative mutation that align divided by the total number of reads aligning, such biases can result in mischaracterization of the zygosity of a mutation based on sequence analysis. In an extreme case, a mutation can be entirely missed. In the case of copy number variants, the invention described herein correctly identifies the copy number.

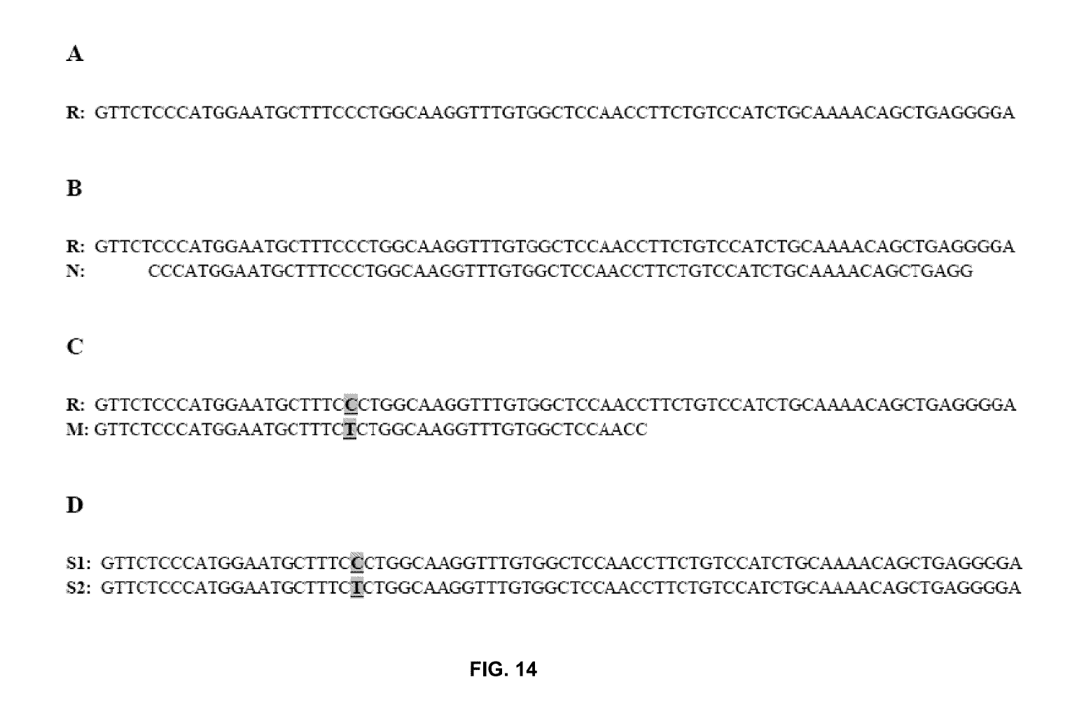

FIG. 14A shows the reference sequence (R) from a normal segment of the human PLP1 gene on chromosome X. FIG. 14B shows the alignment of the reference sequence (R) and a sequence read from a normal chromosome (N). The positions are identical. FIG. 14C shows the alignment for the reference sequence and a sequence read from a mutant chromosome (M). By post-processing the output of the alignment algorithm, the alignment indicates that there is a single mismatch (a “C” in the reference sequence and a “T” in the mutant sequence). This represents the standard method by which the art detects mutations. FIG. 14D shows the methods of the present invention, whereby a library of two references (Sequence 1 and Sequence 2) differing at the mutation position is used to detect the mutation.

According to the methods disclosed herein, a sequence read is aligned to both references. The number of mismatches between the read and each reference is recorded. The smaller the number of mismatches, the better the alignment. In a read with zero errors, the alignment between a normal read and the normal reference has zero mismatches. In a read with zero errors, the alignment between a mutant read and the mutant reference has zero mismatches. By recording only the best alignment for a read (i.e., the alignment having fewest mismatches), each read aligns only once. In other words, mutant reads align to the mutant reference and normal reads align to the normal reference.

Sequences coming from an individual homozygous for the normal nucleotide have all reads aligning to the normal reference. Sequences coming from an individual homozygous for the mutant nucleotide have all reads aligning to the mutant reference. Sequences coming from a heterozygous individual have sequence read alignments distributed approximately equally between the mutant and normal references. The basis of the carrier detection algorithm focuses on the counting of sequence reads aligning to the normal reference and sequence reads aligning to the mutant reference.

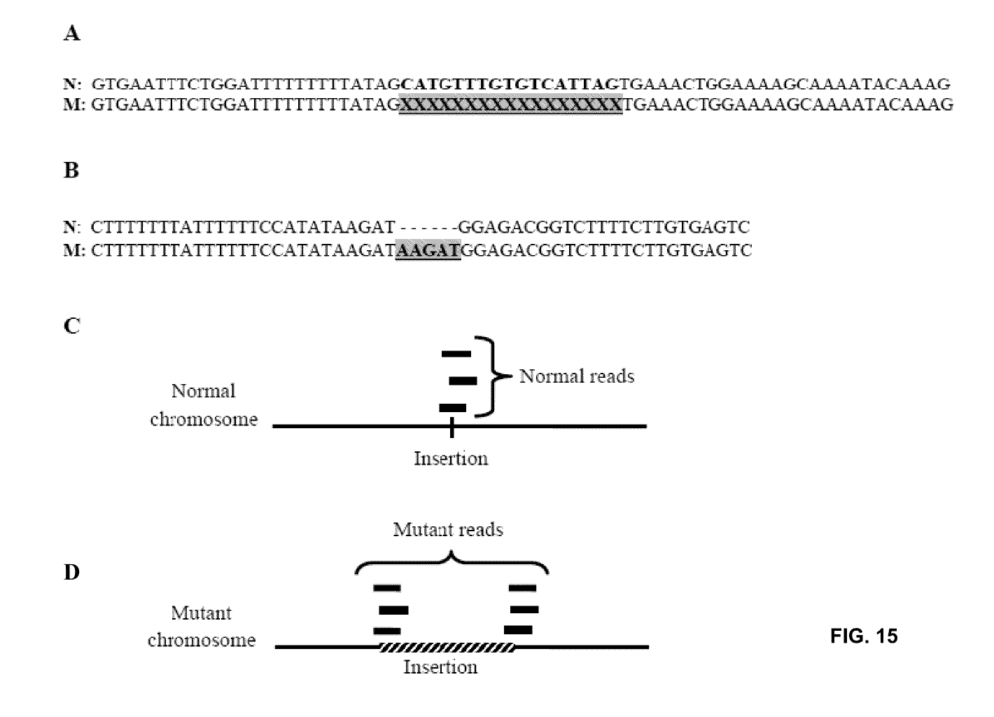

The present method is applicable to any type of mutation. A mutant reference sequence that is identical to the DNA from a mutant chromosome is generated. A mutant reference sequence can be referred to as a custom reference. For deletion mutants, generating a mutant reference sequence is achieved by taking the DNA sequence on either side of the deletion and making them into a continuous DNA sequence. For example, FIG. 15A shows the alignment between a normal sequence of a segment of the human HPRT1 gene and a mutant sequence having a 17 base pair deletion. The mutant reference is created by joining the sequences flanking the deletion as indicated. This works for any size of deletion.

For insertion mutants, the approach for generating a mutant reference depends on the size of the insertion. For example, when the insertion is smaller than the size of the sequence read, the approach for generating a mutant reference is identical to the approach used for generating a deletion mutant. FIG. 15B shows the alignment between a normal sequence of a segment of the human ATP7A gene and a mutant sequence having a 5 bp insertion. When the insertion is longer than the sequence read, a check for perfect alignment of mutant reads at each border of the insertion occurs. A sequence read that occurs entirely within the insertion does not reliably indicate that it is from the mutant. Because that sequence read can be from a different location in the genome, at least two custom references are generated. Each custom reference spans the border between the normal sequence and the mutant insertion. Using the DNA from an individual having the insertion, some reads can be expected to align perfectly to each custom reference. The normal reference used in this situation is a segment of normal DNA that spans the insertion point. FIG. 15C provides a schematic representation of the alignment of sequence reads to a normal reference (top panel) and to an insertion mutant reference (bottom panel).

Embodiments of the present invention consider the introduction of sequencing errors. By setting the parameters of the alignment algorithm to accept no mismatches, a sequence read containing an error is eliminated from further analysis and aligns to neither the normal or mutant reference. The rare cases when an error transforms the nucleotide at the mutation position from normal to mutant or vice versa is the exception. Embodiments of the present invention detect such cases by considering the base quality scores. Bases in error frequently have low quality scores. Perfectly matching reads with a nucleotide at the mutation position having a significantly lower quality score than the surrounding nucleotides are considered suspect.

In an aspect, disclosed herein are methods of identifying an inherited trait in a subject. These methods can comprise collecting a biological sample from the subject comprising a DNA sequence; aligning the DNA sequence to normal reference sequences and mutant reference sequences; counting sequence reads aligning to normal references; counting sequence reads aligning to mutant references; and determining a ratio of aligned reads, wherein if the ratio is greater than a first value the inherited trait is a homozygous mutant, if the ratio is between a second value and a third value the inherited trait is a heterozygous mutant, and if the ratio is less than a fourth value the inherited trait is a homozygous wild-type. In an aspect, in the disclosed methods disclosed, the first value can be 86%, the second value can be 18%, the third value can be 14%, and the fourth value can be 14%.

In an aspect, disclosed herein are methods of determining a status of a subject with regard to an inherited trait. The disclosed methods can comprise assaying an element from a sample from a subject to determine a subject DNA sequence; comparing the subject DNA sequence to a set of DNA sequences by alignment wherein the set of DNA sequences comprises both normal, unaffected DNA sequences and mutated, variant DNA sequences; identifying the element as being associated with the inherited trait by the coincidence of the element and the trait within the sample by determining a ratio of the subject DNA sequence that matches normal, unaffected DNA sequences and the mutated variant DNA sequences.

In the methods disclosed herein, the status can be unaffected and non-carrier of the inherited trait and/or unaffected and carrier of the inherited trait and/or affected and carrier of the inherited trait. The status of a predetermined number of inherited traits can be determined from a sample. The predetermined number can be, for example, from about 1 to about 5,000. In an aspect, the predetermined number can be up to 500, up to 1000, up to 1500, and the like.

In an aspect, the sample can be a blood sample, buccal smear, saliva, urine, excretions, fecal matter, or tissue biopsy. The sample can be any type of sample. The sample can be formaldehyde fixed, paraffin embedded, Guthrie cards, and the like.

In an aspect, in the methods disclosed herein, the inherited trait can be a disease, a phenotype, a quantitative or qualitative trait, a disease outcome, a disease susceptibility, a biomarker, or a syndrome. In an aspect, the inherited trait can be recessive, dominant, partially dominant, X-linked, complex, co-dominant, or multi-factorial.

In an aspect, the assay of the element can be performed by DNA sequencing. In an aspect, the element can be a genetic element, wherein the type of element can be a type of genetic variant, wherein the type of genetic element can be a regulatory variant, a non-regulatory variant, a non-synonymous variant, a synonymous variant, a frameshift variant, a variant with a severity score at, above, or below a threshold value, a genetic rearrangement, a copy number variant, a gene expression difference, an alternative splice isoform, a deletion variant, an insertion variant, a transversion variant, an inversion variant, a translocation, or a combination thereof. The mutated, variant DNA sequences can comprise a plurality of known variant sequences. The alignment can be performed under conditions requiring a perfect match between the subject DNA sequence and a member of the reference set of DNA sequences. The element can be a genetic element, wherein an amount of the element is a number of copies of the genetic element, the magnitude of expression of the genetic element, or a combination thereof. Comparing the subject DNA sequence to a set of DNA sequences by alignment can comprise one or more of BLAST alignments, megaBLAST alignments, GMAP alignments, BLAT alignments, MAQ alignments, gSNAP alignments, or a combination thereof. The reference set of DNA sequences can comprise one or more of the RefSeq genome database, the transcriptome database, the GENBANK database, or a combination thereof.

The variant genetic elements can be filtered to select candidate variant genetic elements, wherein the variant genetic elements can be filtered by selecting variant genetic elements that are present in a threshold number of sequence reads, are present in a threshold percentage of sequence reads, are represented by a threshold read quality score at variant base(s), are present in sequence reads from in a threshold number of strands, are aligned at a threshold level to a reference sequence, are aligned at a threshold level to a second reference sequence, are variants that do not have biasing features bases within a threshold number of nucleotides of the variant, or a combination thereof.

Also disclosed are systems for identifying an inherited trait in a subject. The systems can comprise a memory; and a processor, coupled to the memory, configured for, collecting a biological sample from the subject comprising a DNA sequence, aligning the DNA sequence to normal reference sequences and mutant reference sequences, counting sequence reads aligning to normal references, counting sequence reads aligning to mutant references, and determining a ratio of aligned reads, wherein if the ratio is greater than a first value the inherited trait is a homozygous mutant, if the ratio is between a second value and a third value the inherited trait is a heterozygous mutant, and if the ratio is less than a fourth value the inherited trait is a homozygous wild-type. The first value can be 86%, the second value can be 18%, the third value can be 14%, and the fourth value can be 14%. Comparing aligning the DNA sequence to normal reference sequences and mutant reference sequences can comprise one or more of BLAST alignments, megaBLAST alignments, GMAP alignments, BLAT alignments, MAQ alignments, gSNAP alignments, or a combination thereof. The normal reference sequences and mutant reference sequences can comprise one or more of the RefSeq genome database, the transcriptome database, the GENBANK database, or a combination thereof.

In the methods disclosed herein, the parameters of the alignment algorithm can be set to accept a specified number of mismatches. With one allowed mismatch, a mutant read containing a sequencing error has one mismatch compared to the mutant reference and two mismatches compared to the normal reference. It aligns best to the mutant reference. The same argument applies to relaxation of the parameters to allow 2 or more mismatches.

Although the disclosed model and methods include the use of new traits, phenotypes, elements and the like, the disclosed model and methods also represent a new use of the many traits, phenotypes, elements and the like that are known and used in genetic and disease analysis. The disclosed model and methods use these traits, phenotypes, elements and the like in selective and weighted ways as describe herein. Those of skill in the art are aware of many traits, phenotypes, elements and the like as well as methods and techniques of their detection, measurement, assessment. Such traits, phenotypes, elements, methods and techniques can be used with the disclosed model and methods based on the principles and description herein and such use is specifically contemplated.

### III. EXEMPLARY SYSTEMS

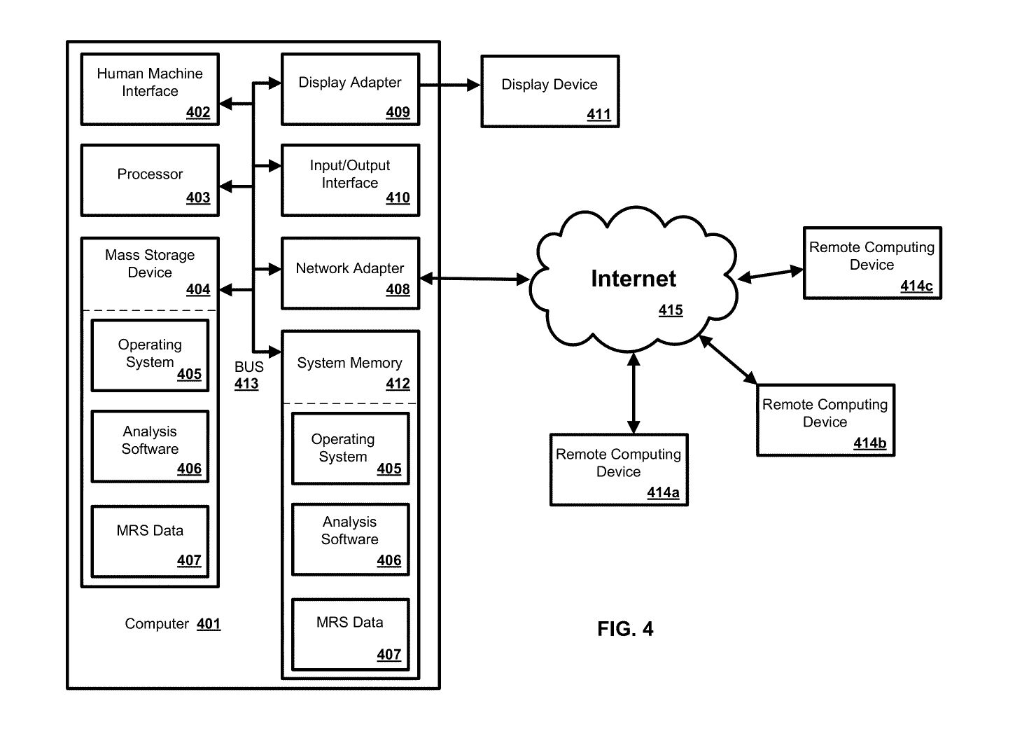

FIG. 4 is a block diagram illustrating an exemplary operating environment for performing the disclosed methods. This exemplary operating environment is only an example of an operating environment and does not indicate limitation as to the scope of use or functionality of operating environment architecture. Neither should the operating environment be interpreted as having any dependency or requirement relating to any one or combination of components illustrated in the exemplary operating environment. One skilled in the art appreciates that this is a functional description and that the respective functions can be performed by software, hardware, or a combination of software and hardware.

The present methods and systems can be operational with numerous other general purpose or special purpose computing system environments or configurations. Examples of well known computing systems, environments, and/or configurations that can be suitable for use with the system and method comprise, but are not limited to, personal computers, server computers, laptop devices, and multiprocessor systems. Additional examples comprise set top boxes, programmable consumer electronics, network PCs, minicomputers, mainframe computers, distributed computing environments that comprise any of the above systems or devices, and the like.

Further, one skilled in the art appreciates that the systems and methods disclosed herein can be implemented via a general-purpose computing device in the form of a computer 401. The components of the computer 401 can comprise, but are not limited to, one or more processors or processing units 403, a system memory 412, and a system bus 413 that couples various system components including the processor 403 to the system memory 412.

The system bus 413 represents one or more of several possible types of bus structures, including a memory bus or memory controller, a peripheral bus, an accelerated graphics port, and a processor or local bus using any of a variety of bus architectures. By way of example, such architectures can comprise an Industry Standard Architecture (USA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI) bus also known as a Mezzanine bus. The bus 413, and all buses specified in this description can also be implemented over a wired or wireless network connection and each of the subsystems, including the processor 403, a mass storage device 404, an operating system 405, analysis software 406, MRS data 407, a network adapter 408, system memory 412, an Input/Output Interface 410, a display adapter 409, a display device 411, and a human machine interface 402, can be contained within one or more remote computing devices 414a,b,c at physically separate locations, connected through buses of this form, in effect implementing a fully distributed system.

The computer 401 typically comprises a variety of computer readable media. Exemplary readable media can be any available media that is accessible by the computer 401 and comprises, for example and not meant to be limiting, both volatile and non-volatile media, removable and non-removable media. The system memory 412 comprises computer readable media in the form of volatile memory, such as random access memory (RAM), and/or non-volatile memory, such as read only memory (ROM). The system memory 412 typically contains data such as MRS data 407 and/or program modules such as operating system 405 and analysis software 406 that are immediately accessible to and/or are presently operated on by the processing unit 403.

In another aspect, the computer 401 can also comprise other removable/non-removable, volatile/non-volatile computer storage media. By way of example, FIG. 4 illustrates a mass storage device 404 which can provide non-volatile storage of computer code, computer readable instructions, data structures, program modules, and other data for the computer 401. For example and not meant to be limiting, a mass storage device 404 can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Optionally, any number of program modules can be stored on the mass storage device 404, including by way of example, an operating system 405 and analysis software 406. Each of the operating system 405 and analysis software 406 (or some combination thereof) can comprise elements of the programming and the analysis software 406. MRS data 407 can also be stored on the mass storage device 404. MRS data 407 can be stored in any of one or more databases known in the art. Examples of such databases comprise, DB2®, Microsoft® Access, Microsoft® SQL Server, Oracle®, mySQL, PostgreSQL, and the like. The databases can be centralized or distributed across multiple systems.

In another aspect, the user can enter commands and information into the computer 401 via an input device (not shown). Examples of such input devices comprise, but are not limited to, a keyboard, pointing device (e.g., a “mouse”), a microphone, a joystick, a scanner, tactile input devices such as gloves, and other body coverings, and the like These and other input devices can be connected to the processing unit 403 via a human machine interface 402 that is coupled to the system bus 413, but can be connected by other interface and bus structures, such as a parallel port, game port, an IEEE 1394 Port (also known as a Firewire port), a serial port, or a universal serial bus (USB).

In yet another aspect, a display device 411 can also be connected to the system bus 413 via an interface, such as a display adapter 409. It is contemplated that the computer 401 can have more than one display adapter 409 and the computer 401 can have more than one display device 411. For example, a display device can be a monitor, an LCD (Liquid Crystal Display), or a projector. In addition to the display device 411, other output peripheral devices can comprise components such as speakers (not shown) and a printer (not shown) which can be connected to the computer 401 via Input/Output Interface 410. Any step and/or result of the methods disclosed can be output in any form known in the art to any output device (such as a display, printer, speakers, etc. . . . ) known in the art.

The computer 401 can operate in a networked environment using logical connections to one or more remote computing devices 414a,b,c. By way of example, a remote computing device can be a personal computer, portable computer, a server, a router, a network computer, a peer device or other common network node, and so on. Logical connections between the computer 401 and a remote computing device 414a,b,c can be made via a local area network (LAN) and a general wide area network (WAN). Such network connections can be through a network adapter 408. A network adapter 408 can be implemented in both wired and wireless environments. Such networking environments are conventional and commonplace in offices, enterprise-wide computer networks, intranets, and the Internet 415.

The processing of the disclosed methods and systems can be performed by software components. The disclosed system and method can be described in the general context of computer-executable instructions, such as program modules, being executed by one or more computers or other devices. Generally, program modules comprise computer code, routines, programs, objects, components, data structures, etc. that perform particular tasks or implement particular abstract data types. The disclosed method can also be practiced in grid-based and distributed computing environments where tasks are performed by remote processing devices that are linked through a communications network. In a distributed computing environment, program modules can be located in both local and remote computer storage media including memory storage devices.

In one aspect, the methods can be implemented in a software system that can utilize data management services, an analysis pipeline, and internet-accessible software for variant discovery and analysis for ultra-high throughput, next generation medical re-sequencing (MRS) data with minimal human manipulation. The software system cyberinfrastructure can use an n-tiered architecture design, with a relational database, middleware and a web server. The data management services can include organizing reads into a searchable database, secure access and backups, and data dissemination to communities over the internet. The automatic analysis pipeline can be based on pair-wise megaBLAST or GMAP alignments and an Enumeration and Characterization module designed for identification and characterization of variants. The variant pipeline can be agnostic as to the read type or the sequence library searched, including RefSeq genome and transcriptome databases.

Data, analysis and results can be delivered to the community using an application server provider implementation, eliminating the need for client-side support of the software. Dynamic queries and visualization of read data, variant data and results can be provided with a user interface. The software system can report, for example, sSNPs, nsSNPs, indels, premature stop codons, and splice isoforms. Read coverage statistics can be reported by gene or transcript, together with a visualization module based upon an individual transcript or genomic segment. As needed, data access can be restricted using security procedures including password protection and HTTPS protocols.

In an aspect, reads can be received in, for example, FASTA format with associated quality score numbers. For example, 454 quality scores can be supplied in “pseudo phred” format (FASTA format with space delimited base 10 ASCII representations of integers in lieu of base pairs). The FASTA headers contain metadata for the sequence including an identifier and sample-specific information. The concept of a sample can be equivalent to an individual run or a specific sample. Data inputs (sequences, lengths and quality scores) can automatically be parsed and loaded into a single relational database table linked to a representation of the sample.

In one aspect, the software system can generate alignments to the NCBI human genome and RefSeq transcript libraries, which includes both experimentally-verified (NM and NR accessions) and computationally predicted transcripts (XM and XR accessions). Reference sequence data, location based feature information (e.g. CDS annotations, variation records) and basic feature metadata imported and stored in an application specific schema.

In a further aspect, reads and quality data can be imported and aligned pairwise to sequence libraries using, for example, MegaBLAST or GMAP. MegaBLAST alignment parameters can be adapted from those used to map SNPs to the human genome: wordsize can be 14; identity count can be >35; expect value filter can be e-10; and low-complexity sequence can not be allowed to seed alignments, but alignments can be allowed to extend through such regions. GMAP parameters can be: identity count can be >35 and identity can be >95%. The best-match alignments for reads can be imported into the database. All alignments equivalent in quality to the best match can be accepted (as in the case of hits to shared exons in splice variants).

All positions at which a read differs from the aligned reference sequence can be enumerated. Contiguous indel events can be treated as single polymorphisms. All occurrences of potential polymorphisms in reads with respect to a given position can be unified as a “single polymorphism,” with associated statistics on frequency, alignment quality, base quality, and other attributes that can be used to assess the likelihood that the polymorphism is a true variant. Candidate variants can be further characterized by type (SNP, indel, splice isoform, stop codon) and as synonymous variant (sV) or non-synonymous variant (nsV).

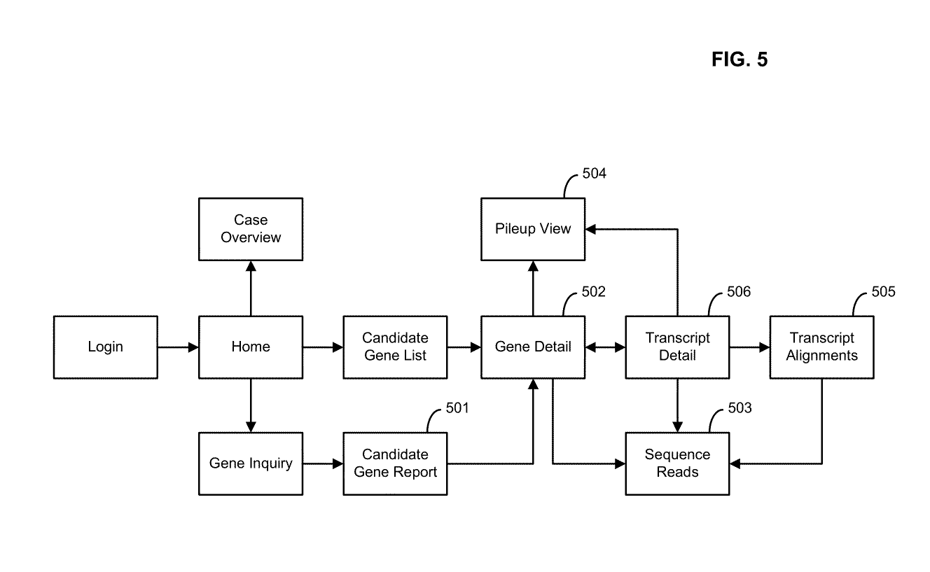

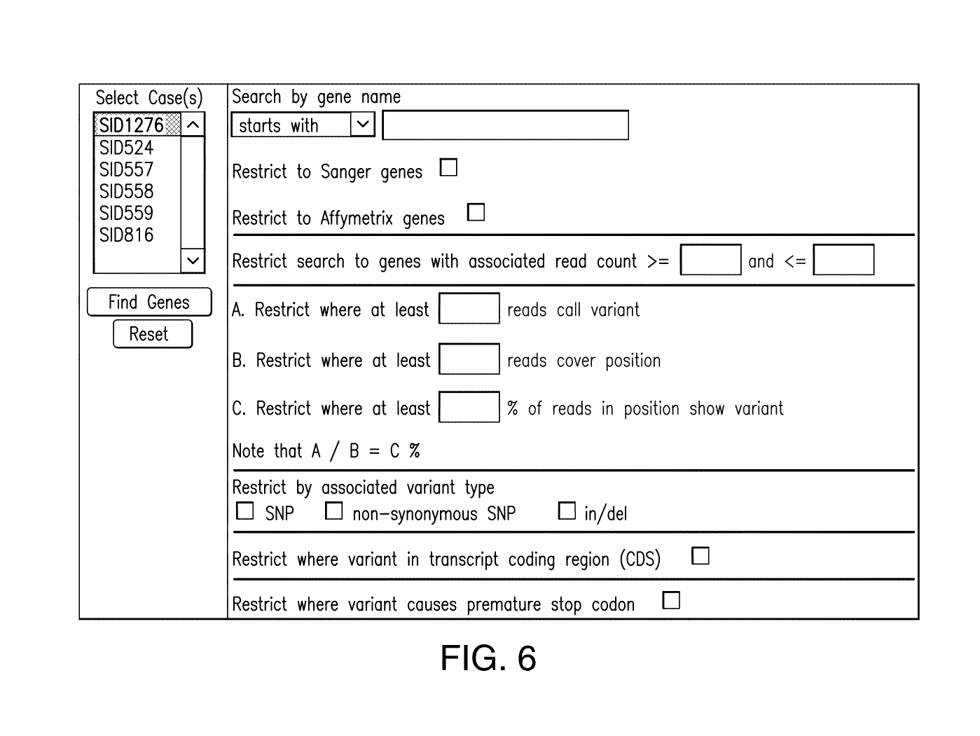

A web-based, user interface can be used to allow data navigation and viewing using a wide variety of paths and filters. FIG. 5 illustrates an exemplary web-based navigation map. Several user-driven query and reporting functions can be implemented. Users can search based upon a gene name or symbol and view their associated reads. Users can also search based upon all genes that meet selectable read coverage, variant frequency, or variant type criteria. FIG. 6 provides an exemplary sequence query interface. Alternatively, a list of candidate genes, supplied prospectively, can be used as an entry point into the results. Resultant data can be further filtered by case, sample or associated read count. Users can search a sample or set of samples. Users can specify the alignment algorithm and reference database from drop down lists. The result of the query can be a sortable Candidate Gene Report 501 table that features, for example, gene symbol (linked to Gene Detail 502 page), gene description, the transcripts or genome segments associated with the gene, sequencing read count total for all matches, and chromosome location. List results can be exportable to Excel and in XML and PDF formats.

Once a gene of interest has been selected, the user can have access to a detailed gene information page. This page can present gene-centric information, for example, synonyms, chromosome position and links to cytogenetic maps, disease association and transcript details at NCBI. For each gene, the gene information page can also display the associated transcripts, genomic segments, reads and variants grouped by case or sample. Links can be made available to views of Sequence Reads 503 and the Pileup View 504. The Sequence Reads 503 page can present a textual display of all annotated reads (with read identifier, length and average quality score) by case number along with the transcript name to which they map (linked to Alignments 505). In Alignments 505, each nucleotide in the read can be color coded with the base quality score to enable facile scanning of overall and position-specific read quality.

The Details 506 page can present a tabular view of all gene segment or transcript associated Sequence Reads 503, pair wise Alignments 505 and a comprehensive read overview (Pileup View 504) grouped by case or sample. It can also provide a table of all variants in cases grouped into SNP, indel and splice variant. For each identified variant, there can be drill-down links to relevant Sequence Reads 503 and pair wise BLAST- or GMAP-generated Alignments 505.

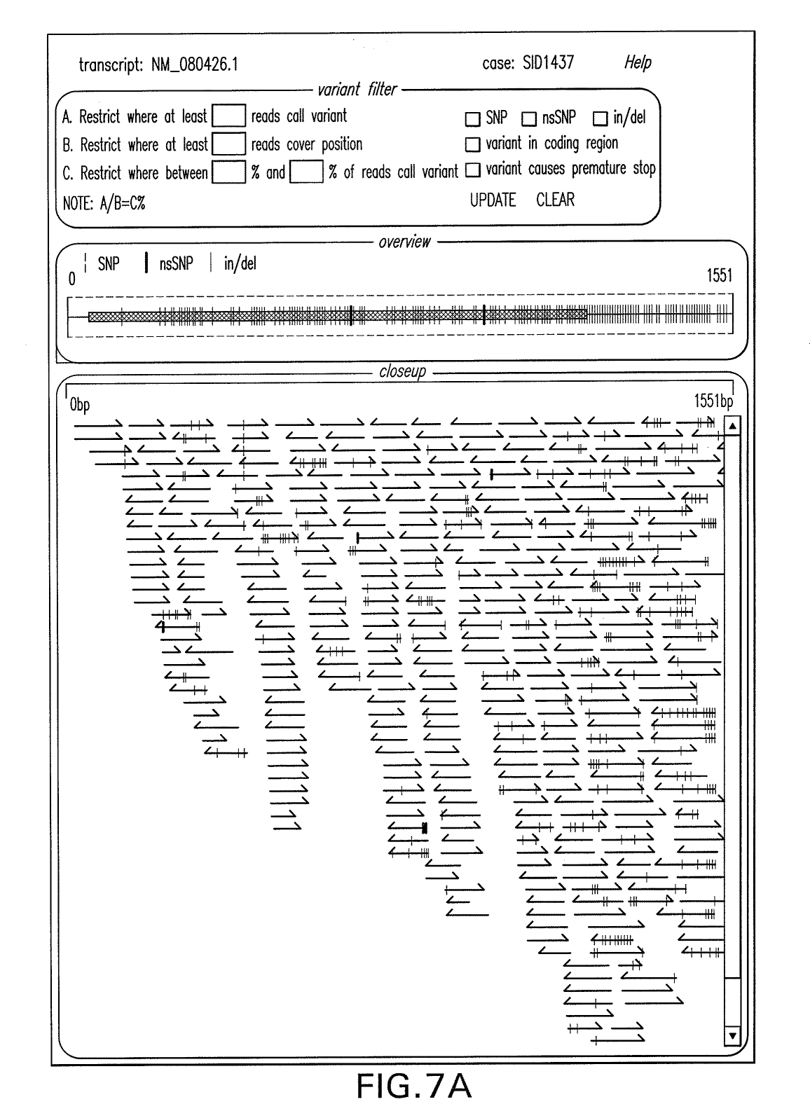

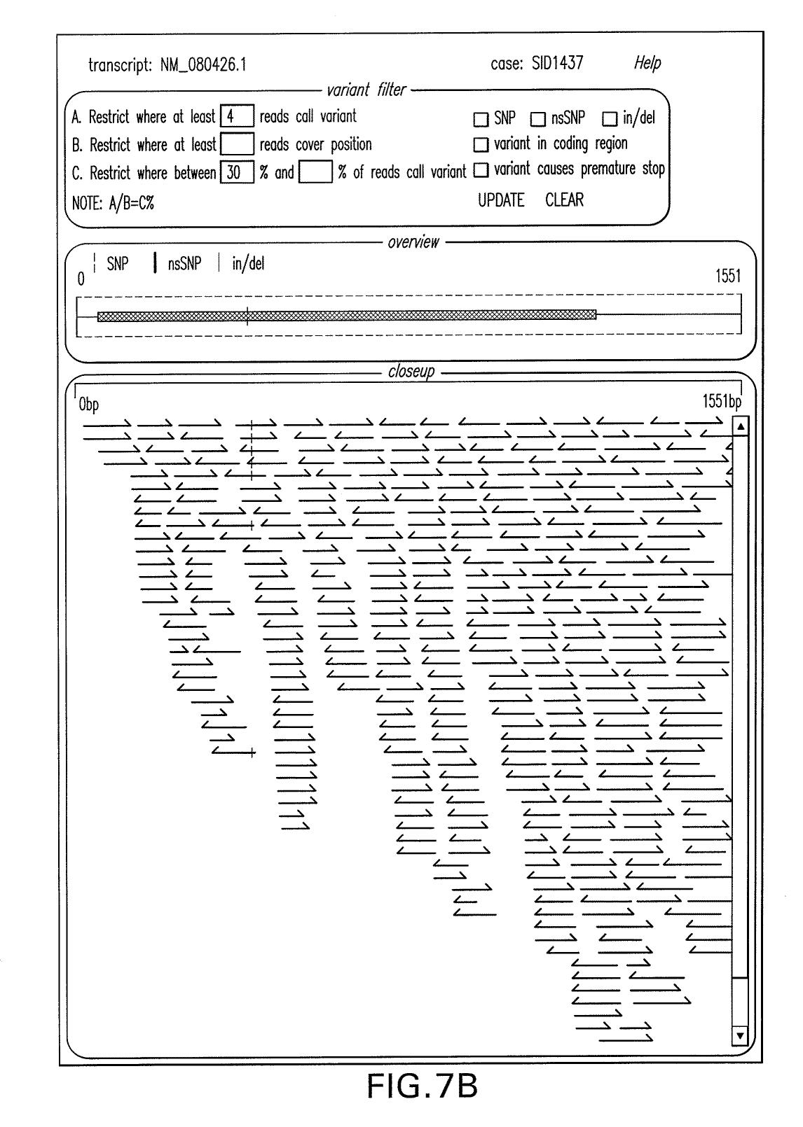

The Pileup View 504 is further illustrated in FIG. 7. The Pileup View 504 can display reads from a single sample aligned against a transcript or genomic segment, along with all nucleotide variants detected in those reads. FIG. 7 illustrates the identification of a coding domain (CD) SNP in the α subunit of the Guanine nucleotide-binding stimulatory protein (GNAS) using the disclosed methods. GNAS is a schizophrenia candidate gene, with a complex imprinted expression pattern, giving rise to maternally, paternally, and biallelically expressed transcripts that are derived from four alternative promoters and 5′ exons. The 1884 bp GNAS transcript, NM_{—}080426.1, is indicated by a horizontal line, oriented from 5′ to 3′, from left to right), along with its associated CD (in green). Three hundred and ninety four 454 reads from sample 1437 are displayed as arrows aligned against NM_{—}080426.1 whose direction reflects their orientation with respect to the transcript. Variants found in individual reads are displayed by hash marks at their relative position on the read. Variants are characterized as synonymous SNPs (sSNPs, blue), nsSNPs (red) and deletions or insertions (black) with respect to individual sequence read alignments. The left panel displays all putative variants. The right displays variants filtered to retain those present in =4 reads, in 30% of reads aligned at that position, and in bidirectional reads. One sSNP (C398T) was retained that was present in seven of thirteen reads aligned at that position in sample 1437, nine of eighteen reads in sample 1438 and twenty of twenty-one reads in 1439. C398T is validated (dbSNP number rs7121), and the homozygous 398T allele has shown association with deficit schizophrenia.

In one aspect, the analysis software 406 can implement any of the methods disclosed. For example, the analysis software 406 can implement a method for determining a candidate biological molecule variant comprising receiving biological molecule sequence data, annotating the biological molecule sequence data wherein the step of annotating results in identification of a plurality of biological molecules, determining if the at least one of the plurality of biological molecules is a potential biological molecule variant of a known biological molecule, filtering the biological molecule sequence data to determine if the determined potential biological molecule variant is a candidate biological molecule variant, prioritizing the candidate biological molecule variants, and presenting a list of the plurality of the candidate biological molecule variants.

In another aspect, the analysis software 406 can implement a method for determining an association between a biological molecule variant and a component phenotype comprising receiving biological molecule sequence data comprising a plurality of biological molecule variants, determining a homeostatic effect for at least one of the plurality of biological molecule variants, determining an intensity of perturbation for the at least one of the plurality of biological molecule variants, determining a duration of effect for the at least one of the plurality of biological molecule variants, compiling the at least one of the plurality of biological molecule variants into at least one biological pathway based on the homeostatic effect, the intensity of perturbation, and the duration of effect, determining if the at least one biological pathway is associated with the component phenotype, and presenting a list comprising the plurality of biological molecule variants in the at least one biological pathway associated with the component phenotype.

For purposes of illustration, application programs and other executable program components such as the operating system 405 are illustrated herein as discrete blocks, although it is recognized that such programs and components reside at various times in different storage components of the computing device 401, and are executed by the data processor(s) of the computer. An implementation of analysis software 406 can be stored on or transmitted across some form of computer readable media. Computer readable media can be any available media that can be accessed by a computer. By way of example and not meant to be limiting, computer readable media can comprise “computer storage media.” “Computer storage media” comprise volatile and non-volatile, removable and non-removable media implemented in any method or technology for storage of information such as computer readable instructions, data structures, program modules, or other data. Exemplary computer storage media comprises, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

The methods and systems can employ Artificial Intelligence techniques such as machine learning and iterative learning. Examples of such techniques include, but are not limited to, expert systems, case based reasoning, Bayesian networks, behavior based AI, neural networks, fuzzy systems, evolutionary computation (e.g., genetic algorithms), swarm intelligence (e.g., ant algorithms), and hybrid intelligent systems (e.g., Expert inference rules generated through a neural network or production rules from statistical learning).

### IV. SCHIZOPHRENIA-ASSOCIATED GENES

Schizophrenia and Bipolar Affective Disorder are common and debilitating psychiatric disorders. Despite a wealth of information on the epidemiology, neuroanatomy and pharmacology of the illness, it is uncertain what molecular pathways are involved and how impairments in these affect brain development and neuronal function. Despite an estimated heritability of 60-80%, very little is known about the number or identity of genes involved in these psychoses. Although there has been recent progress in linkage and association studies, especially from genome-wide scans, these studies have yet to progress from the identification of susceptibility loci or candidate genes to the full characterization of disease-causing genes (Berrettini, 2000).

Disclosed are the GPX, GSPT1 and TKT genes, polynucleotide fragments comprising one or more of GPX, GSPT1 and TKT genes or a fragment, derivative or homologue thereof, the gene products of the GPX, GSPT1 and TKT genes, polypeptide fragments comprising one or more of the gene product of the GPX, GSPT1 and TKT genes or a fragment, derivative or homologue thereof. It has been discovered that genetic variations in the GPX, GSPT1 and TKT genes are associated with schizophrenia.

Also disclosed is a recombinant or synthetic polypeptide for the manufacture of reagents for use as therapeutic agents in the treatment of schizophrenia and/or affective psychosis. In particular, disclosed are pharmaceutical compositions comprising the recombinant or synthetic polypeptide together with a pharmaceutically acceptable carrier therefor.

Also disclosed is a method of diagnosing schizophrenia and/or affective psychosis or susceptibility to schizophrenia and/or affective psychosis in an individual or subject, wherein the method comprises determining if one or more of the GPX, GSPT1 and TKT genes in the individual or subject contains a genetic variation. The genetic variation can be a genetic variation identified as associated with schizophrenia, affective psychosis disorder or both.

The methods which can be employed to detect genetic variations are well known to those of skill in the art and can be detected for example using PCR or in hybridization studies using suitable probes that are designed to span an identified mutation site in one or more of the GPX, GSPT1 and TKT genes, such as the mutations described herein.

Once a particular polymorphism or mutation has been identified it is possible to determine a particular course of treatment. For example the GPX, GSPT1 and TKT genes are implicated in brain glutathione levels. Thus, treatments to change brain glutathione levels are contemplated for individuals or subjects determined to have a genetic variation in one or more of the GPX, GSPT1 and TKT genes.

Mutations in the gene sequence or controlling elements of a gene, e.g., the promoter, the enhancer, or both can have subtle effects such as affecting mRNA splicing, stability, activity, and/or control of gene expression levels, which can also be determined. Also the relative levels of RNA can be determined using for example hybridization or quantitative PCR as a means to determine if the one or more of the GPX, GSPT1 and TKT genes has been mutated or disrupted.

Moreover the presence and/or levels of one or more of the GPX, GSPT1 and TKT gene products themselves can be assayed by immunological techniques such as radioimmunoassay, Western blotting and ELISA using specific antibodies raised against the gene products. Also disclosed are antibodies specific for one or more of the GPX, GSPT1 and TKT gene products and uses thereof in diagnosis and/or therapy.

Also disclosed are antibodies specific to the disclosed GPX, GSPT1 and TKT polypeptides or epitopes thereof. Production and purification of antibodies specific to an antigen is a matter of ordinary skill, and the methods to be used are clear to those skilled in the art. The term antibodies can include, but is not limited to polyclonal antibodies, monoclonal antibodies (mAbs), humanised or chimeric antibodies, single chain antibodies, Fab fragments, F(ab′)₂ fragments, fragments produced by a Fab expression library, anti-idiotypic (anti-Id) antibodies, and epitope binding fragments of any of the above. Such antibodies can be used in modulating the expression or activity of the particular polypeptide, or in detecting said polypeptide in vivo or in vitro.

Using the sequences disclosed herein, it is possible to identify related sequences in other animals, such as mammals, with the intention of providing an animal model for psychiatric disorders associated with the improper functioning of the disclosed nucleotide sequences and proteins. Once identified, the homologous sequences can be manipulated in several ways known to the skilled person in order to alter the functionality of the nucleotide sequences and proteins homologous to the disclosed nucleotide sequences and proteins. For example, “knock-out” animals can be created, that is, the expression of the genes comprising the nucleotide sequences homologous to the disclosed nucleotide sequences and proteins can be reduced or substantially eliminated in order to determine the effects of reducing or substantially eliminating the expression of such genes. Alternatively, animals can be created where the expression of the nucleotide sequences and proteins homologous to the disclosed nucleotide sequences and proteins are upregulated, that is, the expression of the genes comprising the nucleotide sequences homologous to the disclosed nucleotide sequences and proteins can be increased in order to determine the effects of increasing the expression of these genes. In addition to these manipulations substitutions, deletions and additions can be made to the nucleotide sequences encoding the proteins homologous to the disclosed nucleotide sequences and proteins in order to effect changes in the activity of the proteins to help elucidate the function of domains, amino acids, etc. in the proteins. Furthermore, the disclosed sequences can also be used to transform animals to the manner described above. The manipulations described above can also be used to create an animal model of schizophrenia and/or affective psychosis associated with the improper functioning of the disclosed nucleotide sequences and/or proteins in order to evaluate potential agents which can be effective for combating psychotic disorders, such as schizophrenia and/or affective psychosis.

Thus, also disclosed are screens for identifying agents suitable for preventing and/or treating schizophrenia and/or affective psychosis associated with disruption or alteration in the expression of one or more of the GPX, GSPT1 and TKT genes and/or its gene products. Such screens can easily be adapted to be used for the high throughput screening of libraries of compounds such as synthetic, natural or combinatorial compound libraries.

Thus, one or more of the GPX, GSPT1 and TKT gene products can be used for the in vivo or in vitro identification of novel ligands or analogs thereof. For this purpose binding studies can be performed with cells transformed with the disclosed nucleotide fragments or an expression vector comprising a disclosed polynucleotide fragment, said cells expressing one or more of the GPX, GSPT1 and TKT gene products.

Alternatively also one or more of the GPX, GSPT1 and TKT gene products as well as ligand-binding domains thereof can be used in an assay for the identification of functional liqands or analogs for one or more of the GPX, GSPT1 and TKT gene products.

Methods to determine binding to expressed gene products as well as in vitro and in vivo assays to determine biological activity of gene products are well known. In general, expressed gene product is contacted with the compound to be tested and binding, stimulation or inhibition of a functional response is measured.

Thus, also disclosed is a method for identifying ligands for one or more of the GPX, GSPT1 and TKT gene products, said method comprising the steps of: (a) introducing into a suitable host cell a polynucleotide fragment one or more of the GPX, GSPT1 and TKT gene products; (b) culturing cells under conditions to allow expression of the polynucleotide fragment; (c) optionally isolating the expression product; (d) bringing the expression product (or the host cell from step (b)) into contact with potential ligands which can bind to the protein encoded by said polynucleotide fragment from step (a); (e) establishing whether a ligand has bound to the expressed protein; and (f) optionally isolating and identifying the ligand. As a preferred way of detecting the binding of the ligand to the expressed protein, also signal transduction capacity can be measured.

Compounds which activate or inhibit the function of one or more of the GPX, GSPT1 and TKT gene products can be employed in therapeutic treatments to activate or inhibit the disclosed polypeptides.

Schizophrenia and/or affective psychosis as used herein relates to schizophrenia, as well as other affective psychoses such as those listed in “The ICD-10 Classification of Mental and Behavioural Disorders” World Health Organization, Geneva 1992. Categories F20 to F29 inclusive includes Schizophrenia, schizotypal and delusional disorders. Categories F30 to F39 inclusive are Mood (affective) disorders that include bipolar affective disorder and depressive disorder. Mental Retardation is coded F70 to F79 inclusive. The Diagnostic and Statistical Manual of Mental Disorders, Fourth Edition (DSM-IV). American Psychiatric Association, Washington D.C. 1994.

“Polynucleotide fragment” as used herein refers to a chain of nucleotides such as deoxyribose nucleic acid (DNA) and transcription products thereof, such as RNA. The polynucleotide fragment can be isolated in the sense that it is substantially free of biological material with which the whole genome is normally associated in vivo. The isolated polynucleotide fragment can be cloned to provide a recombinant molecule comprising the polynucleotide fragment. Thus, “polynucleotide fragment” includes double and single stranded DNA, RNA and polynucleotide sequences derived therefrom, for example, subsequences of said fragment and which are of any desirable length. Where a nucleic acid is single stranded then both a given strand and a sequence or reverse complementary thereto is contemplated.

In general, the term “expression product” or “gene product” refers to both transcription and translation products of said polynucleotide fragments. When the expression or gene product is a “polypeptide” (i.e., a chain or sequence of amino acids displaying a biological activity substantially similar (e.g., 98%, 95%, 90%, 80%, 75% activity) to the biological activity of the protein), it does not refer to a specific length of the product as such. Thus, it should be appreciated that “polypeptide” encompasses inter alia peptides, polypeptides and proteins. The polypeptide can be modified in vivo and in vitro, for example by glycosylation, amidation, carboxylation, phosphorylation and/or post-translational cleavage.

### V. EXAMPLES

The following examples are put forth so as to provide those of ordinary skill in the art with a complete disclosure and description of how the compounds, compositions, articles, devices and/or methods claimed herein are made and evaluated, and are intended to be purely exemplary and are not intended to limit the scope of the methods and systems. Efforts have been made to ensure accuracy with respect to numbers (e.g., amounts, temperature, etc.), but there can be an accounting of errors and deviations. Unless indicated otherwise, parts are parts by weight, temperature is in ° C. or is at ambient temperature, and pressure is at or near atmospheric.

### A. Mendelian Disorders

The disclosed model notes that:

g(E₁ . . . ₙ)=h(Cp₁ . . . ₙ,Sv₁ . . . ₙ,A₁ . . . ₙ)

For Mendelian disorders, there is typically a single value for E (the causal gene), H (the impact of the causal gene on relevant homeostasis), t (the time at which the causal gene is expressed) and Cp (a pathognomonic phenotype).

Thus:

g(Eᵢ)=h(Cpᵢ,Sv₁ . . . ₙ,A₁ . . . ₙ)

Therefore, for a Mendelian disorder in an individual patient, variation in the value of I (the specific variant in the causal gene) determines the value of Sv (phenotype severity) and A (age of onset). This is in agreement with most evidence in Mendelian disorders. For example, the magnitude of triplet repeat expansions generally is associated with severity and age of onset of symptoms.

### B. Hypertension

Multiple, rare families that exhibited Mendelian segregation of the phenotype (Cp) of severe hypertension were studied to identify single gene mutations (E) that result in a phenotype indistinguishable from that of a common, complex disorder—namely hypertension. The majority of the individual genes that had mutations (E) and resulted in the hypertension phenotype can be collapsed into a single metabolic pathway (P). Thus, these studies agree with the model described herein, namely the convergence of distinct Elements (E) Into Networks and Pathways (P) in causality of common, complex disorders.

### C. Cancer

Recently, researchers undertook medical sequencing of 13,023 genes in 11 breast and 11 colorectal cancers. The study revealed that individual tumors accumulate an average of ˜90 mutant genes but that only a subset of these contribute to the neoplastic process. Using criteria to delineate this subset, the researchers identified 189 genes (11 per tumor) that were mutated at significant frequency. The majority of these genes were not known to be genetically altered in tumors and were predicted to affect a wide range of cellular functions, including transcription, adhesion, and invasion. This study agrees with the model described herein, namely that in complex diseases, there is insufficient homogeneity of causal elements among affected individuals to enable detection of statistical differences. The disclosed model notes that there exists significant genetic and environmental heterogeneity in complex diseases. Thus the specific combinations of genetic and environmental elements that cause D vary widely among the affected individuals in a cohort. In agreement with this study, experimental designs based upon comparisons of candidate variant allele frequencies between affected and unaffected cohorts, even if undertaken on a large scale, fail to disclose causal variants in situations where there is a high degree of heterogeneity among individuals in causal elements.

Another study showed similar findings. Comprehensive, shotgun sequencing of tumor transcriptomes of surgical specimens from individual mesothelioma tumors, an environmentally-induced cancer, was performed. High-throughput pyrosequencing was used to generate 1.6 gigabases of transcriptome sequence from enriched tumor specimens of four mesotheliomas (MPM) and two controls. A bioinformatic pipeline was used to identify candidate causal mutations, namely non-synonymous variants (nsSNPs), in tumor-expressed genes. Of ˜15,000 annotated (RefSeq) genes evaluated in each specimen, 66 genes with previously undescribed nsSNPs were identified in MPM tumors. Genomic resequencing of 19 of these nsSNPs revealed 15 to be germline variants and 4 to represent loss of heterozygosity (LOH) in MPM. Resequencing of these 4 genes in 49 additional MPM surgical specimens identified one gene (MPM1), that exhibited LOH in a second MPM tumor. No overlap was observed in other genes with nsSNPs or LOH among MPM tumors. This study agrees with the model described herein, namely that in complex diseases, there is insufficient homogeneity of causal elements among affected individuals to enable detection of statistical differences.

### D. Schizophrenia

### i. Example 1

Medical sequencing was performed on three related individuals with schizophrenia, multiple expressed genes were identified with variants in each affected individual. Schizophrenia is a “complex” disorder in which inherited elements are believed to be a significant factor. Previous studies have identified some inherited elements but the most common, important contributors remain unknown. The disparate genes (E) identified in affected individuals were found to converge into several discrete pathways (P) that are disordered in schizophrenia. For example, in the affected proband, a male Caucasian of Jewish ethnicity, 621341 sequence reads were identified that matched to 15530 genes, non-synonymous single nucleotide polymorphisms in the genes glutathione peroxidase 1 (GPX1) and glutathione S-transferase pi (GSTP1). These amino-acid changes were also identified in the other two, related individuals with schizophrenia. Thus, some non-synonymous variants in patients with schizophrenia converge into the glutathione metabolism pathway.

These studies of schizophrenia also exemplified the concept of Cp, and especially molecular Cp that are suggested by the E identified in affected individuals, being informative. For example, glutathione (GSH) is converted to oxidized glutathione (GSSG) through glutathione peroxidase (GPx), and converted back to GSH by glutathione reductase (GR). Measurements of GSH, GSSG, GPx and GR in the caudate region of postmortem brains from schizophrenic patients and control subjects (with and without other psychiatric disorders) represent molecular Cp that would be of benefit to seek associations with variants in GPX1 and GSTP1 candidate genes. For example, significantly lower levels of GSH, GPx, and GR were found in schizophrenic group than in control groups without any psychiatric disorders. Concomitantly, a decreased GSH:GSSG ratio was also found in schizophrenic group. Moreover, both GSSG and GR levels were significantly and inversely correlated to age of schizophrenic patients, but not control subjects.

### ii. Example 2

Three lymphoblastoid, two lung and four lung cancer RNA samples were sequenced with 454 technology. The disclosed methods were used to comprehensively catalog nsV. 350 μg of total RNA was isolated from Epstein-Barr-virus-transformed lymphoblastoid cell lines from a schizophrenia pedigree (from the NIGMS Cell Repository panel, Coriell Institute for Medical Research, Camden, N.J.) and 6 lung surgical specimens. The proband had schizophrenia with primarily negative clinical features (Table 1). His father had major depression. His sister had anorexia nervosa and schizoid personality disorder. The mother (not studied) was not affected.

TABLE 1
Family 176 B Lymphoblastoid Cell Line Characteristics

| | Sample 1437 | Sample 1438 | Sample 1439 |
|---|---|---|---|
| Repository # | GM01488 | GM01489 | GM01490 |
| db SNP | 10411 | 10412 | 10413 |
| number | | | |
| Age | 23 YR | 55 YR | 27 YR |
| Gender | Male | Male | Female |
| Race | Caucasian | Caucasian | Caucasian |
| Ethnicity | Jewish | Jewish | Jewish |
| Relation | Proband | affected father | affected sister |
| Symptoms, | paralogical thinking; | 3 episodes of | anorexia |
| History | affective shielding; | depression; | nervosa |
| | splitting of affect from | ECT; | since |
| | content; suspiciousness; | no hypomania | adolescence; |
| | onset age 15; | | more |
| | hospitalized | | schizoid |
| | | | than |
| | | | depressed |
| ISCN | 46, XY | n.d. | n.d. |
| HLA type | Aw26, B16/Aw26, B16 | Aw26, | Aw26, |
| | | B16/A18, B- | B16/A2, B35 |

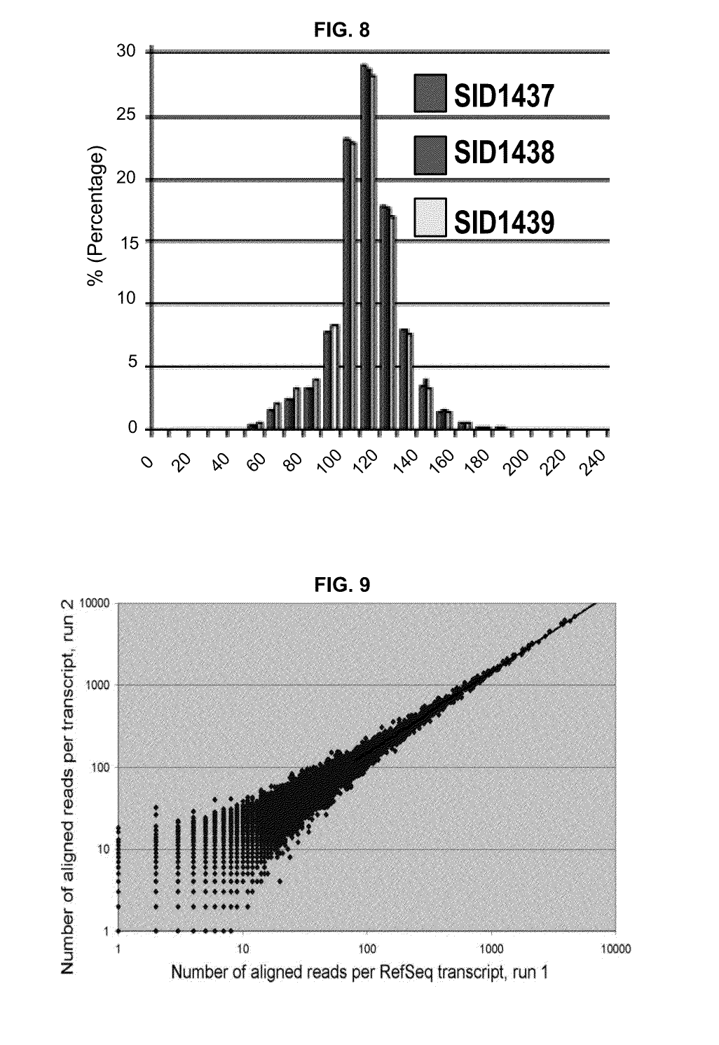

Poly-A+ RNA was prepared using oligo(dT) magnetic beads (PureBiotech, Middlesex, N.J.), and 1 st-strand cDNA prepared from 5-8 μg of poly(A)+ RNA with 200 pmol oligo(dT)25V (V=A, C or G) using 300 U of Superscript II reverse transcriptase (Invitrogen). Second-strand synthesis was performed at 16° C. for 2 h after addition of 10 U of E. coli DNA ligase, 40 U of E. coli DNA polymerase, and 2 U of RNase H (all from Invitrogen). T4 DNA polymerase (5 U) was added and incubated for 5 min at 16° C. cDNA was purified on QIAquick Spin Columns (Qiagen, Valencia, Calif.). Single-stranded template DNA (sstDNA) libraries were prepared using the GS20 DNA Library Preparation Kit (Roche Applied Science, Indianapolis, Ind.) following the manufacturer's recommendations. sstDNA libraries were clonally amplified in a bead-immobilized form using the GS20 emPCR kit (Roche Applied Science). sstDNA libraries were sequenced on the 454 GS20 instrument. Two runs were performed on SID1437 and SID1438, 3 runs on SID1439 (56-64 MB sequence; Table 2, FIG. 8), and up to 18 runs on each of the lung specimens (1.65 GB). FIG. 8 illustrates length distribution of 454 GS20 reads.

TABLE 2
454 GS20 Statistics

| | SID1437 | SID1438 | SID1439 |
|---|---|---|---|
| Number of GS20 runs | 2 | 2 | 3 |
| Average read length | 104 | 104 | 103 |
| Average read quality | 25 | 24 | 25 |
| Number Of Reads | 621,341 | 536,463 | 586,232 |
| Number Of Bases | 64.9M | 56.2M | 60.4M |

Four alignment techniques (MegaBLAST, GMAP, BLAT and SynaSearch) were evaluated for alignment of 454 reads from SID1437 to the NCBI human genome and RefSeq transcript databases using similar parameters. MegaBLAST and BLAT are standard methods for aligning sequences that differ slightly as a result of sequencing errors. GMAP is a recently described algorithm that was developed to align cDNA sequences to a genome in the presence of substantial polymorphisms and sequence errors, and without using probabilistic splice site models. GMAP features a minimal sampling strategy for genomic mapping, oligomer chaining for approximate alignment, sandwich DP for splice site detection, and microexon identification. These features are particularly useful for alignments of short reads with relatively high base calling error rates. GMAP was also anticipated to be useful in identifying novel splice variants. Synasearch (Synamatix, Kuala Lumpur, Malaysia) is a novel, rapid aligment method.

Computationally, SynaSearch and MegaBLAST were most efficient in transcript alignments, whereas SynaSearch and GMAP had the best efficiency for genome alignments (Tables 3, 4). SynaSearch alignments were performed on a dual Itanium server while the other methods employed a much larger blade cluster. Genome alignments were much more computationally intensive than transcript alignments. GMAP aligned the greatest number of reads (82% to the human transcript database and 97.8% to the genome). The greater number of alignments to the genome reflects RefSeq having only 40,545 of ˜185,000 human transcripts. For transcripts with aligned reads, GMAP provided the greatest length and depth of coverage of the methods evaluated. MegaBLAST and Synamatix performed similarly for these latter metrics, while BLAT was inferior. These comparisons indicated GMAP to be the most effective method for alignment of 454 reads to the human genome and transcript databases, and that the blade cluster was adequate for pipelining ˜1 M reads per day.

TABLE 3
Comparison of alignment methods for mapping 621,341 454 reads from
SID1437

| | BLAT | GMAP | MegaBLAST | Synamatix |
|---|---|---|---|---|
| % of reads with | 64.7 | 82.4 | 66.5 | 68.5 |
| transcript match | | | | |
| Transcript CPU Time | 2.0 | 15.5 | 0.5 | 0.9 |
| (hr) | | | | |
| % of reads with genome | 88.0 | 97.8 | 87.6 | 96.5 |
| match | | | | |
| Genome CPU Time (hr) | 52.3 | 14.0 | 171.8 | 3.2 |

MegaBLAST v.2.2.15, BLAT v.32×1, GMAP v.2006-04-21 were used to align 454 reads with human RefSeq transcript dB release 16 and human genome release 16, and Synasearch v1.3.1 with RefSeq release 19 and human genome release 36.1. GMAP, BLAT and MegaBLAST alignments were performed on a 62-Dual-core Processor Dell 1855 Blade Cluster with 124 GB RAM and 2.4 TB disk. Synamatix alignments were performed on a dual Intel Itanium 1.5 GHz CPU with 64 GB RAM. Similar figures were obtained with SID 1438 and SID 1439.

On the basis of MegaBLAST and GMAP read alignments, it was found that the majority of genes were expressed in lymphoblastoid lines and lung samples. ˜55% of genes were detected by >1 aligned read in ˜60 MB of lymphoblastoid cDNA MRS data (Table 4). ˜75% of genes were detected by >1 aligned read in ˜300 MB of lung cDNA MRS data. Very little run-to-run variation was noted in the number of reads aligning to each gene (r2>0.995, FIG. 9). FIG. 9 illustrates run-to-run variation in RefSeq transcript read counts. Two runs of 454 sequence were aligned to the RefSeq transcript dB with megaBLAST. In the range examined (up to 1.65 GB per sample type), the number of transcripts with aligned reads and the depth of coverage increased with the quantity of MRS. This was true both of lymphoblastoid cell lines and lung specimens. These data indicate that 3 GB of MRS per sample provide 8× coverage of ˜40% of human transcripts (sufficient to unambiguously identify heterozygous nsV, see below) and ˜50% of transcripts with 4× coverage (sufficient to unambiguously identify heterozygous nsV).

TABLE 4
RefSeq transcript alignment statistics for 454 sequences from
lymphoblastoid cell line RNAs

| | 1437 | | 1438 | | | |
|---|---|---|---|---|---|---|
| | Mega | 1437 | Mega | 1438 | 1439 Mega | 1439 |
| Case/Method | BLAST | GMAP | BLAST | GMAP | BLAST | GMAP |
| Number of reads | 621341 | 621341 | 536463 | 536463 | 586232 | 586232 |
| % reads aligned | 72 | 64 | 79 | 61 | 64 | 64 |
| to a RefSeq | | | | | | |
| transcript | | | | | | |
| % RefSeq | 58 | 53 | 57 | 51 | 57 | 52 |
| transcripts with | | | | | | |
| ≧1 aligned read | | | | | | |
| Number of indels | 704662 | 211882 | 556910 | 177702 | 604920 | 170407 |
| Number of SNPs | 281915 | 204730 | 275277 | 172183 | 253182 | 190491 |
| Indel per kb | 10.8 | 3.3 | 9.9 | 3.2 | 10.0 | 2.8 |
| SNP per kb | 4.3 | 3.1 | 4.9 | 3.1 | 4.2 | 3.2 |

A moderate 3′ bias was observed in the distribution of read coverage across transcripts, as anticipated with oligo-dT priming. The bias was not, however, sufficiently pronounced to preclude analysis of 5′ regions.

TABLE 5
Schizophrenia Candidate Genes (from www.polygenicpathways.co.uk)

ACE, ADH1B, APOE, ARVCF, ADRA1A, ATN1, AGA, ATXN1, AHI1, AKT1,
ALDH3B1, ALK, APC, B3GAT1, BDNF, BRD1, BZRP, CCKAR, CHGB, CHL1,
CHN2, CHRNA7, CLDN5, CNP, CNR1, CNTF, COMT CPLX2, CTLA4, DAO,
DAOA, DISC1, DLG2, DPYSL2, DRD2, DRD3, DRD4, DRD5, DTNBP1, EGF,
ELSPBP1, ENTH, ERBB4, FEZ1, FOXP2, FZD3, GABBR1, GABRB2, GAD1,
GALNT7, GCLM, GFRA1, GNAS, GNPAT, GPR78, GRIA1, GRIA4, GRID1, GRIK3,
GRIK4, GRIN1, GRIN2A, GRIN2B, GRIN2D, GRM3, GRM4, GRM5, GRM8,
GSTM1, HLA-B, HLA-DRB1, HMBS, HOMER1, HP, HRH2, HTR2A, HTR5A,
HTR6, HTR7, IL10, IL1B, IL1RN, IL2, IL4, IMPA2, JARID2, KCNN3, KIF2,
KLHL1AS, KPNA3, LGI1, LTA, MAG, MAOA, MAP6, MCHR1, MED12, MLC1,
MOG, MPZL1, MTHFR, NAALAD2, NDUFV2, NOS1, NOS1AP, NOTCH4, NPAS3,
NPTN, NPY, NQO2, NRG1, NRG3, NTF3, NTNG1, NTNG2, NUMBL, OLIG2,
OPRS1, PAH, PAX6, PCM1, PCQAP, PDE4B, PDLIM5, PHOX2B, PICK1, PIK3C3,
PIP5K2A, PLA2G4A, PLA2G4B, PLA2G4C, PLP1, PLXNA2, PNOC, PPP3CC,
PRODH, PTGS2, RANBP5, RGS4, RHD, RTN4, RTN4R, S100B, SLC15A1,
SLC18A1, SLC1A2, SLC6A3, SLC6A4, SNAP29, SOD2, SRR, ST8SIA2, STX1A,
SULT4A1, SYN2, SYN3, SYNGR1, TAAR6, TH, TNF, TNXB, TP53, TPH1, TPP2,
TUBA8, TYR, UFD1L, UHMK1, XBP1, YWHAH, ZDHHC8, ZNF74

The expression of schizophrenia candidate genes in lymphoblastoid cells was a concern. 172 schizophrenia candidate genes were identified by literature searching (Table 5). 66-68 candidate genes (40%) had >3 reads aligned by GMAP in the three lymphoblastoid lines. Scaling from 50 MB to 3 GB MRS per sample, this read count is equivalent to 8× coverage. Thus, ˜40% of schizophrenia candidate genes are evaluated for nSV by lymphoblastoid transcriptome MRS.

The number of SNPs and indels for reads aligned with MegaBLAST and GMAP was enumerated for each sample (Table 4). One effect of the incompleteness of the RefSeq transcript database was that some MegaBLAST best matches that met criteria for reporting were misalignments. This was not observed with GMAP. Read misalignment generated false positive SNP and indel calls. Other causes of SNP and indel calls were true nucleotide variants, RefSeq database errors and 454 basecalling errors. 454 data has a higher basecall error rate than conventional Sanger resequencing, particularly indel errors adjacent to homopolymer tracts. The unfiltered indel rate per kb with MegaBLAST read alignment was 9.9-10.8 per kb, and for GMAP was 2.8-3.3 per kb. The SNP rate per kb with MegaBLAST was 4.2-4.9 per kb, and for GMAP was 3.1-3.2 per kb. In contrast, the true SNP rate per kb in the human genome is ˜0.8 per kb and indel rate is approximately 10-fold less than the SNP rate. These data indicated that use of additional filter sets can identify high-likelihood, true-positive SNPs and indels in MRS data.

To circumvent the identification of false-positive nucleotide variants, a rule set was developed for SNP and indel identification in 454 reads (Table 6). These rules represent the threshold values of these elements. These filters had been previously validated on a set of ˜2.5 million 454 reads and 2,465 previously described human SNPs present in 1,415 genes in a human lung RNA sample and it was found that 96% of known SNPs were detected. Application of these filters via the disclosed methods reduced the number of genes with nsV by 60-fold.

TABLE 6
Rules for identification of high-likelihood, true-
positive SNPs and indels in 454 transcriptome MRS:

Variant present in ≧4 reads
Variant present in ≧30% of reads
High quality score at variant base
Present in 5′→3′ and 3′→5′ reads

An example of the utility of application of these bioinformatic filters is shown in FIG. 7. SNPs were 3-times more common than indels (Table 7). The relative frequency of genes with CD sSNP and nsSNP was similar. The frequency of genes with SNPs in untranslated regions (UTRs) was 2-fold greater than in CDs, in agreement with the lung MRS data8. nsSNPs causing premature stop codons were rare. CD SNPs were 7-fold more common than indels. The ratio of the number of reads with wild-type and variant allele nucleotides appeared able to infer homozygosity and heterozygosity, as previously validated. In the pedigree, inheritance patterns of alleles inferred from read-ratios agreed well with identity by descent and inheritance rules.

TABLE 7
Variants identified by GMAP alignment of SID1437 cDNA 454 reads
to the RefSeq transcript dB without and with bioinformatics filters

| Genes with aligned reads | Unfiltered | Filtered |
|---|---|---|
| With ≧1 SNP | 11,459 (40%) | 932 (3%) |
| With ≧1 coding domain SNP | 7595 (26%) | 356 (1%) |
| With ≧1 coding domain, synonymous SNP | 4933 (17%) | 238 |
| With ≧1 non-synonymous SNP (nsSNP) | 6891 (24%) | 199 |
| With a SNP causing a premature stop codon | 1660 (6%) | 4 |
| With ≧1 indel | 11,313 (39%) | 313 (1%) |
| With ≧1 coding domain indel | 8,372 (29%) | 54 |

Further, distributed characterization of nsV (nsSNPs and CD indels) was undertaken with the disclosed methods, in order to identify a subset of candidate genes likely to be associated with medically relevant functional changes in schizophrenia. A second rule set was developed to identify high-likelihood, medically relevant nsV (Table 8). These rules represent a second set of threshold values for these elements. Particularly important at this stage were inspection of the quality of read alignment and BLAST comparison of the read to a second database. ˜10% of nsSNPs were RefSeq transcript database errors and the reads matched perfectly to the NCBI human genome sequence or, upon translation, to protein sequence databases. BLOSUM scores were calculated, but were not used to triage candidate genes, since nsSNPs in complex disorders nsSNPs are strongly biased toward less deleterious substitutions. Congruence with altered gene or protein expression in brains of patients with schizophrenia was ascertained by link-out to the Stanley Medical Research Institute database. Congruence with altered gene expression is important in view of recent studies showing that SNPs are responsible for >84% of genetic variation in gene expression. Functional plausibility of the candidate gene was ascertained by link-outs to OMIM, ENTREZ gene and PubMed. Confluence of candidate genes into networks or pathways was considered highly significant, given the likelihood of pronounced genetic heterogeneity. Pathway analysis was performed both by evaluation of standard pathway databases, such as KEGG, and also by custom database creation and visualization of interactions among these genes using Ariadne Pathways software (Ariadne Genomics, Rockville, Md.).

TABLE 8
Rules for identification of high-likelihood, medically relevant nsV in
transcriptome MRS studies

>90% read alignment to reference sequence
Exclude reference sequence error by alignment to 2^{nd} reference dB (e.g. if
initial alignment to RefSeq transcript, confirm by alignment to NCBI
human genome)
BLOSUM62 score
nsV congruence in parent-child trio, ASP or pedigree
Confluence of nsV into network or pathway
Functional plausibility (ENTREZ, OMIM)
Chromosomal location with QTL
Congruence with gene or protein expression data (for example, Stanley
dB, and the like)

Of the 172 schizophrenia candidate genes (Table 5), 3 (HLA-B, HLA-DRB1 and KIF2) exhibited a nsSNP in the proband, and 2 (LTA, UHMK1) had a nsSNP in one of the other cases. KIF2 contained a novel nsSNP (a821 g) at all aligned reads in SID1437 and SID1439. No reads aligned at this location in SID1438. KIF2 is important in the transport of membranous organelles and protein complexes on microtubules and is involved in BDNF-mediated neurite extension. A prior study of transmission disequilibrium in a cohort of affected family samples identified a common two-SNP haplotype (rs2289883/rs464058, G/A) that showed a significant association with schizophrenia, as did a common four-SNP haplotype (P<0.008).

TABLE 9
nsV identified in three lymphoblastoid lines by GMAP alignment to
RefSeq transcript following application of bioinformatics filters

| | Genes with aligned reads and filtering | | | |
|---|---|---|---|---|
| | SID1437 | SID1438 | SID1439 | All |
| ≧1 nsSNP | 199 | 202 | 252 | 74 |
| SNP-induced premature stop | 4 | 4 | 6 | 0 |
| codon | | | | |
| ≧1 coding domain indel | 54 | 78 | 123 | 5 |

Seventy-nine genes had a nsV in all 3 individuals (Table 9). Of these, four were RefSeq transcript database errors. Ten were in highly polymorphic HLA genes, including two in schizophrenia candidate genes HLA-B and HLA-DRB 1. Thirty-one occurred in putative genes that have been identified informatically from the human genome sequence. nsV within such genes were found to be unreliable due to: i) uneven coverage (likely misannotation of splice variants), ii) an overabundance of putative SNPs, and/or iii) premature truncation of alignments. Of the remaining 36 genes, ADRBK1, GSTP1, MTDH, PARP1, PLCG2, PLEK, SLC25A6, SLC38A1 and SYNCRIP were particularly interesting since they were related to schizophrenia candidate genes (Table 10).

TABLE 10
Genes related to candidates with nsV in SID1437

| | | Related Gene With nsV in |
|---|---|---|
| Function | Candidate Gene | SID1437 |
| Glutamate receptor | NAALAD2 | DPP7 |
| agonist availability | SLC15A1 | SKC25A6 |
| | PRODH | P4HA1 |
| | SLC1A2 | SLC38A1 |
| | DTNBP1 | VAPA |
| | ENTH | FLNA |
| Synaptic vesicle | SNAP29 | ACTN4 |
| exocytosis | SYN2 | ANXA11, ANXA2 |
| | SYN3 | MTDH |
| | STX1A | SYNCRIP |
| | SYNGR1 | SNX3 |
| Plasticity | PLXNA2 | PLEK |
| Cytokine-related | PIP5K2A | PLCG2 |
| Glutathione | GSTM1, GCLM | GPX1, GSTP1 |
| Postsynaptic density | ADRA1A | ADRBK1 |
| | MED12 | PAPOLA, PAP1, PCB1 |
| | MAP6 | MARK3 |

Of 244 genes with an nsV in the proband (Table 9), seven were RefSeq transcript database errors, 71 were in putative genes and twelve were in HLA genes. Twenty-one genes had a nsV in the proband that were either close relatives of schizophrenia candidate genes or in the same pathway (Table 10). Notable were GPX1 and GSTP1, both of which contained known nsSNPs (rs1050450 and rs1695 and rs179981, respectively). GPX1 and GSTP1 are important in glutathione metabolism. Glutathione is the main non-protein antioxidant and plays a critical role in protecting neurons from damage by reactive oxygen species generated by dopamine metabolism. A large literature exists regarding glutathione deficiency in prefrontal cortex in schizophrenia and several groups have sought associations between glutathione metabolism genes or polymorphisms with schizophrenia and tardive dyskinesia. Mendelian deficiency in glutathione metabolism genes results in mental deficiency and psychosis. An interesting follow-up study comprises determining the association between the endophenotype of prefrontal glutathione level (measured by NMR spectroscopy) and GPX1 and GSTP1 genotypes.

Also notable were numerous genes involved in synaptic vesicle exocytosis (ACTN4, ANXA11, ANXA2, MTDH, SYNCRIP, SNX3).

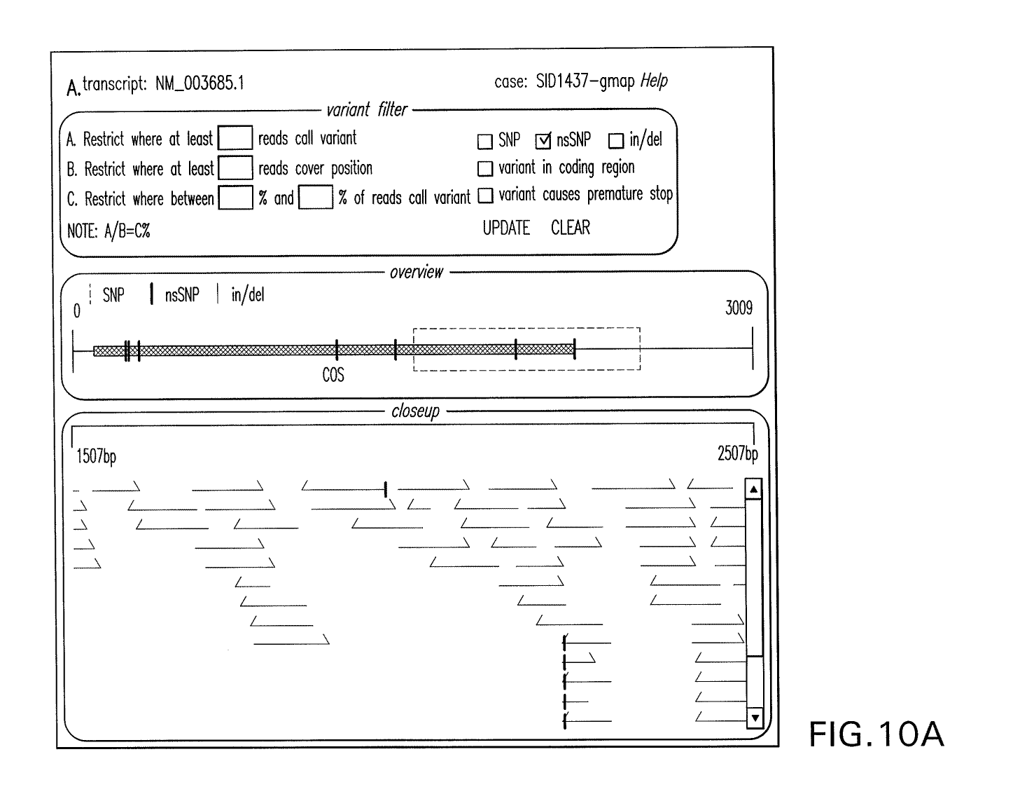

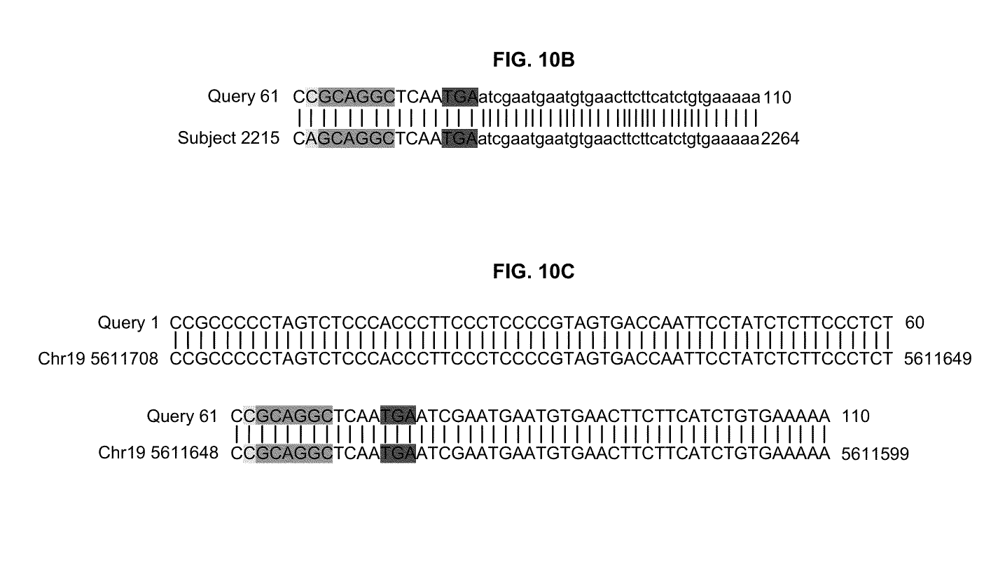

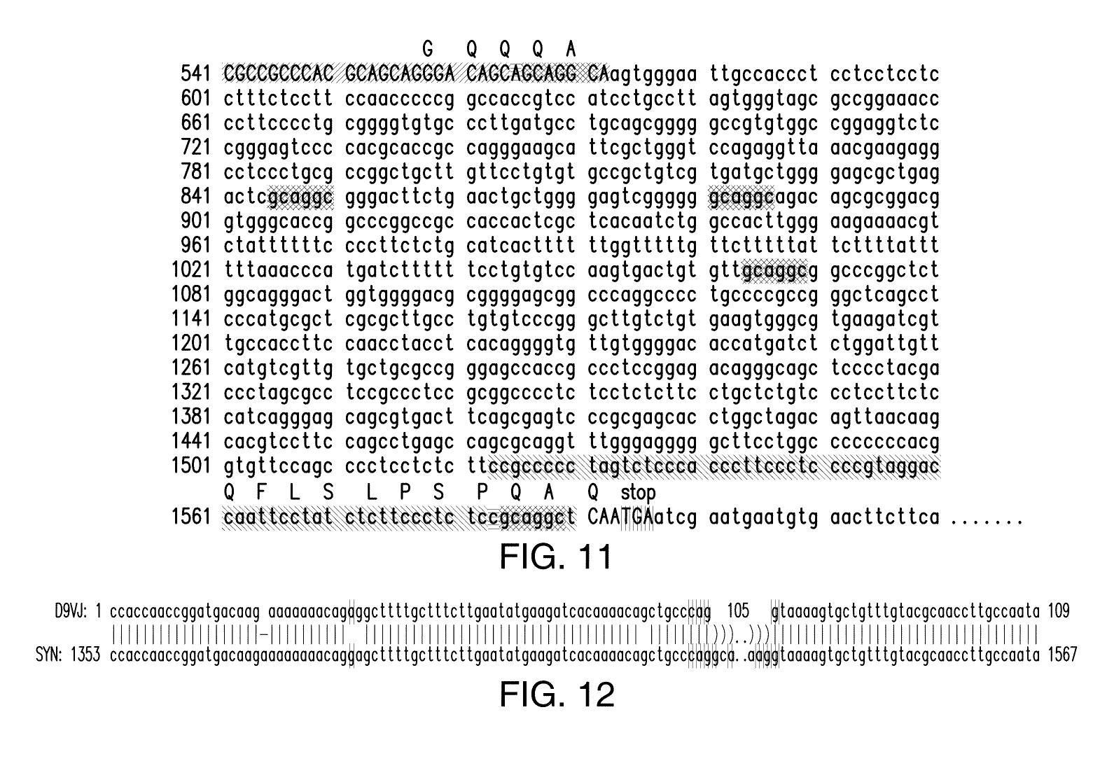

Interestingly, two nsV identified by GMAP were associated with novel splice isoforms (KHSRP, FIG. 10 and FIG. 11, and SYNCRIP, FIG. 12). In the case of KHSRP, the nsSNP was an artifact of GMAP-based alignment extension through a hexanucleotide hairpin that was present at the 3′ terminus of both exon 19 and intron 19. A novel KHSRP splice isoform was identified that retains intron 19 sequences. The novel SYNCRIP splice isoform omits an exon present in the established transcript.

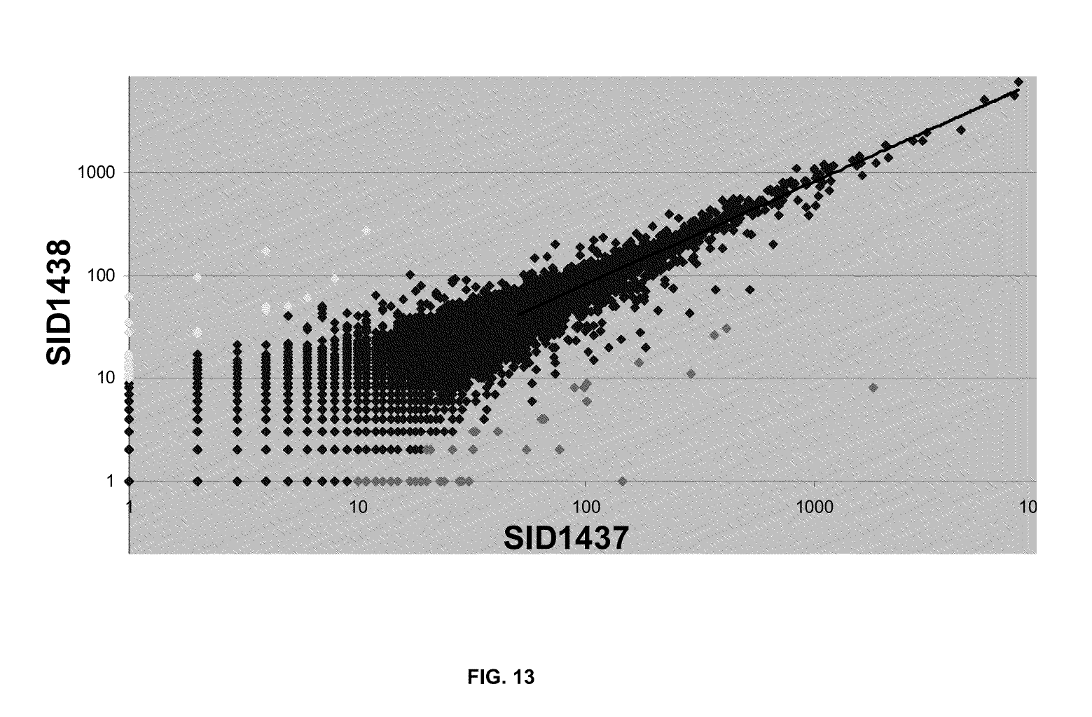

Since next generation sequencing technologies generate clonal sequences from individual mRNA molecules, enumeration of aligned reads permits estimation of the copy number of transcripts, splice variants and alleles. As noted above, the aligned read counts for individual transcripts in a sample showed little run-to-run variation (FIG. 9). Read count was affected by the length of the transcript, the fidelity of alignment, and the repetitiveness of transcript sub-sequences. In particular, some transcripts with repetitive sequences within the 3′ UTR exhibited significant local increases in read counts at those regions, as has been described for pyknons and short tandem repeats. Thus, comparisons of read count-based abundance of different transcripts within a sample were not always accurate. However, comparisons of abundance of a transcript between samples that were based upon read counts were accurate, as previously validated. Pairwise comparisons of the copy numbers of individual transcripts in lymphoblast cell lines from related individuals showed significant correlation (FIG. 13, r²>0.93) and allowed identification of transcripts exhibiting large differences in read count between individuals.

FIG. 10A-C and FIG. 11 illustrate an example of a novel splice isoform identified with GMAP by an apparent SNP at the penultimate base of an alignment. FIG. 10A illustrates GMAP based alignment of SID1437 reads to nucleotides 1507-2507 of KHSRP transcript NM_{—}003685.1, showing a nsSNP in five of twelve reads (red line, a2216c, inducing a Q to C non-conservative substitution, BLOSUM score −1). FIG. 10B illustrates the FASTA-format of the GMAP alignment of one of the five cDNA reads containing a nsSNP (D93AXQMO1ARQC5) to KHSRP transcript NM_{—}003685.1. Note that only the 3′ 50 nt of the read aligned to this transcript. The nsSNP is indicated in yellow, the stop codon in red, and a stable hexanucleotide hairpin in green. Score=Obits (50), Identities=50/50 (98%), Strand=+/+. FIG. 10C illustrates alignment of the entire read D93AXQMO1ARQC5 to KHSRP intron 19 and exon 20. Chr19 nucleotides refer to contig ref|NW_{—}927173.1|HsCraAADB02_{—}624. The nucleotide that corresponded to a nsSNP when aligned to NM_{—}003685.1 shows identity when aligned against Chr19 (yellow). The stop codon is indicated in red, a stable hexanucleotide hairpin in green and exon 20 in grey. Score=204 bits (110), Expect=2e-50, Identities=100%, Gaps=0%, Strand=+/−.

FIG. 11 illustrates the genomic sequence of KHSRP exon 19 (purple), exon 20 (grey) and the 3′ end of intron 19 (blue) which is present in 5 cDNA reads (including D93AXQMO1ARQC5). Apparent nsSNP when aligned to NM_{—}003685.1 shows identity when aligned against Chr19 (indicated in yellow). The stop codon is indicated in red and a stable hexanucleotide hairpin in green. Interestingly, the hairpin sequence flanks the splice donor site of exon 19 and splice acceptor site of intron 19, indicating a possible mechanism whereby KHSRP can be alternatively spliced to retain intron 19 sequences.

FIG. 12 illustrates a GMAP alignment of read D9VJ59F02JQMRR (nt 1-109, top) from SID 1438, to SYNCRIP (NM_{—}006372.3, bottom) showing a nsSNP at nt 30 (yellow, a1384 g) and a novel splice isoform that omits an 105-bp exon and maintains frame. Consensus splice donor and acceptor nucleotides are in red. Four reads demonstrated the nsSNP. Score=0 bits (119), Identities=109/119 (98%).

In summary, ˜150 MB of shotgun, clonal, cDNA MRS of lymphoblastoid lines from a pedigree with mental illness was performed, using approaches developed for a prior ˜2 GB MRS study in cancer. Automated data pipelining and distributed, facilitated analysis was accomplished using web-based cyberinfrastructure. A two-tiered analysis schema identified twenty-one schizophrenia candidate genes that showed reasonable accord with current understanding of the molecular pathogenesis of schizophrenia (Table 10).

### E. Carrier Testing

Preconception testing of motivated populations for recessive disease mutations, together with education and genetic counseling of carriers, can dramatically reduce their incidence within a generation. Tay-Sachs disease (TSD; Mendelian Inheritance in Man accession number (OMIM#) 272800), for example, is an autosomal recessive neurodegenerative disorder with onset of symptoms in infancy and death by two to five years of age. Formerly, the incidence of TSD was one per 3,600 Ashkenazi births in North America. After forty years of preconception screening in this population, however, the incidence of TSD has been reduced by more than 90%. While TSD remains untreatable, therapies are available for many severe recessive diseases of childhood. Thus, in addition to disease prevention, preconception testing enables early treatment of high risk pregnancies and affected neonates, which can profoundly diminish disease severity.

Over the past twenty five years, 1,123 genes that cause Mendelian recessive diseases have been identified. To date, however, preconception carrier testing has been recommended in the US only for five of these (fragile X syndrome [OMIM#300624] in selected individuals, cystic fibrosis [CF, OMIM#219700] in Caucasians and TSD, Canavan disease [OMIM#271900] and familial dysautonomia [OMIM#223900] in individuals of Ashkenazi descent). Thus, while individual Mendelian diseases are uncommon in general populations, collectively they continue to account for ˜20% of infant mortality and ˜10% of pediatric hospitalizations. A framework for development of criteria for comprehensive preconception screening can be inferred from an American College of Medical Genetics report on expansion of newborn screening for inherited diseases. Criteria included test accuracy, cost of testing, disease severity, highly penetrant recessive inheritance and whether an intervention is available for those identified as carriers. Hitherto, the criterion precluding extension of preconception screening to most severe recessive mutations or general populations has been cost (defined in that report as an overall analytical cost requirement of >$1 per test per condition).

Target capture and next generation sequencing have shown efficacy for resequencing human genomes and exomes, providing an alternative potential paradigm for comprehensive carrier testing. An average 30-fold depth of coverage can be sufficient for single nucleotide polymorphism (SNP) and nucleotide insertion or deletion (indel) detection in genome research. The validation of these methods for clinical utility can be different. Data demonstrating the sensitivity and specificity of genotyping of disease mutations (DM), particularly polynucleotide indels, gross insertions and deletions, copy number variations (CNVs) and complex rearrangements, is limited. High analytic validity, concordance in many settings, high-throughput and cost-effectiveness (including sample acquisition and preparation) can be used for broader population-based carrier screening. Here, the development of a preconception carrier screen for 489 severe recessive childhood disease genes based on target enrichment and next generation sequencing that meets most of these criteria is reported Furthermore, the first assessment of carrier burden for severe recessive diseases of childhood is also reported.

### 1. Materials and Methods

i. Disease Choice

Criteria for disease inclusion for preconception screening were broadly based on those for expansion of newborn screening, but with omission of treatment criteria¹⁴. Thus, very broad coverage of severe childhood diseases and mutations was sought to maximize cost-benefit, potential reduction in disease incidence and adoption. A Perl parser identified severe childhood recessive disorders with known molecular basis in OMIM⁶. Database and literature searches and expert reviews were performed on resultant diseases. Six diseases with extreme locus heterogeneity were omitted (OMIM#209900, #209950, Fanconi anemia, #256000, #266510, #214100). Diseases were included if mutations caused severe illness in a proportion of affected children and despite variable inheritance, mitochondrial mutations or low incidence. Mental retardation genes were excluded. 489 recessive disease genes met these criteria (Table 11).

TABLE 11
X-Linked Recessive and Autosomal Recessive Disease Genes

| OMIM # | Name | Symbol | Type |
|---|---|---|---|
| 300069 | #300069 CARDIOMYOPATHY, DILATED, 3A; CMD3A | TAZ | cardiac |
| 302060 | #302060 BARTH SYNDROME; BTHS | TAZ | cardiac |
| 220400 | #220400 JERVELL AND LANGE-NIELSEN SYNDROME | KCNQ1 | cardiac |
| | 1; JLNS1 | | |
| 208000 | #208000 ARTERIAL CALCIFICATION, GENERALIZED, | ENPP1 | cardiac |
| | OF INFANCY; GACI | | |
| 611705 | #611705 MYOPATHY, EARLY-ONSET, WITH FATAL | TTN | cardiac |
| | CARDIOMYOPATHY | | |
| 241550 | #241550 HYPOPLASTIC LEFT HEART SYNDROME | GJA1 | cardiac |
| 255960 | #255960 MYXOMA, INTRACARDIAC | PRKAR1A | cardiac |
| 225320 | #225320 EHLERS-DANLOS SYNDROME, AUTOSOMAL | COL1A2 | cutaneous |
| | RECESSIVE, CARDIAC VALVULAR FORM | | |
| 277580 | #277580 WAARDENBURG-SHAH SYNDROME | EDN3 | cutaneous |
| 277580 | #277580 WAARDENBURG-SHAH SYNDROME | EDNRB | cutaneous |
| 277580 | #277580 WAARDENBURG-SHAH SYNDROME | SOX10 | cutaneous |
| 600501 | #600501 ABCD SYNDROME | EDNRB | cutaneous |
| 263700 | #263700 PORPHYRIA, CONGENITAL | UROS | cutaneous |
| | ERYTHROPOIETIC | | |
| 278800 | #278800 DE SANCTIS-CACCHIONE SYNDROME | ERCC6 | cutaneous |
| 278800 | #278800 DE SANCTIS-CACCHIONE SYNDROME | XPA | cutaneous |
| 109400 | BASAL CELL NEVUS SYNDROME; BCNS | PTCH1 | cutaneous |
| 305100 | #305100 ECTODERMAL DYSPLASIA, HYPOHIDROTIC, | EDA | cutaneous |
| | X-LINKED; XHED | | |
| 309801 | MICROPHTHALMIA SYNDROMIC 7; MCOPS7 | HCCS | cutaneous |
| 245660 | #245660 LARYNGOONYCHOCUTANEOUS | LAMA3 | cutaneous |
| | SYNDROME; LOCS | | |
| 228600 | #228600 FIBROMATOSIS, JUVENILE HYALINE | ANTXR2 | cutaneous |
| 229200 | #229200 BRITTLE CORNEA SYNDROME; BCS | ZNF469 | cutaneous |
| 226600 | #226600 EPIDERMOLYSIS BULLOSA DYSTROPHICA, | COL7A1 | cutaneous |
| | AUTOSOMAL RECESSIVE; RDEB | | |
| 226650 | #226650 EPIDERMOLYSIS BULLOSA, JUNCTIONAL, | COL17A1 | cutaneous |
| | NON-HERLITZ TYPE | | |
| 226650 | #226650 EPIDERMOLYSIS BULLOSA, JUNCTIONAL, | ITGB4 | cutaneous |
| | NON-HERLITZ TYPE | | |
| 226650 | #226650 EPIDERMOLYSIS BULLOSA, JUNCTIONAL, | LAMA3 | cutaneous |
| | NON-HERLITZ TYPE | | |
| 226650 | #226650 EPIDERMOLYSIS BULLOSA, JUNCTIONAL, | LAMB3 | cutaneous |
| | NON-HERLITZ TYPE | | |
| 226650 | #226650 EPIDERMOLYSIS BULLOSA, JUNCTIONAL, | LAMC2 | cutaneous |
| | NON-HERLITZ TYPE | | |
| 226700 | #226700 EPIDERMOLYSIS BULLOSA, JUNCTIONAL, | LAMA3 | cutaneous |
| | HERLITZ TYPE | | |
| 226700 | #226700 EPIDERMOLYSIS BULLOSA, JUNCTIONAL, | LAMB3 | cutaneous |
| | HERLITZ TYPE | | |
| 226700 | #226700 EPIDERMOLYSIS BULLOSA, JUNCTIONAL, | LAMC2 | cutaneous |
| | HERLITZ TYPE | | |
| 242500 | #242500 ICHTHYOSIS CONGENITA, HARLEQUIN | ABCA12 | cutaneous |
| | FETUS TYPE | | |
| 278700 | #278700 XERODERMA PIGMENTOSUM, | XPA | cutaneous |
| | COMPLEMENTATION GROUP A; XPA | | |
| 278730 | #278730 XERODERMA PIGMENTOSUM, | ERCC2 | cutaneous |
| | COMPLEMENTATION GROUP D; XPD | | |
| 278740 | #278740 XERODERMA PIGMENTOSUM, | DDB2 | cutaneous |
| | COMPLEMENTATION GROUP E | | |
| 278760 | #278760 XERODERMA PIGMENTOSUM, | ERCC4 | cutaneous |
| | COMPLEMENTATION GROUP F; XPF | | |
| 278780 | #278780 XERODERMA PIGMENTOSUM, | ERCC5 | cutaneous |
| | COMPLEMENTATION GROUP G; XPG | | |
| 219100 | #219100 CUTIS LAXA, AUTOSOMAL RECESSIVE, | EFEMP2 | cutaneous |
| | TYPE I | | |
| 219100 | #219100 CUTIS LAXA, AUTOSOMAL RECESSIVE, | FBLN5 | cutaneous |
| | TYPE I | | |
| 601675 | #601675 TRICHOTHIODYSTROPHY, | ERCC2 | cutaneous |
| | PHOTOSENSITIVE; TTDP | | |
| 601675 | #601675 TRICHOTHIODYSTROPHY, | ERCC3 | cutaneous |
| | PHOTOSENSITIVE; TTDP | | |
| 601675 | #601675 TRICHOTHIODYSTROPHY, | GTF2H5 | cutaneous |
| | PHOTOSENSITIVE; TTDP | | |
| 219200 | #219200 CUTIS LAXA, AUTOSOMAL RECESSIVE, | ATP6V0A2 | cutaneous |
| | TYPE II | | |
| 226730 | #226730 EPIDERMOLYSIS BULLOSA JUNCTIONALIS | ITGA6 | cutaneous |
| | WITH PYLORIC ATRESIA | | |
| 226730 | #226730 EPIDERMOLYSIS BULLOSA JUNCTIONALIS | ITGB4 | cutaneous |
| | WITH PYLORIC ATRESIA | | |
| 609638 | #609638 EPIDERMOLYSIS BULLOSA, LETHAL | DSP | cutaneous |
| | ACANTHOLYTIC | | |
| 225410 | #225410 EHLERS-DANLOS SYNDROME, TYPE VII, | ADAMTS2 | cutaneous |
| | AUTOSOMAL RECESSIVE | | |
| 226670 | #226670 EPIDERMOLYSIS BULLOSA SIMPLEX WITH | PLEC1 | cutaneous |
| | MUSCULAR DYSTROPHY | | |
| 242300 | #242300 ICHTHYOSIS, LAMELLAR, 1; LI1 | TGM1 | cutaneous |
| 275210 | #275210 TIGHT SKIN CONTRACTURE SYNDROME, | LMNA | cutaneous |
| | LETHAL | | |
| 275210 | #275210 TIGHT SKIN CONTRACTURE SYNDROME, | ZMPSTE24 | cutaneous |
| | LETHAL | | |
| 601706 | #601706 YEMENITE DEAF-BLIND | SOX10 | cutaneous |
| | HYPOPIGMENTATION SYNDROME | | |
| 607626 | #607626 ICHTHYOSIS, LEUKOCYTE VACUOLES, | CLDN1 | cutaneous |
| | ALOPECIA, AND SCLEROSING CHOLANGITIS | | |
| 607655 | #607655 SKIN FRAGILITY-WOOLLY HAIR SYNDROME | DSP | cutaneous |
| 610651 | #610651 XERODERMA PIGMENTOSUM, | ERCC3 | cutaneous |
| | COMPLEMENTATION GROUP B; XPB | | |
| 257980 | #257980 ODONTOONYCHODERMAL DYSPLASIA; | WNT10A | cutaneous |
| | OODD | | |
| 300537 | HETEROTOPIA PERIVENTRICULAR EHLERS-DANLOS | FLNA | cutaneous |
| | VARIANT | | |
| 605462 | BASAL CELL CARCINOMA SUSCEPTIBILITY TO 1; | PTCH1 | cutaneous |
| | BCC1 | | |
| 208085 | #208085 ARTHROGRYPOSIS, RENAL DYSFUNCTION, | VPS33B | developmental |
| | AND CHOLESTASIS | | |
| 306955 | #306955 HETEROTAXY, VISCERAL, 1, X-LINKED; | ZIC3 | developmental |
| | HTX1 | | |
| 300215 | #300215 LISSENCEPHALY, X-LINKED, 2 LISX2 | ARX | developmental |
| 600118 | #600118 WARBURG MICRO SYNDROME; WARBM | RAB3GAP1 | developmental |
| 300209 | #300209 SIMPSON-GOLABI-BEHMEL SYNDROME, | OFD1 | developmental |
| | TYPE 2 | | |
| 601378 | #601378 CRISPONI SYNDROME | CRLF1 | developmental |
| 300166 | MICROPHTHALMIA SYNDROMIC 2; MCOPS2 | BCOR | developmental |
| 222448 | #222448 DONNAI-BARROW SYNDROME | LRP2 | developmental |
| 607598 | #607598 LETHAL CONGENITAL CONTRACTURE | ERBB3 | developmental |
| | SYNDROME 2 | | |
| 608612 | #608612 MANDIBULOACRAL DYSPLASIA WITH TYPE | ZMPSTE24 | developmental |
| | B LIPODYSTROPHY; MADB | | |
| 309500 | #309500 RENPENNING SYNDROME 1; RENS1 | PQBP1 | developmental |
| 211750 | #211750 C SYNDROME | CD96 | developmental |
| 605039 | #605039 C-LIKE SYNDROME | CD96 | developmental |
| 243800 | #243800 JOHANSON-BLIZZARD SYNDROME; JBS | UBR1 | developmental |
| 270400 | #270400 SMITH-LEMLI-OPITZ SYNDROME; SLOS | DHCR7 | developmental |
| 311300 | OTOPALATODIGITAL SYNDROME TYPE I; OPD1 | FLNA | developmental |
| 214150 | #214150 CEREBROOCULOFACIOSKELETAL | ERCC6 | developmental |
| | SYNDROME 1; COFS1 | | |
| 311200 | OROFACIODIGITAL SYNDROME I; OFD1 | OFD1 | developmental |
| 611561 | #611561 MECKEL SYNDROME, TYPE 5; MKS5 | RPGRIP1L | developmental |
| 219000 | #219000 FRASER SYNDROME | FRAS1 | developmental |
| 219000 | #219000 FRASER SYNDROME | FREM2 | developmental |
| 249000 | #249000 MECKEL SYNDROME, TYPE 1; MKS1 | MKS1 | developmental |
| 253310 | #253310 LETHAL CONGENITAL CONTRACTURE | GLE1 | developmental |
| | SYNDROME 1; LCCS1 | | |
| 236680 | #236680 HYDROLETHALUS SYNDROME 1 | HYLS1 | developmental |
| 200990 | #200990 ACROCALLOSAL SYNDROME; ACLS | GLI3 | developmental |
| 257320 | #257320 LISSENCEPHALY 2; LIS2 | RELN | developmental |
| 308300 | INCONTINENTIA PIGMENTI; IP | IKBKG | developmental |
| 305600 | FOCAL DERMAL HYPOPLASIA; FDH | PORCN | developmental |
| 300815 | CHROMOSOME Xq28 DUPLICATION SYNDROME | GDI1 | developmental |
| 300422 | FG SYNDROME 4; FGS4 | CASK | developmental |
| 300321 | FG SYNDROME 2; FGS2 | FLNA | developmental |
| 300472 | CORPUS CALLOSUM, AGENESIS OF, WITH MENTAL | IGBP1 | developmental |
| | RETARDATION, OCULAR COLOBOMA, | | |
| 309000 | #309000 LOWE OCULOCEREBRORENAL SYNDROME; | OCRL | developmental |
| | OCRL | | |
| 310600 | #310600 NORRIE DISEASE; ND | NDP | developmental |
| 311150 | #311150 OPTICOACOUSTIC NERVE ATROPHY WITH | TIMM8A | developmental |
| | DEMENTIA | | |
| 208150 | #208150 FETAL AKINESIA DEFORMATION | RAPSN | developmental |
| | SEQUENCE; FADS | | |
| 300590 | CORNELIA DE LANGE SYNDROME 2; CDLS2 | SMC1A | developmental |
| 302950 | #302950 CHONDRODYSPLASIA PUNCTATA 1, X- | ARSE | developmental |
| | LINKED RECESSIVE; CDPX1 | | |
| 215100 | #215100 RHIZOMELIC CHONDRODYSPLASIA | PEX7 | developmental |
| | PUNCTATA, TYPE 1; RCDP1 | | |
| 222600 | #222600 DIASTROPHIC DYSPLASIA | SLC26A2 | developmental |
| 256050 | #256050 ATELOSTEOGENESIS, TYPE II; AOII | SLC26A2 | developmental |
| 268300 | #268300 ROBERTS SYNDROME; RBS | ESCO2 | developmental |
| 273395 | #273395 TETRA-AMELIA, AUTOSOMAL RECESSIVE | WNT3 | developmental |
| 602398 | #602398 DESMOSTEROLOSIS | DHCR24 | developmental |
| 201000 | #201000 CARPENTER SYNDROME | RAB23 | developmental |
| 309350 | MELNICK-NEEDLES SYNDROME; MNS | FLNA | developmental |
| 601451 | #601451 NEVO SYNDROME | PLOD1 | developmental |
| 253290 | #253290 MULTIPLE PTERYGIUM SYNDROME, | CHRNA1 | developmental |
| | LETHAL TYPE | | |
| 253290 | #253290 MULTIPLE PTERYGIUM SYNDROME, | CHRND | developmental |
| | LETHAL TYPE | | |
| 253290 | #253290 MULTIPLE PTERYGIUM SYNDROME, | CHRNG | developmental |
| | LETHAL TYPE | | |
| 265000 | #265000 MULTIPLE PTERYGIUM SYNDROME, | CHRNG | developmental |
| | ESCOBAR VARIANT | | |
| 601186 | #601186 MICROPHTHALMIA, SYNDROMIC 9; MCOPS9 | STRA6 | developmental |
| 253250 | #253250 MULIBREY NANISM | TRIM37 | developmental |
| 240300 | #240300 AUTOIMMUNE POLYENDOCRINE | AIRE | endocrine |
| | SYNDROME, TYPE I; APS1 | | |
| 264700 | #264700 VITAMIN D-DEPENDENT RICKETS, TYPE I | CYP27B1 | endocrine |
| 308370 | #308370 INFERTILE MALE SYNDROME | AR | endocrine |
| 244460 | #244460 KENNY-CAFFEY SYNDROME, TYPE 1; KCS | TBCE | endocrine |
| 203800 | #203800 ALSTROM SYNDROME; ALMS | ALMS1 | endocrine |
| 201710 | #201710 LIPOID CONGENITAL ADRENAL | CYP11A1 | endocrine |
| | HYPERPLASIA | | |
| 201710 | #201710 LIPOID CONGENITAL ADRENAL | STAR | endocrine |
| | HYPERPLASIA | | |
| 246200 | #246200 DONOHUE SYNDROME | INSR | endocrine |
| 262600 | #262600 PITUITARY DWARFISM III | PROP1 | endocrine |
| 262600 | #262600 PITUITARY DWARFISM III | HESX1 | endocrine |
| 262600 | #262600 PITUITARY DWARFISM III | LHX3 | endocrine |
| 262600 | #262600 PITUITARY DWARFISM III | POU1F1 | endocrine |
| 270450 | #270450 INSULIN-LIKE GROWTH FACTOR I, | IGF1 | endocrine |
| | RESISTANCE TO | | |
| 275100 | #275100 HYPOTHYROIDISM, CONGENITAL, | TSHB | endocrine |
| | NONGOITROUS, 4; CHNG4 | | |
| 201910 | +201910 ADRENAL HYPERPLASIA, CONGENITAL, | CYP21A2 | endocrine |
| | DUE TO 21-HYDROXYLASE DEFICIENCY | | |
| 300048 | INTESTINAL PSEUDOOBSTRUCTION, NEURONAL, | FLNA | gastro- |
| | CHRONIC IDIOPATHIC, X-LINKED | | enterologic |
| 610370 | #610370 DIARRHEA 4, MALABSORPTIVE, | NEUROG3 | gastro- |
| | CONGENITAL | | enterologic |
| 301040 | α-THALASSEMIA/MENTAL RETARDATION | ATRX | hematologic |
| | SYNDROME, NONDELETION TYPE, X-LINKED ATRX | | |
| 260400 | #260400 SHWACHMAN-DIAMOND SYNDROME; SDS | SBDS | hematologic |
| 202400 | #202400 AFIBRINOGENEMIA, CONGENITAL | FGA | hematologic |
| 202400 | #202400 AFIBRINOGENEMIA, CONGENITAL | FGB | hematologic |
| 202400 | #202400 AFIBRINOGENEMIA, CONGENITAL | FGG | hematologic |
| 274150 | #274150 THROMBOTIC THROMBOCYTOPENIC | ADAMTS13 | hematologic |
| | PURPURA, CONGENITAL; TTP | | |
| 612304 | #612304 THROMBOPHILIA, HEREDITARY, DUE TO | PROC | hematologic |
| | PROTEIN C DEFICIENCY, AUTOSOMAL | | |
| 266200 | #266200 PYRUVATE KINASE DEFICIENCY OF RED | PKLR | hematologic |
| | CELLS | | |
| 217090 | #217090 PLASMINOGEN DEFICIENCY, TYPE I | PLG | hematologic |
| 266130 | #266130 GLUTATHIONE SYNTHETASE DEFICIENCY | GSS | hematologic |
| 604498 | #604498 AMEGAKARYOCYTIC | MPL | hematologic |
| | THROMBOCYTOPENIA, CONGENITAL; CAMT | | |
| 141800 | +141800 HEMOGLOBIN--α LOCUS 1; HBA1 | HBA1 | hematologic |
| 141900 | +141900 HEMOGLOBIN--BETA LOCUS; HBB | HBB | hematologic |
| 603903 | #603903 SICKLE CELL ANEMIA | HBB | hematologic |
| 602390 | #602390 HEMOCHROMATOSIS, JUVENILE; JH | HAMP | hematologic |
| 602390 | #602390 HEMOCHROMATOSIS, JUVENILE; JH | HFE2 | hematologic |
| 300448 | α-THALASSEMIA MYELODYSPLASIA SYNDROME; | ATRX | hematologic |
| | ATMDS | | |
| 215600 | #215600 CIRRHOSIS, FAMILIAL | KRT18 | hepatic |
| 215600 | #215600 CIRRHOSIS, FAMILIAL | KRT8 | hepatic |
| 107400 | +107400 PROTEASE INHIBITOR 1; PI | SERPINA1 | hepatic |
| 235550 | #235550 HEPATIC VENOOCCLUSIVE DISEASE WITH | SP110 | immuno- |
| | IMMUNODEFICIENCY; VODI | | deficiency |
| 300240 | #300240 HOYERAAL-HREIDARSSON SYNDROME; | DKC1 | immuno- |
| | HHS | | deficiency |
| 208900 | #208900 ATAXIA-TELANGIECTASIA; AT | ATM | immuno- |
| | | | deficiency |
| 301000 | #301000 WISKOTT-ALDRICH SYNDROME; WAS | WAS | immuno- |
| | | | deficiency |
| 304790 | #304790 IMMUNODYSREGULATION, | FOXP3 | immuno- |
| | POLYENDOCRINOPATHY, AND ENTEROPATHY, X- | | deficiency |
| | LINKED; | | |
| 308240 | #308240 LYMPHOPROLIFERATIVE SYNDROME, X- | SH2D1A | immuno- |
| | LINKED, 1; XLP1 | | deficiency |
| 312060 | #312060 PROPERDIN DEFICIENCY, X-LINKED | CFP | immuno- |
| | | | deficiency |
| 300755 | #300755 AGAMMAGLOBULINEMIA, X-LINKED XLA | BTK | immuno- |
| | | | deficiency |
| 300301 | ANHIDROTIC ECTODERMAL DYSPLASIA WITH | IKBKG | immuno- |
| | IMMUNODEFICIENCY, OSTEOPETROSIS AND | | deficiency |
| | LYMPHEDEMA OLEDAID | | |
| 300291 | #300291 ECTODERMAL DYSPLASIA, HYPOHIDROTIC, | IKBKG | immuno- |
| | WITH IMMUNE DEFICIENCY | | deficiency |
| 312863 | #312863 COMBINED IMMUNODEFICIENCY, X- | IL2RG | immuno- |
| | LINKED; CIDX | | deficiency |
| 300400 | #300400 SEVERE COMBINED IMMUNODEFICIENCY, | IL2RG | immuno- |
| | X-LINKED; SCIDX1 | | deficiency |
| 308230 | #308230 IMMUNODEFICIENCY WITH HYPER-IgM, | CD40LG | immuno- |
| | TYPE 1; HIGM1 | | deficiency |
| 102700 | #102700 SEVERE COMBINED IMMUNODEFICIENCY, | ADA | immuno- |
| | AUTOSOMAL RECESSIVE, T CELL-NEGATIVE, | | deficiency |
| 210900 | #210900 BLOOM SYNDROME; BLM | BLM | immuno- |
| | | | deficiency |
| 249100 | #249100 FAMILIAL MEDITERRANEAN FEVER; FMF | MEFV | immuno- |
| | | | deficiency |
| 251260 | #251260 NIJMEGEN BREAKAGE SYNDROME | NBN | immuno- |
| | | | deficiency |
| 603554 | #603554 OMENN SYNDROME | DCLRE1C | immuno- |
| | | | deficiency |
| 603554 | #603554 OMENN SYNDROME | RAG1 | immuno- |
| | | | deficiency |
| 603554 | #603554 OMENN SYNDROME | RAG2 | immuno- |
| | | | deficiency |
| 242860 | #242860 IMMUNODEFICIENCY-CENTROMERIC | DNMT3B | immuno- |
| | INSTABILITY-FACIAL ANOMALIES SYNDROME | | deficiency |
| 607624 | #607624 GRISCELLI SYNDROME, TYPE 2; GS2 | RAB27A | immuno- |
| | | | deficiency |
| 601457 | #601457 SEVERE COMBINED IMMUNODEFICIENCY, | RAG1 | immuno- |
| | AUTOSOMAL RECESSIVE, T CELL-NEGATIVE, | | deficiency |
| 601457 | #601457 SEVERE COMBINED IMMUNODEFICIENCY, | RAG2 | immuno- |
| | AUTOSOMAL RECESSIVE, T CELL-NEGATIVE, | | deficiency |
| 250250 | #250250 CARTILAGE-HAIR HYPOPLASIA; CHH | RMRP | Immuno- |
| | | | deficiency |
| 601705 | #601705 T-CELL IMMUNODEFICIENCY, CONGENITAL | FOXN1 | Immuno- |
| | ALOPECIA, AND NAIL DYSTROPHY | | deficiency |
| 214500 | CHEDIAK-HIGASHI SYNDROME; CHS | LYST | Immuno- |
| | | | deficiency |
| 600802 | SEVERE COMBINED IMMUNODEFICIENCY, AR, T | JAK3 | Immuno- |
| | CELL-NEGATIVE, B CELL-POSITIVE, NK CELL | | deficiency |
| | NEGATIVE | | |
| 261740 | #261740 GLYCOGEN STORAGE DISEASE OF HEART, | PRKAG2 | Metabolic |
| | LETHAL CONGENITAL | | |
| 232400 | #232400 GLYCOGEN STORAGE DISEASE III | AGL | Metabolic |
| 214950 | #214950 BILE ACID SYNTHESIS DEFECT, | AMACR | metabolic |
| | CONGENITAL, 4 | | |
| 609060 | #609060 COMBINED OXIDATIVE PHOSPHORYLATION | GFM1 | metabolic |
| | DEFICIENCY 1; COXPD1 | | |
| 610498 | #610498 COMBINED OXIDATIVE PHOSPHORYLATION | MRPS16 | metabolic |
| | DEFICIENCY 2; COXPD2 | | |
| 611719 | #611719 COMBINED OXIDATIVE PHOSPHORYLATION | MRPS22 | metabolic |
| | DEFICIENCY 5; COXPD5 | | |
| 232200 | +232200 GLYCOGEN STORAGE DISEASE I | G6PC3 | metabolic |
| 232500 | #232500 GLYCOGEN STORAGE DISEASE IV | GBE1 | metabolic |
| 215700 | #215700 CITRULLINEMIA, CLASSIC | ASS1 | metabolic |
| 230900 | #230900 GAUCHER DISEASE, TYPE II | GBA | metabolic |
| 245200 | #245200 KRABBE DISEASE | GALC | metabolic |
| 248500 | #248500 MANNOSIDOSIS, α B, LYSOSOMAL | MAN2B1 | metabolic |
| 252500 | #252500 MUCOLIPIDOSIS II α/BETA | GNPTAB | metabolic |
| 252600 | #252600 MUCOLIPIDOSIS III α/BETA | GNPTAB | metabolic |
| 252650 | #252650 MUCOLIPIDOSIS IV | MCOLN1 | metabolic |
| 257200 | #257200 NIEMANN-PICK DISEASE, TYPE A | SMPD1 | metabolic |
| 257220 | #257220 NIEMANN-PICK DISEASE, TYPE C1; NPC1 | NPC1 | metabolic |
| 269920 | #269920 INFANTILE SIALIC ACID STORAGE | SLC17A5 | metabolic |
| | DISORDER | | |
| 604369 | #604369 SIALURIA, FINNISH TYPE | SLC17A5 | metabolic |
| 607625 | #607625 NIEMANN-PICK DISEASE, TYPE C2 | NPC2 | metabolic |
| 608013 | #608013 GAUCHER DISEASE, PERINATAL LETHAL | GBA | metabolic |
| 253200 | #253200 MUCOPOLYSACCHARIDOSIS TYPE VI | ARSB | metabolic |
| 253220 | #253220 MUCOPOLYSACCHARIDOSIS TYPE VII | GUSB | metabolic |
| 256550 | #256550 NEURAMINIDASE DEFICIENCY | NEU1 | metabolic |
| 230000 | #230000 FUCOSIDOSIS | FUCA1 | metabolic |
| 230600 | #230600 GM1-GANGLIOSIDOSIS, TYPE II | GLB1 | metabolic |
| 252930 | #252930 MUCOPOLYSACCHARIDOSIS TYPE IIIC | HGSNAT | metabolic |
| 611721 | #611721 COMBINED SAPOSIN DEFICIENCY | PSAP | metabolic |
| 230800 | #230800 GAUCHER DISEASE, TYPE I | GBA | metabolic |
| 607616 | #607616 NIEMANN-PICK DISEASE, TYPE B | SMPD1 | metabolic |
| 265800 | #265800 PYCNODYSOSTOSIS | CTSK | metabolic |
| 231000 | #231000 GAUCHER DISEASE, TYPE III | GBA | metabolic |
| 252900 | #252900 MUCOPOLYSACCHARIDOSIS TYPE IIIA | SGSH | metabolic |
| 208400 | +208400 ASPARTYLGLUCOSAMINURIA | AGA | metabolic |
| 607014 | #607014 HURLER SYNDROME | IDUA | metabolic |
| 608688 | #608688 AICAR TRANSFORMYLASE/IMP | ATIC | metabolic |
| | CYCLOHYDROLASE, DEFICIENCY OF | | |
| 604377 | #604377 CARDIOENCEPHALOMYOPATHY, FATAL | SCO2 | metabolic |
| | INFANTILE, DUE TO CYTOCHROME c OXIDASE | | |
| 600121 | #600121 RHIZOMELIC CHONDRODYSPLASIA | AGPS | metabolic |
| | PUNCTATA, TYPE 3; RCDP3 | | |
| 271900 | #271900 CANAVAN DISEASE | ASPA | metabolic |
| 300816 | COMBINED OXIDATIVE PHOSPHORYLATION | AIFM1 | metabolic |
| | DEFICIENCY 6 | | |
| 300100 | #300100 ADRENOLEUKODYSTROPHY; ALD | ABCD1 | metabolic |
| 213700 | #213700 CEREBROTENDINOUS XANTHOMATOSIS | CYP27A1 | metabolic |
| 250620 | #250620 BETA-HYDROXYISOBUTYRYL CoA | HIBCH | metabolic |
| | DEACYLASE, DEFICIENCY OF | | |
| 609241 | #609241 SCHINDLER DISEASE, TYPE I | NAGA | metabolic |
| 608782 | #608782 PYRUVATE DEHYDROGENASE | PDP1 | metabolic |
| | PHOSPHATASE DEFICIENCY | | |
| 605407 | #605407 SEGAWA SYNDROME, AUTOSOMAL | TH | metabolic |
| | RECESSIVE | | |
| 612736 | #612736 GUANIDINOACETATE | GAMT | metabolic |
| | METHYLTRANSFERASE DEFICIENCY | | |
| 300438 | 17-@BETA-HYDROXYSTEROID DEHYDROGENASE X | HSD17B10 | metabolic |
| | DEFICIENCY | | |
| 312170 | PYRUVATE DECARBOXYLASE DEFICIENCY | PDHA1 | metabolic |
| 301500 | #301500 FABRY DISEASE | GLA | metabolic |
| 311250 | #311250 ORNITHINE TRANSCARBAMYLASE | OTC | metabolic |
| | DEFICIENCY, HYPERAMMONEMIA DUE TO | | |
| 201450 | #201450 ACYL-CoA DEHYDROGENASE, MEDIUM- | ACADM | metabolic |
| | CHAIN, DEFICIENCY OF | | |
| 211600 | #211600 CHOLESTASIS, PROGRESSIVE FAMILIAL | ATP8B1 | metabolic |
| | INTRAHEPATIC 1; PFIC1 | | |
| 212065 | #212065 CONGENITAL DISORDER OF | PMM2 | metabolic |
| | GLYCOSYLATION, TYPE Ia; CDG1A | | |
| 219750 | #219750 CYSTINOSIS, ADULT NONNEPHROPATHIC | CTNS | metabolic |
| 219800 | #219800 CYSTINOSIS, NEPHROPATHIC; CTNS | CTNS | metabolic |
| 230400 | #230400 GALACTOSEMIA | GALT | metabolic |
| 231680 | #231680 MULTIPLE ACYL-CoA DEHYDROGENASE | ETFA | metabolic |
| | DEFICIENCY; MADD | | |
| 231680 | #231680 MULTIPLE ACYL-CoA DEHYDROGENASE | ETFB | metabolic |
| | DEFICIENCY; MADD | | |
| 231680 | #231680 MULTIPLE ACYL-CoA DEHYDROGENASE | ETFDH | metabolic |
| | DEFICIENCY; MADD | | |
| 232220 | #232220 GLYCOGEN STORAGE DISEASE Ib | SLC37A4 | metabolic |
| 232300 | #232300 GLYCOGEN STORAGE DISEASE II | GAA | metabolic |
| 243500 | #243500 ISOVALERIC ACIDEMIA; IVA | IVD | metabolic |
| 248600 | #248600 MAPLE SYRUP URINE DISEASE Type Ia | BCKDHA | metabolic |
| 251000 | #251000 METHYLMALONIC ACIDURIA DUE TO | MUT | metabolic |
| | METHYLMALONYL-CoA MUTASE DEFICIENCY | | |
| 253260 | #253260 BIOTINIDASE DEFICIENCY | BTD | metabolic |
| 255110 | #255110 CARNITINE PALMITOYLTRANSFERASE II | CPT2 | metabolic |
| | DEFICIENCY, LATE-ONSET | | |
| 255120 | #255120 CARNITINE PALMITOYLTRANSFERASE I | CPT1A | metabolic |
| | DEFICIENCY | | |
| 258501 | #258501 3-@METHYLGLUTACONIC ACIDURIA, TYPE | OPA3 | metabolic |
| | III | | |
| 259900 | #259900 HYPEROXALURIA, PRIMARY, TYPE I | AGXT | metabolic |
| 260000 | #260000 HYPEROXALURIA, PRIMARY, TYPE II | GRHPR | metabolic |
| 271980 | #271980 SUCCINIC SEMIALDEHYDE | ALDH5A1 | metabolic |
| | DEHYDROGENASE DEFICIENCY | | |
| 277900 | #277900 WILSON DISEASE | ATP7B | metabolic |
| 600649 | #600649 CARNITINE PALMITOYLTRANSFERASE II | CPT2 | metabolic |
| | DEFICIENCY, INFANTILE | | |
| 602579 | #602579 CONGENITAL DISORDER OF | MPI | metabolic |
| | GLYCOSYLATION, TYPE Ib; CDG1B | | |
| 605899 | #605899 GLYCINE ENCEPHALOPATHY; GCE | AMT | metabolic |
| 605899 | #605899 GLYCINE ENCEPHALOPATHY; GCE | GCSH | metabolic |
| 605899 | #605899 GLYCINE ENCEPHALOPATHY; GCE | GLDC | metabolic |
| 606812 | #606812 FUMARASE DEFICIENCY | FH | metabolic |
| 608836 | #608836 CARNITINE PALMITOYLTRANSFERASE II | CPT2 | metabolic |
| | DEFICIENCY, LETHAL NEONATAL | | |
| 610198 | #610198 3-@METHYLGLUTACONIC ACIDURIA, TYPE V | DNAJC19 | metabolic |
| 610377 | #610377 MEVALONIC ACIDURIA | MVK | metabolic |
| 250950 | #250950 3-@METHYLGLUTACONIC ACIDURIA, TYPE I | AUH | metabolic |
| 124000 | #124000 MITOCHONDRIAL COMPLEX III DEFICIENCY | BCS1L | metabolic |
| 124000 | #124000 MITOCHONDRIAL COMPLEX III DEFICIENCY | UQCRB | metabolic |
| 124000 | #124000 MITOCHONDRIAL COMPLEX III DEFICIENCY | UQCRQ | metabolic |
| 607091 | #607091 CONGENITAL DISORDER OF | B4GALT1 | metabolic |
| | GLYCOSYLATION, TYPE IId; CDG2D | | |
| 608643 | #608643 AROMATIC L-AMINO ACID | DDC | metabolic |
| | DECARBOXYLASE DEFICIENCY | | |
| 600721 | #600721 D-2-@HYDROXYGLUTARIC ACIDURIA | D2HGDH | metabolic |
| 210210 | #210210 3-@METHYLCROTONYL-CoA | MCCC2 | metabolic |
| | CARBOXYLASE 2 DEFICIENCY | | |
| 201475 | #201475 ACYL-CoA DEHYDROGENASE, VERY LONG- | ACADVL | metabolic |
| | CHAIN, DEFICIENCY OF | | |
| 609015 | #609015 TRIFUNCTIONAL PROTEIN DEFICIENCY | HADHA | metabolic |
| 609015 | #609015 TRIFUNCTIONAL PROTEIN DEFICIENCY | HADHB | metabolic |
| 610006 | #610006 2-@METHYLBUTYRYL-CoA | ACADSB | metabolic |
| | DEHYDROGENASE DEFICIENCY | | |
| 610992 | #610992 PHOSPHOSERINE AMINOTRANSFERASE | PSAT1 | metabolic |
| | DEFICIENCY | | |
| 277400 | #277400 METHYLMALONIC ACIDURIA AND | MMACHC | metabolic |
| | HOMOCYSTINURIA, cblC TYPE | | |
| 201460 | #201460 ACYL-CoA DEHYDROGENASE, LONG-CHAIN, | ACADL | metabolic |
| | DEFICIENCY OF | | |
| 220111 | #220111 LEIGH SYNDROME, FRENCH-CANADIAN | LRPPRC | metabolic |
| | TYPE; LSFC | | |
| 261515 | #261515 D-BIFUNCTIONAL PROTEIN DEFICIENCY | HSD17B4 | metabolic |
| 245349 | #245349 PYRUVATE DEHYDROGENASE E3-BINDING | PDHX | metabolic |
| | PROTEIN DEFICIENCY | | |
| 245400 | #245400 LACTIC ACIDOSIS, FATAL INFANTILE | SUCLG1 | metabolic |
| 231530 | #231530 3-@HYDROXYACYL-CoA DEHYDROGENASE | HADH | metabolic |
| | DEFICIENCY | | |
| 237300 | #237300 CARBAMOYL PHOSPHATE SYNTHETASE I | CPS1 | metabolic |
| | DEFICIENCY, HYPERAMMONEMIA DUE TO | | |
| 264470 | #264470 PEROXISOMAL ACYL-CoA OXIDASE | ACOX1 | metabolic |
| | DEFICIENCY | | |
| 265120 | #265120 SURFACTANT METABOLISM DYSFUNCTION, | SFTPB | metabolic |
| | PULMONARY, 1; SMDP1 | | |
| 272300 | #272300 SULFOCYSTEINURIA | SUOX | metabolic |
| 602473 | #602473 ENCEPHALOPATHY, ETHYLMALONIC | ETHE1 | metabolic |
| 610090 | #610090 PYRIDOXAMINE 5-PRIME-PHOSPHATE | PNPO | metabolic |
| | OXIDASE DEFICIENCY | | |
| 601847 | #601847 CHOLESTASIS, PROGRESSIVE FAMILIAL | ABCB11 | metabolic |
| | INTRAHEPATIC 2; PFIC2 | | |
| 608799 | #608799 CONGENITAL DISORDER OF | DPM1 | metabolic |
| | GLYCOSYLATION, TYPE Ie; CDG1E | | |
| 610505 | #610505 COMBINED OXIDATIVE PHOSPHORYLATION | TSFM | metabolic |
| | DEFICIENCY 3; COXPD3 | | |
| 610768 | #610768 CONGENITAL DISORDER OF | DOLK | metabolic |
| | GLYCOSYLATION, TYPE Im; CDG1M | | |
| 611126 | #611126 ACYL-CoA DEHYDROGENASE FAMILY, | ACAD9 | metabolic |
| | MEMBER 9, DEFICIENCY OF | | |
| 212066 | #212066 CONGENITAL DISORDER OF | MGAT2 | metabolic |
| | GLYCOSYLATION, TYPE IIa; CDG2A | | |
| 266265 | #266265 CONGENITAL DISORDER OF | SLC35C1 | metabolic |
| | GLYCOSYLATION, TYPE IIc; CDG2C | | |
| 603147 | #603147 CONGENITAL DISORDER OF | ALG6 | metabolic |
| | GLYCOSYLATION, TYPE Ic; CDG1C | | |
| 603585 | #603585 CONGENITAL DISORDER OF | SLC35A1 | metabolic |
| | GLYCOSYLATION, TYPE IIf; CDG2F | | |
| 606056 | #606056 CONGENITAL DISORDER OF | MOGS | metabolic |
| | GLYCOSYLATION, TYPE IIb; CDG2B | | |
| 607330 | #607330 LATHOSTEROLOSIS | SC5DL | metabolic |
| 608540 | #608540 CONGENITAL DISORDER OF | ALG1 | metabolic |
| | GLYCOSYLATION, TYPE Ik; CDG1K | | |
| 236250 | #236250 HOMOCYSTINURIA DUE TO DEFICIENCY OF | MTHFR | metabolic |
| | N(5,10)-METHYLENETETRAHYDROFOLATE | | |
| 266150 | #266150 PYRUVATE CARBOXYLASE DEFICIENCY | PC | metabolic |
| 207900 | #207900 ARGININOSUCCINIC ACIDURIA | ASL | metabolic |
| 238970 | #238970 HYPERORNITHINEMIA-HYPERAMMONEMIA- | SLC25A15 | metabolic |
| | HOMOCITRULLINURIA SYNDROME | | |
| 253270 | #253270 HOLOCARBOXYLASE SYNTHETASE | HLCS | metabolic |
| | DEFICIENCY | | |
| 261600 | #261600 PHENYLKETONURIA; PKU | PAH | metabolic |
| 237310 | #237310 N-ACETYLGLUTAMATE SYNTHASE | NAGS | metabolic |
| | DEFICIENCY | | |
| 212140 | #212140 CARNITINE DEFICIENCY, SYSTEMIC | SLC22A5 | metabolic |
| | PRIMARY; CDSP | | |
| 251100 | #251100 METHYLMALONIC ACIDURIA, cblA TYPE | MMAA | metabolic |
| 203750 | #203750 α-METHYLACETOACETIC ACIDURIA | ACAT1 | metabolic |
| 219900 | #219900 CYSTINOSIS, LATE-ONSET JUVENILE OR | CTNS | metabolic |
| | ADOLESCENT NEPHROPATHIC TYPE | | |
| 230200 | #230200 GALACTOKINASE DEFICIENCY | GALK1 | metabolic |
| 251110 | #251110 METHYLMALONIC ACIDURIA, cblB TYPE | MMAB | metabolic |
| 608093 | #608093 CONGENITAL DISORDER OF | DPAGT1 | metabolic |
| | GLYCOSYLATION, TYPE Ij; CDG1J | | |
| 232240 | #232240 GLYCOGEN STORAGE DISEASE Ic | SLC37A4 | metabolic |
| 229600 | +229600 FRUCTOSE INTOLERANCE, HEREDITARY | ALDOB | metabolic |
| 231670 | #231670 GLUTARIC ACIDEMIA I | GCDH | metabolic |
| 236200 | +236200 HOMOCYSTINURIA | CBS | metabolic |
| 248600 | #248600 MAPLE SYRUP URINE DISEASE Type III | DLD | metabolic |
| 246450 | +246450 3-@HYDROXY-3-METHYLGLUTARYL-CoA | HMGCL | metabolic |
| | LYASE DEFICIENCY | | |
| 248600 | 248600 MAPLE SYRUP URINE DISEASE, CLASSIC, | BCKDHB | metabolic |
| | TYPE IB | | |
| 274270 | +274270 DIHYDROPYRIMIDINE DEHYDROGENASE; | DPYD | metabolic |
| | DPYD | | |
| 276700 | +276700 TYROSINEMIA, TYPE I | FAH | metabolic |
| 600890 | HYDROXYACYL-CoA DEHYDROGENASE/3- | HADHA | metabolic |
| | KETOACYL-CoA THIOLASE/ENOYL-CoA | | |
| | HYDRATASE, | | |
| 603358 | #603358 GRACILE SYNDROME | BCS1L | metabolic |
| 212138 | +212138 CARNITINE-ACYLCARNITINE | SLC25A20 | metabolic |
| | TRANSLOCASE DEFICIENCY | | |
| 300257 | DANON DISEASE | LAMP2 | metabolic |
| 309900 | MUCOPOLYSACCHARIDOSIS TYPE II | IDS | metabolic |
| 606612 | #606612 MUSCULAR DYSTROPHY, CONGENITAL, 1C; | FKRP | neurological |
| | MDC1C | | |
| 609528 | CEREBRAL DYSGENESIS, NEUROPATHY, | SNAP29 | neurological |
| | ICHTHYOSIS, AND PALMOPLANTAR KERATODERMA | | |
| 231550 | #231550 ACHALASIA-ADDISONIANISM-ALACRIMA | AAAS | neurological |
| | SYNDROME; AAA | | |
| 254780 | #254780 MYOCLONIC EPILEPSY OF LAFORA | EPM2A | neurological |
| 254780 | #254780 MYOCLONIC EPILEPSY OF LAFORA | NHLRC1 | neurological |
| 254800 | #254800 MYOCLONIC EPILEPSY OF UNVERRICHT | CSTB | neurological |
| | AND LUNDBORG | | |
| 300067 | #300067 LISSENCEPHALY, X-LINKED, 1; LISX1 | DCX | neurological |
| 300220 | #300220 MENTAL RETARDATION, X-LINKED, | HSD17B10 | neurological |
| | SYNDROMIC 10; MRXS10 | | |
| 300322 | #300322 LESCH-NYHAN SYNDROME; LNS | HPRT1 | neurological |
| 300352 | #300352 CREATINE DEFICIENCY SYNDROME, X- | SLC6A8 | neurological |
| | LINKED | | |
| 301835 | #301835 ARTS SYNDROME; ARTS | PRPS1 | neurological |
| 303350 | #303350 MASA SYNDROME | L1CAM | neurological |
| 304100 | #304100 CORPUS CALLOSUM, PARTIAL AGENESIS | L1CAM | neurological |
| | OF, X-LINKED | | |
| 307000 | #307000 HYDROCEPHALUS DUE TO CONGENITAL | L1CAM | neurological |
| | STENOSIS OF AQUEDUCT OF SYLVIUS; HSAS | | |
| 308350 | #308350 EPILEPTIC ENCEPHALOPATHY, EARLY | ARX | neurological |
| | INFANTILE, 1 | | |
| 309400 | #309400 MENKES DISEASE | ATP7A | neurological |
| 309520 | #309520 LUJAN-FRYNS SYNDROME | MED12 | neurological |
| 312080 | #312080 PELIZAEUS-MERZBACHER DISEASE; PMD | PLP1 | neurological |
| 312920 | #312920 SPASTIC PARAPLEGIA 2, X-LINKED; SPG2 | PLP1 | neurological |
| 105830 | #105830 ANGELMAN SYNDROME AS | MECP2 | neurological |
| 300243 | #300243 MENTAL RETARDATION, X-LINKED, | SLC9A6 | neurological |
| | SYNDROMIC, CHRISTIANSON | | |
| 300523 | #300523 ALLAN-HERNDON-DUDLEY SYNDROME | SLC16A2 | neurological |
| | AHDS | | |
| 206700 | #206700 ANIRIDIA, CEREBELLAR ATAXIA, AND | PAX6 | neurological |
| | MENTAL DEFICIENCY | | |
| 216550 | #216550 COHEN SYNDROME; COH1 | VPS13B | neurological |
| 225750 | #225750 AICARDI-GOUTIERES SYNDROME 1; AGS1 | TREX1 | neurological |
| 252150 | #252150 MOLYBDENUM COFACTOR DEFICIENCY | MOCS1 | neurological |
| 252150 | #252150 MOLYBDENUM COFACTOR DEFICIENCY | MOCS2 | neurological |
| 212720 | #212720 MARTSOLF SYNDROME | RAB3GAP2 | neurological |
| 241410 | #241410 HYPOPARATHYROIDISM-RETARDATION- | TBCE | neurological |
| | DYSMORPHISM SYNDROME; HRD | | |
| 253280 | #253280 MUSCLE-EYE-BRAIN DISEASE; MEB | FKRP | neurological |
| 253280 | #253280 MUSCLE-EYE-BRAIN DISEASE; MEB | POMGNT1 | neurological |
| 271930 | #271930 STRIATONIGRAL DEGENERATION, | NUP62 | neurological |
| | INFANTILE; SNDI | | |
| 312750 | RETT SYNDROME; RTT | MECP2 | neurological |
| NA | X-linked mental retardation | KIAA2022 | neurological |
| NA | X-linked mental retardation | NXF5 | neurological |
| NA | X-linked mental retardation | RPL10 | neurological |
| NA | X-linked mental retardation | ZCCHC12 | neurological |
| NA | X-linked mental retardation | ZMYM3 | neurological |
| NA | Autosomal mental retardation | ST3GAL3 | neurological |
| NA | Autosomal mental retardation | ZC3H14 | neurological |
| NA | Autosomal mental retardation | SRD5A3 | neurological |
| NA | Autosomal mental retardation | NSUN2 | neurological |
| NA | Autosomal mental retardation | ZNF526 | neurological |
| NA | Autosomal mental retardation | BOD1 | neurological |
| 309548 | MENTAL RETARDATION X-LINKED ASSOCIATED | AFF2 | neurological |
| | WITH FRAGILE SITE FRAXE | | |
| 309530 | MENTAL RETARDATION X-LINKED 1; MRX1 | IQSEC2 | neurological |
| 303600 | COFFIN-LOWRY SYNDROME; CLS | RPS6KA3 | neurological |
| 300803 | MENTAL RETARDATION X-LINKED ZNF711- | ZNF711 | neurological |
| | RELATED | | |
| 300802 | MENTAL RETARDATION X-LINKED SYP-RELATED | SYP | neurological |
| 300799 | MENTAL RETARDATION X-LINKED SYNDROMIC | ZDHHC9 | neurological |
| | ZDHHC9-RELATED | | |
| 300749 | MENTAL RETARDATION AND MICROCEPHALY | CASK | neurological |
| | WITH PONTINE AND CEREBELLAR HYPOPLASIA | | |
| 300716 | MENTAL RETARDATION X-LINKED 95; MRX95 | MAGT1 | neurological |
| 300706 | MENTAL RETARDATION X-LINKED SYNDROMIC | HUWE1 | neurological |
| | TURNER TYPE | | |
| 300639 | MENTAL RETARDATION X-LINKED WITH | CUL4B | neurological |
| | BRACHYDACTYLY AND MACROGLOSSIA | | |
| 300607 | HYPEREKPLEXIA AND EPILEPSY | ARHGEF9 | neurological |
| 300573 | MENTAL RETARDATION X-LINKED 92; MRX92 | ZNF674 | neurological |
| 300271 | MENTAL RETARDATION X-LINKED 72; MRX72 | RAB39B | neurological |
| 300189 | MENTAL RETARDATION X-LINKED 90; MRX90 | DLG3 | neurological |
| 300088 | EPILEPSY FEMALE-RESTRICTED WITH MENTAL | PCDH19 | neurological |
| | RETARDATION; EFMR | | |
| 300075 | MENTAL RETARDATION X-LINKED 19 INCLUDED; | RPS6KA3 | neurological |
| | MRX19 INCLUDED | | |
| 300034 | MENTAL RETARDATION X-LINKED 88; MRX88 | AGTR2 | neurological |
| 312180 | MENTAL RETARDATION X-LINKED SYNDROMIC | UBE2A | neurological |
| | UBE2A-RELATED | | |
| 314995 | MENTAL RETARDATION X-LINKED 89; MRX89 | ZNF41 | neurological |
| 613192 | MENTAL RETARDATION AUTOSOMAL RECESSIVE | TRAPPC9 | neurological |
| | 13; MRT13 | | |
| 611092 | MENTAL RETARDATION AUTOSOMAL RECESSIVE 6; | GRIK2 | neurological |
| | MRT6 | | |
| 611093 | MENTAL RETARDATION AUTOSOMAL RECESSIVE 7; | TUSC3 | neurological |
| | MRT7 | | |
| 268800 | #268800 SANDHOFF DISEASE | HEXB | neurological |
| 223900 | #223900 NEUROPATHY, HEREDITARY SENSORY AND | IKBKAP | neurological |
| | AUTONOMIC, TYPE III; HSAN3 | | |
| 133540 | #133540 COCKAYNE SYNDROME, TYPE B; CSB | ERCC6 | neurological |
| 204200 | #204200 CEROID LIPOFUSCINOSIS, NEURONAL, 3; | CLN3 | neurological |
| | CLN3 | | |
| 204500 | #204500 CEROID LIPOFUSCINOSIS, NEURONAL, 2; | TPP1 | neurological |
| | CLN2 | | |
| 216400 | #216400 COCKAYNE SYNDROME, TYPE A; CSA | ERCC8 | neurological |
| 248800 | #248800 MARINESCO-SJOGREN SYNDROME | SIL1 | neurological |
| 256730 | #256730 CEROID LIPOFUSCINOSIS, NEURONAL, 1; | PPT1 | neurological |
| | CLN1 | | |
| 256731 | #256731 CEROID LIPOFUSCINOSIS, NEURONAL, 5; | CLN5 | neurological |
| | CLN5 | | |
| 600143 | #600143 CEROID LIPOFUSCINOSIS, NEURONAL, 8; | CLN8 | neurological |
| | CLN8 | | |
| 601780 | #601780 CEROID LIPOFUSCINOSIS, NEURONAL, 6; | CLN6 | neurological |
| | CLN6 | | |
| 610003 | #610003 CEROID LIPOFUSCINOSIS, NEURONAL, 8, | CLN8 | neurological |
| | NORTHERN EPILEPSY VARIANT | | |
| 610127 | #610127 CEROID LIPOFUSCINOSIS, NEURONAL, 10; | CTSD | neurological |
| | CLN10 | | |
| 610951 | #610951 CEROID LIPOFUSCINOSIS, NEURONAL, 7; | MFSD8 | neurological |
| | CLN7 | | |
| 203700 | ALPERS DIFFUSE DEGENERATION OF CEREBRAL | POLG | neurological |
| | GRAY MATTER WITH HEPATIC CIRRHOSIS | | |
| 249900 | #249900 METACHROMATIC LEUKODYSTROPHY DUE | PSAP | neurological |
| | TO SAPOSIN B DEFICIENCY | | |
| 271245 | #271245 INFANTILE-ONSET SPINOCEREBELLAR | C10ORF2 | neurological |
| | ATAXIA; IOSCA | | |
| 608804 | #608804 LEUKODYSTROPHY, HYPOMYELINATING, 2 | GJC2 | neurological |
| 610532 | #610532 LEUKODYSTROPHY, HYPOMYELINATING, 5 | FAM126A | neurological |
| 234200 | #234200 NEURODEGENERATION WITH BRAIN IRON | PANK2 | neurological |
| | ACCUMULATION 1; NBIA1 | | |
| 277460 | #277460 VITAMIN E, FAMILIAL ISOLATED | TTPA | neurological |
| | DEFICIENCY OF; VED | | |
| 205100 | #205100 AMYOTROPHIC LATERAL SCLEROSIS 2, | ALS2 | neurological |
| | JUVENILE; ALS2 | | |
| 270550 | #270550 SPASTIC ATAXIA, CHARLEVOIX-SAGUENAY | SACS | neurological |
| | TYPE; SACS | | |
| 606353 | #606353 PRIMARY LATERAL SCLEROSIS, JUVENILE; | ALS2 | neurological |
| | PLSJ | | |
| 611067 | #611067 SPINAL MUSCULAR ATROPHY, DISTAL, | PLEKHG5 | neurological |
| | AUTOSOMAL RECESSIVE, 4; DSMA4 | | |
| 270200 | #270200 SJOGREN-LARSSON SYNDROME; SLS | ALDH3A2 | neurological |
| 300623 | FRAGILE X TREMOR/ATAXIA SYNDROME; FXTAS | FMR1 | neurological |
| 609560 | #609560 MITOCHONDRIAL DNA DEPLETION | TK2 | neurological |
| | SYNDROME, MYOPATHIC FORM | | |
| 301830 | #301830 SPINAL MUSCULAR ATROPHY, X-LINKED 2; | UBA1 | neurological |
| | SMAX2 | | |
| 218000 | #218000 AGENESIS OF THE CORPUS CALLOSUM | SLC12A6 | neurological |
| | WITH PERIPHERAL NEUROPATHY; ACCPN | | |
| 253300 | #253300 SPINAL MUSCULAR ATROPHY, TYPE I; SMA1 | SMN1 | neurological |
| 256030 | #256030 NEMALINE MYOPATHY 2; NEM2 | NEB | neurological |
| 602771 | #602771 RIGID SPINE MUSCULAR DYSTROPHY 1; | SEPN1 | neurological |
| | RSMD1 | | |
| 605355 | #605355 NEMALINE MYOPATHY 5; NEM5 | TNNT1 | neurological |
| 604320 | #604320 SPINAL MUSCULAR ATROPHY, DISTAL, | IGHMBP2 | neurological |
| | AUTOSOMAL RECESSIVE, 1; DSMA1 | | |
| 253550 | #253550 SPINAL MUSCULAR ATROPHY, TYPE II; | SMN1 | neurological |
| | SMA2 | | |
| 607855 | #607855 MUSCULAR DYSTROPHY, CONGENITAL | LAMA2 | neurological |
| | MEROSIN-DEFICIENT, 1A; MDC1A | | |
| 608840 | #608840 MUSCULAR DYSTROPHY, CONGENITAL, | LARGE | neurological |
| | TYPE 1D | | |
| 253400 | #253400 SPINAL MUSCULAR ATROPHY, TYPE III; | SMN1 | neurological |
| | SMA3 | | |
| 236670 | #236670 WALKER-WARBURG SYNDROME; WWS | POMT1 | neurological |
| 236670 | #236670 WALKER-WARBURG SYNDROME; WWS | POMT2 | neurological |
| 300489 | SPINAL MUSCULAR ATROPHY DISTAL X-LINKED 3; | ATP7A | neurological |
| | SMAX3 | | |
| 310200 | #310200 MUSCULAR DYSTROPHY, DUCHENNE TYPE; | DMD | neurological |
| | DMD | | |
| 253800 | #253800 FUKUYAMA CONGENITAL MUSCULAR | FKTN | neurological |
| | DYSTROPHY; FCMD | | |
| 310400 | #310400 MYOTUBULAR MYOPATHY 1; MTM1 | MTM1 | neurological |
| 145900 | #145900 HYPERTROPHIC NEUROPATHY OF | EGR2 | neurological |
| | DEJERINE-SOTTAS. CMT3, CMT4F | | |
| 145900 | #145900 HYPERTROPHIC NEUROPATHY OF | MPZ | neurological |
| | DEJERINE-SOTTAS. CMT3, CMT4F | | |
| 145900 | #145900 HYPERTROPHIC NEUROPATHY OF | PMP22 | neurological |
| | DEJERINE-SOTTAS. CMT3, CMT4F | | |
| 145900 | #145900 HYPERTROPHIC NEUROPATHY OF | PRX | neurological |
| | DEJERINE-SOTTAS. CMT3, CMT4F | | |
| 300004 | #300004 CORPUS CALLOSUM, AGENESIS OF, WITH | ARX | neurological |
| | ABNORMAL GENITALIA | | |
| 300673 | #300673 ENCEPHALOPATHY, NEONATAL SEVERE, | MECP2 | neurological |
| | DUE TO MECP2 MUTATIONS | | |
| 308930 | #308930 LEIGH SYNDROME, X-LINKED | PDHA1 | neurological |
| 208920 | #208920 ATAXIA, EARLY-ONSET, WITH | APTX | neurological |
| | OCULOMOTOR APRAXIA AND HYPOALBUMINEMIA; | | |
| 250100 | #250100 METACHROMATIC LEUKODYSTROPHY | ARSA | neurological |
| 256600 | #256600 NEUROAXONAL DYSTROPHY, INFANTILE; | PLA2G6 | neurological |
| | INAD1 | | |
| 272800 | #272800 TAY-SACHS DISEASE; TSD | HEXA | neurological |
| 604004 | #604004 MEGALENCEPHALIC | MLC1 | neurological |
| | LEUKOENCEPHALOPATHY WITH SUBCORTICAL | | |
| | CYSTS; MLC | | |
| 605253 | NEUROPATHY, CONGENITAL HYPOMYELINATING- | EGR2 | neurological |
| | CHARCOT-MARIE-TOOTH DISEASE, TYPE 4E | | |
| 605253 | NEUROPATHY, CONGENITAL HYPOMYELINATING- | MPZ | neurological |
| | CHARCOT-MARIE-TOOTH DISEASE, TYPE 4E | | |
| 607426 | #607426 COENZYME Q10 DEFICIENCY | APTX | neurological |
| 607426 | #607426 COENZYME Q10 DEFICIENCY | CABC1 | neurological |
| 607426 | #607426 COENZYME Q10 DEFICIENCY | COQ2 | neurological |
| 607426 | #607426 COENZYME Q10 DEFICIENCY | PDSS1 | neurological |
| 607426 | #607426 COENZYME Q10 DEFICIENCY | PDSS2 | neurological |
| 608629 | #608629 JOUBERT SYNDROME 3; JBTS3 | AHI1 | neurological |
| 609311 | #609311 CHARCOT-MARIE-TOOTH DISEASE, TYPE 4H; | FGD4 | neurological |
| | CMT4H | | |
| 609583 | #609583 JOUBERT SYNDROME 4; JBTS4 | NPHP1 | neurological |
| 610188 | #610188 JOUBERT SYNDROME 5; JBTS5 | CEP290 | neurological |
| 610688 | #610688 JOUBERT SYNDROME 6; JBTS6 | TMEM67 | neurological |
| 611722 | #611722 KRABBE DISEASE, ATYPICAL, DUE TO | PSAP | neurological |
| | SAPOSIN A DEFICIENCY | | |
| 251880 | #251880 MITOCHONDRIAL DNA DEPLETION | C10ORF2 | neurological |
| | SYNDROME, HEPATOCEREBRAL FORM | | |
| 251880 | #251880 MITOCHONDRIAL DNA DEPLETION | DGUOK | neurological |
| | SYNDROME, HEPATOCEREBRAL FORM | | |
| 251880 | #251880 MITOCHONDRIAL DNA DEPLETION | MPV17 | neurological |
| | SYNDROME, HEPATOCEREBRAL FORM | | |
| 256810 | #256810 NAVAJO NEUROHEPATOPATHY; NN | MPV17 | neurological |
| 214450 | #214450 GRISCELLI SYNDROME, TYPE 1; GS1 | MYO5A | neurological |
| 256710 | #256710 ELEJALDE DISEASE | MYO5A | neurological |
| 230500 | #230500 GM1-GANGLIOSIDOSIS, TYPE I | GLB1 | neurological |
| 256800 | #256800 INSENSITIVITY TO PAIN, CONGENITAL, | NTRK1 | neurological |
| | WITH ANHIDROSIS; CIPA | | |
| 609056 | #609056 AMISH INFANTILE EPILEPSY SYNDROME | ST3GAL5 | neurological |
| 609304 | #609304 EPILEPTIC ENCEPHALOPATHY, EARLY | SLC25A22 | neurological |
| | INFANTILE, 3 | | |
| 224050 | CEREBELLAR HYPOPLASIA AND MENTAL | VLDLR | neurological |
| | RETARDATION WITH OR WITHOUT QUADRUPEDAL | | |
| 225753 | #225753 PONTOCEREBELLAR HYPOPLASIA TYPE 4; | TSEN54 | neurological |
| | PCH4 | | |
| 277470 | #277470 PONTOCEREBELLAR HYPOPLASIA TYPE 2A; | TSEN54 | neurological |
| | PCH2A | | |
| 606369 | #606369 EPILEPTIC ENCEPHALOPATHY, LENNOX- | MAPK10 | neurological |
| | GASTAUT TYPE | | |
| 611726 | #611726 EPILEPSY, PROGRESSIVE MYOCLONIC 3; | KCTD7 | neurological |
| | EPM3 | | |
| 612164 | #612164 EPILEPTIC ENCEPHALOPATHY, EARLY | STXBP1 | neurological |
| | INFANTILE, 4 | | |
| 300804 | JOUBERT SYNDROME 10; JBTS10 | OFD1 | neurological |
| 300049 | HETEROTOPIA PERIVENTRICULAR X-LINKED | FLNA | neurological |
| | DOMINANT | | |
| 610828 | HOLOPROSENCEPHALY 7; HPE7 | PTCH1 | neurological |
| 217400 | #217400 CORNEAL DYSTROPHY AND PERCEPTIVE | SLC4A11 | ocular |
| | DEAFNESS | | |
| 276900 | #276900 USHER SYNDROME, TYPE I | MYO7A | ocular |
| 276901 | #276901 USHER SYNDROME, TYPE IIA; USH2A | USH2A | ocular |
| 276904 | #276904 USHER SYNDROME, TYPE IC; USH1C | USH1C | ocular |
| 601067 | #601067 USHER SYNDROME, TYPE ID; USH1D | CDH23 | ocular |
| 605472 | #605472 USHER SYNDROME, TYPE IIC; USH2C | GPR98 | ocular |
| 606943 | #606943 USHER SYNDROME, TYPE IG; USH1G | USH1G | ocular |
| 300216 | COATS DISEASE | NDP | ocular |
| 203780 | #203780 ALPORT SYNDROME, AUTOSOMAL | COL4A3 | renal |
| | RECESSIVE | | |
| 203780 | #203780 ALPORT SYNDROME, AUTOSOMAL | COL4A4 | renal |
| | RECESSIVE | | |
| 263200 | #263200 POLYCYSTIC KIDNEY DISEASE, | PKHD1 | renal |
| | AUTOSOMAL RECESSIVE; ARPKD | | |
| 606407 | #606407 HYPOTONIA-CYSTINURIA SYNDROME | PREPL | renal |
| 606407 | #606407 HYPOTONIA-CYSTINURIA SYNDROME | SLC3A1 | renal |
| 609049 | #609049 PIERSON SYNDROME | LAMB2 | renal |
| 241200 | #241200 BARTTER SYNDROME, ANTENATAL, TYPE 2 | KCNJ1 | renal |
| 256100 | #256100 NEPHRONOPHTHISIS 1; NPHP1 | NPHP1 | renal |
| 256370 | #256370 NEPHROTIC SYNDROME, EARLY-ONSET, | WT1 | renal |
| | WITH DIFFUSE MESANGIAL SCLEROSIS | | |
| 267430 | #267430 RENAL TUBULAR DYSGENESIS; RTD | ACE | renal |
| 267430 | #267430 RENAL TUBULAR DYSGENESIS; RTD | AGT | renal |
| 267430 | #267430 RENAL TUBULAR DYSGENESIS; RTD | AGTR1 | renal |
| 267430 | #267430 RENAL TUBULAR DYSGENESIS; RTD | REN | renal |
| 602088 | #602088 NEPHRONOPHTHISIS 2; NPHP2 | INVS | renal |
| 208540 | #208540 RENAL-HEPATIC-PANCREATIC DYSPLASIA; | NPHP3 | renal |
| | RHPD | | |
| 248190 | #248190 HYPOMAGNESEMIA, RENAL, WITH OCULAR | CLDN19 | renal |
| | INVOLVEMENT | | |
| 256300 | #256300 NEPHROSIS 1, CONGENITAL, FINNISH TYPE; | NPHS1 | renal |
| | NPHS1 | | |
| 266900 | #266900 SENIOR-LOKEN SYNDROME 1; SLSN1 | NPHP1 | renal |
| 609254 | #609254 SENIOR-LOKEN SYNDROME 5; SLSN5 | IQCB1 | renal |
| 610725 | #610725 NEPHROTIC SYNDROME, TYPE 3; NPHS3 | PLCE1 | renal |
| 606966 | #606966 NEPHRONOPHTHISIS 4; NPHP4 | NPHP4 | renal |
| 601678 | #601678 BARTTER SYNDROME, ANTENATAL, TYPE 1 | SLC12A1 | renal |
| 600995 | #600995 NEPHROTIC SYNDROME, STEROID- | NPHS2 | renal |
| | RESISTANT, AUTOSOMAL RECESSIVE; SRN1 | | |
| 264350 | #264350 PSEUDOHYPOALDOSTERONISM, TYPE I, | SCNN1A | renal |
| | AUTOSOMAL RECESSIVE; PHA1 | | |
| 264350 | #264350 PSEUDOHYPOALDOSTERONISM, TYPE I, | SCNN1B | renal |
| | AUTOSOMAL RECESSIVE; PHA1 | | |
| 264350 | #264350 PSEUDOHYPOALDOSTERONISM, TYPE I, | SCNN1G | renal |
| | AUTOSOMAL RECESSIVE; PHA1 | | |
| 219700 | #219700 CYSTIC FIBROSIS; CF | CFTR | respiratory |
| 608800 | #608800 SUDDEN INFANT DEATH WITH DYSGENESIS | TSPYL1 | respiratory |
| | OF THE TESTES SYNDROME; SIDDT | | |
| 265450 | #265450 PULMONARY VENOOCCLUSIVE DISEASE; | BMPR2 | respiratory |
| | PVOD | | |
| 265100 | #265100 PULMONARY ALVEOLAR MICROLITHIASIS | SLC34A2 | respiratory |
| 265380 | #265380 PULMONARY HYPERTENSION, FAMILIAL | CPS1 | respiratory |
| | PERSISTENT, OF THE NEWBORN | | |
| 267450 | #267450 RESPIRATORY DISTRESS SYNDROME IN | SFTPA1 | respiratory |
| | PREMATURE INFANTS | | |
| 267450 | #267450 RESPIRATORY DISTRESS SYNDROME IN | SFTPB | respiratory |
| | PREMATURE INFANTS | | |
| 267450 | #267450 RESPIRATORY DISTRESS SYNDROME IN | SFTPC | respiratory |
| | PREMATURE INFANTS | | |
| 226980 | #226980 EPIPHYSEAL DYSPLASIA, MULTIPLE, WITH | EIF2AK3 | skeletal |
| | EARLY-ONSET DIABETES MELLITUS | | |
| 236490 | #236490 HYALINOSIS, INFANTILE SYSTEMIC | ANTXR2 | skeletal |
| 241510 | #241510 HYPOPHOSPHATASIA, CHILDHOOD | ALPL | skeletal |
| 600972 | #600972 ACHONDROGENESIS, TYPE IB; ACG1B | SLC26A2 | skeletal |
| 610854 | #610854 OSTEOGENESIS IMPERFECTA, TYPE IIB | CRTAP | skeletal |
| 241520 | #241520 HYPOPHOSPHATEMIC RICKETS, | DMP1 | skeletal |
| | AUTOSOMAL RECESSIVE | | |
| 277440 | #277440 VITAMIN D-DEPENDENT RICKETS, TYPE II | VDR | skeletal |
| 601559 | #601559 STUVE-WIEDEMANN SYNDROME | LIFR | skeletal |
| 215045 | #215045 CHONDRODYSPLASIA, BLOMSTRAND TYPE; | PTH1R | skeletal |
| | BOLD | | |
| 231050 | #231050 GELEOPHYSIC DYSPLASIA | ADAMTSL2 | skeletal |
| 207410 | #207410 ANTLEY-BIXLER SYNDROME; ABS | FGFR2 | skeletal |
| 215140 | HYDROPS-ECTOPIC CALCIFICATION-MOTH-EATEN | LBR | skeletal |
| | SKELETAL DYSPLASIA | | |
| 259720 | OSTEOPETROSIS, AUTOSOMAL RECESSIVE 5; OPTB5 | OSTM1 | skeletal |
| 259730 | OSTEOPETROSIS, AUTOSOMAL RECESSIVE 3; OPTB3 | CA2 | skeletal |
| 259770 | OSTEOPOROSIS-PSEUDOGLIOMA SYNDROME; OPPG | LRP5 | skeletal |
| 277300 | SPONDYLOCOSTAL DYSOSTOSIS, AUTOSOMAL | DLL3 | skeletal |
| | RECESSIVE 1; SCDO1 | | |
| 607095 | ANAUXETIC DYSPLASIA | RMRP | skeletal |
| 210600 | SECKEL SYNDROME 1 | ATR | skeletal |
| 224410 | DYSSEGMENTAL DYSPLASIA, SILVERMAN- | HSPG2 | skeletal |
| | HANDMAKER TYPE; DDSH | | |
| 228930 | FIBULAR APLASIA OR HYPOPLASIA, FEMORAL | WNT7A | skeletal |
| | BOWING AND POLY-, SYN-, AND | | |
| 259700 | OSTEOPETROSIS, AUTOSOMAL RECESSIVE 1; OPTB1 | TCIRG1 | skeletal |
| 259775 | RAINE SYNDROME; RNS | FAM20C | skeletal |
| 269250 | SCHNECKENBECKEN DYSPLASIA | SLC35D1 | Skeletal |
| 276820 | ULNA AND FIBULA, ABSENCE OF, WITH SEVERE | WNT7A | Skeletal |
| | LIMB DEFICIENCY | | |
| 610915 | OSTEOGENESIS IMPERFECTA, TYPE VIII | LEPRE1 | Skeletal |
| 239000 | PAGET DISEASE, JUVENILE | TNFRSF11B | Skeletal |
| 215150 | OTOSPONDYLOMEGAEPIPHYSEAL DYSPLASIA; | COL11A2 | Skeletal |
| | OSMED | | |
| 215150 | OTOSPONDYLOMEGAEPIPHYSEAL DYSPLASIA; | COL2A1 | Skeletal |
| | OSMED | | |

ii. DNA Samples
Target enrichment was performed with 104 DNA samples obtained from the Coriell Institute (Camden, N.J.) (Table 13). Seventy six of these were carriers or affected by 37 severe, childhood recessive disorders. The latter samples contained 120 known DMs in 34 genes (63 substitutions, 20 indels, 13 gross deletions, 19 splicing, 2 regulatory and 3 complex DMs). These samples also represented homozygous, heterozygous, compound heterozygous and hemizygous DM states. Twenty six samples were well-characterized, from “normal” individuals, and two had previously undergone genome sequencing. In Table 13, the following apply: 1 refers to SureSelect, library 1; 2 refers to SureSelect, library design 2; 3 refers to RainDance; 4 refers to Illumina GAIIx SBS; 5 refers to: 53 SBL; and 6 refers to Illumina 6 2000.

| | | | | | | | Coriell annotated mutation |
|---|---|---|---|---|---|---|---|
| Coriell | Selection | Sequencing | | | | | (NCBI human genome |
| DNA # | Method | Method | Description | OMIM # | Gene | Zygosity | coordinates, build 36.3) |
| NA02825 | 1, 3 | 4 | ADA DEFICIENCY | 102700 | ADA | CHT | exon 11, c.986C > T, A329V, |
| | | | | | | | chr20: 42682446C > T |
| NA02825 | 1, 3 | 4 | ADA DEFICIENCY | 102700 | ADA | CHT | intron 3, IVS3-2A > G, exon4del, |
| | | | | | | | chr20: 42688656A > G |
| NA02471 | 2 | 6 | ADA DEFICIENCY | 102700 | ADA | CHT | exon 10, c.911T > G, L304R, |
| | | | | | | | chr20: 42683137T > G |
| NA02471 | 2 | 6 | ADA DEFICIENCY | 102700 | ADA | CHT | exon 5, c.466C > T, R156C, |
| | | | | | | | chr20: 42687636C > T |
| NA02756 | 2 | 6 | ADA DEFICIENCY | 102700 | ADA | CHT | exon 7, c.632G > A, R211H, |
| | | | | | | | chr20: 42685108G > A |
| NA02756 | 2 | 6 | ADA DEFICIENCY | 102700 | ADA | CHT | exon 11, c.986C > T, A329V, |
| | | | | | | | chr20: 42682446C > T |
| NA05816 | 2 | 6 | ADA DEFICIENCY | 102700 | ADA | CHT | exon 4, c.226C > T, R76W, |
| | | | | | | | chr20: 42688647C > T |
| NA05816 | 2 | 6 | ADA DEFICIENCY | 102700 | ADA | CHT | exon 9, c.821C > T, P274L, |
| | | | | | | | chr20: 42684667C > T |
| NA02057 | 1, 3 | 4 | ASPARTYLGLUCOSAMINURIA | 208400 | AGA | CHT | exon 4, c.482G > A, R161Q, |
| | | | | | | | chr4: 178596918G > A |
| NA02057 | 1, 3 | 4 | ASPARTYLGLUCOSAMINURIA | 208400 | AGA | CHT | exon 4, c.488G > C, C163S, |
| | | | | | | | chr4: 178596912G > C |
| NA10641 | 2 | 6 | SJOGREN-LARSSON | 270200 | ALDH3A2 | HM | exon 7, |
| | | | SYNDROME | | | | c.941_943delCCCins21bpGGGCT |
| | | | | | | | AAAAGTACTGTTGGGG, |
| | | | | | | | A314G insAKSTVG P315A, |
| | | | | | | | chr17: |
| | | | | | | | 19507238_19507240delCCCins21bp |
| NA00059 | 1 | 6 | CANAVAN DISEASE | 271900 | ASPA | HT | exon 6, c.914C > A, A305E, |
| | | | | | | | chr17: 3349104C > A |
| NA04268 | 2 | 6 | CANAVAN DISEASE | 271900 | ASPA | HM | exon 6, c.854A > C, E285A, |
| | | | | | | | chr17: 3349044A > C |
| NA18929 | 2 | 6 | CANAVAN DISEASE | 271900 | ASPA | HT | exon 5, c.693C > A, Y231X, |
| | | | | | | | chr17: 3344452C > A |
| NA13669 | 1 | 4, 5, 6 | MENKES SYNDROME | 309400 | ATP7A | XLR | intron 7, IVS7 + 2T > C, |
| | | | | | | | exon8del&fs, chrX: 77153407T > C |
| NA13672 | 1 & 2 | 4, 5, 6 | MENKES SYNDROME | 309400 | ATP7A | XLR | intron 7, IVS7-5_-1dupATAAG, |
| | | | | | | | W650fs, |
| | | | | | | | chrX: 77153602dupATAAG |
| NA13668 | 1 & 2 | 4, 5, 6 | MENKES SYNDROME | 309400 | ATP7A | XLR | exon 3, c.653_657delATCTT, |
| | | | | | | | I220fs, |
| | | | | | | | chrX: 77131427_77131431delATC |
| | | | | | | | TT |
| NA13674 | 1 | 4, 5, 6 | MENKES SYNDROME | 309400 | ATP7A | XLR | exon 2, c.499C > T, Q167X, |
| | | | | | | | chrX: 77130772C > T |
| NA13675 | 1 | 4, 5, 6 | MENKES SYNDROME | 309400 | ATP7A | XLR | intron 19, IVS19-2A > G, |
| | | | | | | | chrX: 77185469A > G |
| NA01982 | 2 | 6 | MENKES SYNDROME | 309400 | ATP7A | XLR | exon 3, c.658_662delATCTC, |
| | | | | | | | I220fs, |
| | | | | | | | chrX: 77131432_77131436delATC |
| | | | | | | | TC |
| NA00649 | 1, 3 | 4 | MAPLE SYRUP URINE | 248600 | BCKDHA | CHT | exon 9, c.1312T > A, Y438N, |
| | | | DISEASE Type Ia | | | | chr19: 46622327T > A |
| NA00649 | 1, 3 | 4 | MAPLE SYRUP URINE | 248600 | BCKDHA | CHT | exon 7, c.860_867del, P289fs, |
| | | | DISEASE Type Ia | | | | chr19: 46620380_46620387del |
| NA18803 | 1, 3 | 4 | CYSTIC FIBROSIS | 219700 | CFTR | CHT | exon 11, c.1521_1523delCTT, |
| | | | | | | | F508del, |
| | | | | | | | chr7: 116986882_116986884delCTT |
| NA18803 | 1, 3 | 4 | CYSTIC FIBROSIS | 219700 | CFTR | CHT | exon 14, c.2051_2052delAAinsG, |
| | | | | | | | K684fs, |
| | | | | | | | chr7: 117019508_117019509delA |
| | | | | | | | AinsG |
| NA18668 | 1, 3 | 4 | CYSTIC FIBROSIS | 219700 | CFTR | CHT | exon 11, c.1521_1523delCTT, |
| | | | | | | | F508del, |
| | | | | | | | chr7: 116986882_116986884delCTT |
| NA18668 | 1, 3 | 4 | CYSTIC FIBROSIS | 219700 | CFTR | CHT | introns 1_3, 21,080bp del, |
| | | | | | | | chr7: 116925603_116946682del |
| NA11277 | 1, 3 | 4 | CYSTIC FIBROSIS | 219700 | CFTR | HT | exon 11, c.1519_1521delATC, |
| | | | | | | | I507del, |
| | | | | | | | chr7: 116986880_116986882delATC |
| NA11496 | 1 | 6 | CYSTIC FIBROSIS | 219700 | CFTR | HM | exon 12, c.1624G > T, G542X, |
| | | | | | | | chr7: 117015068G > T |
| NA11472 | 2 | 6 | CYSTIC FIBROSIS | 219700 | CFTR | CHT | exon 25, c.4046G > A, G1349D, |
| | | | | | | | chr7: 117092060G > A |
| NA11472 | 2 | 6 | CYSTIC FIBROSIS | 219700 | CFTR | CHT | exon 24, c.3909C > G, N1303K, |
| | | | | | | | chr7: 117080167C > G |
| NA20836 | 2 | 6 | CYSTIC FIBROSIS | 219700 | CFTR | HT | exon 23, c.3773insT, L1258fs, |
| | | | | | | | chr7: 117069783insT |
| NA13591 | 1, 3 | 4 | CYSTIC FIBROSIS | 219700 | CFTR | CHT | exon 11, c.1521_1523delCTT, |
| | | | | | | | F508del, |
| | | | | | | | chr7: 116986882_116986884delCTT |
| NA13591 | 1, 3 | 4 | CYSTIC FIBROSIS | 219700 | CFTR | CHT | exon 4, c.350G > A, R117H, |
| | | | | | | | chr7: 116958265G > A |
| NA20381 | 1 & | 4, 6 | NEURONAL CEROID | 204200 | CLN3 | CHT | introns 6_8, 966bpdel, |
| | 2, 3 | | LIPOFUSCINOSIS - 3 | | | | exons7_8del and fs, |
| | | | | | | | chr16: 28405752_28404787del |
| NA20381 | 1 & | 4, 6 | NEURONAL CEROID | 204200 | CLN3 | CHT | intron 11, IVS11 + 6G > A, |
| | 2, 3 | | LIPOFUSCINOSIS - 3 | | | | chr16: 28401294G > A |
| NA20382 | 1 & | 4, 6 | NEURONAL CEROID | 204200 | CLN3 | CHT | introns 6_8, 966bpdel, |
| | 2, 3 | | LIPOFUSCINOSIS - 3 | | | | exons7_8del and fs, |
| | | | | | | | chr16: 28405752_28404787del |
| NA20382 | 1 & | 4, 6 | NEURONAL CEROID | 204200 | CLN3 | CHT | exon 6, c.424delG, V142fs, |
| | 2, 3 | | LIPOFUSCINOSIS - 3 | | | | chr16: 28406314delG |
| NA20383 | 1 & | 4, 6 | NEURONAL CEROID | 204200 | CLN3 | CHT | introns 6_8, 966bpdel, |
| | 2, 3 | | LIPOFUSCINOSIS - 3 | | | | exons7_8del and fs, |
| | | | | | | | chr16: 28405752_28404787del |
| NA20383 | 1 & | 4, 6 | NEURONAL CEROID | 204200 | CLN3 | CHT | exon 11, c.1020G > A, E295K, |
| | 2, 3 | | LIPOFUSCINOSIS - 3 | | | | chr16: 28401322G > A |
| NA20384 | 1 & | 4, 6 | NEURONAL CER0ID | 204200 | CLN3 | CHT | introns 6_8, 966bpdel, |
| | 2, 3 | | LIPOFUSCINOSIS - 3 | | | | exons7_8del and fs, |
| | | | | | | | chr16: 28405752_28404787del |
| NA20384 | 1 & | 4, 6 | NEURONAL CER0ID | 204200 | CLN3 | CHT | intron 14, IVS14-1G > T, |
| | 2, 3 | | LIPOFUSCINOSIS - 3 | | | | chr16: 28396458G > T |
| NA03193 | 2 | 6 | DYSKERATOSIS | 305000 | DKC1 | XLR | exon 4, c.196A > G, T66A, |
| | | | CONGENITA, X-LINKED | | | | chrX: 153647400A > G |
| NA04364 | 2 | 6 | MUSCULAR DYSTROPHY, | 310200 | DMD | XLR | exons 51_55 del, |
| | | | DUCHENNE TYPE | | | | chrX: 31702000_31555711del |
| NA05022 | 2 | 6 | MUSCULAR DYSTROPHY, | 310200 | DMD | HT | exon 45_50 del, |
| | | | DUCHENNE TYPE | | | | chrX: undefined(cDNAonly) |
| NA03542 | 2 | 6 | XERODERMA | 278760 | ERCC4 | CHT | exon 8, c.1469G > A, R490Q, |
| | | | PIGMENTOSUM, COMP. | | | | chr16: 13936759G > A |
| | | | GROUP F | | | | |
| NA03542 | 2 | 6 | XERODERMA | 278760 | ERCC4 | CHT | exon 9, 1823T > C, L608P, |
| | | | PIGMENTOSUM, COMP. | | | | chr16: 13939135T > C |
| | | | GROUP F | | | | |
| NA01712 | 2 | 6 | COCKAYNE SYNDROME, | 216400 | ERCC6 | CHT | exon 17, c.3533delT, Y1179fs, |
| | | | TYPE B | | | | chr10: 50348479delT |
| NA01712 | 2 | 6 | COCKAYNE SYNDROME, | 216400 | ERCC6 | CHT | exon 9, c.1993_2169del, |
| | | | TYPE B | | | | p.665_723del, |
| | | | | | | | chr10: 50360915_50360739del |
| NA01464 | 1, 3 | 4 | GLYCOGEN STORAGE | 232300 | GAA | CHT | −44T > G, chr17: 75692936T > G |
| | | | DISEASE II | | | | |
| NA01464 | 1, 3 | 4 | GLYCOGEN STORAGE | 232300 | GAA | CHT | second mutation undetermined |
| | | | DISEASE II | | | | |
| NA01935 | 1, 3 | 4 | GLYCOGEN STORAGE | 232300 | GAA | CHT | exon 17, c.2560C > T, R854X, |
| | | | DISEASE II | | | | chr17: 75706665C > T |
| NA01935 | 1, 3 | 4 | GLYCOGEN STORAGE | 232300 | GAA | CHT | exon 13, c.1935C > A, D645E, |
| | | | DISEASE II | | | | chr17: 75701316C > A |
| NA00244 | 2 | 6 | GLYCOGEN STORAGE | 232300 | GAA | CHT | exon 4, c.953T > C, M318T, |
| | | | DISEASE II | | | | chr17: 75696288T > C |
| NA00244 | 2 | 6 | GLYCOGEN STORAGE | 232300 | GAA | CHT | exon 17, c.2560C > T, R854X, |
| | | | DISEASE II | | | | chr17: 75706665C > T |
| NA12932 | 2 | 6 | GLYCOGEN STORAGE | 232300 | GAA | CHT | exon 9, c.1441T > C, W481R, |
| | | | DISEASE II | | | | chr17: 75699124T > C |
| NA12932 | 2 | 6 | GLYCOGEN STORAGE | 232300 | GAA | CHT | intron 7, IVS7 + 1G > A, |
| | | | DISEASE II | | | | chr17: 75697223G > A |
| NA01210 | 2 | 6 | GALACTOSEMIA | 230400 | GALT | HM | exon 3, c.292G > C, D98H, |
| | | | | | | | chr9: 34637528G > C |
| NA17435 | 2 | 6 | GALACTOSEMIA | 230400 | GALT | CHT | exon 6, c.563A > G, Q188R, |
| | | | | | | | chr9: 34638167A > G |
| NA17435 | 2 | 6 | GALACTOSEMIA | 230400 | GALT | CHT | exon 10, c.940A > G, N314D, |
| | | | | | | | chr9: 34639442A > G |
| NA00852 | 2 | 6 | GAUCHER DISEASE, TYPE I | 231000 | GBA | CHT | exon 9, c.1226A > G, N409S, |
| | | | | | | | chr1: 153472258A > G |
| NA00852 | 2 | 6 | GAUCHER DISEASE, TYPE I | 231000 | GBA | CHT | exon 2, c.84insG, L29fs, |
| | | | | | | | chr1: 153477076insG |
| NA04394 | 2 | 6 | GAUCHER DISEASE, TYPE I | 230800 | GBA | CHT | exon 8, c.1208G > C, S403T, |
| | | | | | | | chr1: 153472676G > C |
| NA04394 | 2 | 6 | GAUCHER DISEASE, TYPE I | 230800 | GBA | CHT | exon 10, c.1448T > C, L483P, |
| | | | | | | | chr1: 153471667T > C |
| NA01260 | 2 | 6 | GAUCHER DISEASE, TYPE II | 230900 | GBA | CHT | exon 10, c.1448T > C, L483P, |
| | | | | | | | chr1: 153471667T > C |
| NA01260 | 2 | 6 | GAUCHER DISEASE, TYPE II | 230900 | GBA | CHT | exon 9, c.1361C > G, P454R, |
| | | | | | | | chr1: 153472123C > G |
| NA01031 | 2 | 6 | GAUCHER DISEASE, TYPE | 231000 | GBA | HT | intron 2, IVS2 + 1G > A, |
| | | | III | | | | chr1: 153477044G > A |
| NA05002 | 2 | 6 | GLUTARIC ACIDEMIA I | 231670 | GCDH | CHT | exon 5, c.344G > A, C115Y, |
| | | | | | | | chr19: 12865306G > A |
| NA05002 | 2 | 6 | GLUTARIC ACIDEMIA I | 231670 | GCDH | CHT | exon 7, c.743C > T, P248L, |
| | | | | | | | chr19: 12868126C > T |
| NA16392 | 2 | 6 | GLUTARIC ACIDEMIA I | 231670 | GCDH | HM | exon 7, c.769C > T, R257W, |
| | | | | | | | chr19: 12868152C > T |
| NA02013 | 1, 3 | 4 | MUCOLIPIDOSIS II α/β | 252500 | GNPTAB | CHT | exon 16, c.3231_3234dupCTAC, |
| | | | | | | | Y1079fs, |
| | | | | | | | chr12: 100677954_100677957dup |
| | | | | | | | CTAC |
| NA02013 | 1, 3 | 4 | MUCOLIPIDOSIS II α/β | 252500 | GNPTAB | CHT | exon 19, c.3503_3504delTC, |
| | | | | | | | L1168fs, |
| | | | | | | | chr12: 100671379_100671380delTC |
| NA03066 | 2 | 6 | MUCOLIPIDOSIS II α/β | 252500 | GNPTAB | CHT | exon 8, c.848delA, T284fsX288, |
| | | | | | | | chr12: 100688989delA |
| NA03066 | 2 | 6 | MUCOLIPIDOSIS II α/β | 252500 | GNPTAB | CHT | exon 12, c.1581delC, C528fsX546, |
| | | | | | | | chr12: 100684031delC |
| NA10798 | 2 | 6 | HEMOGLOBIN--α LOCUS 1 | 141800 | HBA1 | HT | chr16: 141620_172294del, 30676b |
| | | | | | | | del from 5′ of ζ-3′ of θ1 |
| NA07406 | 1, 3 | 4 | β-PLUS-THALASSEMIA | 141900 | HBB | CHT | 5′ UTR, −87C > G, |
| | | | | | | | chr11: 5204964C > G |
| NA07406 | 1, 3 | 4 | β-PLUS-THALASSEMIA | 141900 | HBB | CHT | intron 1, IVS1 + 110G > A, |
| | | | | | | | chr11: 5204626G > A |
| NA07426 | 1, 3 | 4 | β-ZERO-THALASSEMIA | 141900 | HBB | CHT | exon 2, c.216_217insA, S73fs, |
| | | | | | | | chr11: 5204481insA |
| NA07426 | 1, 3 | 4 | β-ZERO-THALASSEMIA | 141900 | HBB | CHT | intron 2, IVS2 + 654C > T, |
| | | | | | | | chr11: 5203729C > T |
| NA07407 | 1 | 6 | HEMOGLOBIN-β LOCUS | 141900 | HBB | CHT | intron 1, IVS1 + 6T > C, |
| | | | | | | | chr11: 5204730T > C |
| NA07407 | 1 | 6 | HEMOGLOBIN--β LOCUS | 141900 | HBB | CHT | intron 1, IVS1 + 1G > A, |
| | | | | | | | chr11: 5204735T > C |
| NA16643 | 2 | 6 | HEMOGLOBIN--β LOCUS | 141900 | HBB | HT | exon 2, c.306G > T, E102D, |
| | | | | | | | chr11: 5204392G > T |
| NA03575 | 1, 3 | 4 | TAY-SACHS DISEASE | 272800 | HEXA | CHT | exon 7, c.805G > A, G269S, |
| | | | | | | | chr15: 70429913G > A |
| NA03575 | 1, 3 | 4 | TAY-SACHS DISEASE | 272800 | HEXA | CHT | exon 11, c.1277_1278insTATC, |
| | | | | | | | Y427fs, |
| | | | | | | | chr15: 70425974_70425975insTA |
| | | | | | | | TC |
| NA09787 | 2 | 6 | TAY-SACHS DISEASE | 272800 | HEXA | CHT | intron 9, IVS9 + 1G > A, |
| | | | | | | | chr15: 70427442G > A |
| NA06804 | 1 | 6 | LESCH-NYHAN SYNDROME | 300322 | HPRT1 | XLR | ins exon2, 3 in IVS1, chrX: |
| | | | | | | | 133428309_ins |
| | | | | | | | exon2, 3_133428318 |
| NA07092 | 1 | 6 | LESCH-NYHAN SYNDROME | 300322 | HPRT1 | XLR | exon 8, c.532_609del, |
| | | | | | | | chrX: 133460304_133460380del |
| NA01899 | 2 | 6 | LESCH-NYHAN SYNDROME | 300322 | HPRT1 | XLR | exon 9, c.610_626del, H204fs, |
| | | | | | | | chrX: 133461726_133461742del |
| NA09295 | 2 | 6 | HEREDITARY SENSORY & | 223900 | IKBKAP | HM | intron 19, IVS19 + 6T > C, |
| | | | AUTONOMIC NEUROPATHY 3 | | | | chr9: 110701917T > C |
| NA09295 | 2 | 6 | GAUCHER DISEASE, TYPE I | 223900 | GBA | HT | exon 9, c.1226A > G, N409S, |
| | | | | | | | chr1: 153472258A > G |
| NA02075 | 1, 3 | 4 | CHEDIAK-HIGASHI | 214500 | LYST | HT | exon 1, c.117insG, A40Xfs, |
| | | | SYNDROME | | | | chr1: 234060224insG |
| NA03365 | 1 | 6 | CHEDIAK-HIGASHI | 214500 | LYST | HM | exon 4, 3310C > T, R1104X, |
| | | | SYNDROME | | | | chr1: 234035749C > T |
| NA02533 | 1, 3 | 4 | MUCOLIPIDOSIS IV | 252650 | MCOLN1 | CHT | intron 3, IVS3 − 2A > G, exon4skip, |
| | | | | | | | chr19: 7497645A > G |
| NA02533 | 1, 3 | 4 | MUCOLIPIDOSIS IV | 252650 | MCOLN1 | CHT | exons 1_7, del6433bp, |
| | | | | | | | chr19: 7492622_7499054del |
| NA16382 | 1, 3 | 4 | RETT SYNDROME | 312750 | MECP2 | HT | exon 3, c.1160_1185del, P387fs, |
| | | | | | | | chrX: 152949313_152949288del |
| NA17540 | 2 | 6 | RETT SYNDROME | 312750 | MECP2 | HT | exon 3, c.401C > G, S134C, |
| | | | | | | | chrX: 152950072C > G |
| NA11110 | 1, 3 | 4 | PHENYLKETONURIA | 261600 | PAH | CHT | exon 12, c.1241A > G, Y414C, |
| | | | | | | | chr12: 101758382A > G |
| NA11110 | 1, 3 | 4 | PHENYLKETONURIA | 261600 | PAH | CHT | intron 12, IVS12 + 1G > A, |
| | | | | | | | chr12: 101758307G > A |
| NA00006 | 2 | 6 | PHENYLKETONURIA | 261600 | PAH | CHT | exon 7, c.842C > T, P281L, |
| | | | | | | | chr12: 101770723C > T |
| NA00006 | 2 | 6 | PHENYLKETONURIA | 261600 | PAH | CHT | exon 12, c.1223G > A, R408Q, |
| | | | | | | | chr12: 101758400G > A |
| NA01565 | 2 | 6 | PHENYLKETONURIA | 261600 | PAH | CHT | exon 7, c.755G > A, R252Q, |
| | | | | | | | chr12: 101770810G > A |
| NA01565 | 2 | 6 | PHENYLKETONURIA | 261600 | PAH | CHT | intron 12, IVS12 + 1G > A, |
| | | | | | | | chr12: 101758307G > A |
| NA13435 | 1 | 4, 5, 6 | PELIZAEUS-MERZBACHER | 312080 | PLP1 | XLR | exon 3, c.384C > G, G128G, |
| | | | DISEASE | | | | chrX: 102928242C > G |
| NA13434 | 1 | 6 | PELIZAEUS-MERZBACHER | 312080 | PLP1 | XLR | exons 3_4, c.349_495del, |
| | | | DISEASE | | | | chrX: 102928207_102929424del |
| NA16081 | 1, 3 | 4 | NEURONAL CEROID | 256730 | PPT1 | CHT | exon 5, c.451C > T, R151X, |
| | | | LIPOFUSCINOSIS-1 | | | | chr1: 40327754C > T |
| NA16081 | 1, 3 | 4 | NEURONAL CEROID | 256730 | PPT1 | CHT | exon 3, c.236A > G, D79G, |
| | | | LIPOFUSCINOSIS-1 | | | | chr1: 40330430A > G |
| NA20379 | 1, 3 | 4 | NEURONAL CEROID | 256730 | PPT1 | CHT | exon 4, c.364A > T, R122W, |
| | | | LIPOFUSCINOSIS-1 | | | | chr1: 40329657A > T |
| NA20379 | 1, 3 | 4 | NEURONAL CEROID | 256730 | PPT1 | CHT | exon 2, c.125G > A, G42E, |
| | | | LIPOFUSCINOSIS-1 | | | | chr1: 40330766G > A |
| NA03580 | 2 | 6 | PROTEASE INHIBITOR 1 | 107400 | SERPINA1 | HT | exon 4, c.1096G > A, E366K, |
| | | | | | | | chr14: 93914700G > A |
| NA00879 | 2 | 6 | MUCOPOLYSACCHARIDOSIS | 252900 | SGSH | CHT | exon 8, c.1339G > A, E447K, |
| | | | TYPE IIIA | | | | chr17: 75799016G > A |
| NA00879 | 2 | 6 | MUCOPOLYSACCHARIDOSIS | 252900 | SGSH | CHT | exon 6, c.734G > A, R245H, |
| | | | TYPE IIIA | | | | chr17: 75802209G > A |
| NA01881 | 2 | 6 | MUCOPOLYSACCHARIDOSIS | 252900 | SGSH | CHT | exon 2, c.197C > G, S66W, |
| | | | TYPE IIIA | | | | chr17: 75805478C > G |
| NA01881 | 2 | 6 | MUCOPOLYSACCHARIDOSIS | 252900 | SGSH | CHT | exon 4, c.391G > A, V131M, |
| | | | TYPE IIIA | | | | chr17: 75803124G > A |
| NA03813 | 1 | 6 | SPINAL MUSCULAR | 253300 | SMN1 | HM | Del of exons 7 and 8 |
| | | | ATROPHY, TYPE I | | | | |
| NA16193 | 1, 3 | 4 | NIEMANN-PICK DISEASE, | 607616 | SMPD1 | CHT | exon 5, c.1361G > T, R454L, |
| | | | TYPE B | | | | chr11: 6372010G > T |
| NA16193 | 1, 3 | 4 | NIEMANN-PICK DISEASE, | 607616 | SMPD1 | CHT | exon 5, c.1822_1824delCGC, |
| | | | TYPE B | | | | R608del, |
| | | | | | | | chr11: 6372345_6372347delCGC |
| NA16193 | 1, 3 | 4 | GAUCHER DISEASE, TYPE I | 223900 | GBA | HT | exon 9, c.1226A > G, N409S, |
| | | | | | | | chr1: 153472258A > G |
| NA01960 | 2 | 6 | FAMILIAL ISOLATED | 277460 | TTPA | HM | exon 4, c.661C > T, R221W, |
| | | | DEFICIENCY OF VITAMIN E | | | | chr8: 64139321C > T |
| NA09069 | 2 | 6 | USHER SYNDROME, TYPE | 276904 | USH1C | HT | exon 3, c.216G > A, |
| | | | IC | | | | chr11: 17509554G > A |
| NA12875 | 2 | 6 | CEU-HapMap | | | | |
| NA12003 | 2 | 6 | CEU-HapMap | | | | |
| NA10860 | 2 | 6 | CEU-HapMap | | | | |
| NA07019 | 2 | 6 | CEU-HapMap | | | | |
| NA12044 | 2 | 6 | CEU-HapMap | | | | |
| NA12753 | 2 | 6 | CEU-HapMap | | | | |
| NA18540 | 2 | 6 | JPT/HAN-HapMap | | | | |
| NA18571 | 2 | 6 | JPT/HAN-HapMap | | | | |
| NA18956 | 2 | 6 | JPT/HAN-HapMap | | | | |
| NA18572 | 2 | 6 | JPT/HAN-HapMap | | | | |
| NA18960 | 2 | 6 | JPT/HAN-HapMap | | | | |
| NA19007 | 2 | 6 | JPT/HAN-HapMap | | | | |
| NA15029 | 2 | 6 | Polymorphism Discovery Panel | | | | |
| NA15036 | 2 | 6 | Polymorphism Discovery Panel | | | | |
| NA15215 | 2 | 6 | Polymorphism Discovery Panel | | | | |
| NA15223 | 2 | 6 | Polymorphism Discovery Panel | | | | |
| NA15224 | 2 | 6 | Polymorphism Discovery Panel | | | | |
| NA15236 | 2 | 6 | Polymorphism Discovery Panel | | | | |
| NA15245 | 2 | 6 | Polymorphism Discovery Panel | | | | |
| NA15510 | 2 | 6 | Polymorphism Discovery Panel | | | | |
| twin0001 | 2 | 6 | Twin, Affected Multiple | | | | |
| | | | Sclerosis | | | | |
| twin0101 | 2 | 6 | Twin, Unaffected Multiple | | | | |
| | | | Sclerosis | | | | |
| NA19193 | 2 | 6 | Yoruba-HapMap | | | | |
| NA19130 | 2 | 6 | Yoruba-HapMap | | | | |
| NA19120 | 2 | 6 | Yoruba-HapMap | | | | |
| NA19171 | 2 | 6 | Yoruba-HapMap | | | | |
| NA18912 | 2 | 6 | Yoruba-HapMap | | | | |
| NA18517 | 2 | 6 | Yoruba-HapMap | | | | |

| | | | Discovered | | |
|---|---|---|---|---|---|
| Coriell | | HGMD | differing | HGMD | |
| DNA # | Mutation type | accession # | mutation | accession # | Notes |
| NA02825 | SNS¹ | CM870001 | | | |
| NA02825 | Splicing | CS880096 | | | |
| NA02471 | SNS | CM860002 | | | |
| NA02471 | SNS | CM920005 | | | |
| NA02756 | SNS | CM880002 | | | |
| NA02756 | SNS | CM870001 | | | |
| NA05816 | SNS | CM900003 | | | phenotypically |
| | | | | | normal |
| NA05816 | SNS | CM900008 | | | phenotypically |
| | | | | | normal |
| NA02057 | SNS | CM910010 | | | misannotated: |
| | | | | | homozygous non- |
| | | | | | disease causing |
| | | | | | polymorphism linked |
| | | | | | with C163 mutation |
| | | | | | in 98% of cases |
| NA02057 | SNS | CM910011 | | | misannotated: |
| | | | | | homozygous |
| NA10641 | Complex | CX962369 | | | Detected in 1 read |
| NA00059 | SNS | CM940124 | | | clinically affected; |
| | | | | | second mutation not |
| | | | | | annotated |
| NA04268 | SNS | CM930046 | | | |
| NA18929 | SNS | CM940123 | | | |
| NA13669 | Splicing | CS942075 | | | |
| NA13672 | Small | CI942082 | | | |
| | ins | | | | |
| NA13668 | Small | CD942141 | | | |
| | del | | | | |
| NA13674 | SNS | CM942029 | | | |
| NA13675 | Splicing | CS942076 | | | |
| NA01982 | Small | CD942142 | | | |
| | del | | | | |
| NA00649 | SNS | CM890022 | | | |
| NA00649 | Small | CD941612 | | | |
| | del | | | | |
| NA18803 | Small | CD890142 | | | |
| | del | | | | |
| NA18803 | Complex | CX931110 | | | |
| NA18668 | Small | CD890142 | | | |
| | del | | | | |
| NA18668 | Gross | CG004951 | | | |
| | del | | | | |
| NA11277 | Small | CD900275 | | | |
| | del | | | | |
| NA11496 | SNS | CM900049 | | | uniparental disomy |
| NA11472 | SNS | CM920193 | | | |
| NA11472 | SNS | CM910076 | | | |
| NA20836 | Small | CI941851 | | | |
| | ins | | | | |
| NA13591 | Small | CD890142 | | | |
| | del | | | | |
| NA13591 | SNS | CM900043 | | | |
| NA20381 | Gross | CG952287 | | | |
| | del | | | | |
| NA20381 | Splicing | CS003697 | | | |
| NA20382 | Gross | CG952287 | | | |
| | del | | | | |
| NA20382 | Small | CD972140 | | | |
| | del | | | | |
| NA20383 | Gross | CG952287 | | | |
| | del | | | | |
| NA20383 | SNS | CM970334 | exon 11, | CM003663 | misannotated: correct |
| | | | c.1020G > T, | | location, different |
| | | | E295X, | | SNS |
| | | | chr16: 28401322 | | |
| | | | G > T | | |
| NA20384 | Gross | CG952287 | | | |
| | del | | | | |
| NA20384 | Splicing | CS971665 | | | |
| NA03193 | SNS | CM990478 | | | |
| NA04364 | Gross | | | | |
| | del | | | | |
| NA05022 | Gross | | No mutation | | likely de novo; |
| | del | | | | absent in sample |
| | | | | | (mother of proband) |
| NA03542 | SNS | CM980616 | | | annotated mutation |
| | | | | | absent (0/130 reads) |
| NA03542 | SNS | CM980621 | | | annotated mutation |
| | | | | | absent (0/166 reads) |
| NA01712 | Small | CD982623 | exon 17, | CD982624 | missanotated; actual |
| | del | | c.3536delA, | | mutation 1bp over |
| | | | Y1179fs, | | |
| | | | chr10: 50348476delA | | |
| NA01712 | Gross | CG984340 | exon 8, | unlisted | cDNA analysis |
| | del | | c.1990C > T, | | annotated only |
| | | | Q664X, | | |
| | | | chr10: 50360741C > T | | |
| NA01464 | Regulatory | CS941489 | | | |
| NA01464 | | | exon 17, | unlisted | clinically affected |
| | | | c.2544delC, | | |
| | | | p.K849fs, | | |
| | | | chr17: 75706649delC | | |
| NA01935 | SNS | CM930288 | | | |
| NA01935 | SNS | CM940801 | | | |
| NA00244 | SNS | CM910165 | | | |
| NA00244 | SNS | CM930288 | | | |
| NA12932 | SNS | CM980802 | | | |
| NA12932 | Splicing | CS982202 | | | |
| NA01210 | SNS | CM074203 | | | |
| NA17435 | SNS | CM910169 | | | |
| NA17435 | SNS | CM940804 | | | Duarte variant |
| | | | | | (clinically normal) |
| NA00852 | SNS | CM880036 | | | listed Gaucher type |
| | | | | | III; mutation is type I |
| NA00852 | Small | CI910569 | | | |
| | ins | | | | |
| NA04394 | SNS | CM910177 | exon 8, | CM970621 | misannotated |
| | | | c.1171G > C, | | |
| | | | p.V391L, | | |
| | | | chr1: 153472713 | | |
| | | | G > C | | |
| NA04394 | SNS | CM870010 | | | |
| NA01260 | SNS | CM870010 | | | |
| NA01260 | SNS | CM890055 | | | |
| NA01031 | Splicing | CS920754 | | | |
| NA05002 | SNS | CM980851 | | | |
| NA05002 | SNS | CM000398 | | | |
| NA16392 | SNS | CM980863 | | | |
| NA02013 | Small | CI060694 | | | |
| | ins | | | | |
| NA02013 | Small | CD060604 | | | |
| | del | | | | |
| NA03066 | Small | CD060608 | | | |
| | del | | | | |
| NA03066 | Small | CD060605 | | | |
| | del | | | | |
| NA10798 | Gross | CG994932 | | | |
| | del | | | | |
| NA07406 | Regulatory | CR820007 | | | |
| NA07406 | Splicing | CS810003 | | | |
| NA07426 | Small | CI840016 | | | |
| | ins | | | | |
| NA07426 | Splicing | CS840010 | | | |
| NA07407 | Splicing | CS820004 | | | |
| NA07407 | Splicing | CS991412 | | | |
| NA16643 | SNS | not listed | exon 2, | unlisted | misannoted |
| | | | c.306G > C, | | |
| | | | E102D, | | |
| | | | chr11: 5204392G > C | | |
| NA03575 | SNS | CM890061 | | | |
| NA03575 | Small | CI880091 | | | |
| | ins | | | | |
| NA09787 | Splicing | CS910444 | | | second mutation not |
| | | | | | reported |
| NA06804 | Complex | CN880139 | | | |
| NA07092 | Gross | CG890253 | intron 8, IVS8 + | CG890253 | cDNA annotated |
| | del | | 1_4delGTAA, | | only; actual mutation |
| | | | chrX: 133460381_133460384delG | | is 4bp del |
| | | | TAA | | |
| NA01899 | Splicing | not listed | intron 8, IVS8 − | CS005406 | misannotated; actual |
| | | | 2A > T, | | mutation is splice |
| | | | chrX: 133461724 | | site substitution, |
| | | | A > T | | transcription restarts |
| | | | | | at cryptic splice site |
| NA09295 | Splicing | CS011046 | | | |
| NA09295 | SNS | CM880036 | | | |
| NA02075 | Small | CI962241 | | | |
| | ins | | | | |
| NA03365 | SNS | CM960301 | | | |
| NA02533 | Splicing | CS002473 | | | Homozygous (20/22 |
| | | | | | reads) |
| NA02533 | Gross | CG005059 | | | |
| | del | | | | |
| NA16382 | Gross | CG005065 | | | X Dominant |
| | del | | | | |
| NA17540 | SNS | CM000746 | | | X Dominant |
| NA11110 | SNS | CM910294 | | | |
| NA11110 | Splicing | CS860021 | | | |
| NA00006 | SNS | CM910292 | | | |
| NA00006 | SNS | CM920562 | | | |
| NA01565 | SNS | CM941134 | | | |
| NA01565 | Splicing | CS860021 | | | |
| NA13435 | SNS | not disease | | | disease-causing |
| | | causing | | | mutation not |
| | | | | | annotated |
| NA13434 | Gross | CG952440 | | | |
| | del | | | | |
| NA16081 | SNS | CM981629 | | | |
| NA16081 | SNS | CM981627 | | | |
| NA20379 | SNS | CM950975 | | | |
| NA20379 | SNS | CM981625 | | | |
| NA03580 | SNS | CM830003 | | | |
| NA00879 | SNS | CM971373 | | | |
| NA00879 | SNS | CM971366 | exon 8, | CD972442 | misannotated; |
| | | | c.1079delC, | | annotated mutation |
| | | | p.V361fs, | | absent |
| | | | chr17: 75799276delC | | |
| NA01881 | SNS | CM971353 | | | |
| NA01881 | SNS | CM971359 | | | |
| NA03813 | Gross | unknown | | | |
| | del | | | | |
| NA16193 | SNS | CM910355 | | | |
| NA16193 | Small | CD910554 | | | |
| | del | | | | |
| NA16193 | SNS | CM880036 | | | |
| NA01960 | SNS | CM981967 | | | |
| NA09069 | SNS | CS002472 | | | synonymous; creates |
| | | | | | a novel splice site |
| NA12875 | | | | | |
| NA12003 | | | | | |
| NA10860 | | | | | |
| NA07019 | | | | | |
| NA12044 | | | | | |
| NA12753 | | | | | |
| NA18540 | | | | | |
| NA18571 | | | | | |
| NA18956 | | | | | |
| NA18572 | | | | | |
| NA18960 | | | | | |
| NA19007 | | | | | |
| NA15029 | | | | | |
| NA15036 | | | | | |
| NA15215 | | | | | |
| NA15223 | | | | | |
| NA15224 | | | | | |
| NA15236 | | | | | |
| NA15245 | | | | | |
| NA15510 | | | | | |
| twin0001 | | | | | |
| twin0101 | | | | | |
| NA19193 | | | | | |
| NA19130 | | | | | |
| NA19120 | | | | | |
| NA19171 | | | | | |
| NA18912 | | | | | |
| NA18517 | | | | | |

### iii Target Enrichment and Sequencing by Synthesis (SBS)

For Illumina GAIIx SBS (San Diego, Calif.), 3 μg DNA was sonicated by Covaris S2 (Woburn, Mass.) to ˜250 nt using 20% duty cycle, 5 intensity and 200 cycles/burst for 180 sec. For Illumina HiSeq SBS, shearing to ˜150 nt was by 10% duty cycle, 5 intensity and 200 cycles/burst for 660 sec. Barcoded sequencing libraries were made per manufacturer protocols. Following adapter ligation, Illumina libraries were prepared with AMPure bead—(Beckman Coulter, Danvers, Mass.) rather than gel-purification. Library quality was assessed by optical density and electrophoresis (Agilent 2100, Santa Clara, Calif.).

SureSelect enrichment of 6, 8 or 12-plex pooled libraries was per Agilent protocols¹⁵ with 100 ng of custom bait library, blocking oligos specific for paired-end sequencing libraries and 60 hr. hybridization. Biotinylated RNA-library hybrids were recovered with streptavidin beads. Enrichment was assessed by quantitative PCR (Life Technologies, Foster City, Calif.; CLN3, exon 15, Hs00041388_cn; HPRT1, exon 9, Hs02699975_cn; LYST, exon 5, Hs02929596_cn; PLP1, exon 4; Hs01638246_cn) and a non-targeted locus (chrX: 77082157, Hs05637993_cn) pre- and post-enrichment.

RainDance RDT1000 (Lexington, Mass.) target enrichment was as described and used a custom primer library: Genomic DNA samples were fragmented by nebulization to 2-4 kb and 1 μg mixed with all PCR reagents but primers. Microdroplets containing three primer pairs were fused with PCR reagent droplets and amplified. Following emulsion breaking and purification by MinElute column (Qiagen, Valencia, Calif.), amplicons were concatenated overnight at 16° C. and sequencing libraries were prepared. Sequencing was performed on Illumina GAIIx and HiSeq2000 instruments per manufacturer protocols.

iv. Hybrid Capture and Sequencing by Ligation (SBL)

For SOLiD3 SBL, 3 μg DNA was sheared by Covaris to ˜150 nt using 10% duty cycle, 5 intensity and 100 cycles/bursts for 60 sec. Barcoded fragment sequencing libraries were made using Life Tehnologies (Carlsbad, Calif.) protocols and reagents. Taqman quantitative PCR was used to assess each library, and an equimolar 6-plex pool was produced for enrichment using Agilent SureSelect and a modified protocol. Prior to enrichment, the 6-plex pool was single stranded. Furthermore, 1.2 μg pooled DNA with 5 μL (100 ng) custom baits was used for enrichment, with blocking oligos specific for SOLiD sequencing libraries and 24 hr. hybridization. Sequencing was performed on a SOLiD 3 instrument using one quadrant on a single sequencing slide, generating singleton 50 mer reads.

v. Sequence Analysis

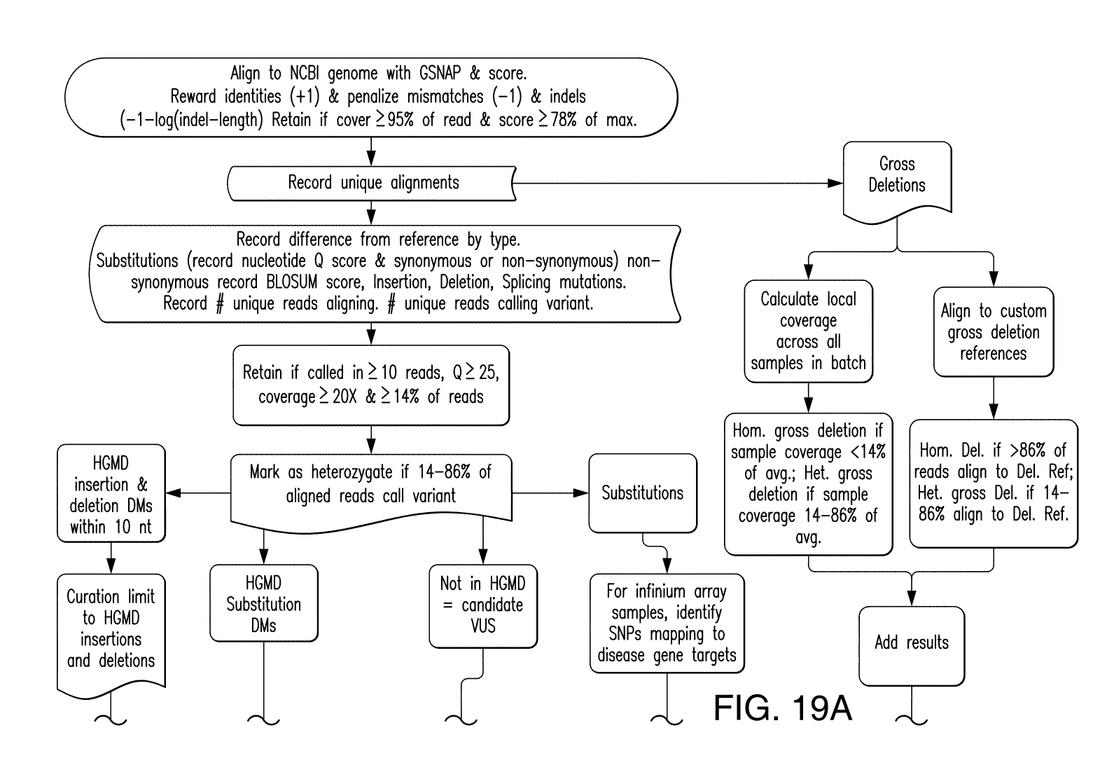

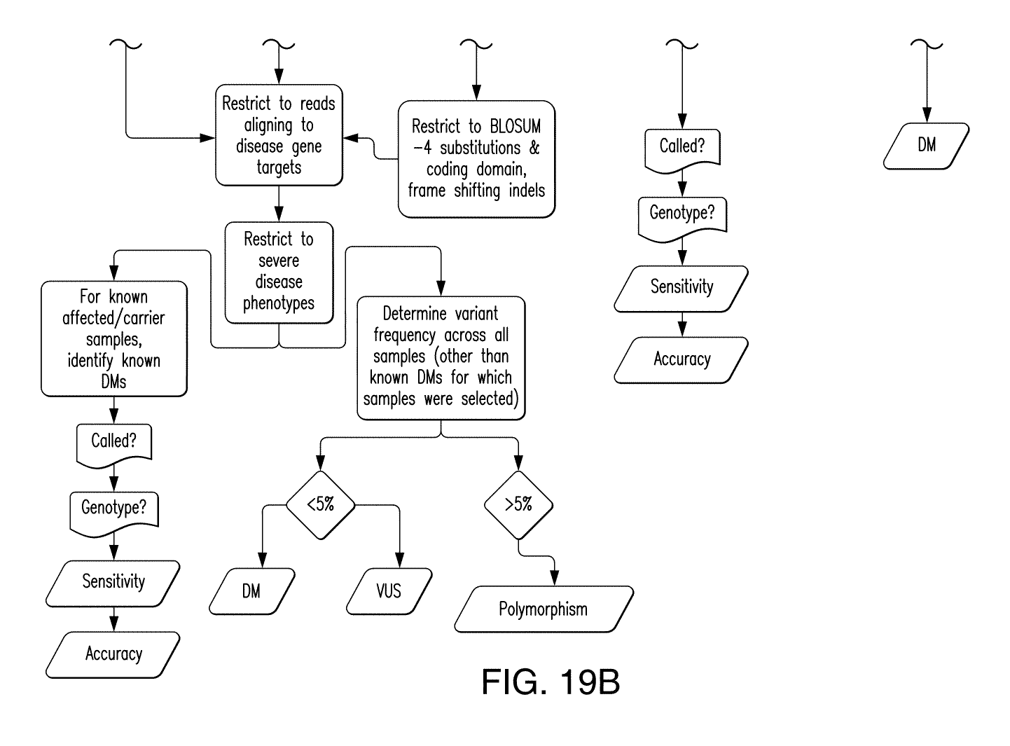

The bioinformatic decision tree for detecting and genotyping DMs was predicated on experience with detection and genotyping of variants in next generation genome and chromosome sequences (FIG. 19). Briefly, SBS sequences were aligned to the NCBI reference human genome sequence (Version 36.3) with GSNAP and scored by rewarding identities (+1) and penalizing mismatches (−1) and indels (−1-log(indel-length)). Alignments were retained if covering ≧95% of the read and scoring ≧78% of maximum. Variants were detected with Alpheus using stringent filters (≧14% and ≧10 reads calling variants and average quality score ≧20). Allele frequencies of 14-86% were designated heterozygous, and >86% homozygous. Reference genotypes of SNPs and CNVs mapping within targets were obtained with Illumina Omni1-Quad arrays and GenomeStudio 2010.1. indel genotypes were confirmed by genomic PCR of <600 bp flanking variants and Sanger sequencing.

SBL sequence data analysis was performed using Bioscope v1.2. 50 bp reads were aligned to NCBI genome build 36.3 using a seed and extend approach (max-mapping). A 25 bp seed with up to 2 mismatches is first aligned to the reference. Extension can proceed in both directions, depending on the footprint of the seed within the read. During extension, each base match receives a score of +1, while mismatches get a default score of −2. The alignment with the highest mapping quality value is chosen as the primary alignment. If 2 or more alignments have the same score then one of them is randomly chosen as the primary alignment. SNPs were called using the Bioscope diBayes algorithm at medium stringency setting. DiBayes is a Bayesian algorithm which incorporates position and probe errors as well as color quality value information for SNP calling. Reads with mapping quality <8 were discarded by diBayes. A position must have at least 2× or 3× coverage to call a homozygous or heterozygous SNP, respectively. The Bioscope small indel pipeline was used with default settings and calls insertions of size ≦3 bp and deletions of size ≦11 bp. In comparisons with SBS, SNP and indel calls were further restricted to positions where at least 4 or 10 reads called a variant.

### 2. Results

i. Disease Inclusion

The carrier test reported herein considered several factors. Firstly, cost effectiveness was assumed to be critical for test adoption. The incremental cost associated with increasing the degree of multiplexing was assumed to decrease toward an asymptote. Thus, very broad coverage of diseases was assumed to offer optimal cost-benefit. Secondly, comprehensive mutation sets, allele frequencies in populations and individual mutation genotype-phenotype relationships have been defined in very few recessive diseases. In addition, some studies of CF carrier screening for a few common alleles have shown decreased prevalence of tested alleles with time, rather than reduced disease incidence. These two different lines of evidence indicated that very broad coverage of mutations offered the greatest likelihood of substantial reductions in disease incidences with time. Thirdly, physician and patient adoption of screening was assumed to be optimal for the most severe childhood diseases. Therefore, diseases were chosen can almost certainly change family planning by prospective parents or impact ante-, peri- or neo-natal care of high risk pregnancies. Milder recessive disorders, such as deafness, and adult-onset diseases, such as inherited cancer syndromes, were omitted.

Database and literature searches and expert reviews were performed on 1,123 diseases with recessive inheritance of known molecular basis. Several subordinate requirements were gathered: In view of pleiotropy and variable severity, disease genes were included if mutations caused severe illness in a proportion of affected children. All but six diseases that featured genocopies (including variable inheritance and mitochondrial mutations) were included. Diseases were not excluded on the basis of low incidence. Diseases for which large population carrier screens exist were included, such as TSD, hemoglobinopathies and CF. Mental retardation genes were not included in this iteration. 489 X-linked recessive (XLR) and autosomal recessive (AR) disease genes met these criteria (Table 11).

ii. Technology Selection

Array hybridization with allele-specific primer extension can be favored for expanded carrier detection due to test simplicity, cost, scalability and accuracy. The majority of carriers can be accounted for by a few mutations, and most DMs must be nucleotide substitutions. Of 215 AR disorders examined, only 87 were assessed to meet these criteria. Most recessive disorders for which a large proportion of burden was attributable to a few DMs were limited to specific ethnic groups. Indeed, 286 severe childhood AR diseases encompassed 19,640 known DMs Given that the Human Gene Mutation Database (HGMD) lists 102,433 disease mutations (DMs), a number which is steadily increasing, a fixed-content method appeared impractical. Other concerns with array-based screening for recessive disorders were Type 1 errors in the absence of confirmatory testing and Type 2 errors for DMs other than substitutions (complex rearrangements, indels or gross deletions with uncertain boundaries).

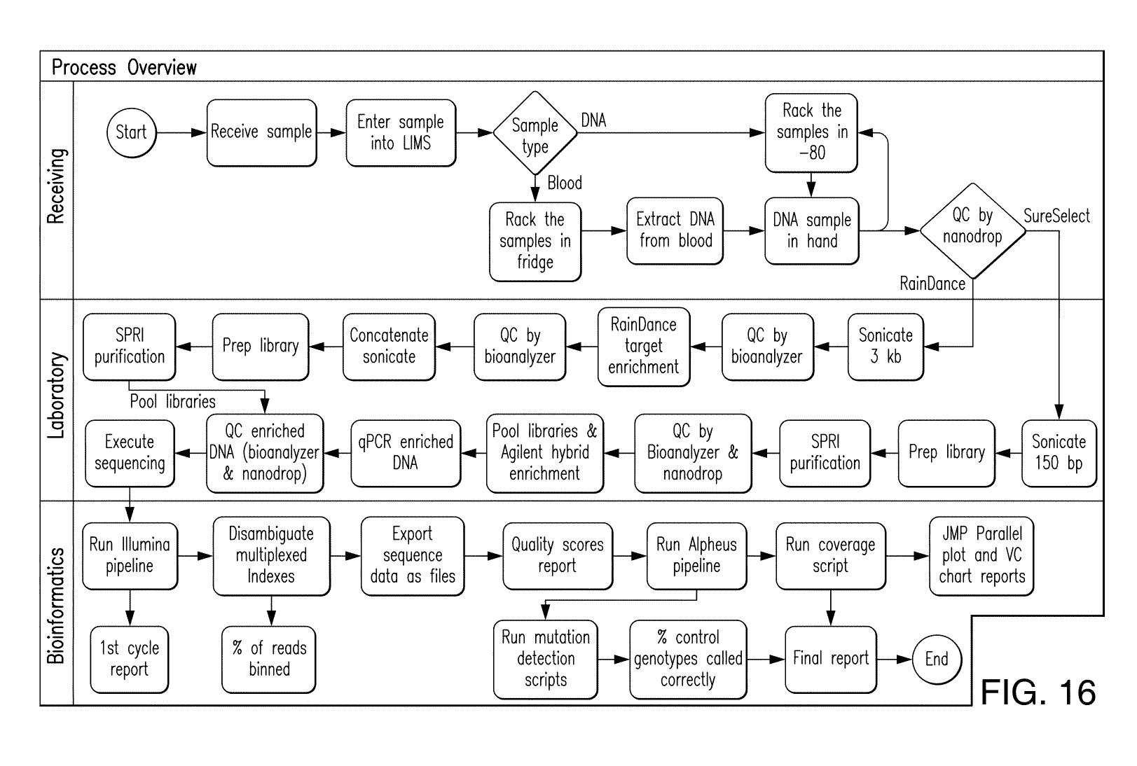

The effectiveness and remarkable decline in cost of exome capture and next generation sequencing for variant detection in genomes and exomes suggested an alternative potential paradigm for comprehensive carrier testing. Four target enrichment and three next generation sequencing methods were preliminarily evaluated for multiplexed carrier testing. Preliminary experiments indicated that existing protocols for Agilent SureSelect hybrid capture and RainDance micro-droplet PCR but not Febit HybSelect microarray-based biochip capture or Olink padlock probe ligation and PCR yielded consistent target enrichment (data not shown). Therefore, detailed workflows were developed for comprehensive carrier testing by hybrid capture or micro-droplet PCR, followed by next generation sequencing (FIG. 16). Baits or primers were designed to capture or amplify 1,978,041 nucleotides (nt), corresponding to 7,717 segments of 489 recessive disease genes by hybrid capture and micro-droplet PCR, respectively. Targeted were all coding exons and splice site junctions, and intronic, regulatory and untranslated regions known to contain DMs. In general, baits for hybrid capture or PCR primers were designed to encompass or flank DMs, respectively. Primers were also designed to avoid known polymorphisms and minimize non-target nucleotides. Custom baits or primers were also designed for 11 gross deletion DMs for which boundaries had been defined, in order to capture or amplify both the normal and DM alleles (Table 14). 29,891 120mer RNA baits were designed to capture of 98.7% of targets. 55% of 101 exons that failed bait design contained repeat sequences (Table 15). 10,280 primer pairs were designed to amplify 99% of targets. Twenty exons failed primer design by falling outside the amplicon size range of 200-600 nt.

TABLE 15
Repeat content of 55 exons failing RNA bait design due to
repetitive sequences.

| | | | Length | % of |
|---|---|---|---|---|
| Type | Element | Number1 | (total nt) | Sequence |
| SINE | Alu | 16 | 2175 | 17.4 |
| | MIR | 8 | 950 | 7.6 |
| LINE | LINE1 | 5 | 779 | 6.2 |
| | LINE2 | 0 | 0 | 0 |
| | L3/CR1 | 0 | 0 | 0 |
| LTR | ERVL | 2 | 276 | 2.2 |
| | ERVL-MaLR | 2 | 115 | 0.9 |
| | ERV-ClassI | 3 | 427 | 3.4 |
| | ERV-ClassII | 0 | 0 | 0 |
| DNA | hAT-Charlie | 0 | 0 | 0 |
| | TcMar-Tigger | 1 | 78 | 0.6 |
| Small RNA | | 0 | 0 | 0 |
| Satellite | | 0 | 0 | 0 |
| Simple Repeats | | 8 | 479 | 3.8 |
| Low Complexity | | 10 | 494 | 4 |

1: repeats fragmented by insertions or deletions were counted as 1 element

iii. Analytic Metrics

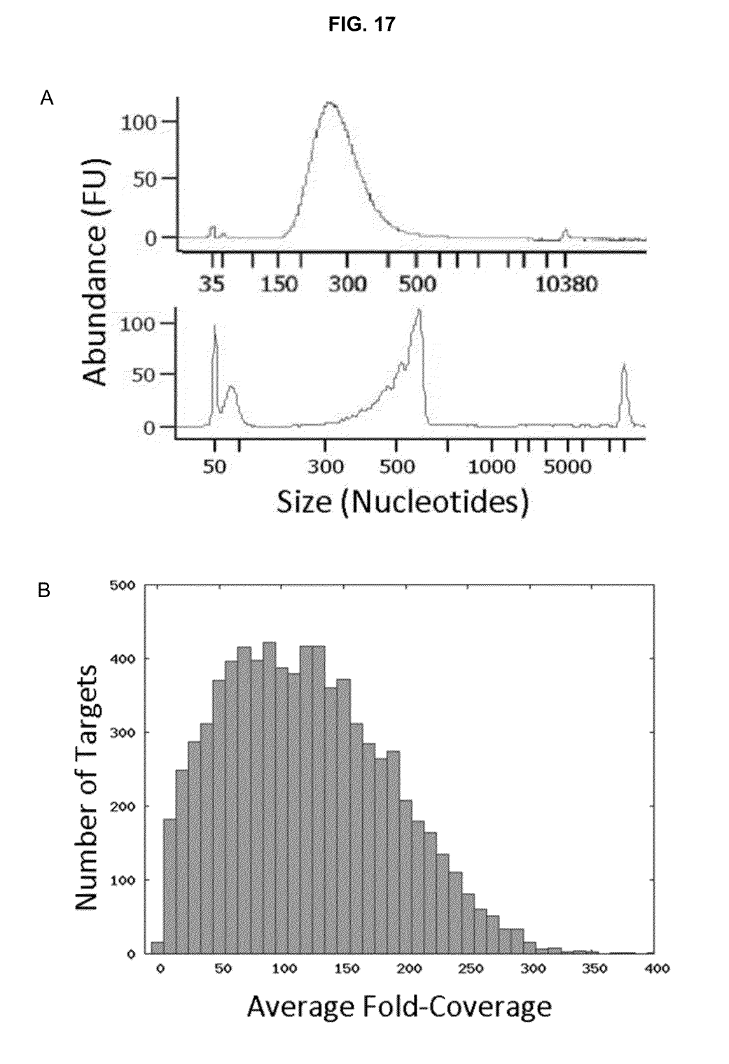

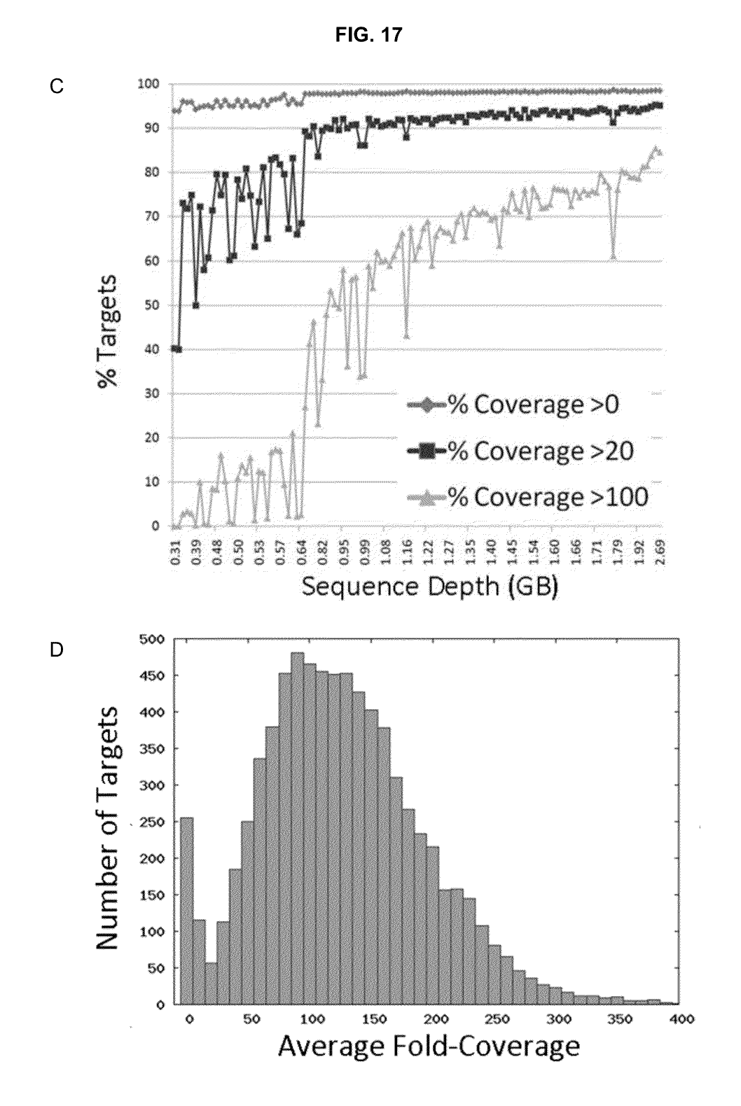

An target enrichment protocol can inexpensively result in at least 30% of nucleotides being on target, which corresponded to approximately 500-fold enrichment with ˜2 million nt target size. This was achieved with hybrid capture following one round of bait redesign for under-represented exons and decreased bait representation in over-represented exons (Table 12). An ideal target enrichment protocol can also give a narrow distribution of target coverage and without tails or skewness (indicative of minimal enrichment-associated bias). Following hybrid capture, the sequencing library size distribution was narrow (FIG. 17A). In FIG. 17A, the top panel shows target enrichment by hybrid capture, and the bottom panel shows target enrichment by microdroplet PCR. Size markers are shown at 40 and 8000 nt. FU: fluorescent units. The aligned sequence coverage distribution was unimodal but flat (platykurtic) and right-skewed (FIG. 17B). This implied that hybrid capture can require over-sequencing of the majority of targets to recruit a minority of poorly selected targets to adequate coverage. In FIG. 17B, aligned sequences had quality score ≧25. As expected, median coverage increased linearly with sequence depth. The proportion of bases with greater than zero and ≧20× coverage increased toward asymptotes at ˜99% and ˜96%, respectively (Table 12, FIG. 17C). Interestingly, targets with low (≦3×) coverage were highly reproducible and had high GC content. Table 16. This indicated that targets failing hybrid capture could be predicted and rescued by individual PCR reactions.

TABLE 12
Sequencing, alignment and coverage statistics for target enrichment and sequencing platforms.

| | | | | | | | Median % | |
|---|---|---|---|---|---|---|---|---|
| | | | | Read | Median | Median | Uniquely | |
| Sample | Enrichment | Sequencing | Multi- | Length | Quality | Total reads ± | Aligning | Median Total |
| Set | Method | Method | plexing | (nt) | Score | % CV¹ | Reads | nucleotides |
| 1, n = 12 | SureSelect | GAIIx | 12 | 50 | 30 | 9,952,972.5 ± 21 | 94 | 497,648,625 |
| 2, n = 12 | SureSelect | GAIIx | 12 | 50 | 30 | 10,127,721 ± 16 | 95 | 506,386,025 |
| 1 + 2, | RainDance | GAIIx | 12 | 50 | 36 | 9,412,698 ± 30 | 97 | 470,634,900 |
| n = 24 | | | | | | | | |
| 1 + 2, | RainDance | GAIIx | 12 | 50 | 31 | 12,807,392 ± 17 | 96 | 640,369,600 |
| n = 12 | | | | | | | | |
| 3, n = 6 | SureSelect | GAIIx | 6 | 50 | 30 | 19,711,735 ± 34 | 95 | 985,586,750 |
| 3, n = 6 | SureSelect | SOLiD 3 | 6 | 50 | 24 | 16,506,076 ± 5 | 82 | 825,303,800 |
| 4, n = 72 | SureSelect 2 | HiSeq | 8 | 149³ | 42³ | 9,273,596 ± 24 | 98 | 1,390,464,487 |
| 5, n = 8 | SureSelect | HiSeq | 8 | 149³ | 41³ | 9,861,765 ± 35 | 97 | 1,493,946,141 |

| | | Median | | | | | Pearson's |
|---|---|---|---|---|---|---|---|
| | Median | % nt on | Median | Median % | Median % | Median | Median |
| Sample | Aligning | target ± | Fold | 0X | ≧20X | Coverage ± | Skewness |
| Set | depth | % CV | Enrichment | Coverage | Coverage | % CV | Coefficient² |
| 1, n = 12 | 225 | 13.7 ± 3 | 214 | 4.83 | 61 | 27 ± 21 | 0.28 |
| 2, n = 12 | 234 | 23.0 ± 2 | 358 | 3.66 | 80 | 50 ± 16 | 0.19 |
| 1 + 2, | 196 | 29.6 ± 5 | 462 | 5.46 | 86 | 52.5 ± 33 | 0.23 |
| n = 24 | | | | | | | |
| 1 + 2, | 277 | 22.2 ± 7 | 346 | 4.62 | 88 | 56 ± 12 | 0.27 |
| n = 12 | | | | | | | |
| 3, n = 6 | 463 | 17.4 ± 3 | 273 | 1.80 | 86 | 76 ± 30 | 0.14 |
| 3, n = 6 | 310 | 19.5 ± 7 | 304 | 6.08 | 79 | 58 ± 7 | 0.24 |
| 4, n = 72 | 495 | 31.7 ± 4 | 494 | 2.33 | 92 | 152 ± 26 | 0.02 |
| 5, n = 8 | 517 | 28.4 ± 4 | 442 | 2.25 | 93 | 139 ± 40 | 0.06 |

¹Coefficient of variation (%).
²Pearson's median skewness coefficient [3(mean − median)/standard deviation].
³Following assembly of forward and reverse 130 bp paired reads.

TABLE 16
Coordinates, genes and GC content of 40 exons with recurrent coverage <3X.

| | | | | | SureSelect Bate Design | |
|---|---|---|---|---|---|---|
| | | | | | Design 2: | Design 1: |
| | | | | | Samples with | Samples with |
| | | | | | <3X Coverage | <3X Coverage |
| Gene | Chr | Start | Stop | GC % | (n = 80) | (n = 8) |
| GAA | 17 | 75689949 | 75690019 | 85 | 97.2% | 100.0% |
| PDSS1 | 10 | 27026600 | 27026775 | 80 | 97.2% | 87.5% |
| HGSNAT | 8 | 43114748 | 43114914 | 83 | 97.2% | 100.0% |
| TTPA | 8 | 64160930 | 64161166 | 76 | 97.2% | 100.0% |
| AAAS | 12 | 51987506 | 51987764 | 57 | 97.2% | — |
| MTM1 | 23 | 149487704 | 149487770 | 81 | 97.2% | 100.0% |
| IDUA | 4 | 970784 | 971030 | 78 | 97.2% | 87.5% |
| EFEMP2 | 11 | 65396729 | 65396916 | 82 | 97.2% | 100.0% |
| ENPP1 | 6 | 132170848 | 132171108 | 79 | 97.2% | 100.0% |
| G6PD | 23 | 153428197 | 153428427 | 78 | 97.2% | 100.0% |
| MYO5A | 15 | 50608268 | 50608539 | 82 | 97.2% | 87.5% |
| CPT1A | 11 | 68365818 | 68365975 | 79 | 97.2% | 100.0% |
| ST3GAL5 | 2 | 85969457 | 85969668 | 80 | 97.2% | 100.0% |
| LIFR | 5 | 38592192 | 38592505 | 78 | 97.2% | 100.0% |
| IDUA | 4 | 986519 | 986732 | 77 | 94.4% | 87.5% |
| INSR | 19 | 7244802 | 7245011 | 80 | 94.4% | 100.0% |
| D2HGDH | 2 | 242322702 | 242322783 | 79 | 93.1% | 100.0% |
| OCRL | 23 | 128501932 | 128502136 | 75 | 87.5% | 87.5% |
| ITGB4 | 17 | 71229110 | 71229287 | 78 | 77.8% | 100.0% |
| SLC25A15 | 13 | 40261596 | 40261799 | 80 | 77.8% | 87.5% |
| MMAB | 12 | 108483607 | 108483705 | 61 | 68.1% | 87.5% |
| LHX3 | 9 | 138234612 | 138234825 | 77 | 66.7% | 75.0% |
| DLL3 | 19 | 44685294 | 44685537 | 79 | 66.7% | — |
| PLEC1 | 8 | 145088547 | 145088680 | 75 | 65.3% | 12.5% |
| VDR | 12 | 46585004 | 46585081 | 72 | 62.5% | 87.5% |
| ASS1 | 9 | 132309914 | 132310203 | 79 | 61.1% | 75.0% |
| CBS | 21 | 43358794 | 43358874 | 63 | 55.6% | 50.0% |
| CDH23 | 10 | 73243006 | 73243111 | 58 | 52.8% | 87.5% |
| VLDLR | 9 | 2611792 | 2612271 | 70 | 52.8% | 75.0% |
| ADA | 20 | 42713629 | 42713790 | 75 | 52.8% | 25.0% |
| DNMT3B | 20 | 30813851 | 30814166 | 79 | 48.6% | 25.0% |
| NPHP4 | 1 | 5974890 | 5975118 | 74 | 48.6% | 25.0% |
| MOCS1 | 6 | 40010011 | 40010232 | 75 | 40.3% | 50.0% |
| ETHE1 | 19 | 48723088 | 48723236 | 74 | 38.9% | — |
| MCOLN1 | 19 | 7493511 | 7493667 | 75 | 36.1% | 87.5% |
| POMT1 | 9 | 133384596 | 133384694 | 65 | 34.7% | 87.5% |
| SLC37A4 | 11 | 118406768 | 118406800 | 67 | 33.3% | 87.5% |
| GCSH | 16 | 79687236 | 79687481 | 79 | 33.3% | 100.0% |
| IDUA | 4 | 987132 | 987258 | 80 | 30.6% | 75.0% |
| COL17A1 | 10 | 105806722 | 105806920 | 68 | 29.2% | 37.5% |

Given the need for highly accurate carrier detection, ≧10 uniquely aligned reads of quality score ≧20 and >14% of reads were required to call a variant. The requirement for ≧10 reads was highly effective for nucleotides with moderate coverage. For heterozygote detection, for example, this was equivalent to ˜20× coverage, which was achieved in ˜96% of exons with ˜2.6 GB of sequence (FIG. 17C). In FIG. 17C, target coverage was a function of depth of sequencing across 104 samples and six experiments. The proportion of targets with at least 20× coverage appeared to be useful for quality assessment. The requirement for ≧14% of reads to call a variant was highly effective for nucleotides with very high coverage and was derived from the genotype data discussed below. A quality score requirement was important when next generation sequencing started, but is now largely redundant.

Micro-droplet PCR can result in all cognate amplicons being on target and can induce minimal bias. In practice, the coverage distribution was narrower than hybrid capture but with similar right-skewing (FIG. 17D). In FIG. 17D, the frequency distribution of target coverage following microdroplet PCR and 1.49 GB of singleton 50mer SBS of sample NA20379. Aligned sequences had quality score ≧25. These results were complicated by ˜11% recurrent primer synthesis failures. This resulted in linear amplification of a subset of targets, ˜5% of target nucleotides with zero coverage and similar proportion of nucleotides on target to that obtained in the best hybrid capture experiments (˜30%; Table 12). Hybrid capture was employed for subsequent studies for reasons of cost.

Multiplexing of samples during hybrid selection and next generation sequencing had not previously been reported. Six- and twelve-fold multiplexing was achieved by adding molecular bar-codes to adapter sequences. Interference of bar-code nucleotides with hybrid selection did not occur appreciably: The stoichiometry of multiplexed pools was essentially unchanged before and after hybrid selection. Multiplexed hybrid selection was found to be approximately 10% less effective than singleton selection, as assessed by median fold-enrichment. Less than 1% of sequences were discarded at alignment because of bar-code sequence ambiguity. Therefore, up to 12-fold multiplexing at hybrid selection and per sequencing lane (equivalent to 96-plex per sequencing flow cell) were used in subsequent studies to achieve the targeted cost of <$1 per test per sample.

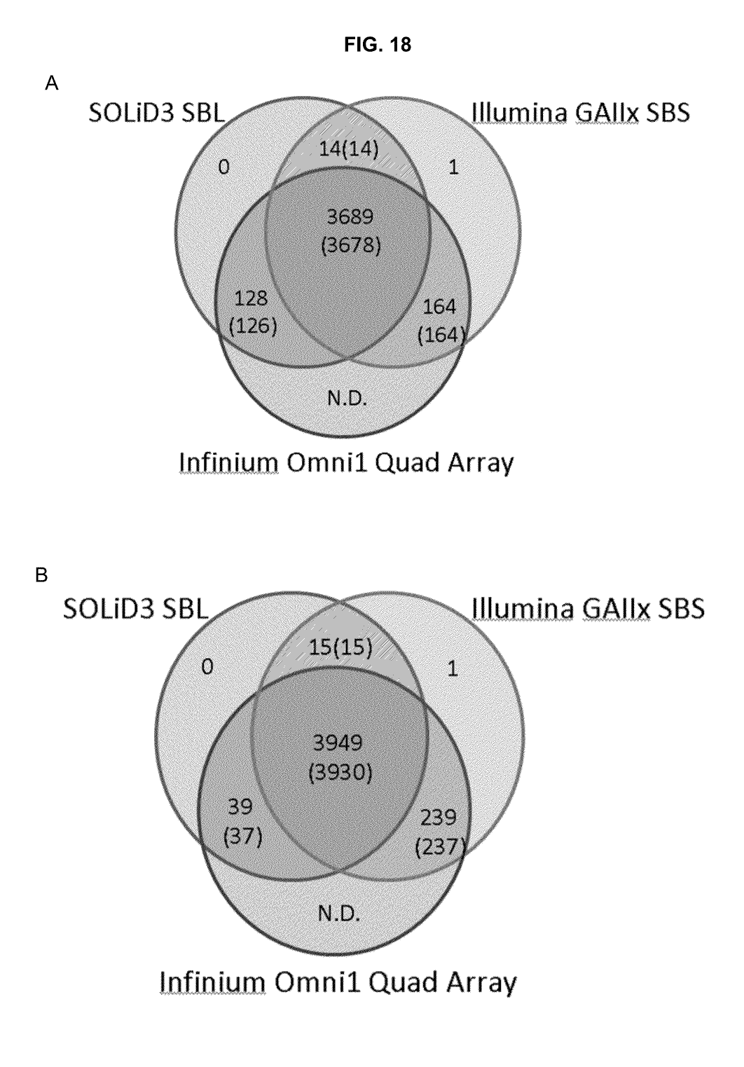

Several next generation sequencing technologies are currently available. Of these, the Illumina sequencing-by-synthesis (SBS) and SOLiD sequencing-by-ligation (SBL) platforms are widely disseminated, have throughput of at least 50 GB per run and read lengths of at least 50 nt. Therefore, the quality and quantity of sequences from multiplexed, target-enriched libraries were compared using SBS (GAIIx singleton 50mers) and SBL (SOLiD3 singleton 50mers; Table 12). SBS- and SBL-derived 50mer sequences (and alignment algorithms) gave similar alignment metrics (Table 12). When compared with Infinium array results, specificity of SNP genotypes by SBS and SBL were very similar (SBS 99.69%, SBL 99.66%, following target enrichment and multiplexed sequencing; FIG. 18). In FIG. 18, target nucleotides were enriched by hybrid selection and sequenced by Illumina GAIIx SBS and SOLiD3 SBL at 6-fold multiplexing. The samples were also genotyped with Infinium OminQuad1 SNP arrays. In FIG. 18, the following apply: (A) Comparison of SNP calls and genotypes obtained by SBS, SBL and arrays at nucleotides surveyed by all three methods. SNPs were called if present in ≧10 uniquely aligning SBS reads, ≧14% of reads and with average quality score ≧20. Heterozygotes were identified if present in 14%-86% of reads. Numbers refer to SNP calls. Numbers in brackets refer to SNP genotypes. (B) Comparison of SNP calls and genotypes obtained by SBS, SBL and arrays. SNPs were called if present in ≧4 uniquely aligning SBS reads, ≧14% of reads and with average quality score ≧20. Heterozygotes were identified if present in 14%-86% of reads.

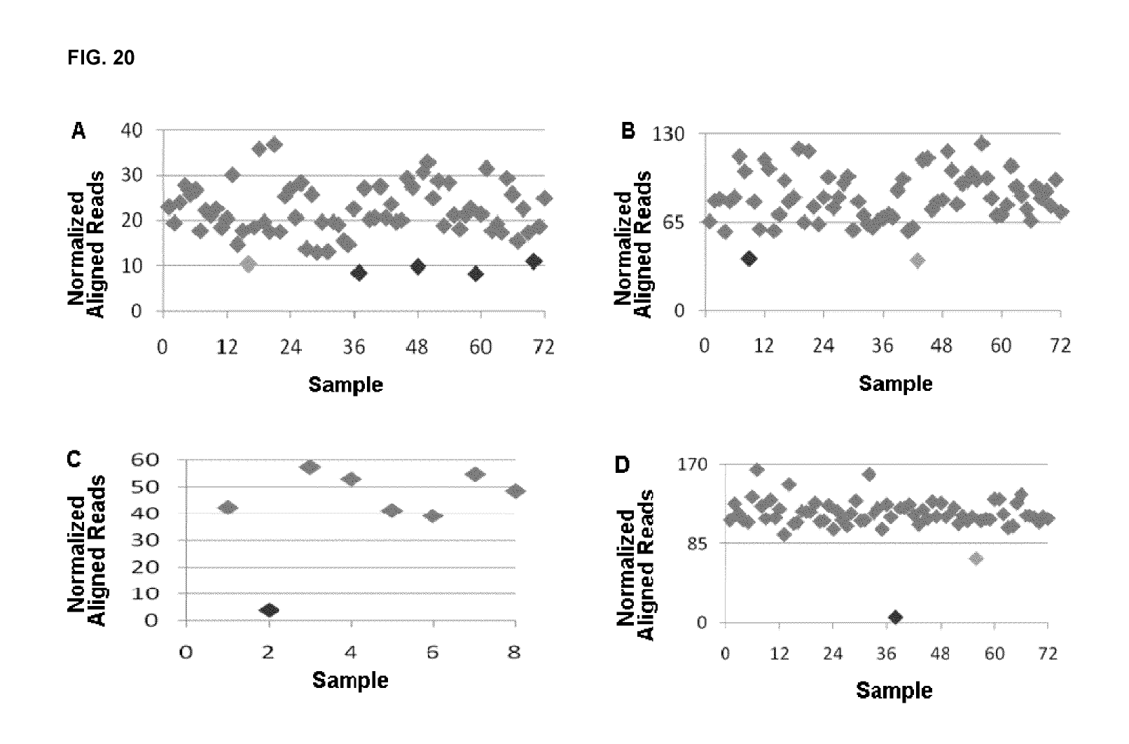

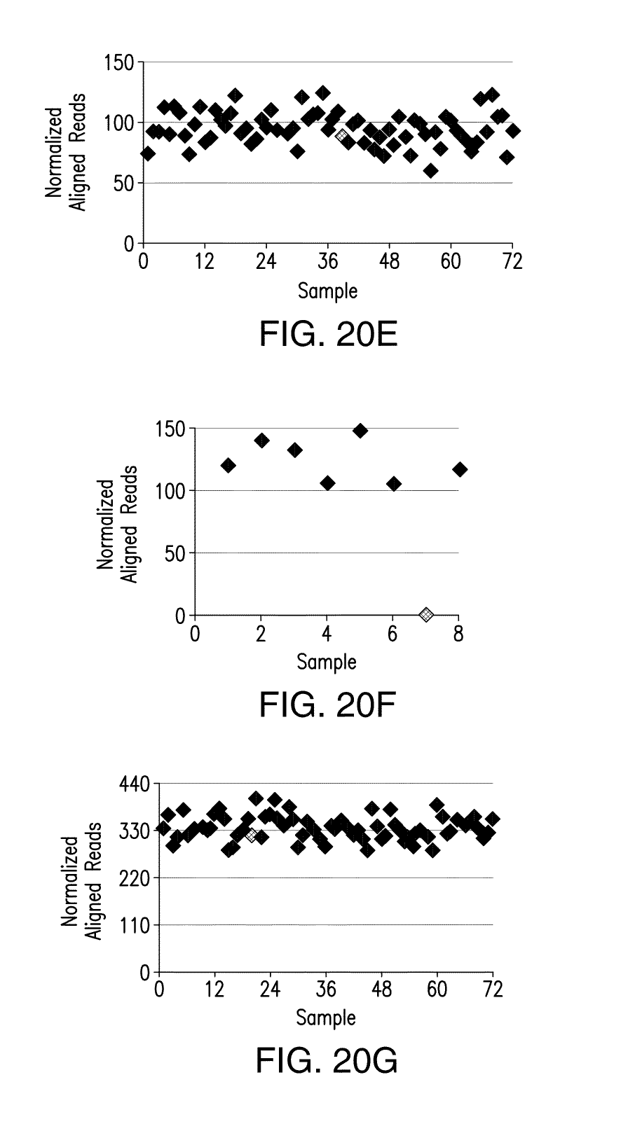

Given approximate parity of throughput and accuracy, consideration was given to optimal read length. Unambiguous alignment of short read sequences is typically confounded by repetitive sequences, which can be irrelevant for carrier testing since targets overwhelmingly contained unique sequences. The number of mismatches tolerated for unique alignment of short read sequences is highly constrained but increases with read length. The majority of disease mutations are single nucleotide substitutions or small indels. Comprehensive carrier testing also requires detection of polynucleotide indels, gross insertions, gross deletions and complex rearrangements. A combination of bioinformatic approaches were used to overcome short read alignment shortcomings (FIG. 19). Firstly, with the Illumina HiSeq SBS platform, the novel approach of read pair assembly before alignment (99% efficiency) was employed, in order to generate longer reads with high quality scores (148.6±3.8 nt combined read length and increase in nucleotides with quality score >30 from 75% to 83%). This was combined with generation of 150 nt sequencing libraries without gel purification by optimization of DNA shearing procedures and use of silica membrane columns. Omission of gel purification was critical for scalability of library generation. Secondly, the penalty on polynucleotide variants was reduced, rewarding identities (+1) and penalizing mismatches (−1) and indels (−1-log(indel-length)). Thirdly, gross deletions were detected either by perfect alignment to mutant reference sequences or by local decreases in normalized coverage (FIG. 20). Seeking perfect alignment to mutant reference sequences obviates low alignment scores when short reads containing polynucleotide variants are mapped to a normal reference. This was illustrated by identification of 11 gross deletion DMs for which boundaries had been defined (Table 14). This approach is anticipated to be extensible to gross insertions and complex rearrangements. In FIG. 20, the following apply: (A) deletion of CLN3 introns 6-8, 966bpdel, exons7-8del and fs, chr16:28405752_{—}28404787del in four known compound heterozygotes (NA20381, NA20382, NA20383 and NA20384, red diamonds) and one undescribed carrier (NA00006, green diamond) among 72 samples sequenced; (B) heterozygous deletion in HBA1 (chr16:141620_{—}172294del, 30,676 bp deletion from 5′ of ζ2 to 3′ of θ1 in ALU regions) in one known (NA10798, red diamond) and one undescribed carriers (NA19193, green diamond) among 72 samples; (C) known homozygous deletion of exons 7 and 8 of SMN1 in one of eight samples (NA03813, red diamond); and (D) detection of a gross deletion that is a cause of Duchenne muscular dystrophy (OMIM#310200, DMD exon 51-55 del, chrX:31702000_{—}31555711del) by reduction in normalized aligned reads at chrX:31586112. FIGS. 20E-G show 72 samples, of which one (NA04364, red diamond) was from an affected male, and another (NA18540, a female JPT/HAN HapMap sample) was determined to carry a deletion that extends to at least chrX:31860199 (see FIG. 20E). In FIGS. 20E-G, the following apply: (E) An undescribed heterozygous deletion of DMD 3′ exon 44-3′ exon 50 (chrX:32144956-31702228del) in NA18540 (green diamond), a JPT/HAN HapMap sample. This deletion extends from at least chrX:31586112 to chrX:31860199 (see FIG. 20D). Sample NA (red diamond) is the uncharacterized mother of an affected son with 3′ exon 44-3′ exon 50 del, chrX:32144956-31702228del; (F) hemizygous deletion in PLP1 exons3_{—}4, c.del349_{—}495del, chrX:102928207_{—}102929424del in one (NA13434, red diamond) of eight samples; and (G) absence of gross deletion CG984340 (ERCC6 exon 9, c.1993_{—}2169del, 665_{—}723del, exon 9 del, chr10:50360915_{—}50360739del) in 72 DNA samples. The sample in red (NA01712) was incorrectly annotated to be a compound heterozygote with CG984340 based on cDNA sequencing.

TABLE 14
Custom Agilent SureSelect RNA baits for hybrid capture of 11 gross
deletion DMs with defined boundaries.

| Bait | | | | | | | |
|---|---|---|---|---|---|---|---|
| ID | Chr | Start | Stop | Length | Disease | OMIM # | Gene |
| A | 11 | 4033883 | 4034083 | 200 | Immunodeficiency & | 605921 | STIM1 |
| | | | | | autoimmunity | | |
| B | 11 | 5204606 | 5204726 | 120 | β thalassemia | 141900 | HBB |
| C | 12 | 101758207 | 101758306 | 99 | PKU | 261600 | PAH |
| D | 16 | 143180 | 143380 | 200 | α thalassemia | 142310 | HBZ |
| E | 16 | 170677 | 170877 | 200 | α thalassemia | 142240 | HBQ1 |
| F | 16 | 28404587 | 28404987 | 400 | Batten disease | 204200 | CLN3 |
| G | 16 | 28405652 | 28405852 | 200 | Batten disease | 204200 | CLN3 |
| H | 17 | 75692836 | 75692947 | 111 | GSD2 | 232300 | GAA |
| I | 19 | 7492522 | 7492722 | 200 | ML4 | 252650 | MCOLN1 |
| J | 19 | 7498954 | 7499042 | 88 | ML4 | 252650 | MCOLN1 |
| K | X | 133428209 | 133428418 | 209 | Lesch-Nyhan syn. | 308000 | HPRT1 |
| L | 5 | 70283407 | 70283522 | 115 | SMA1 | 253300 | SMN1 |
| M | 7 | 116925503 | 116925703 | 200 | CF | 219700 | CFTR |
| N | 7 | 116946582 | 116946782 | 200 | CF | 219700 | CFTR |
| O | 7 | 117038745 | 117038869 | 124 | CF | 219700 | CFTR |
| P | 7 | 117073059 | 117073259 | 200 | CF | 219700 | CFTR |

iv. Clinical Metrics

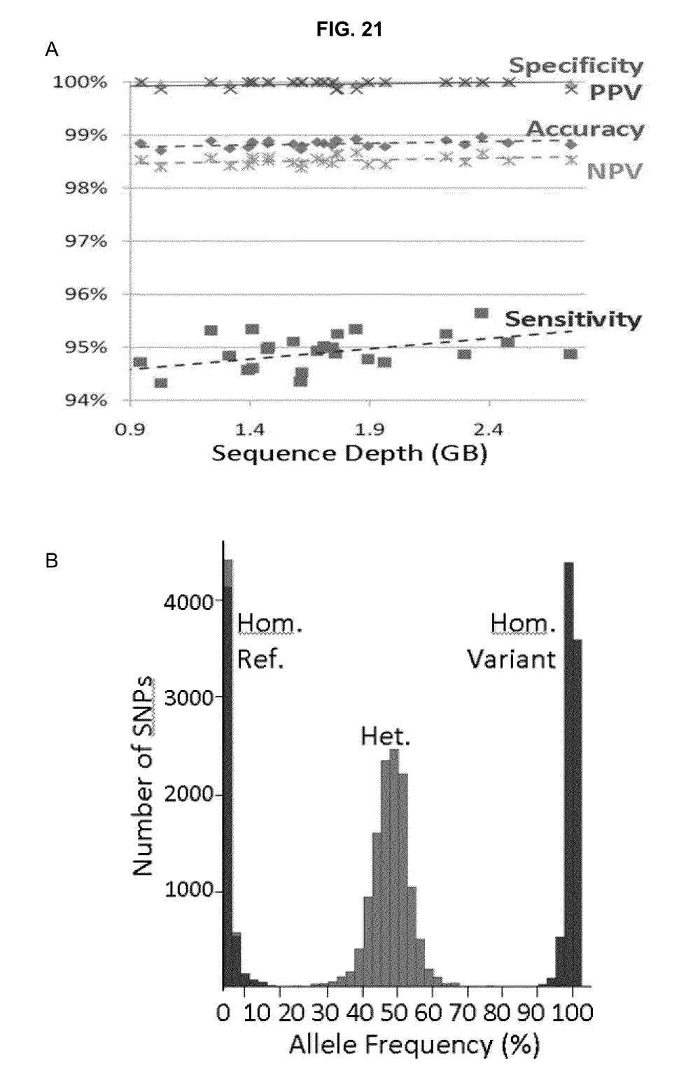

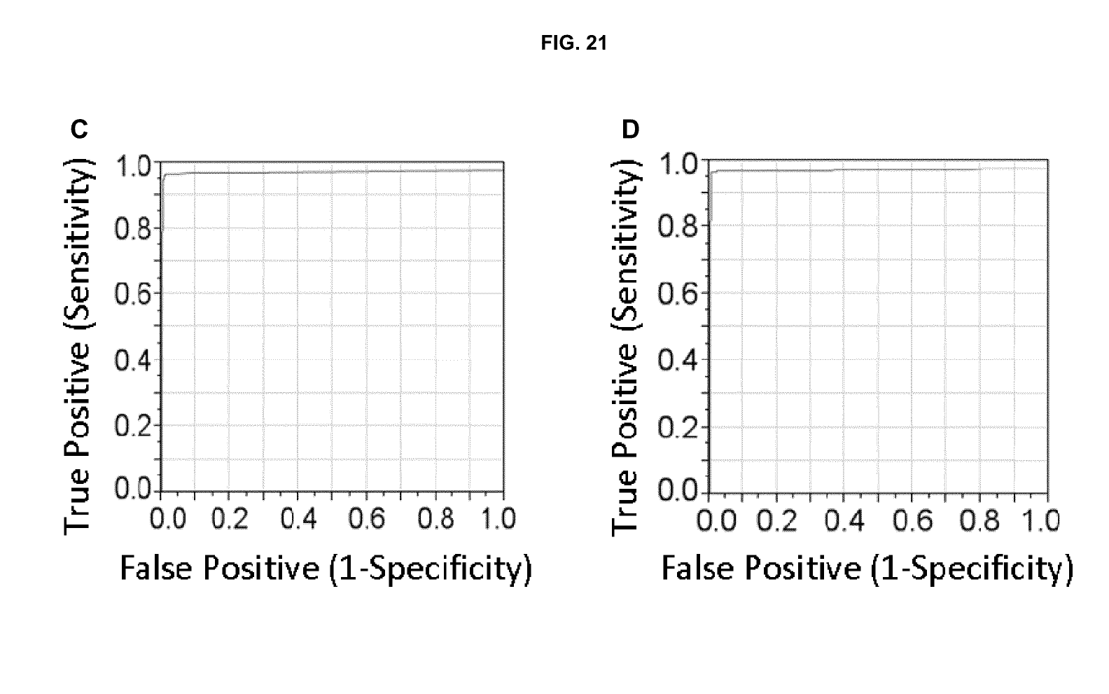

Based on these strategies of genotyping variants identified in next generation genome and chromosome sequences bioinformatic decision tree for genotyping DMs was developed (FIG. 19). Clinical utility of target enrichment, SBS sequencing and this decision tree for genotyping DMs were assessed. SNPs in 26 samples were genotyped both by high density arrays and sequencing. The distribution of read-count-based allele frequencies of 92,106 SNP calls was trimodal, with peaks corresponding to homozygous reference alleles, heterozygotes and homozygous variant alleles, as ascertained by array hybridization (FIG. 21B). Optimal genotyping cut-offs were 14% and 86% (FIG. 21B). With these cutoffs and a requirement for 20× coverage and 10 reads of quality ≧20 to call a variant, the accuracy of sequence-based SNP genotyping was 98.8%, sensitivity was 94.9% and specificity was 99.99%. The positive predictive value (PPV) of sequence-based SNP genotypes was 99.96% and negative predictive value was 98.5%, as ascertained by array hybridization. As sequence depth increased from 0.7 to 2.7 GB, sensitivity increased from 93.9% to 95.6%, while PPV remained ˜100% (FIG. 21A). Areas under the curve (AUC) of the receiver operating characteristic (ROC) for SNP calls by hybrid capture and SBS were calculated. When genotypes in 26 samples were compared with genome-wide SNP array hybridization, the AUC was 0.97 when either the number or % reads calling a SNP was varied (FIG. 21C-D). When the parameters were combined, the AUC was 0.99. For known substitution, indel, splicing, gross deletion and regulatory alleles in 76 samples, sensitivity was 100% (113 of 113 known alleles; Table 13). The higher sensitivity for detection of known mutations reflected manual curation. Of note, substitutions, indels, splicing mutations and gross deletions account for the vast majority (96%) of annotated mutations

In FIG. 21, the following apply: (A) comparison of 92,128 SNP genotypes by array hybridization with those obtained by target enrichment, SBS and a bioinformatic decision tree in 26 samples. SNPs were called if present in ≧10 uniquely aligning reads, ≧14% of reads and average quality score ≧20. Heterozygotes were identified if present in 14%-86% of reads. TP=SNP called and genotyped correctly. TN=Reference genotype called correctly. FN=SNP genotype undercall. FP=SNP genotype overcall. Accuracy=(TP+TN)/(TP+FN+TN+FP). Sensitivity=TP/(TP+FN). Specificity=TN/(TN+FP). PPV=TP/(TP+FP). NPV=TN/(TN+FN); (B) distribution of allele frequencies of SNP calls by hybrid capture and SBS in 26 samples. Light blue: heterozygotes by array hybridization; (C) receiver operating characteristic (ROC) curve of sensitivity and specificity of SNP genotypes by hybrid capture and SBS in 26 samples (when compared with array-based genotypes). Genomic regions with less than 20× coverage were excluded. Upon varying the number of reads calling the SNP, the area under the curve (AUC) was 0.97; and (D) ROC curve of SNP genotypes by hybrid capture and SBS in 26 samples. Genomic regions with less than 20× coverage were excluded. Upon varying the percent reads calling the SNP, AUC was 0.97.

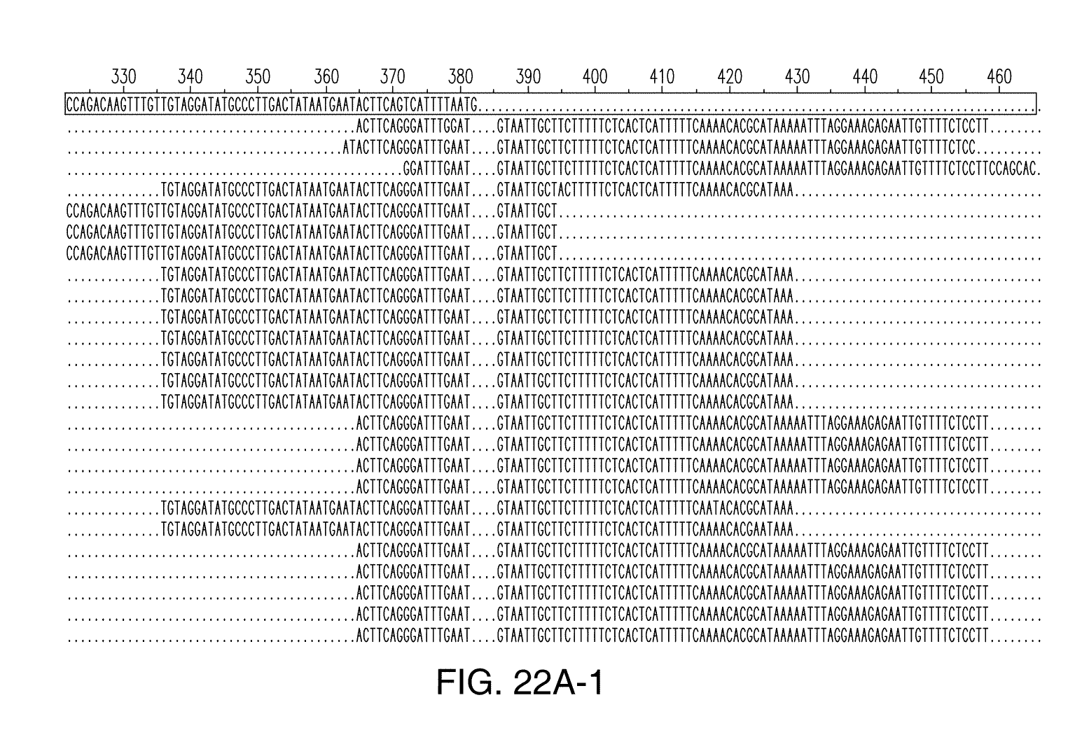

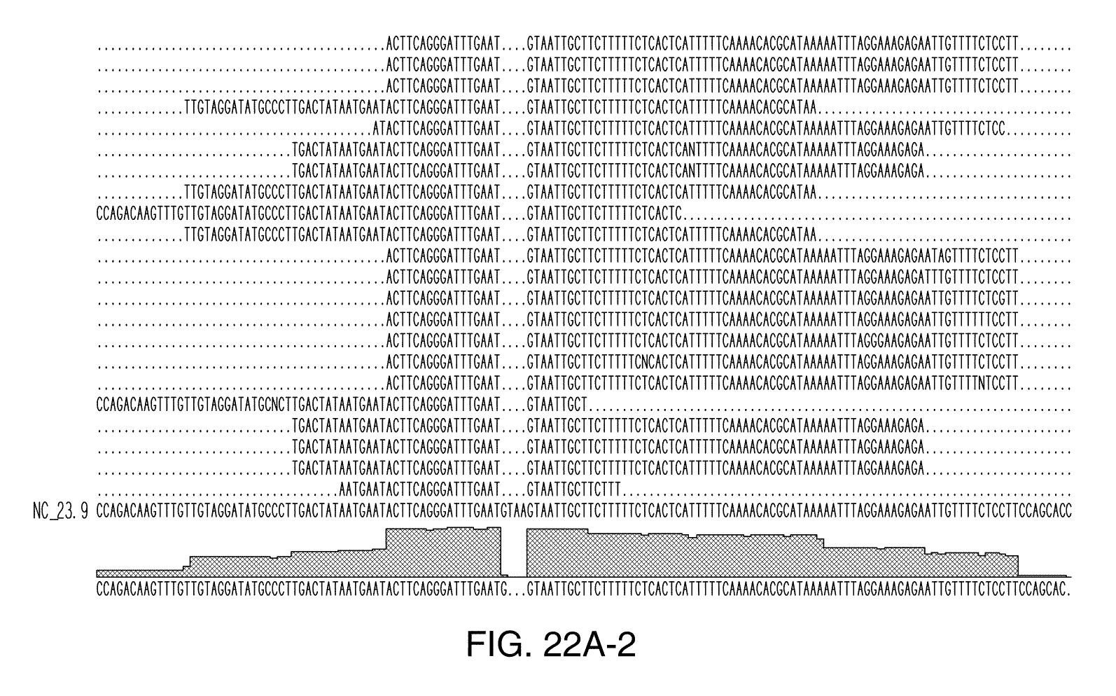

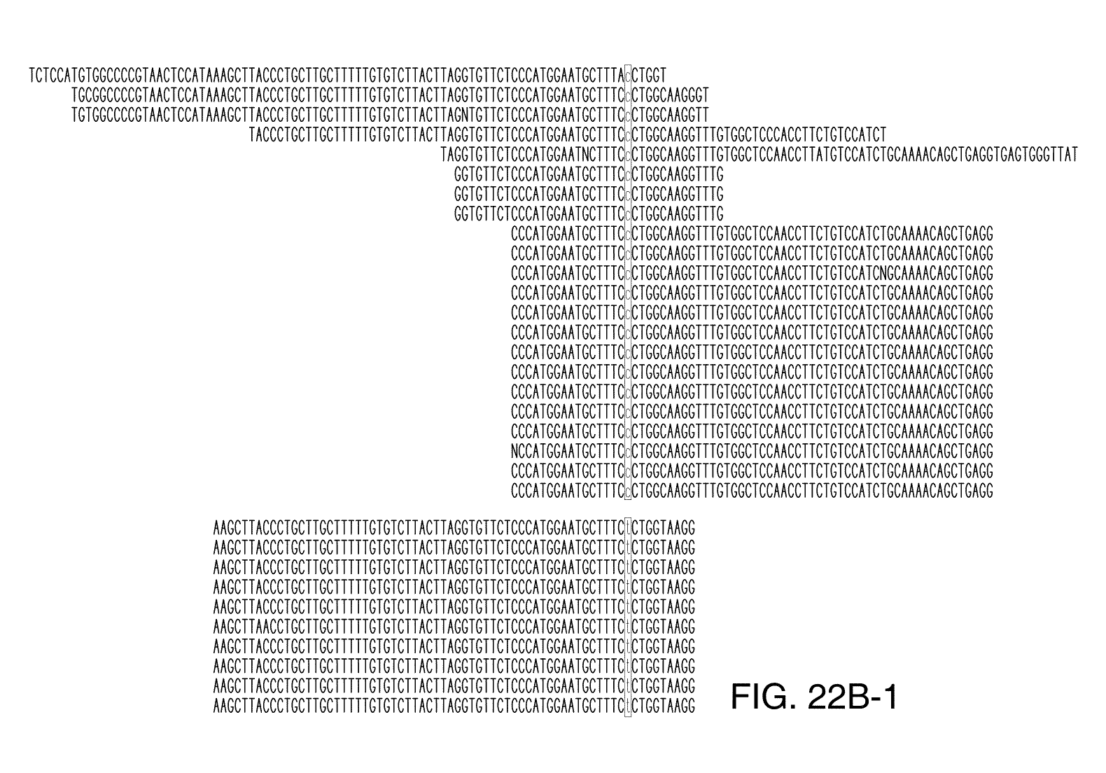

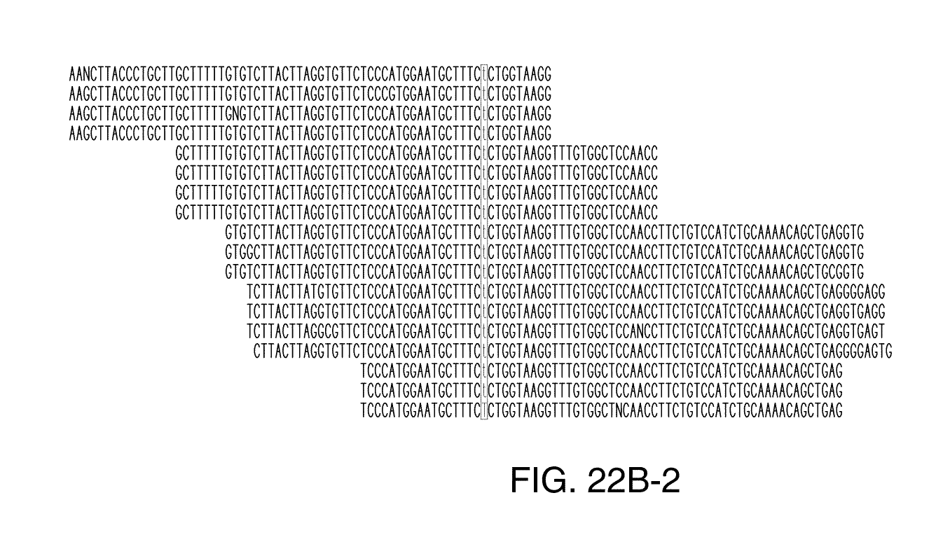

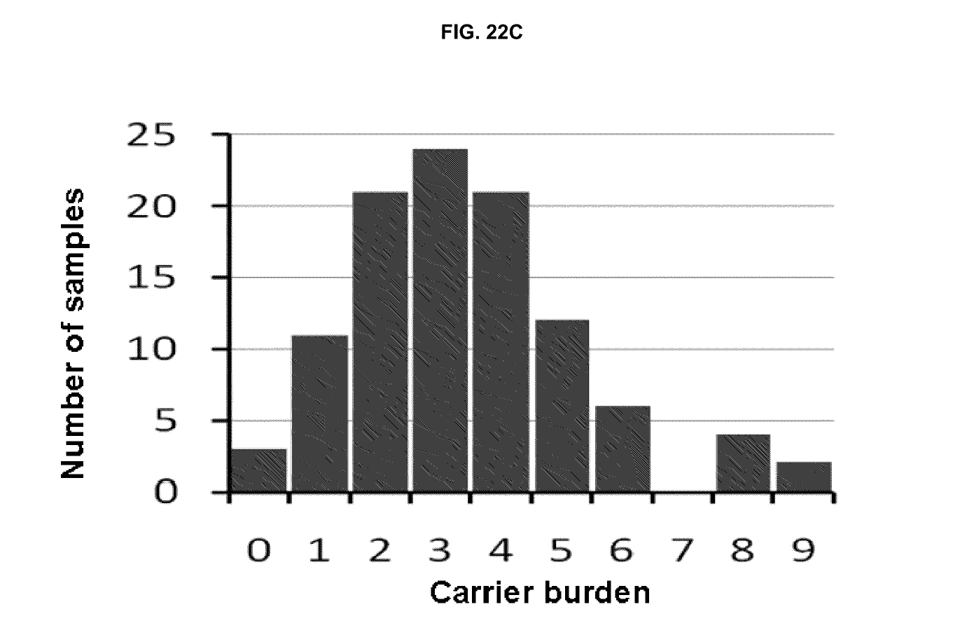

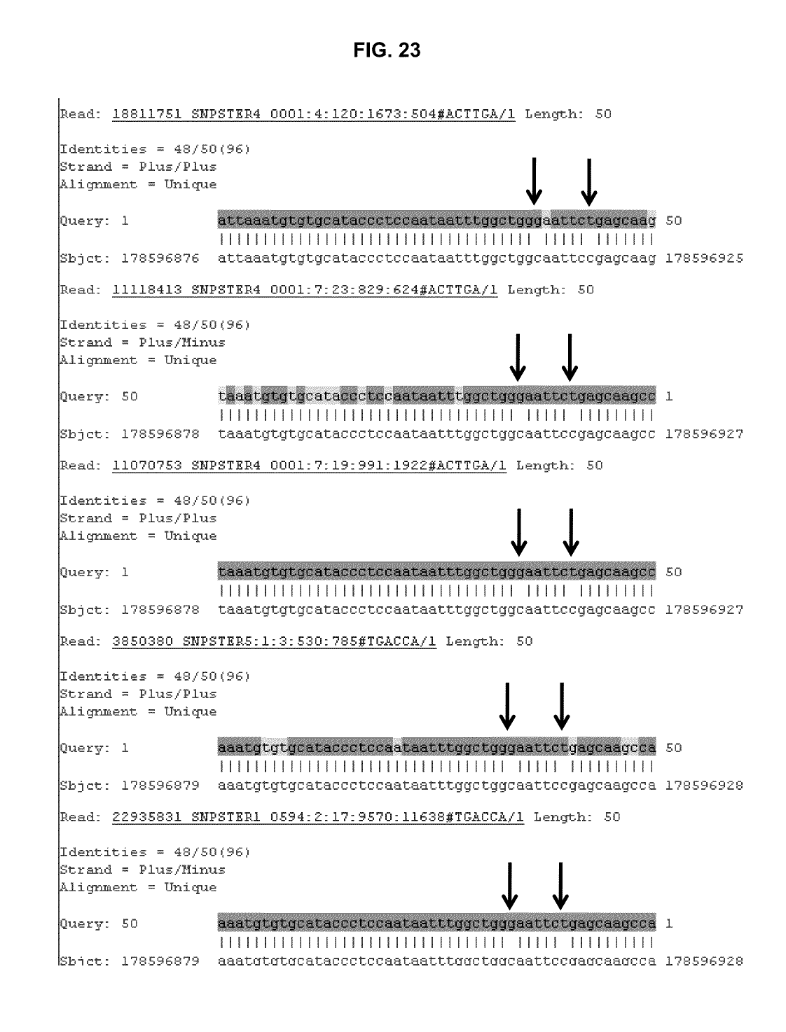

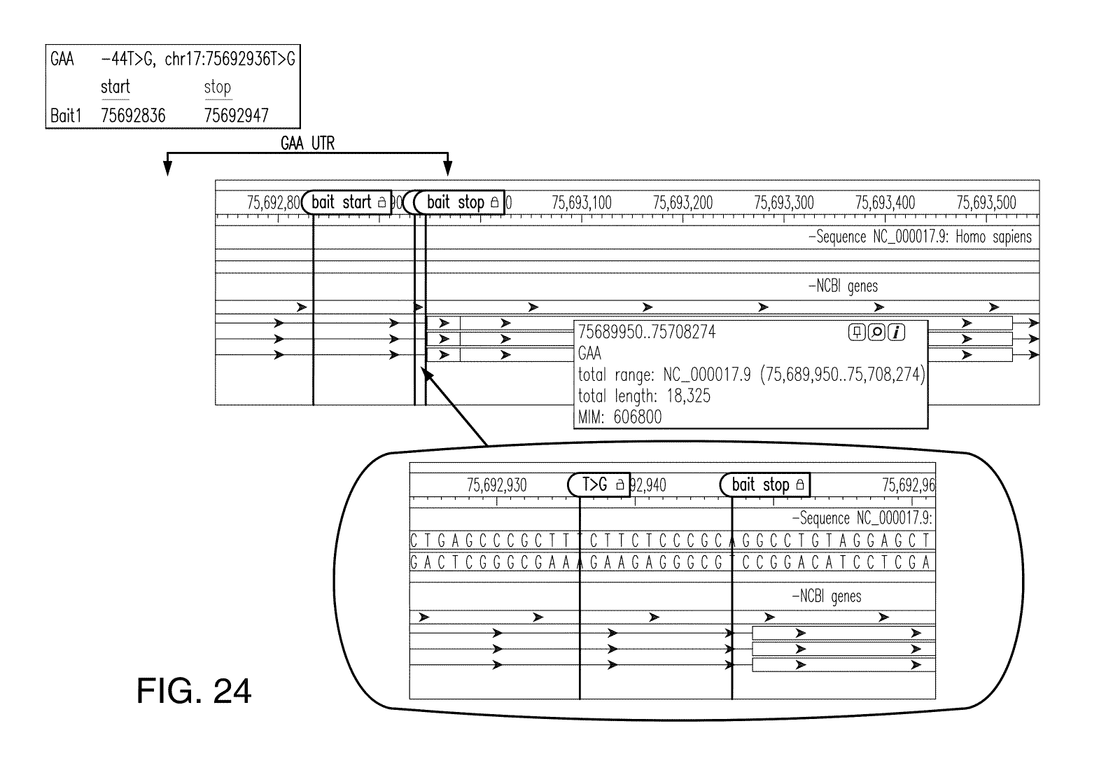

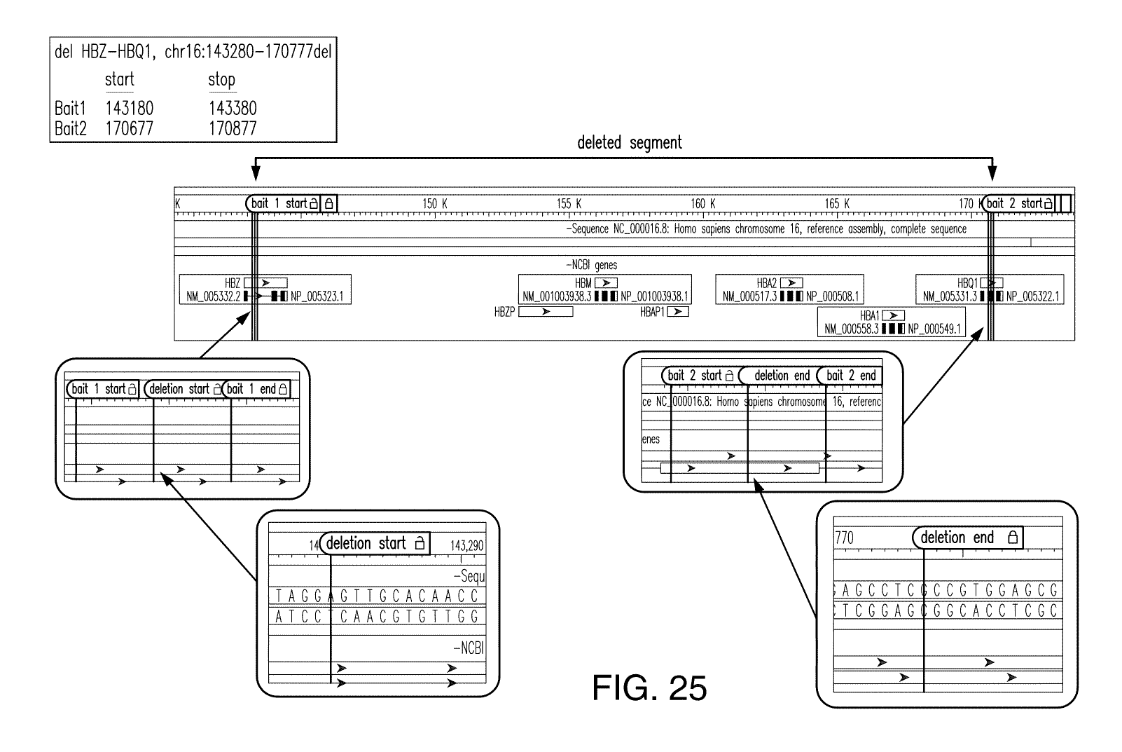

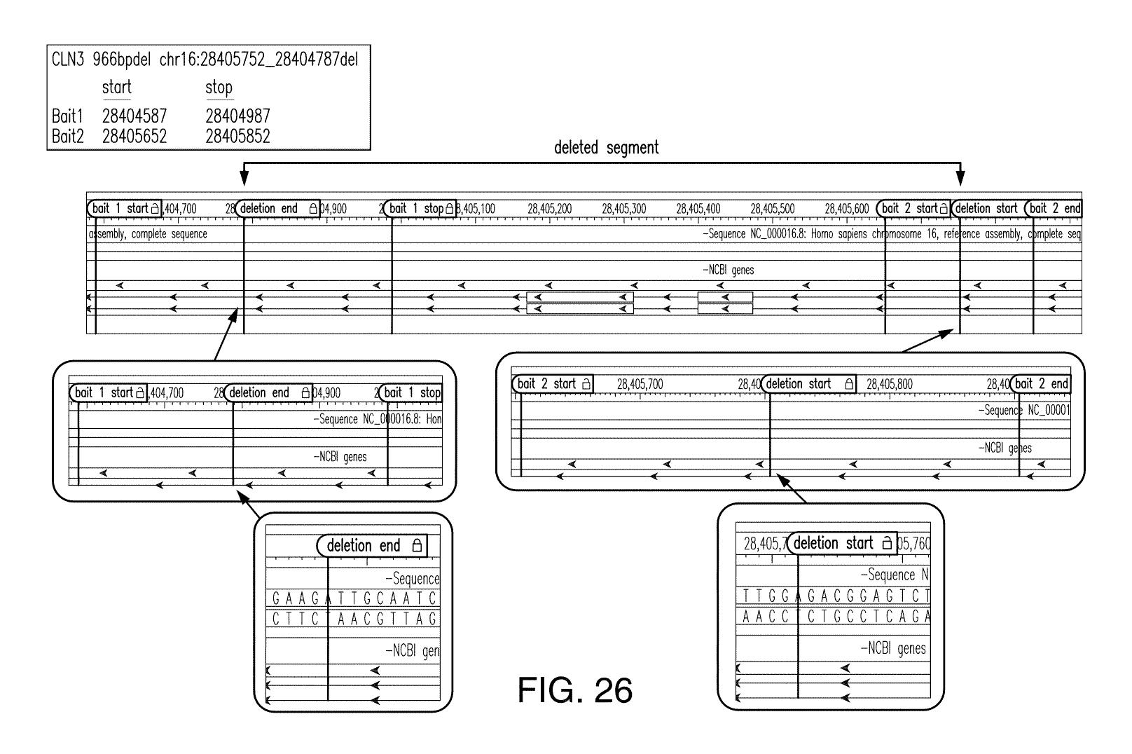

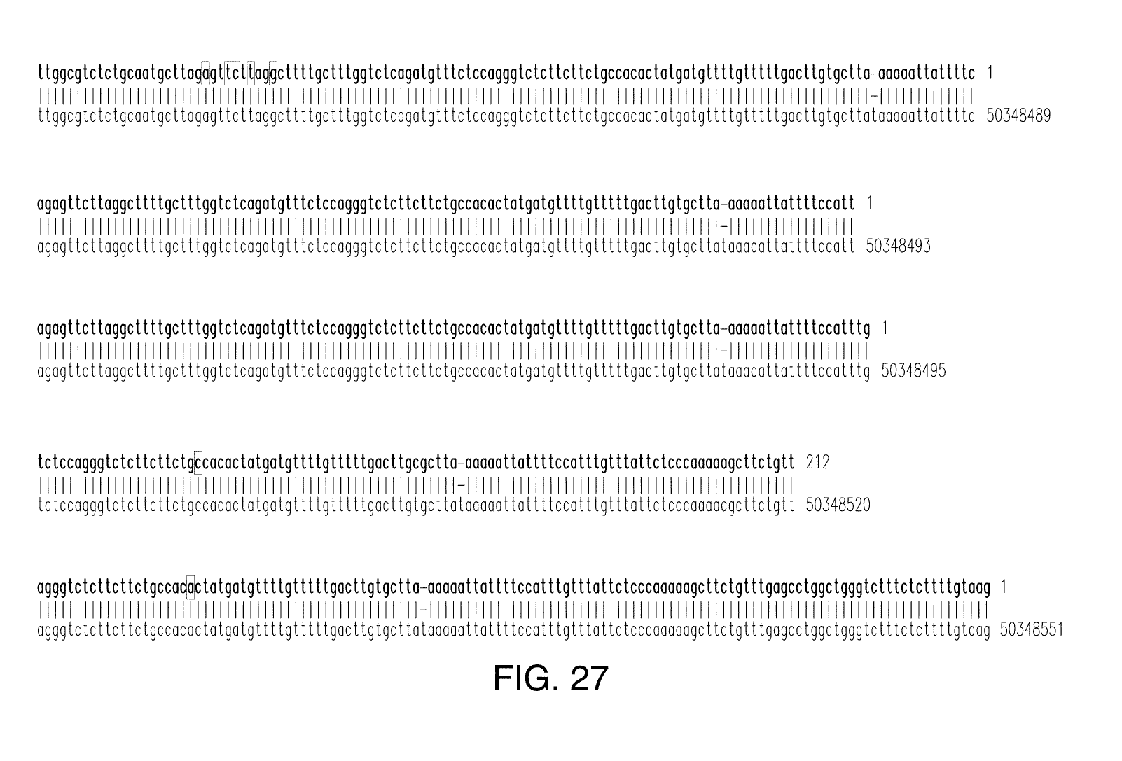

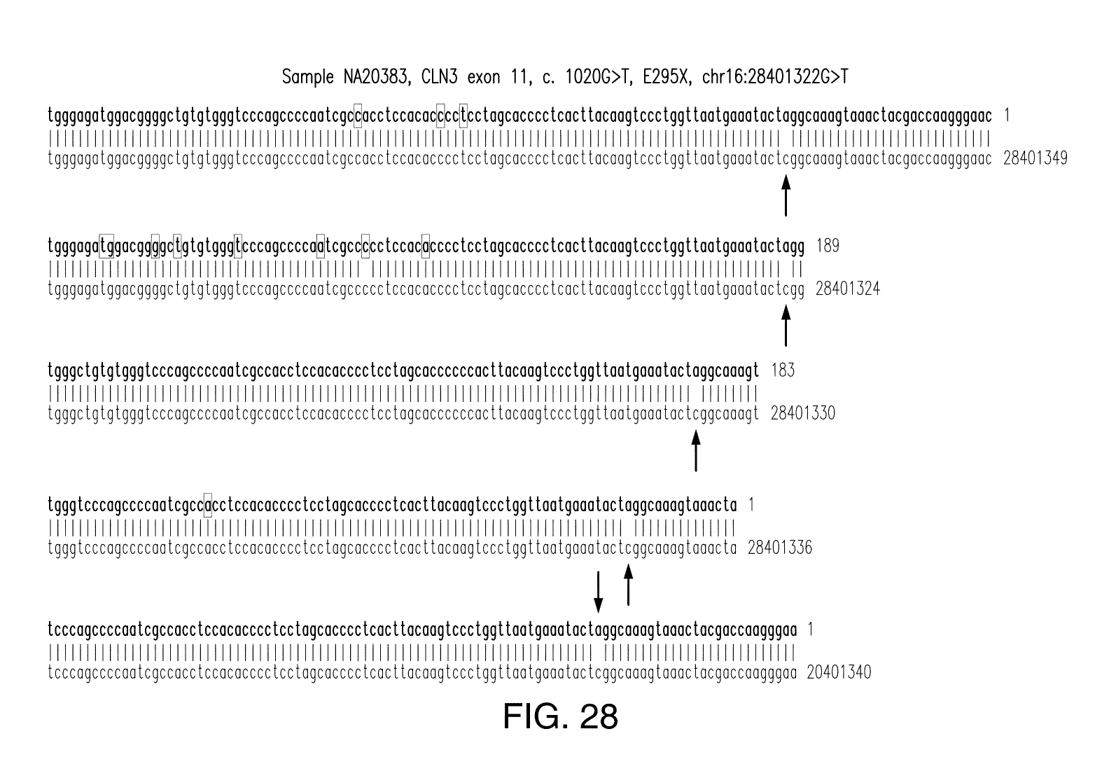

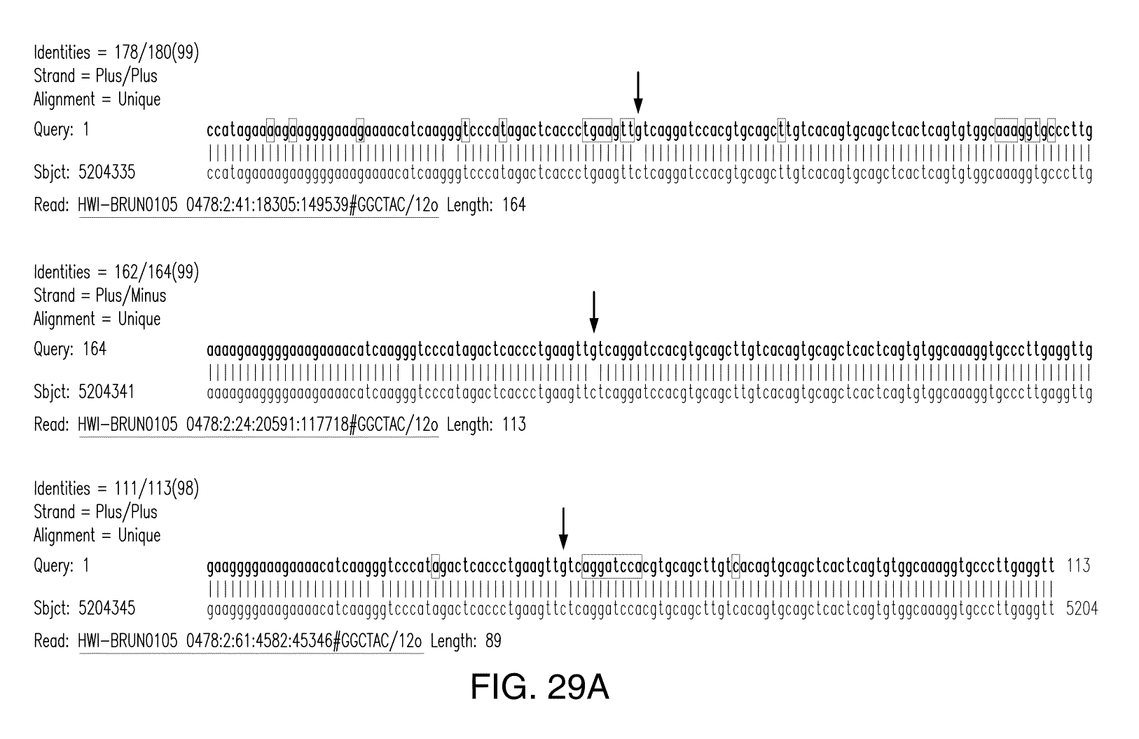

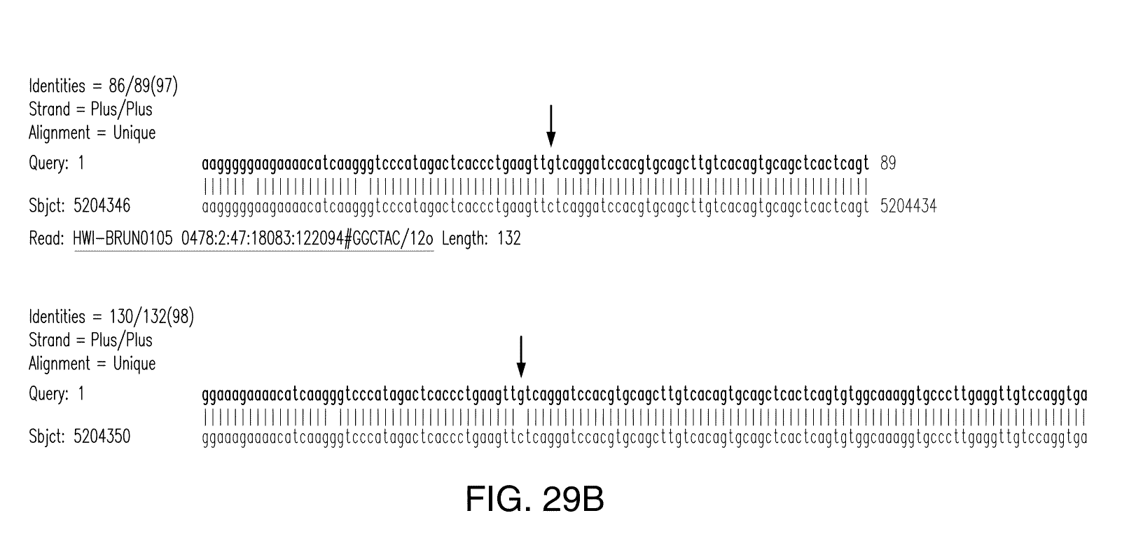

14 of 113 literature-annotated DMs were either incorrect or incomplete (Table 13): Sample NA07092, from a male with XLR Lesch-Nyhan syndrome (LN, OMIM#300322), was characterized as a deletion of HPRT1 exon 8 by cDNA sequencing, but had an explanatory splicing mutation (intron 8, IVS8+1_{—}4delGTAA, chrX:133460381_{—}133460384delGTAA; FIG. 22A). NA01899, also from a male with LN, was characterized as an exon 9 deletion (c.610_{—}626del, H204fs, chrX:133461726_{—}133461742del) by cDNA sequencing³³ but none of 22 reads detected this variant whereas 26 of 27 reads detected a splicing mutation of intron 8 (intron 8, IVS8-2A>T, chrX:133461724A>T). NA09545, from a male with XLR Pelizaeus-Merzbacher disease (PMD, OMIM#312080), characterized as a substitution DM (PLP1 exon 5, c.767C>T, P215S), was found to also feature PLP1 gene duplication (which is reported in 62% of sporadic PMD FIG. 22B). One allele of NA00879, from an affected compound heterozygote (CHT) for AR Sanfilippo syndrome A (mucopolysaccharidosis 111A, OMIM#252900) had been reported as a conservative substitution DM (exon 6, c.734G>A, R245H, chr17:75,802,210G>A), but was a frame-shifting, nucleotide deletion (exon 8, c.1079delC, p.V361fs, chr17:75799276delC in 72 of 164 reads). NA02057, from a female with aspartylglucosaminuria (OMIM#208400), characterized as a CHT, was homozygous for two adjacent substitutions (AGA exon 4, c.482G>A, R161Q, chr4:178596918 G>A and exon 4, c.488G>C, C163S, chr4:178596912 G>C in 38 of 39 reads; FIG. 23), of which C163S had been shown to be the DM. In FIG. 24, the top lines of doublets are Illumina GAIIx 50 nt reads and the bottom lines are NCBI reference genome, build 36.3. Colors represent quality (O) scores of each nucleotide: Red >30; Orange 20-29; and Green 10-19. Reads aligned uniquely to these coordinates. While one allele of NA01712, a CHT with Cockayne syndrome, type B (OMIM#133540), had been characterized by cDNA analysis as a deletion of ERCC6 exon 9 (c.1993_{—}2169del, p. 665_{—}723del, exon 9 del, chr10:50360915_{—}50360739del, no decrease in normalized exon 9 read number was observed despite over 300× coverage (FIG. 20G). 64 of 138 NA01712 reads contained a nucleotide substitution that created a premature stop codon (Q664X, chr10:50360741 C>T). The other allele of NA01712 had been characterized as a deletion within a homopolymeric repeat (exon 17, c.3533delT, Y1179fs, chr10:50348479delT), but instead occurred three bases upstream (exon 17, c.3536delA, Y1179fs, chr10:50348476delA; FIG. 27). NA01464, a CHT for glycogen storage disease, type II (OMIM#232300), which had an undefined second mutation, contained a frame-shifting deletion of GAA (exon 17, c.2544delC, p.K849fs, chr17:75706649delC) in 44 of 117 reads. One allele of NA20383, a CHT for neuronal ceroid lipofuscinosis, type 3, had been characterized as exon 11, c.1020G>A, E295K, chr16:28401322 G>A. Instead, however, 193 of 400 reads called a different, more deleterious mutation at that nucleotide (c.1020G>T, E295X, chr16:28401322 G>T; FIG. 28). One allele of NA04394, a CHT, was annotated as GBA exon 8, c.1208G>C, S403T, chr1:153472676 G>C, but was exon 8, c.1171G>C, p.V391L, chr1:153472713 G>C. NA16643 was annotated as an HBB exon 2, c.306G>T, E102D, chr11:5204392G>T heterozygote, but 23 of 49 reads called c.306G>C, E102D, chr11:5204392 G>C (FIG. 29). Both ERCC4 mutations described in CHT NA03542 were absent in at least 130 aligning reads. However, the current study used DNA from EBV-transformed cell lines, in which somatic hypermutation has been noted. In particular ERCC4, a DNA repair gene, is a likely candidate for somatic mutation. Including these results, the specificity of sequence-based genotyping of substitution, indel, gross deletion and splicing DMs was 100% (97/97).

Also, FIG. 27 shows one end of five reads from NA01712 showing ERCC6 exon 17, c.3536delA, Y1179fs, chr10:50348476del A. 94 of 249 reads contained this deletion DM (CD982624). The top lines of doublets are Illumina HiSeq assembled reads (following assembly of overlapping paired forward and reverse 130 nt reads). The bottom lines are NCBI reference genome, build 36.3. Colors represent quality (Q) scores of each nucleotide: Red >30, Orange 20-29; Green 10-19; and Blue <10. Reads aligned uniquely to these coordinates. The top read was of length 237 nt and matched the minus reference strand at 235 of 237 positions. The second read matched the minus strand at 220 of 221 nt. The third read matched the minus strand at 222 of 223 nt. The fourth read matched the plus strand at 212 of 213 nt. The fifth read matched the minus strand at 238 of 239 nt.

In FIG. 28, 193 of 400 reads contained this substitution DM (CM003663). The top lines of doublets are Illumina HiSeq assembled reads (following assembly of overlapping paired forward and reverse 130 nt reads). The bottom lines are NCBI reference genome, build 36.3. Colors represent quality (Q) scores of each nucleotide: Red >30; Orange 20-29; Green 10-19; and Blue <10. Reads aligned uniquely to these coordinates. The top read was of length 214 nt and matched the minus reference strand at 213 of 214 positions. The second read matched the plus strand at 187 of 189 nt. The third read matched the plus strand at 182 of 183 nt. The fourth read matched the minus strand at 180 of 181 nt. The fifth read matched the minus strand at 188 of 189 nt.

In FIG. 29, one end of five reads from NA16643 showing HBB exon 2, c.306G>C, E102D, chr11:5204392 G>C (Black arrow) is shown. 29 of 43 reads contained this substitution DM. The top lines of doublets are Illumina HiSeq assembled reads (following assembly of overlapping paired forward and reverse 130 nt reads). The bottom lines are NCBI reference genome, build 36.3. Colors represent quality (Q) scores of each nucleotide: Red >30; Orange 20-29; Green 10-19; and Blue <10. Reads aligned uniquely to these coordinates.

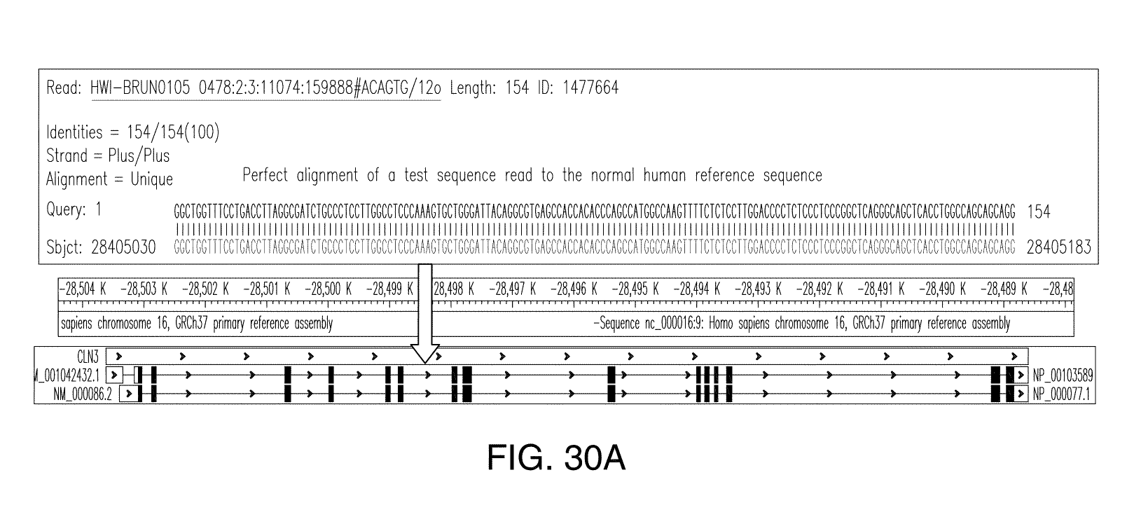

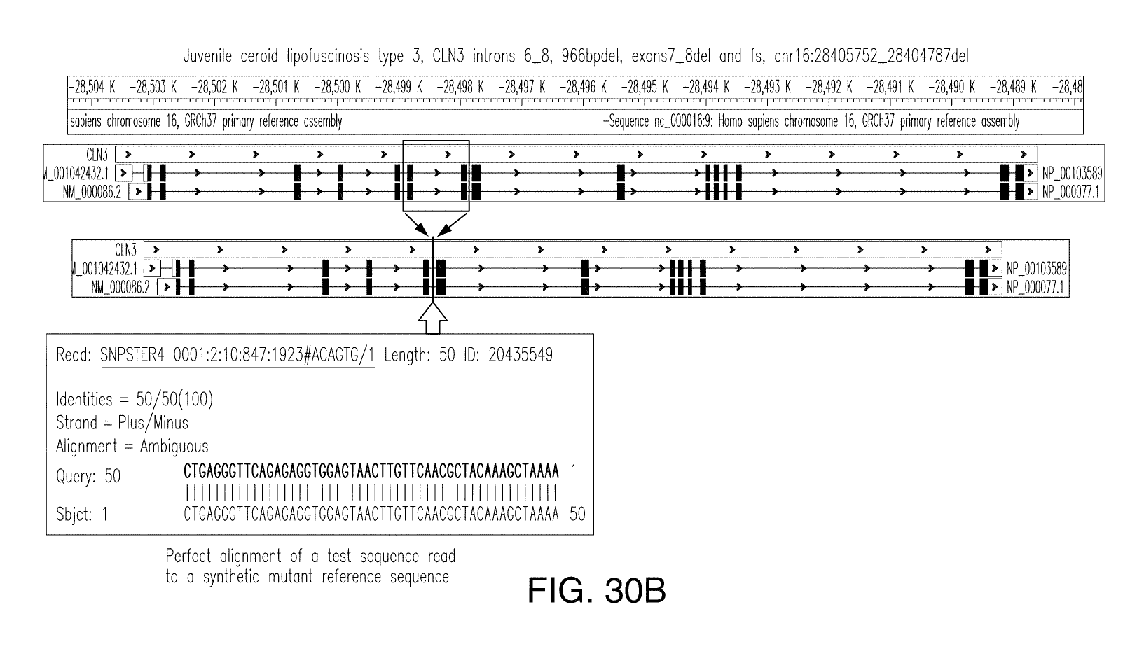

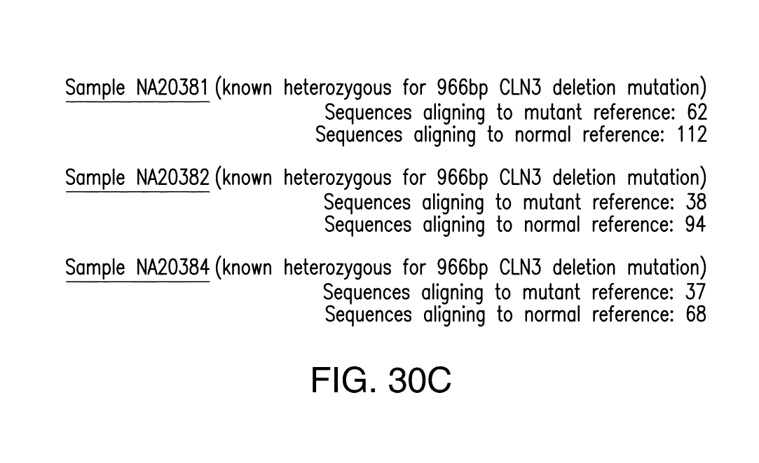

FIG. 30 shows the strategy for detection of a large deletion mutation in a human genomic DNA sample. In (A), the region of human chromosome 16 that contains the Ceroid Lipofuscinosis type 3 (CLN3) gene is shown. In the upper panel, a 154 nucleotide sequence from an individual who is a heterozygote carrier of a 966 nucleotide mutation in CLN3 is shown. The sequence is a normal sequence and aligns perfectly to the reference human genome sequence. In the lower panel, numbers refer to nucleotide positions on human chromosome 16. The CLN3 gene is shown in green, with exons illustrated by vertical green bars and introns by grey arrows illustrating the direction of transcription. In FIG. 30B, the region of human chromosome 16 that contains the Ceroid Lipofuscinosis type 3 (CLN3) gene is shown. A 966 bp region of the chromosome is indicated by a grey box in the upper panel. The middle panel shows the genomic region following deletion of the 966 bp region which includes introns 6,7 and 8 and exons 7 and 8 of CLN3. The lower panel shows perfect alignment of a 50 nucleotide sequence from an individual who is a heterozygote carrier of a 966 nucleotide mutation in CLN3. The sequence is a mutantsequence and aligns perfectly to a synthetic mutant reference sequence. In FIG. 30C, the alignment results from three heterozygote carriers of the CLN3 966 bp deletion is shown. In each case a proportion of sequences aligns to the normal reference and a proportion of sequences aligns to the synthetic mutant sequence, indicating each sample to be heterozygous for the CLN3 deletion.

v. Carrier Burden

Having established sensitivity and specificity, the average carrier burden of severe recessive DMs was assessed. A complication in estimating the true carrier burden was that 74% of “DM” calls were accounted for by 47 substitutions each with incidence of ≧5%. In addition, 20 of these were homozygous in samples unaffected by the corresponding disease, strongly suggesting them to be SNPs. Thus, 24% (61 of 254) literature-cited DMs were adjudged to be common polymorphisms or misannotated, indicating a need for additional experimental verification of DM entries. Novel, putatively deleterious variants (variants in severe pediatric disease genes that create premature stop codons or coding domain frame shifts) were also quantified: 26 heterozygous or hemizygous novel nonsense variants were identified in 104 samples. The average carrier burden was calculated excluding presumed SNPs and one allele in compound heterozygotes and including novel nonsense variants. The average carrier burden of severe recessive substitutions, indels and gross deletion DMs was 3.42 per genome (356 in 104 samples). The carrier burden frequency distribution was unimodal with slight right skewing (FIG. 22C). The range in carrier burden was surprisingly narrow (zero to nine per genome, with a mode of three; FIG. 22C).

As exemplified by cystic fibrosis, the carrier incidence and mutation spectrum of individual recessive disorders vary widely among populations. However, while group sizes were small, no significant differences in total carrier burden were found between Caucasians and other ethnicities nor between males and females. Hierarchical clustering of samples and DMs revealed an apparently random topology, suggesting that targeted population testing is likely to be ineffective (FIG. 22D). Adequacy of hierarchical clustering was attested to by samples from identical twins being nearest neighbors, as were two DMs in linkage disequilibrium.

### 3. Discussion

These results indicate that comprehensive population screening is a technically feasible and cost-effective approach to reduce the incidence of severe childhood recessive diseases and ameliorate resultant suffering. Comprehensive carrier screening by target enrichment, next generation sequencing and bioinformatic analyses was remarkably specific (99.96%). When sequence depth of 2.5 GB per sample was employed, ˜95% sensitivity was attained with hybrid capture. Since enrichment failures with hybrid capture were reproducible, many may be amenable to rescue by individual PCR or probe redesign. Alternatively, micro-droplet PCR should theoretically achieve sensitivity of ˜99%, albeit at higher cost. The cost of consumables was $218 for the hybrid enrichment-based test and $322 for the micro-droplet PCR test. This excluded capital equipment, manpower, sales, marketing and regulatory costs. It also did not account for counseling and other health care provider costs. These aspects—facile interpretation of results, physician and public education, and training of genetic counselors—are anticipated to be the most significant hurdles in implementation of comprehensive carrier screening. Nevertheless, the overall cost of <$1 per test per condition was clearly realistic for 489 severe recessive childhood disease genes. Thus, total cost of carrier testing can be lower than that expended on treatment of severe recessive childhood disorders per US live birth (˜$360). Thus, for example, all prospective mothers (or fathers) in Iceland could be screened at a consumable cost of ˜$6M per generation.

Obstetricians, clinical geneticists and patient advocates vary in opinion regarding the breadth of conditions for which preconception carrier testing should be offered. Parents of affected children, in general, desire testing for all severe childhood conditions, and as soon as possible. Some clinical geneticists prefer incremental expansion of test menus, starting with the five established diseases and indicated subpopulations. The latter also make a case for development of an assortment of panels, each with clinical utility for different populations, akin to the current panel for Ashkenazi populations. The test described herein has minimal incremental cost for additional conditions: A panel for fifty diseases, for example, has a consumable cost of about $180. An alternative suggestion has been to offer a comprehensive test, but with an assortment of subpanels that are unmasked as determined individually by the patient and physician.

Patients and physicians also vary in opinion regarding preconception testing of general populations versus targeted groups. Cost is only one factor in such decisions. Physician and patient confidence are important. For example, cystic fibrosis carrier testing has been undertaken via Canadian high schools for over thirty years, but has not been accepted in the US. This is unfortunate, since of practical and Hippocratic importance is the need to test individuals at preconception physician visits. Sadly, a significant proportion of current genetic screening in the US occurs during pregnancy rather than before conception. Immediate adoption of comprehensive carrier testing is likely by in vitro fertilization clinics, where screening of sperm and oocyte donors has high clinical utility and the relative cost is small. Early adoption is also likely in medical genetics clinics, screening individuals with a family history of inherited disease or other high risk situations. Arguments related to targeted screening based on population-specific disease and allele risk are likely to diminish as experience grows and given minimal incremental cost for inclusion of all severe childhood conditions and all mutations. Although the data reported herein are preliminary, the apparent random topology of mutations in individuals is consistent with many mutations being of recent, rather than ancient, origin. This can argue against arbitrary population-defined disease exclusion.

Traditionally, a two-stage approach has been used for preconception carrier screening, with confirmatory testing of all positive results. However, this has been in a setting of testing individual genes for specific mutations where positive results are rare. The requirement for at least ten high quality reads to substantiate a variant call resulted in a specificity of 99.96% for single nucleotide substitutions (which is the limit of accuracy for the gold standard method employed) and 100% for a relatively small number of known mutations. Confirmatory testing of all single nucleotide substitutions and indels can be unnecessary. Inclusion of controls in each test run and random sample retesting can be prudent. Detection of perfect alignments to mutant reference sequences is robust for identification of gross insertions and deletions. The identification of specific polynucleotide indels was influenced in some sequences by the particular alignment seed, indicate that such events can utilize manual curation and/or confirmatory testing. Given a median carrier burden of 3 per individual, reflex testing of the prospective partner or relatives of a tested individual for specific mutations can be more cost effective than broad screening.

Validation can be conducted. Addressing issues of specificity and false positives are complex when hundreds genes are being sequenced simultaneously. For certain diseases, such as cystic fibrosis, reference sample panels and metrics have been established. For diseases without reference materials, it can be prudent to test as many samples containing known mutations as possible. It is also logical to test examples of all classes of mutations and situations that are anticipated to be potentially problematic, such as mutations within high GC content regions, simple sequence repeats and repetitive elements. It has been suggested that how evaluations of clinical influenced by who develops a test and their motivations (e.g., economic and/or public health). Rigorous validation with reference panels is present.

The average carrier burden of severe recessive substitutions, indels and gross deletion DMs was determined for the first time. In 104 unrelated individuals, it was 3.42 per genome. This agrees with theoretical estimates validity and utility are performed and who pays for such assessments might be of reproductive lethal allele burden. It also concurred with severe childhood recessive carrier burdens obtained by sequencing individual genomes (two substitution DMs in the Quake genome and a monozygotic twin pair, 5 each in the YH and Watson genomes, 4 in the NA07022 genome and 10 in the AK1 genome). A modest increase in the average carrier burden number is anticipated as reference catalogs of disease mutations mature (the estimate reported herein included nonsense but not missense variants of unknown significance) and as the sensitivity of carrier testing approaches 100%. The range in carrier burden was surprisingly narrow (zero to nine per genome), potentially reflecting selective pressure. Given the large variations in SNP burden and incidence of individual disease alleles among populations, it the evaluation of variation in the burden of severe recessive disease mutations among human populations can be determined, as can how population bottlenecks influence the variation.

A remarkable finding was the proportion of literature-annotated DMs that were incorrect, incomplete or common polymorphisms. Differentiation of a common polymorphism from a disease mutation requires genotyping a large number of unaffected individuals. Severe, orphan disease mutations should be uncommon (<<5% incidence) and should not be found in the homozygous state in unaffected individuals. 74% of “DM” calls were accounted for by substitutions with incidences of ≧5%, of which almost one half were homozygous in samples unaffected by the corresponding disease. 14 of 113 literature-annotated DMs were incorrect: Principal errors were incorrect imputation of genomic mutation from cDNA sequencing and of haplotypes from Sanger sequences. An advantage of clonally-derived next-generation single strand sequences is that they maintain phase information for adjacent variants. Thus, substantive side benefits of large-scale carrier testing can be comprehensive allele frequency-based differentiation of polymorphisms and mutations, identification of potentially misannotated DMs, nomination of VUS for experimental validation and mutation frequency determination in populations.

Finally, the technology platform described herein is agnostic with regard to target genes. There are a variety of medical applications for this technology in addition to preconception carrier screening. For example, newborn screening for treatable or preventable Mendelian diseases can allow early diagnosis and institution of treatment while neonates are asymptomatic. Early treatment can have a profound impact on the clinical severity of conditions and could provide a framework for centralized assessment of investigational new treatments before organ decompensation. Given impending identification of novel disease genes by exome and genome resequencing, the number of recessive disease genes is likely to increase substantially over the next several years, requiring expansion of the carrier target set.

In summary, establishment of effective and comprehensive preconception carrier screening and genetic counseling of general populations is anticipated to reduce the incidence of orphan disorders and to improve fetal and neonatal treatment of these diseases.

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

Throughout this application, various publications are referenced. The disclosures of these publications in their entireties are hereby incorporated by reference into this application in order to more fully describe the state of the art to which the methods and systems pertain.

It is apparent to those skilled in the art that various modifications and variations can be made without departing from the scope or spirit. Other embodiments will be apparent to those skilled in the art from consideration of the specification and practices disclosed herein. It is intended that the specification and examples be considered as exemplary only, with a true scope and spirit being indicated by the following claims.

### REFERENCES

1. ACOG Committee on Genetics. ACOG Committee Opinion No. 442: Preconception and prenatal carrier screening for genetic diseases in individuals of Eastern European Jewish descent. Obstet. Gynecol. 114:950-3 (2009).
2. ACOG Committee on Genetics. ACOG committee opinion. No. 338: Screening for fragile X syndrome. Obstet. Gynecol. 107:1483-5 (2006).
3. ACOG Committee on Genetics. ACOG Committee Opinion. Number 325, December 2005. Update on carrier screening for cystic fibrosis. Obstet. Gynecol. 106:1465-8 (2005).
4. Ashley E A, Butte A J, Wheeler M T, Chen R, Klein T E, Dewey F E, Dudley J T, Ormond K E, Pavlovic A, Morgan A A, Pushkarev D, Neff N F, Hudgins L, Gong L, Hodges L M, Berlin D S, Thorn C F, Sangkuhl K, Hebert J M, Woon M, Sagreiya H, Whaley R, Knowles J W, Chou M F, Thakuria J V, Rosenbaum A M, Zaranek A W, Church G M, Greely H T, Quake S R, Altman R B. Clinical assessment incorporating a personal genome. Lancet. 375:1525-35 (2010). PMID: 20435227
5. Baranzini S E, Mudge J, van Velkinburgh J C, Khankhanian P, Khrebtukova I, Miller N A, Zhang L, Farmer A D, Bell C J, Kim R W, May G D, Woodward J E, Caillier S J, McElroy J P, Gomez R, Pando M J, Clendenen L E, Ganusova E E, Schilkey F D, Ramaraj T, Khan O A, Huntley J J, Luo S, Kwok P Y, Wu T D, Schroth G P, Oksenberg J R, Hauser S L, Kingsmore S F. Genome, epigenome and RNA sequences of monozygotic twins discordant for multiple sclerosis. Nature 464:1351-6 (2010).
6. Blanch, L., et al. Molecular defects in Sanfilippo syndrome type A. Hum Mol. Genet. 6:787-91 (1997).
7. Board of Directors of the American College of Medical Genetics. Position Statement on Carrier Testing for Canavan Disease. Jan. 10, 1998. Available at http://www.acmg.net/StaticContent/StaticPages/Canavan.pdf
8. Bobadilla J L, Macek M Jr, Fine J P, Farrell P M. Cystic Fibrosis: A Worldwide Analysis of CFTR Mutations-Correlation With Incidence Data and Application to Screening. Hum Mutat. 19:575-606 (2002). PubMed PMID: 12007216.
9. Castellani, C., et al. Association between carrier screening and incidence of cystic fibrosis. JAMA. 302:2573-9 (2009).
10. Charache S, Jacobson R, Brimhall B, Murphy E A, Hathaway P, Winslow R, Jones R, Rath C, Simkovich J. Hb Potomac (101 Glu replaced by Asp): speculations on placental oxygen transport in carriers of high-affinity hemoglobins. Blood. 51:331-8 (1978).
11. Cleaver J E, Thompson L H, Richardson A S, States J C, A summary of mutations in the UV-sensitive disorders: xeroderma pigmentosum, Cockayne syndrome, and trichothiodystrophy. Hum Mutat. 14:9-22 (1999). PubMed ID: 10447254
12. Cleaver, J. E., Thompson, L. H., Richardson, A. S., States, J.C. A summary of mutations in the UV-sensitive disorders: xeroderma pigmentosum, Cockayne syndrome, and trichothiodystrophy. Hum Mutat. 14:9-22 (1999). PubMed PMID: 10447254.
13. Costa, T., Scriver, C. R., Childs, B. The effect of Mendelian disease on human health: a measurement. Am J Med. Genet. 21:231-42 (1985).
14. Dahl F, Stenberg J, Fredriksson S, Welch K, Zhang M, Nilsson M, Bicknell D, Bodmer W F, Davis R W, Ji H. Multigene amplification and massively parallel sequencing for cancer mutation discovery. Proc Natl Acad Sci USA. 104:9387-92 (2007). PMID: 17517648
15. Drmanac R, Sparks A B, Callow M J, Halpern A L, Burns N L, Kermani B G, Carnevali P, Nazarenko I, Nilsen G B, Yeung G, Dahl F, Fernandez A, Staker B, Pant K P, Baccash J, Borcherding A P, Brownley A, Cedeno R, Chen L, Chernikoff D, Cheung A, Chirita R, Curson B, Ebert J C, Hacker C R, Hartlage R, Hauser B, Huang S, Jiang Y, Karpinchyk V, Koenig M, Kong C, Landers T, Le C, Liu J, McBride C E, Morenzoni M, Morey R E, Mutch K, Perazich H, Perry K, Peters B A, Peterson J, Pethiyagoda C L, Pothuraju K, Richter C, Rosenbaum A M, Roy S, Shafto J, Sharanhovich U, Shannon K W, Sheppy C G, Sun M, Thakuria J V, Tran A, Vu D, Zaranek A W, Wu X, Drmanac S, Oliphant A R, Banyai W C, Martin B, Ballinger D G, Church G M, Reid C A. Human genome sequencing using unchained base reads on self-assembling DNA nanoarrays. Science. 327:78-81 (2010). PubMed PMID: 19892942.
16. Epeldegui, M., et al. Infection of human B cells with Epstein-Barr virus results in the expression of somatic hypermutation-inducing molecules and in the accrual of oncogene mutations. Mol Immunol. 44:934-42 (2007).
17. Fisher K J, Aronson N N Jr. Characterization of the mutation responsible for aspartylglucosaminuria in three Finnish patients. Amino acid substitution Cys163-Ser abolishes the activity of lysosomal glycosylasparaginase and its conversion into subunits. J Biol. Chem. 266:12105-13 (1991).
18. Gencic, S., Abuelo, D., Ambler, M., Hudson, L. D. Pelizaeus-Merzbacher disease: an X-linked neurologic disorder of myelin metabolism with a novel mutation in the gene encoding proteolipid protein. Am J Hum Genet. 45:435-42 (1989).
19. GeneTests: Medical Genetics Information Resource (database online) Copyright, University of Washington, Seattle. 1993-2010. Available at http://www.genetests.org Accessed Aug. 11, 2010.
20. Gibbs, R. A., et al. Identification of mutations leading to the Lesch-Nyhan syndrome by automated direct DNA sequencing of in vitro amplified cDNA. Proc Natl Acad Sci U S A. 86:1919-23 (1989).
21. Gnirke A, Melnikov A, Maguire J, Rogov P, LeProust E M, Brockman W, Fennell T, Giannoukos G, Fisher S, Russ C, Gabriel S, Jaffe D B, Lander E S, Nusbaum C. Solution hybrid selection with ultra-long oligonucleotides for massively parallel targeted sequencing. Nat. Biotechnol. 27:182-9 (2009).
22. Grody, W. W., Cutting, G. R., Klinger, K. W., Richards, C. S., Watson, M. S., Desnick, R. J. Laboratory standards and guidelines for population based cystic fibrosis carrier screening. Genetics in Medicine. 3:149-54 (2001).
23. Hale, J. E., Parad, R. B., Comeau, A. M. Newborn screening showing decreasing incidence of cystic fibrosis. N Engl J Med. 358:973-974 (2008).
24. Hedges, D. J., et al. Exome sequencing of a multigenerational human pedigree. PLoS One. 4:e8232 (2009). PubMed PMID: 20011588.
25. Hu H, Wrogemann K, Kalscheuer V, Tzschach A, Richard H, Haas S A, Menzel C, Bienek M, Froyen G, Raynaud M, Von Bokhoven H, Chelly J, Ropers H, Chen W. Mutation screening in 86 known X-linked mental retardation genes by droplet-based multiplex PCR and massive parallel sequencing. HUGO J. (2010).
26. Kaback M M. Hexosaminidase A Deficiency. In: Pagon R A, Bird T C, Dolan C R, Stephens K, editors. GeneReviews [Internet]. Seattle (WA): University of Washington, Seattle; 1993-. 1999 Mar 11 [updated 2006 May 19].PMID: 20301397
27. Kaback M M. Population-based genetic screening for reproductive counseling: the Tay-Sachs disease model. Eur J Pediatr. 159 Suppl 3:S192-5 (2000). PMID: 11216898
28. Kim J I, Ju Y S, Park H, Kim S, Lee S, Yi J H, Mudge J, Miller N A, Hong D, Bell C J, Kim H S, Chung I S, Lee W C, Lee J S, Seo S H, Yun J Y, Woo H N, Lee H, Suh D, Lee S, Kim H J, Yavartanoo M, Kwak M, Zheng Y, Lee M K, Park H, Kim J Y, Gokcumen O, Mills R E, Zaranek A W, Thakuria J, Wu X, Kim R W, Huntley J J, Luo S, Schroth G P, Wu T D, Kim H, Yang K S, Park W Y, Kim H, Church G M, Lee C, Kingsmore S F, Seo J S. A highly-annotated, whole-genome sequence of a Korean Individual. Nature 460:1011-5 (2009).
29. Kronn, D., Jansen, V., Ostrer, H. Carrier screening for cystic fibrosis, Gaucher disease, and Tay-Sachs disease in the Ashkenazi Jewish population: the first 1000 cases at New York University Medical Center, New York, N.Y. Arch Intern Med. 158:777-81 (1998).
30. Kumar, P., Radhakrishnan, J., Chowdhary, M. A., Giampietro, P. F. Prevalence and patterns of presentation of genetic disorders in a pediatric emergency department. Mayo Clin Proc. 76:777-83 (2001).
31. McConkey, E. Human Genetics: The Molecular Revolution. Sudbury, Mass.: Jones & Bartlett, 1^{st} Edition (1993).
32. McKernan K J, Peckham H E, Costa G L, McLaughlin S F, Fu Y, Tsung E F, Clouser C R, Duncan C, Ichikawa J K, Lee C C, Zhang Z, Ranade S S, Dimalanta E T, Hyland F C, Sokolsky T D, Zhang L, Sheridan A, Fu H, Hendrickson C L, Li B, Kotler L, Stuart J R, Malek J A, Manning J M, Antipova A A, Perez D S, Moore M P, Hayashibara K C, Lyons M R, Beaudoin R E, Coleman B E, Laptewicz M W, Sannicandro A E, Rhodes M D, Gottimukkala R K, Yang S, Bafna V, Bashir A, MacBride A, Alkan C, Kidd J M, Eichler E E, Reese M G, De La Vega F M, Blanchard A P. Sequence and structural variation in a human genome uncovered by short-read, massively parallel ligation sequencing using two-base encoding. Genome Res. 19:1527-41 (2009). PMID:19546169
33. Miller N A, Kingsmore S F, Farmer A, Langley R J, Mudge J, Crow J A, Gonzalez A J, Schilkey F D, Kim R J, van Velkinburgh J, May G D, Black C F, Myers M K, Utsey J P, Frost N S, Sugarbaker D J, Bueno R, Gullans S R, Baxter S M, Day S W, Retzel E F. Management of high-throughput DNA sequencing projects: Alpheus. J. Comput. Sci. Syst. Biol. 1, 132-148 (2008).
34. Mimault, C., et al. Proteolipoprotein gene analysis in 82 patients with sporadic Pelizaeus-Merzbacher Disease: duplications, the major cause of the disease, originate more frequently in male germ cells, but point mutations do not. The Clinical European Network on Brain Dysmyelinating Disease. Am J Hum Genet. 65:360-9 (1999).
35. Mitchell, J. J., Capua, A., Clow, C., Scriver, C. R. Twenty-year outcome analysis of genetic screening programs for Tay-Sachs and beta-thalassemia disease carriers in high schools. Am J Hum Genet. 59:793-8 (1996).
36. Myrianthopoulos N C, Aronson S M. Population dynamics of Tay-Sachs disease. I. Reproductive fitness and selection. Am J Hum Genet. 18:313-27 (1966). PMID: 5945951.
37. Ng, S. B., et al. Exome sequencing identifies the cause of a mendelian disorder. Nat. Genet. 42:30-5 (2010). PubMed PMID: 19915526.
38. Ng, S. B., et al. Targeted capture and massively parallel sequencing of 12 human exomes. Nature 461:272-6 (2009). PubMed PMID: 19684571.
39. Online Mendelian Inheritance in Man, OMIM™. McKusick-Nathans Institute of Genetic Medicine, Johns Hopkins University (Baltimore, Md.). Available at http://www.ncbi.nlm.nih.gov/omim/Accessed Aug. 11, 2010.
40. Population-based carrier screening for single gene disorders: lessons learned and new opportunities. Feb. 6-7, 2008. Available at http://www.genome.gov/27026048
41. Roach, J. C., et al. Analysis of genetic inheritance in a family quartet by whole-genome sequencing. Science 328:636-9 (2010). PubMed PMID: 20220176.
42. Srinivasan B S, Evans E A, Flannick J, Patterson A S, Chang C C, Pham T, Young S, Kaushal A, Lee J, Jacobson J L, Patrizio P. A universal carrier test for the long tail of Mendelian disease. Reprod Biomed Online. Aug. 21 (2010). PMID: 20729146
43. Stenson, P. D., et al. The Human Gene Mutation Database: 2008 update. Genome Med. 1:13 (2009).
44. Sugarbaker D J, Richards W G, Gordon G J, Dong L, De Rienzo A, Maulik G, Glickman J N, Chirieac L R, Hartman M L, Taillon B E, Du L, Bouffard P, Kingsmore S F, Miller N A, Farmer A D, Jensen R V, Gullans S R, Bueno R. Transcriptome sequencing of malignant pleural mesothelioma tumors. Proc. Natl. Acad. Sci. USA 105, 3521-3526 (2008).
45. Summerer D, Hevroni D, Jain A, Oldenburger O, Parker J, Caruso A, Stahler C F, Stahler P F, Beier M. A flexible and fully integrated system for amplification, detection and genotyping of genomic DNA targets based on microfluidic oligonucleotide arrays. N. Biotechnol. 27, 149-155 (2010). PMID: 20359559
46. Tewhey R, Warner J B, Nakano M, Libby B, Medkova M, David P H, Kotsopoulos S K, Samuels M L, Hutchison J B, Larson J W, Topol E J, Weiner M P, Harismendy O, Olson J, Link D R, Frazer K A. Microdroplet-based PCR enrichment for large-scale targeted sequencing. Nat. Biotechnol. 27:1025-31 (2009).
47. Wang J, Wang W, Li R, Li Y, Tian G, Goodman L, Fan W, Zhang J, Li J, Zhang J, Guo Y, Feng B, Li H, Lu Y, Fang X, Liang H, Du Z, Li D, Zhao Y, Hu Y, Yang Z, Zheng H, Hellmann I, Inouye M, Pool J, Yi X, Zhao J, Duan J, Zhou Y, Qin J, Ma L, Li G, Yang Z, Zhang G, Yang B, Yu C, Liang F, Li W, Li S, Li D, Ni P, Ruan J, Li Q, Zhu H, Liu D, Lu Z, Li N, Guo G, Zhang J, Ye J, Fang L, Hao Q, Chen Q, Liang Y, Su Y, San A, Ping C, Yang S, Chen F, Li L, Zhou K, Zheng H, Ren Y, Yang L, Gao Y, Yang G, Li Z, Feng X, Kristiansen K, Wong G K, Nielsen R, Durbin R, Bolund L, Zhang X, Li S, Yang H, Wang J. The diploid genome sequence of an Asian individual. Nature. 456:60-5 (2008). PubMed PMID: 18987735.
48. Watson, M. S., Lloyd-Puryear, M. A., Mann, M. Y., Rinaldo, P., Howell, R. R. Newborn screening main report. Genetics in Medicine. 8:12 S-252S (2006).
49. Wheeler D A, Srinivasan M, Egholm M, Shen Y, Chen L, McGuire A, He W, Chen Y J, Makhijani V, Roth G T, Gomes X, Tartaro K, Niazi F, Turcotte C L, Irzyk G P, Lupski J R, Chinault C, Song X Z, Liu Y, Yuan Y, Nazareth L, Qin X, Muzny D M, Margulies M, Weinstock G M, Gibbs R A, Rothberg J M. Nature. 452:872-6 (2008). PubMed PMID: 18421352
50. Wigderson M, Firon N, Horowitz Z, Wilder S, Frishberg Y, Reiner O, Horowitz M. Characterization of mutations in Gaucher patients by cDNA cloning. Am J Hum Genet. 44:365-77 (1989). PubMed ID: 2464926
51. Zhong N, Martiniuk F, Tzall S, Hirschhorn R, Identification of a missense mutation in one allele of a patient with Pompe disease, and use of endonuclease digestion of PCR-amplified RNA to demonstrate lack of mRNA expression from the second allele. Am J Hum Genet. 49:635-45 (1991). PubMed ID: 1652892
52. Zhong N, Wisniewski K E, Kaczmarski A L, Ju W, Xu W M, Xu W W, Mclendon L, Liu B, Kaczmarski W, Sklower Brooks S S, Brown W T, Molecular screening of Batten disease: identification of a missense mutation (E295K) in the CLN3 gene. Hum Genet. 102:57-62 (1998).
53. Emery AEH (ed) Duchenne muscular dystrophy. No 15 in: Motulsky A G, Harper P S, Bobrow M, Scriver C(eds) Oxford monographs on medical genetics. Oxford University Press, Oxford. 1988.

What is claimed is:

1. A method of identifying an inherited trait in a subject, comprising
collecting a biological sample from the subject comprising a DNA sequence;
aligning the DNA sequence to normal reference sequences and mutant reference sequences;
counting sequence reads aligning to normal references;
counting sequence reads aligning to mutant references; and
determining a ratio of aligned reads, wherein if the ratio is greater than a first value the inherited trait is a homozygous mutant, if the ratio is between a second value and a third value the inherited trait is a heterozygous mutant, and if the ratio is less than a fourth value the inherited trait is a homozygous wild-type.

2. The method of claim 1, wherein the first value is 86%, the second value is 18%, the third value is 14%, and the fourth value is 14%.

3. A method of determining a status of a subject with regard to an inherited trait comprising:
assaying an element from a sample from a subject to determine a subject DNA sequence;
comparing the subject DNA sequence to a set of DNA sequences by alignment wherein the set of DNA sequences comprises both normal, unaffected DNA sequences and mutated, variant DNA sequences;
identifying the element as being associated with the inherited trait by the coincidence of the element and the trait within the sample by determining a ratio of the subject DNA sequence that matches normal, unaffected DNA sequences and the mutated variant DNA sequences.

4. The method of claim 3, wherein the status can be unaffected and non-carrier of the inherited trait and/or unaffected and carrier of the inherited trait and/or affected and carrier of the inherited trait.

5. The method of claim 3, wherein the status of a predetermined number of inherited traits is determined from a sample.

6. The method of claim 3, wherein the inherited trait is a disease, a phenotype, a quantitative or qualitative trait, a disease outcome, a disease susceptibility, a biomarker, or a syndrome.

7. The method of claim 6, wherein the inherited trait is recessive, dominant, partially dominant, X-linked, complex, or multi-factorial.

8. The method of claim 3, where the sample is a blood sample, buccal smear, or biopsy.

9. The method of claim 3, wherein the assay of the element is performed by DNA sequencing.

10. The method of claim 3, wherein the element is a genetic element, wherein the type of element is a type of genetic variant, wherein the type of genetic element is a regulatory variant, a non-regulatory variant, a non-synonymous variant, a synonymous variant, a frameshift variant, a variant with a severity score at, above, or below a threshold value, a genetic rearrangement, a copy number variant, a gene expression difference, an alternative splice isoform, a deletion variant, an insertion variant, a transversion variant, an inversion variant, a translocation, or a combination thereof.

11. The method of claim 3, wherein the mutated, variant DNA sequences comprise a plurality of known variant sequences.

12. The method of claim 3, wherein the alignment is performed under conditions requiring a perfect match between the subject DNA sequence and a member of the reference set of DNA sequences.

13. The method of claim 3, wherein the element is a genetic element, wherein an amount of the element is a number of copies of the genetic element, the magnitude of expression of the genetic element, or a combination thereof.

14. The method of claim 3, wherein the comparing the subject DNA sequence to a set of DNA sequences by alignment comprises one or more of BLAST alignments, megaBLAST alignments, GMAP alignments, BLAT alignments, MAQ alignments, gSNAP alignments, or a combination thereof.

15. The method of claim 3, wherein the reference set of DNA sequences comprises one or more of the RefSeq genome database, the transcriptome database, the GENBANK database, or a combination thereof.

16. The method of claim 10, wherein the variant genetic elements are filtered to select candidate variant genetic elements, wherein the variant genetic elements are filtered by selecting variant genetic elements that are present in a threshold number of sequence reads, are present in a threshold percentage of sequence reads, are represented by a threshold read quality score at variant base(s), are present in sequence reads from in a threshold number of strands, are aligned at a threshold level to a reference sequence, are aligned at a threshold level to a second reference sequence, are variants that do not have biasing features bases within a threshold number of nucleotides of the variant, or a combination thereof.

17. A system for identifying an inherited trait in a subject, comprising
a memory; and
a processor, coupled to the memory, configured for,
collecting a biological sample from the subject comprising a DNA sequence,
aligning the DNA sequence to normal reference sequences and mutant reference sequences,
counting sequence reads aligning to normal references,
counting sequence reads aligning to mutant references, and
determining a ratio of aligned reads, wherein if the ratio is greater than a first value the inherited trait is a homozygous mutant, if the ratio is between a second value and a third value the inherited trait is a heterozygous mutant, and if the ratio is less than a fourth value the inherited trait is a homozygous wild-type.

18. The system of claim 17, wherein the first value is 86%, the second value is 18%, the third value is 14%, and the fourth value is 14%.

19. The system of claim 17, wherein the comparing aligning the DNA sequence to normal reference sequences and mutant reference sequences comprises one or more of BLAST alignments, megaBLAST alignments, GMAP alignments, BLAT alignments, MAQ alignments, gSNAP alignments, or a combination thereof.

20. The system of claim 17, wherein the normal reference sequences and mutant reference sequences comprises one or more of the RefSeq genome database, the transcriptome database, the GENBANK database, or a combination thereof.


SEQUENCE LISTING (174 sequences)

SEQ ID NO: 1 - DNA, 50 bp, Artificial Sequence
  Description of Artificial Sequence; note = synthetic construct
ccgcaggctcaatgaatcgaatgaatgtgaacttcttcatctgtgaaaaa

SEQ ID NO: 2 - DNA, 50 bp, Artificial Sequence
  Description of Artificial Sequence; note = synthetic construct
cagcaggctcaatgaatcgaatgaatgtgaacttcttcatctgtgaaaaa

SEQ ID NO: 3 - DNA, 60 bp, Artificial Sequence
  Description of Artificial Sequence; note = synthetic construct
ccgccccctagtctcccacccttccctccccgtagtgaccaattcctatctcttccctct

SEQ ID NO: 4 - DNA, 60 bp, Artificial Sequence; identical to SEQ ID NO: 3
  Description of Artificial Sequence; note = synthetic construct

SEQ ID NO: 5 - DNA, 50 bp, Artificial Sequence; identical to SEQ ID NO: 1
  Description of Artificial Sequence; note = synthetic construct

SEQ ID NO: 6 - DNA, 50 bp, Artificial Sequence; identical to SEQ ID NO: 1
  Description of Artificial Sequence; note = synthetic construct

SEQ ID NO: 7 - DNA, 1077 bp, Artificial Sequence
  Description of Artificial Sequence; note = synthetic construct
cgccgcccacgcagcagggacagcaccaggcaagtgggaattgccaccctcctcctcctcctttctccttccaacccccggccaccgtccatcctgccttagtgggtagcgccggaaaccccttcccctgcggggtgtgcccttgatgcctgcagcgggggccgtgtggccggaggtctccgggagtccccacgcaccgccagggaagcattcgctgggtccagaggttaaacgaagaggcctccctgcgccggctgcttgttcctgtgtgccgctgtcgtgatgctggggagcgctgagactcgcaggcgggacttctgaactgctggggagtcggggggcaggcagacagcgcggacggtgggcaccggcccggccgccaccactcgctcacaatctggccacttgggaagaaaacgtctattttttccccttctctgcatcacttttttggtttttgttctttttattcttttattttttaaacccatgatcttttttcctgtgtccaagtgactgtgttgcaggcggcccggctctggcagggactggtggggacgcggggagcggcccaggcccctgccccgccgggctcagcctcccatgcgctcgcgcttgcctgtgtcccgggcttgtctgtgaagtgggcgtgaagatcgttgccaccttccaacctacctcacaggggtgttgtggggacaccatgatctctggattgttcatgtcgttgtgctgcgccgggagccaccgccctccggagacagggcactcccctacgaccctagcgcctccgccctccgcggcccctctcctctcttcctgctctgtccctccttctccatcagggagcagcgtgacttcagcgagtcccgcaagcacctggctagacagttaacaagcacgtccttccagcctgagccagcgcaggtttgggagggggcttcggccccccccacggtgttccagcccctcctctcttccgccccctagtctcccacccttccctccccgtaggcccaattcctatctcttccctctccgcacgctcaatgaatcgaatgaatgtgaacttcttca

SEQ ID NO: 8 - DNA, 108 bp, Artificial Sequence
  Description of Artificial Sequence; note = synthetic construct
ccaccaaccggatgacaagaaaaaaacagaggcttttgctttcttgaatatgaagatcaccaaacagctgccccgtaaaagtgctgtttgtacgcaaccttgccaata

SEQ ID NO: 9 - DNA, 115 bp, Artificial Sequence
  Description of Artificial Sequence; note = synthetic construct
ccaccaaccggatgacaagaaaaaaaacaggagttttgctttcttgaatatgaagatcacaaaacagctgccccccctaaggtaaaagtgctgtttgtacgcaaccttgccaata

SEQ ID NO: 10 - DNA, 76 bp, Artificial Sequence
  Description of Artificial Sequence; note = synthetic construct
gttctcccatggaatgctttccctggcaaggtttgtggctccaaccttctgtccatctgcaaaacagctgagggga

SEQ ID NO: 11 - DNA, 76 bp, Artificial Sequence; identical to SEQ ID NO: 10
  Description of Artificial Sequence; note = synthetic construct

SEQ ID NO: 12 - DNA, 68 bp, Artificial Sequence
  Description of Artificial Sequence; note = synthetic construct
cccatggaatgctttccctggcaaggtttgtggctccaaccttctgtccatctgcaaaacagctgagg

SEQ ID NO: 13 - DNA, 76 bp, Artificial Sequence; identical to SEQ ID NO: 10
  Description of Artificial Sequence; note = synthetic construct

SEQ ID NO: 14 - DNA, 46 bp, Artificial Sequence
  Description of Artificial Sequence; note = synthetic construct
gttctcccatggaatgctttctctggcaaggtttgtggctccaacc

SEQ ID NO: 15 - DNA, 76 bp, Artificial Sequence; identical to SEQ ID NO: 10
  Description of Artificial Sequence; note = synthetic construct

SEQ ID NO: 16 - DNA, 76 bp, Artificial Sequence
  Description of Artificial Sequence; note = synthetic construct
gttctcccatggaatgctttctctggcaaggtttgtggctccaaccttctgtccatctgcaaaacagctgagggga

SEQ ID NO: 17 - DNA, 69 bp, Artificial Sequence
  Description of Artificial Sequence; note = synthetic construct
gtgaatttctggatttttttttatagcatgtttgtgtcattagtgaaactggaaaagcaaaatacaaag

SEQ ID NO: 18 - DNA, 52 bp, Artificial Sequence
  Description of Artificial Sequence; note = synthetic construct
gtgaatttctggatttttttttatagtgaaactggaaaagcaaaatacaaag

SEQ ID NO: 19 - DNA, 50 bp, Artificial Sequence
  Description of Artificial Sequence; note = synthetic construct
ctttttttattttttccatataagatggagacggtcttttcttgtgagtc

SEQ ID NO: 20 - DNA, 55 bp, Artificial Sequence
  Description of Artificial Sequence; note = synthetic construct
ctttttttattttttccatataagataagatggagacggtcttttcttgtgagtc

SEQ ID NO: 21 - DNA, 61 bp, Artificial Sequence
  Description of Artificial Sequence; note = synthetic construct
ccagacaagtttgttgtaggatatgcccttgactataatgaatacttcagtcattttaatg

SEQ ID NO: 22 - DNA, 88 bp, Artificial Sequence
  Description of Artificial Sequence; note = synthetic construct
acttcagggatttggatgtaattgcttctttttctcactcatttttcaaaacacgcataaaaatttaggaaagagaattgttttctcc

SEQ ID NO: 23 - DNA, 90 bp, Artificial Sequence
  Description of Artificial Sequence; note = synthetic construct
atacttcatggatttgaatgtaattgcttctttttctcactcatttttcaaaacacgcataaaaatttaggaaagagaattgttttctcc

SEQ ID NO: 24 - DNA, 90 bp, Artificial Sequence
  Description of Artificial Sequence; note = synthetic construct
ggatttgaatgtaattgcttctttttctcactcatttttcaaaacacgcataaaaatttaggaaagagaattgttttctccttccagcac

SEQ ID NO: 25 - DNA, 90 bp, Artificial Sequence
  Description of Artificial Sequence; note = synthetic construct
tgtaggatatgcccttgactataatgaatacttcagggatttgaatgtaattgctactttttctcactcatttttcaaaacacgcataaa

SEQ ID NO: 26 - DNA, 69 bp, Artificial Sequence
  Description of Artificial Sequence; note = synthetic construct
ccagacaagtttgttgtaggatatgcccttgactataatgaatacttcagggatttgaatgtaattgct

SEQ ID NO: 27 - DNA, 69 bp, Artificial Sequence; identical to SEQ ID NO: 26
  Description of Artificial Sequence; note = synthetic construct

SEQ ID NO: 28 - DNA, 69 bp, Artificial Sequence; identical to SEQ ID NO: 26
  Description of Artificial Sequence; note = synthetic construct

SEQ ID NO: 29 - DNA, 90 bp, Artificial Sequence
  Description of Artificial Sequence; note = synthetic construct
tgtaggatatgcccttgactataatgaatacttcagggatttgaatgtaattgcttctttttctcactcatttttcaaaacacgcataaa

SEQ ID NO: 30 - DNA, 90 bp, Artificial Sequence; identical to SEQ ID NO: 29
  Description of Artificial Sequence; note = synthetic construct

SEQ ID NO: 31 - DNA, 90 bp, Artificial Sequence; identical to SEQ ID NO: 29
  Description of Artificial Sequence; note = synthetic construct

SEQ ID NO: 32 - DNA, 90 bp, Artificial Sequence; identical to SEQ ID NO: 29
  Description of Artificial Sequence; note = synthetic construct

SEQ ID NO: 33 - DNA, 90 bp, Artificial Sequence; identical to SEQ ID NO: 29
  Description of Artificial Sequence; note = synthetic construct

SEQ ID NO: 34 - DNA, 90 bp, Artificial Sequence; identical to SEQ ID NO: 29
  Description of Artificial Sequence; note = synthetic construct

SEQ ID NO: 35 - DNA, 90 bp, Artificial Sequence; identical to SEQ ID NO: 29
  Description of Artificial Sequence; note = synthetic construct

SEQ ID NO: 36 - DNA, 90 bp, Artificial Sequence
  Description of Artificial Sequence; note = synthetic construct
acttcagggatttgaatgtaattgcttctttttctcactcatttttcaaaacacgcataaaaatttaggaaagagaattgttttctcctt

SEQ ID NO: 37 - DNA, 90 bp, Artificial Sequence; identical to SEQ ID NO: 36
  Description of Artificial Sequence; note = synthetic construct

SEQ ID NO: 38 - DNA, 90 bp, Artificial Sequence; identical to SEQ ID NO: 36
  Description of Artificial Sequence; note = synthetic construct

SEQ ID NO: 39 - DNA, 90 bp, Artificial Sequence; identical to SEQ ID NO: 36
  Description of Artificial Sequence; note = synthetic construct

SEQ ID NO: 40 - DNA, 90 bp, Artificial Sequence
  Description of Artificial Sequence; note = synthetic construct
tgtaggatatgcccttgactataatgaatacttcagggatttgaatgtaattgcttctttttctcactcatttttcaatacacgcataaa

SEQ ID NO: 41 - DNA, 90 bp, Artificial Sequence
  Description of Artificial Sequence; note = synthetic construct
tgtaggatatgcccttgactataatgaatacttcagggatttgaatgtaattgcttctttttctcactcatttttcaaaacacgaataaa

SEQ ID NO: 42 - DNA, 90 bp, Artificial Sequence; identical to SEQ ID NO: 36
  Description of Artificial Sequence; note = synthetic construct

SEQ ID NO: 43 - DNA, 90 bp, Artificial Sequence; identical to SEQ ID NO: 36
  Description of Artificial Sequence; note = synthetic construct

SEQ ID NO: 44 - DNA, 90 bp, Artificial Sequence; identical to SEQ ID NO: 36
  Description of Artificial Sequence; note = synthetic construct

SEQ ID NO: 45 - DNA, 90 bp, Artificial Sequence; identical to SEQ ID NO: 36
  Description of Artificial Sequence; note = synthetic construct

SEQ ID NO: 46 - DNA, 90 bp, Artificial Sequence; identical to SEQ ID NO: 36
  Description of Artificial Sequence; note = synthetic construct

SEQ ID NO: 47 - DNA, 90 bp, Artificial Sequence; identical to SEQ ID NO: 36
  Description of Artificial Sequence; note = synthetic construct

SEQ ID NO: 48 - DNA, 90 bp, Artificial Sequence; identical to SEQ ID NO: 36
  Description of Artificial Sequence; note = synthetic construct

SEQ ID NO: 49 - DNA, 90 bp, Artificial Sequence; identical to SEQ ID NO: 36
  Description of Artificial Sequence; note = synthetic construct

SEQ ID NO: 50 - DNA, 90 bp, Artificial Sequence
  Description of Artificial Sequence; note = synthetic construct
ttgtaggatatgcccttgactataatgaatacttcagggatttgaatgtaattgcttctttttctcactcatttttcaaaacacgcataa

SEQ ID NO: 51 - DNA, 90 bp, Artificial Sequence
  Description of Artificial Sequence; note = synthetic construct
atacttcagggatttgaatgtaattgcttctttttctcactcatttttcaaaacacgcataaaaatttaggaaagagaattgttttctcc

SEQ ID NO: 52 - DNA, 90 bp, Artificial Sequence
  Description of Artificial Sequence; note = synthetic construct
tgactataatgaatacttcagggatttgaatgtaattgcttctttttctcactcanttttcaaaacacgcataaaaatttaggaaagaga

SEQ ID NO: 53 - DNA, 90 bp, Artificial Sequence; identical to SEQ ID NO: 52
  Description of Artificial Sequence; note = synthetic construct

SEQ ID NO: 54 - DNA, 90 bp, Artificial Sequence; identical to SEQ ID NO: 50
  Description of Artificial Sequence; note = synthetic construct

SEQ ID NO: 55 - DNA, 83 bp, Artificial Sequence
  Description of Artificial Sequence; note = synthetic construct
ccagacaagtttgttgtaggatatgcccttgactataatgaatacttcagggatttgaatgtaattgcttctttttctcactc

SEQ ID NO: 56 - DNA, 90 bp, Artificial Sequence; identical to SEQ ID NO: 50
  Description of Artificial Sequence; note = synthetic construct

SEQ ID NO: 57 - DNA, 90 bp, Artificial Sequence
  Description of Artificial Sequence; note = synthetic construct
acttcagggatttgaatgtaattgcttctttttctcactcatttttcaaaacacgcataaaaatttaggaaagagaatagttttctcctt

SEQ ID NO: 58 - DNA, 90 bp, Artificial Sequence
  Description of Artificial Sequence; note = synthetic construct
acttcagggatttgaatgtaattgcttctttttctcactcatttttcaaaacacgcataaaaatttaggaaagagatttgttttctcctt

SEQ ID NO: 59 - DNA, 90 bp, Artificial Sequence
  Description of Artificial Sequence; note = synthetic construct
acttcagggatttgaatgtaattgcttctttttctcactcatttttcaaaacacgcataaaaatttaggaaagagaattgttttctcgtt

SEQ ID NO: 60 - DNA, 90 bp, Artificial Sequence
  Description of Artificial Sequence; note = synthetic construct
acttcagggatttgaatgtaattgcttctttttctcactcatttttcaaaacacgcataaaaatttaggaaagagaattgttttttcctt

SEQ ID NO: 61 - DNA, 90 bp, Artificial Sequence
  Description of Artificial Sequence; note = synthetic construct
acttcagggatttgaatgtaattgcttctttttctcactcatttttcaaaacacgcataaaaatttagggaagagaattgttttctcctt

SEQ ID NO: 62 - DNA, 90 bp, Artificial Sequence; identical to SEQ ID NO: 36
  Description of Artificial Sequence; note = synthetic construct

SEQ ID NO: 63 - DNA, 90 bp, Artificial Sequence
  Description of Artificial Sequence; note = synthetic construct
acttcagggatttgaatgtaattgcttctttttctcactcatttttcaaaacacgcataaaaatttaggaaagagaattgttttntcctt

SEQ ID NO: 64 - DNA, 70 bp, Artificial Sequence
  Description of Artificial Sequence; note = synthetic construct
ccaggacaagtttgttgtaggatatgcncttgactataatgaatacttcagggatttgaatgtaattgct

SEQ ID NO: 65 - DNA, 90 bp, Artificial Sequence
  Description of Artificial Sequence; note = synthetic construct
tgactataatgaatacttcagggatttgaatgtaattgcttctttttctcactcatttttcaaaacacgcataaaaatttaggaaagaga

SEQ ID NO: 66 - DNA, 90 bp, Artificial Sequence; identical to SEQ ID NO: 65
  Description of Artificial Sequence; note = synthetic construct

SEQ ID NO: 67 - DNA, 90 bp, Artificial Sequence; identical to SEQ ID NO: 65
  Description of Artificial Sequence; note = synthetic construct

SEQ ID NO: 68 - DNA, 38 bp, Artificial Sequence
  Description of Artificial Sequence; note = synthetic construct
aatgaatacttcagggatttgaatgtaattgcttcttt

SEQ ID NO: 69 - DNA, 145 bp, Artificial Sequence
  Description of Artificial Sequence; note = synthetic construct
ccagacaagtttgttgtaggatatgcccttgactataatgaatacttcagggatttgaatgtaagtaattgcttctttttctcactcatttttcaaaacacgcataaaaatttaggaaagagaattgttttctccttccagcacc

SEQ ID NO: 70 - DNA, 141 bp, Artificial Sequence
  Description of Artificial Sequence; note = synthetic construct
ccagacaagtttgttgtaggatatgcccttgactataatgaatacttcagggatttgaatggtaattgcttctttttctcactcatttttcaaaacacgcataaaaatttaggaaagagaattgttttctccttccagcac

SEQ ID NO: 71 - DNA, 87 bp, Artificial Sequence
  Description of Artificial Sequence; note = synthetic construct
tctccatgtggccccgtaactccataaagcttaccctgcttgctttttgtcttacttaggtgttctcccatggaatgcttacctggt

SEQ ID NO: 72 - DNA, 90 bp, Artificial Sequence
  Description of Artificial Sequence; note = synthetic construct
tgcggccccgtaactccataaagcttaccctgcttgctttttgtgtcttacttaggtgttctcccatggaatgctttccctggcaagggt

SEQ ID NO: 73 - DNA, 90 bp, Artificial Sequence
  Description of Artificial Sequence; note = synthetic construct
tgtggccccgtaactccataaagcttaccctgcttgctttttgtgtcttacttacntgttctcccatggaatgctttccctggcaaggtt

SEQ ID NO: 74 - DNA, 88 bp, Artificial Sequence
  Description of Artificial Sequence; note = synthetic construct
taccctgcttgctttttgtgtcttacttaggtgttctcccatggaatgcttccctggcaaggttgtggctcccaccttctctccatct

SEQ ID NO: 75 - DNA, 89 bp, Artificial Sequence
  Description of Artificial Sequence; note = synthetic construct
taggtgttctcccatggaatnctttccctggcaaggtttgtggctccaaccttatgtccatctgcaaaacagcgaggtgagtgggttat

SEQ ID NO: 76 - DNA, 38 bp, Artificial Sequence
  Description of Artificial Sequence; note = synthetic construct
ggtgttctcccatggaatggtttccctggcaaggtttg

SEQ ID NO: 77 - DNA, 38 bp, Artificial Sequence
  Description of Artificial Sequence; note = synthetic construct
ggtgttctcccatggaatgctttccctggcaaggtttg

SEQ ID NO: 78 - DNA, 38 bp, Artificial Sequence; identical to SEQ ID NO: 77
  Description of Artificial Sequence; note = synthetic construct

SEQ ID NO: 79 - DNA, 67 bp, Artificial Sequence
  Description of Artificial Sequence; note = synthetic construct
cccatggaatgctttccctggcaaggttgtggctccaaccttctgtccatctgcaaaacagctgagg

SEQ ID NO: 80 - DNA, 68 bp, Artificial Sequence
  Description of Artificial Sequence; note = synthetic construct
cccatggaatgctttccctggcaaggtttgtggctccaaccttctgtccatgtgcaaaacaggtgagg

SEQ ID NO: 81 - DNA, 68 bp, Artificial Sequence
  Description of Artificial Sequence; note = synthetic construct
cccatggaatgctttccctggcaaggtttgtggctccaaccttctgtccatcngcaaaacaggtgagg

SEQ ID NO: 82 - DNA, 67 bp, Artificial Sequence
  Description of Artificial Sequence; note = synthetic construct
cccatggaatgctttccctggcaaggtttgtggtccaaccttctgtccatctgcaaaacagctgagg

SEQ ID NO: 83 - DNA, 68 bp, Artificial Sequence
  Description of Artificial Sequence; note = synthetic construct
cccatggaatgctttccctggcaaggtttgtggctccaaccttctctccatctgcaaaacagctgagg

SEQ ID NO: 84 - DNA, 68 bp, Artificial Sequence; identical to SEQ ID NO: 12
  Description of Artificial Sequence; note = synthetic construct

SEQ ID NO: 85 - DNA, 68 bp, Artificial Sequence; identical to SEQ ID NO: 12
  Description of Artificial Sequence; note = synthetic construct

SEQ ID NO: 86 - DNA, 68 bp, Artificial Sequence; identical to SEQ ID NO: 12
  Description of Artificial Sequence; note = synthetic construct

SEQ ID NO: 87 - DNA, 68 bp, Artificial Sequence; identical to SEQ ID NO: 12
  Description of Artificial Sequence; note = synthetic construct

SEQ ID NO: 88 - DNA, 68 bp, Artificial Sequence
  Description of Artificial Sequence; note = synthetic construct
cccatggaatggtttccctggcaaggtttgtggctccaaccttctgtccatctgcaaaacagctgagg

SEQ ID NO: 89 - DNA, 68 bp, Artificial Sequence; identical to SEQ ID NO: 88
  Description of Artificial Sequence; note = synthetic construct

SEQ ID NO: 90 - DNA, 69 bp, Artificial Sequence
  Description of Artificial Sequence; note = synthetic construct
nccatggaatgctttccctgggcaaggtttgtgggtccaaccttctgtccatctgcaaaacagctgagg

SEQ ID NO: 91 - DNA, 68 bp, Artificial Sequence
  Description of Artificial Sequence; note = synthetic construct
cccatggaatggtttccctgggaaggtttgtggctggaaccttctgtccatctgcaaaacagctgagg

SEQ ID NO: 92 - DNA, 68 bp, Artificial Sequence
  Description of Artificial Sequence; note = synthetic construct
cccatggaatggtttccctggcaaggtttgtggctccaaccttgtgtccatctgcaaaacagctgagg

SEQ ID NO: 93 - DNA, 68 bp, Artificial Sequence
  Description of Artificial Sequence; note = synthetic construct
aagcttaccctgcttgctttttgtgtcttacttaggtgttctcccatggaatgctttccctggcaagg

SEQ ID NO: 94 - DNA, 68 bp, Artificial Sequence; identical to SEQ ID NO: 93
  Description of Artificial Sequence; note = synthetic construct

SEQ ID NO: 95 - DNA, 68 bp, Artificial Sequence; identical to SEQ ID NO: 93
  Description of Artificial Sequence; note = synthetic construct

SEQ ID NO: 96 - DNA, 68 bp, Artificial Sequence; identical to SEQ ID NO: 93
  Description of Artificial Sequence; note = synthetic construct

SEQ ID NO: 97 - DNA, 68 bp, Artificial Sequence; identical to SEQ ID NO: 93
  Description of Artificial Sequence; note = synthetic construct

SEQ ID NO: 98 - DNA, 68 bp, Artificial Sequence
  Description of Artificial Sequence; note = synthetic construct
aagcttaacctgcttgctttttgtgtcttacttaggtgttctcccatggaatgctttccctggcaagg

SEQ ID NO: 99 - DNA, 68 bp, Artificial Sequence; identical to SEQ ID NO: 93
  Description of Artificial Sequence; note = synthetic construct

SEQ ID NO: 100 - DNA, 68 bp, Artificial Sequence; identical to SEQ ID NO: 93
  Description of Artificial Sequence; note = synthetic construct

SEQ ID NO: 101 - DNA, 68 bp, Artificial Sequence; identical to SEQ ID NO: 93
  Description of Artificial Sequence; note = synthetic construct

SEQ ID NO: 102 - DNA, 68 bp, Artificial Sequence; identical to SEQ ID NO: 93
  Description of Artificial Sequence; note = synthetic construct

SEQ ID NO: 103 - DNA, 69 bp, Artificial Sequence
  Description of Artificial Sequence; note = synthetic construct
aangcttaccctgcttgctttttgtctcttacttaggtgttctcccatggaatgctttccctggcaagg

SEQ ID NO: 104 - DNA, 68 bp, Artificial Sequence
  Description of Artificial Sequence; note = synthetic construct
aagcttaccctgcttgctttttgtctcttacttaggtgttctcccgtggaatgctttccctggcaagg

SEQ ID NO: 105 - DNA, 69 bp, Artificial Sequence
  Description of Artificial Sequence; note = synthetic construct
aagcttaccctgcttgctttttgtgntcttacttaggtgttctcccatggaatgctttccctggcaagg

SEQ ID NO: 106 - DNA, 68 bp, Artificial Sequence; identical to SEQ ID NO: 93
  Description of Artificial Sequence; note = synthetic construct

SEQ ID NO: 107 - DNA, 70 bp, Artificial Sequence
  Description of Artificial Sequence; note = synthetic construct
gctttttgtgtcttacttaggtgtgttctcccatggaatgctttctctggcaagctttgtggctccaacc

SEQ ID NO: 108 - DNA, 68 bp, Artificial Sequence
  Description of Artificial Sequence; note = synthetic construct
gcttttgtgtcttacttaggtcgttctcccatggaatgctttctctggcaaggtttgtggctccaacc

SEQ ID NO: 109 - DNA, 69 bp, Artificial Sequence
  Description of Artificial Sequence; note = synthetic construct
gctttttgtgtcttacttaggtggttctcccatggaatgctttctctggcaaggtttgtggctccaacc

SEQ ID NO: 110 - DNA, 69 bp, Artificial Sequence
  Description of Artificial Sequence; note = synthetic construct
gctttttgtgtgttacttaggtggttctcccatggaatgctttctctggcaaggtttgtggctccaacc

SEQ ID NO: 111 - DNA, 91 bp, Artificial Sequence
  Description of Artificial Sequence; note = synthetic construct
gtgtcttacttaggtgttctcccatggaatgctttctctggcaaggtttgtggctccaaccttctgtcccatctccaaaacagctgaggtg

SEQ ID NO: 112 - DNA, 89 bp, Artificial Sequence
  Description of Artificial Sequence; note = synthetic construct
gtggcttacttaggtgttctcccatggaatgctttccctggcaaggtttgtgctccaaccttctgtccatctgcaaaacagctgaggtg

SEQ ID NO: 113 - DNA, 90 bp, Artificial Sequence
  Description of Artificial Sequence; note = synthetic construct
gtgtcttacttaggtgttctcccatggaatgctttctctggcaaggtttgtggctccaaccttctgtccatctgcaaaacagctgcggtg

SEQ ID NO: 114 - DNA, 90 bp, Artificial Sequence
  Description of Artificial Sequence; note = synthetic construct
tcttacttatgtgttctcccatggaatgctttctctggcaaggtttgtggctccaaccttctgtccatctgcaaaccagctgaggggagg

SEQ ID NO: 115 - DNA, 90 bp, Artificial Sequence
  Description of Artificial Sequence; note = synthetic construct
tcttacttaggtgttctcccatggaatgctttctctgggaaggtttgtggctccaaccttctgtccatctgcaaaacagctgaggtgagg

SEQ ID NO: 116 - DNA, 90 bp, Artificial Sequence
  Description of Artificial Sequence; note = synthetic construct
tcttacttaggcgttctcccatggaatgctttctctggcaaggtttgtggctccanccttctgtccatctgcaaaacagctgaggtgagt

SEQ ID NO: 117 - DNA, 90 bp, Artificial Sequence
  Description of Artificial Sequence; note = synthetic construct
cttacttaggtgttctcccatggaatgctttcgctggcaaggtttgtggctccaaccttctgtccatctgcaaaacagctgaggggagtg

SEQ ID NO: 118 - DNA, 68 bp, Artificial Sequence
  Description of Artificial Sequence; note = synthetic construct
tcccatggaatgctttccctggcaaggtttgtggctccaaccttctgtccatctgcaaaacagctgag

SEQ ID NO: 119 - DNA, 68 bp, Artificial Sequence; identical to SEQ ID NO: 118
  Description of Artificial Sequence; note = synthetic construct

SEQ ID NO: 120 - DNA, 69 bp, Artificial Sequence
  Description of Artificial Sequence; note = synthetic construct
tcccatggaatgctttctctggcaaggtttgtggctnccaaccttctgtccatctgcaaaacagctgag

SEQ ID NO: 121 - DNA, 50 bp, Artificial Sequence
  Description of Artificial Sequence; note = synthetic construct
attaaatgtgtgcataccctccaataatttggctgggaattctgagcaag

SEQ ID NO: 122 - DNA, 50 bp, Artificial Sequence
  Description of Artificial Sequence; note = synthetic construct
attaaatgtgtgcataccctccaataatttggctggcaattccgagcaag

SEQ ID NO: 123 - DNA, 50 bp, Artificial Sequence
  Description of Artificial Sequence; note = synthetic construct
taaatgtgtgcataccctccaataatttggctgggaattctgagcaagcc

SEQ ID NO: 124 - DNA, 50 bp, Artificial Sequence
  Description of Artificial Sequence; note = synthetic construct
taaatgtgtgcataccctccaataatttggctggcaattccgagcaagcc

SEQ ID NO: 125 - DNA, 50 bp, Artificial Sequence; identical to SEQ ID NO: 123
  Description of Artificial Sequence; note = synthetic construct

SEQ ID NO: 126 - DNA, 50 bp, Artificial Sequence; identical to SEQ ID NO: 124
  Description of Artificial Sequence; note = synthetic construct

SEQ ID NO: 127 - DNA, 50 bp, Artificial Sequence
  Description of Artificial Sequence; note = synthetic construct
aaatgtgtgcataccctccaataatttggctgggaattctgagcaagcca

SEQ ID NO: 128 - DNA, 50 bp, Artificial Sequence
  Description of Artificial Sequence; note = synthetic construct
aaatgtgtgcataccctccaataatttggctggcaattccgagcaagcca

SEQ ID NO: 129 - DNA, 50 bp, Artificial Sequence; identical to SEQ ID NO: 127
  Description of Artificial Sequence; note = synthetic construct

SEQ ID NO: 130 - DNA, 50 bp, Artificial Sequence; identical to SEQ ID NO: 128
  Description of Artificial Sequence; note = synthetic construct

SEQ ID NO: 131 - DNA, 38 bp, Artificial Sequence
  Description of Artificial Sequence; note = synthetic construct
ctgagcccgctttcttctcccgcaggcctgtaggagct

SEQ ID NO: 132 - DNA, 38 bp, Artificial Sequence
  Description of Artificial Sequence; note = synthetic construct
gactcgggcgaaagaagagggcgtccggacatcctcga

SEQ ID NO: 133 - DNA, 16 bp, Artificial Sequence
  Description of Artificial Sequence; note = synthetic construct
taggagttgcacaacc

SEQ ID NO: 134 - DNA, 16 bp, Artificial Sequence
  Description of Artificial Sequence; note = synthetic construct
atcctcaacgtgttgg

SEQ ID NO: 135 - DNA, 17 bp, Artificial Sequence
  Description of Artificial Sequence; note = synthetic construct
agcctgcggctggagcg

SEQ ID NO: 136 - DNA, 17 bp, Artificial Sequence
  Description of Artificial Sequence; note = synthetic construct
tccgagcggcacgtggc

SEQ ID NO: 137 - DNA, 13 bp, Artificial Sequence
  Description of Artificial Sequence; note = synthetic construct
gaagattgcaatc

SEQ ID NO: 138 - DNA, 13 bp, Artificial Sequence
  Description of Artificial Sequence; note = synthetic construct
gttgtaacgttag

SEQ ID NO: 139 - DNA, 15 bp, Artificial Sequence
  Description of Artificial Sequence; note = synthetic construct
ttggagacggagtct

SEQ ID NO: 140 - DNA, 15 bp, Artificial Sequence
  Description of Artificial Sequence; note = synthetic construct
aacctctgcctcaga

SEQ ID NO: 141 - DNA, 126 bp, Artificial Sequence
  Description of Artificial Sequence; note = synthetic construct
ttggcgtctctgcaatgcttagagttcttaggctttttgctttggtctcagatgtttctccagggtctcttcttctgccacactatgatgttttgtttttgacttgtgcttataaaaattattttc

SEQ ID NO: 142 - DNA, 126 bp, Artificial Sequence; identical to SEQ ID NO: 141
  Description of Artificial Sequence; note = synthetic construct

SEQ ID NO: 143 - DNA, 108 bp, Artificial Sequence
  Description of Artificial Sequence; note = synthetic construct
agagttcttaggcttttgctttggtctcagatgtttctccagggtctcttcttctgccacactatgatgttttgtttttgacttgtgcttaaaaaattattttccatt

SEQ ID NO: 144 - DNA, 108 bp, Artificial Sequence; identical to SEQ ID NO: 143
  Description of Artificial Sequence; note = synthetic construct

SEQ ID NO: 145 - DNA, 108 bp, Artificial Sequence
  Description of Artificial Sequence; note = synthetic construct
agagttcttaggcttttgctttggtctcagatgtttctccagggtctcttcttctgccacactatgatgttttgtttttgactgtgcttaaaaattattttccatttg

SEQ ID NO: 146 - DNA, 108 bp, Artificial Sequence; identical to SEQ ID NO: 145
  Description of Artificial Sequence; note = synthetic construct

SEQ ID NO: 147 - DNA, 99 bp, Artificial Sequence
  Description of Artificial Sequence; note = synthetic construct
tctccagggtctcttcttctgccacactatgatgttttgtttttgacttgtgcttaaaaaattattttcatttgtttattctcccaaaaagcttctgtt

SEQ ID NO: 148 - DNA, 102 bp, Artificial Sequence
  Description of Artificial Sequence; note = synthetic construct
tctccagggtctcttcttctgccacactatgatgttttgtttttgacttgtgcttataaaaaattattttccatttgtttattctcccaaaaagcttctgtt

SEQ ID NO: 149 - DNA, 127 bp, Artificial Sequence
  Description of Artificial Sequence; note = synthetic construct
agggtgtgttgttgtgggagagtatgatgttttgtttttgagttgtggttataaaaattattttccatttgtttattctcggaaaaaggttctgtttgagggtggctgggtgtttgtcttttgtaag

SEQ ID NO: 150 - DNA, 127 bp, Artificial Sequence; identical to SEQ ID NO: 149
  Description of Artificial Sequence; note = synthetic construct

SEQ ID NO: 151 - DNA, 125 bp, Artificial Sequence
  Description of Artificial Sequence; note = synthetic construct
gggagatggacggggctgtgtgggtcccagccccaatcgccacctccacacccctcctagcacccctcacttacaagtccctggttaatgaaatactaggcaaagtaaactacgaccaagggaac

SEQ ID NO: 152 - DNA, 125 bp, Artificial Sequence; identical to SEQ ID NO: 151
  Description of Artificial Sequence; note = synthetic construct

SEQ ID NO: 153 - DNA, 100 bp, Artificial Sequence
  Description of Artificial Sequence; note = synthetic construct
gggagatggacggggctgtgtgggtcccagccccaatcgccccctccacacccctcctagcacccctcacttacaagtccctggttaatgaaatactcgg

SEQ ID NO: 154 - DNA, 100 bp, Artificial Sequence; identical to SEQ ID NO: 153
  Description of Artificial Sequence; note = synthetic construct

SEQ ID NO: 155 - DNA, 94 bp, Artificial Sequence
  Description of Artificial Sequence; note = synthetic construct
gggctgtgtgggtcccagccccaatcgccacctccacacccctggtagcacccctcacttacaagtccctggttaatgaaatactaggcaaagt

SEQ ID NO: 156 - DNA, 94 bp, Artificial Sequence; identical to SEQ ID NO: 155
  Description of Artificial Sequence; note = synthetic construct

SEQ ID NO: 157 - DNA, 92 bp, Artificial Sequence
  Description of Artificial Sequence; note = synthetic construct
tgggtcccagccccaatcgccacctccacacccctcctagcacccctcacttacaagtccctggttaatgaaatactaggcaaagtaaacta

SEQ ID NO: 158 - DNA, 92 bp, Artificial Sequence; identical to SEQ ID NO: 157
  Description of Artificial Sequence; note = synthetic construct

SEQ ID NO: 159 - DNA, 100 bp, Artificial Sequence
  Description of Artificial Sequence; note = synthetic construct
tcccagccccaatcgccacctccacacccctcctagcacccctcacttacaagtccctggttaatgaaatactaggcaaagtaaactacgaccaagggaa

SEQ ID NO: 160 - DNA, 100 bp, Artificial Sequence; identical to SEQ ID NO: 159
  Description of Artificial Sequence; note = synthetic construct

SEQ ID NO: 161 - DNA, 118 bp, Artificial Sequence
  Description of Artificial Sequence; note = synthetic construct
ccatagaaaagaaggggaaagaaaacatcaagggtcccatagactcaccctgaagttgtcaggatccacgtgcagcttgtcacagtgcagctcactcagtgtggcaaaggtgcccttg

SEQ ID NO: 162 - DNA, 118 bp, Artificial Sequence
  Description of Artificial Sequence; note = synthetic construct
ccatagaaaagaaggggaaagaaaacatcaagcgtcccatagactcaccctgaagttctcaggatccacgtgcagcttgtcacagtgcagctcactcagtgcggcaaaggtgcccttg

SEQ ID NO: 163 - DNA, 118 bp, Artificial Sequence
  Description of Artificial Sequence; note = synthetic construct
aaaagaaggggaaagaaaacatcaagggtcccatagactcaccctgaagttgtcaggatccacgtgcagcttgtcacagtgcagctcactcagtgtggcaaaggtgcccttgaggttg

SEQ ID NO: 164 - DNA, 118 bp, Artificial Sequence
  Description of Artificial Sequence; note = synthetic construct
aaaagaaggggaaagaaaacatcaagcgtcccatagactcaccctgaagttctcaggatccacgtgcagcttgtcacagtgcagctcactcagtgtggcaaaggtgcccttgaggttg

SEQ ID NO: 165 - DNA, 113 bp, Artificial Sequence
  Description of Artificial Sequence; note = synthetic construct
gaaggggaaagaaaacatcaagggtcccatagactcaccctgaagttgtcaggatccacgtgcagcttgtcacagtgcagctcactcagtgtggcaaaggtgcccttgaggtt

SEQ ID NO: 166 - DNA, 113 bp, Artificial Sequence
  Description of Artificial Sequence; note = synthetic construct
gaaggggaaagaaaacatcaagcgtcccatagactcaccctgaagttctcaggatccacgtgcagcttgtcacagtgcagctcactcagtgtggcaaaggtgcccttgaggtt

SEQ ID NO: 167 - DNA, 89 bp, Artificial Sequence
  Description of Artificial Sequence; note = synthetic construct
aagggggaagaaaacatcaagggtcccatagactcaccctgaagttgtcaggatccacgtgcagcttgtcacagtgcagctcactcagt

SEQ ID NO: 168 - DNA, 89 bp, Artificial Sequence
  Description of Artificial Sequence; note = synthetic construct
aaggggaaagaaaacatcaagcgtcccatagactcaccctgaagttctcaggatccacgtgcagcttgtcacagtgcagctcactcagt

SEQ ID NO: 169 - DNA, 118 bp, Artificial Sequence
  Description of Artificial Sequence; note = synthetic construct
ggaaagaaaacatcaagggtcccatagactcaccctgaagttgtcaggatccacgtgcagcttgtcacagtgcagctcactcagtgtggcaaaggtgcccttgaggttgtccaggtga

SEQ ID NO: 170 - DNA, 118 bp, Artificial Sequence
  Description of Artificial Sequence; note = synthetic construct
ggaaagaaaacatcaagcgtcccatagactcaccctgaagttctcaggatccacgtgcagcttgtcacagtgcagctcactcagtgtggcaaaggtgcccttgaggttgtccaggtga

SEQ ID NO: 171 - DNA, 154 bp, Artificial Sequence
  Description of Artificial Sequence; note = synthetic construct
ggctggtttcctgaccttaggcgatctgccctccttggcctcccaaagtgctgggattacaggcgtgagccaccacacccagccatggccaagttttgtctccttggacccctctccctcccggctcagggcagctcacctggccagcagcagg

SEQ ID NO: 172 - DNA, 154 bp, Artificial Sequence
  Description of Artificial Sequence; note = synthetic construct
ggctggtttcctgaccttaggcgatctgccctccttggcctcccaaagtgctgggattacaggcgtgagccaccacacccagccatggccaagttttctctccttggacccctctccctgccggctcagggcagctcacctggccagcagcagg

SEQ ID NO: 173 - DNA, 51 bp, Artificial Sequence
  Description of Artificial Sequence; note = synthetic construct
ctgagggttcagaagaggtggagtaacttgttcaacgctacaaagctaaaa

SEQ ID NO: 174 - DNA, 51 bp, Artificial Sequence; identical to SEQ ID NO: 173
  Description of Artificial Sequence; note = synthetic construct